(19) United States
(12) Patent Application Publication
(10) Pub. No.: US 2026/0368617 A1
(43) Pub. Date: Nov. 19, 2026

(54) TRAINING DYNAMIC HYBRID AI NETWORKS

(71) Applicant: D5AI LLC, Maitland, FL (US)

(72) Inventor: James K. Baker, Maitland, FL (US)

(21) Appl. No.: 19/148,212

(22) PCT Filed: Jan. 24, 2024
(86) PCT No.: PCT/US2024/012671

§ 371 Date: Jul. 15, 2025

Related U.S. Application Data
(60) Provisional application No. 63/481,697, filed on Jan. 26, 2023.
(60) Provisional application No. 63/468,145, filed on May 22, 2023.
(60) Provisional application No. 63/529,563, filed on Jul. 28, 2023.
(60) Provisional application No. 63/537,671, filed on Sep. 11, 2023.

(51) Int. Cl. G06N 20/00

(52) U.S. Cl. CPC G06N 20/00

(57) ABSTRACT

Computer-implemented methods and systems train, dynamically, a machine-learning network from a base system. Computing learned parameters for the network comprises, for at least a first portion of the machine-learning network, a back-propagation pass through the machine-learning network. The back-propagation pass comprises, for the first portion of the machine-learning network, computation of derivatives, with respect to a loss function, for the learned parameters. The method further comprises making a sensibility level assessment that comprises a determination of whether the machine-learning network produces an insensible result according to a criteria of sensibility. The method further comprises making one or more sensibility-improving modifications in response to a determination, in the sensibility level assessment of the machine-learning network, that the machine-learning network produces an insensible result, such that the one or one or more sensibility-improving modifications make the machine-learning network less vulnerable to producing insensible results.

### PRIORITY CLAIM

The present application claims priority to, and incorporates herein by reference, each of the following U.S. provisional patent applications: (1) Ser. No. 63/481,697, filed Jan. 26, 2023, titled “Training Dynamic Hybrid AI Networks”; (2) Ser. No. 63/468,145, filed May 22, 2023, titled “Training Human-Guided Hybrid AI Networks”; (3) Ser. No. 63/529,563, filed Jul. 28, 2023, titled “Explainable Adaptable Artificial Intelligence Networks”; and (4) Ser. No. 63/537,671, filed Sep. 11, 2023, titled “Explainable Adaptable Artificial Intelligence Networks.”

### BACKGROUND

Deep neural networks have had remarkable success in recent years. However, some fundamental problems remain, such as sensitivity to small adversarial perturbations in the data and the difficulty of interpreting the inner nodes in a large network. The sensitivity to small adversarial perturbations can cause a deep neural network classifier to make mistakes that no sensible entity would make. The difficulty of holistically interpreting inner nodes in context may make it impossible to fully trust the decisions and actions of an AI system based on such a network. The dangers posed by these problems can become very serious as society becomes increasingly dependent on AI systems using deep neural networks.

Although deep learning using large, deep neural networks is one of the most successful techniques in artificial intelligence, the size and complexity of a large, deep network can make it very difficult to understand its inner workings and to detect and diagnose any problems. Furthermore, the design of neural networks and the training techniques make a large neural network vulnerable to making mistakes that no sensible person would make. In general, deep neural networks are trained by a process called gradient descent in which, for each training data item, a computer system applies the chain rule of calculus to back propagate the derivative of an objective such as a divergence measure that penalizes errors. Adversarial attacks may make use of gradient descent to find small adversarial perturbations that cause a deep neural network classifier to make a mistake. Designing a network to be trained by gradient descent makes the network vulnerable to adversarial attacks based on gradient descent and to other sources of small perturbations.

The mistakes caused by such small perturbations are examples of the fact that the system lacks sensibility. That is, the system may make a mistake that no sensible person would make. More generally, deep neural networks lack common sense. Furthermore, the complexity of large neural networks makes it difficult if not impossible for humans to comprehend the details of the training process, much less to help contribute common sense. As AI systems become more and more capable and take on more and more tasks, the lack of common sense will become an increasing danger. Once AI systems take over the task of designing the next generation of AI systems without human understanding and control, it will become increasingly difficult to introduce sensibility and common sense. As AI systems control more aspects of human life, the consequences of mistakes could become catastrophic.

The difficulty of understanding inner nodes of a neural network is mainly caused by the large size and depth of the network together with training routines that give no guidance to get inner nodes to represent concepts that can be expressed in human language. In large part, the lack of sensibility and the lack of holistic interpretability are a consequence of the methods of training deep neural networks.

### SUMMARY

In one general aspect, the invention presents the concept of a dynamic hybrid network, which is a generalization of the concept of a neural network. Methods of hybrid training provide alternatives to training the network solely by gradient descent. The architecture of a hybrid network includes new elements called units and cells as well as neural network nodes. The training techniques for dynamic hybrid networks support training architectures that are robust against disturbances in the input data. The system supports several methods of training elements such as piecewise constant activation functions, including linear threshold functions. The training supports incremental growth of the network and continuing training during deployment. The configuration of a hybrid network is dynamic and may be changed and customized after receiving a specific input data item. Techniques are included to train the system to avoid classification errors that violate sensibility, including mistakes caused by adversarial attacks. Hybrid models and training techniques also contribute to the interpretability of inner elements in the context of surrounding elements and the rest of the network. The system supports supervision of the training process by a cooperative effort of a human team and one or more AI systems trained in the supervision of the training of a hybrid network. These and other benefits of dynamic hybrid networks will be apparent from the description below.

### DRAWINGS

Various embodiments of the present invention are described in conjunction with the following figures.

FIG. 1 is a flow chart of an illustrative embodiment of the invention.

FIG. 2 is a flow chart of an illustrative embodiment of processes for enhancing elementary sensibility in an aspect of the invention.

FIG. 3A is an illustrative diagram of a hybrid unit in an illustrative embodiment of the invention.

FIG. 3B is an illustrative diagram of an aspect of the invention called active defense.

FIG. 3C is an illustrative diagram of a substitute derivative function used in an aspect of the invention.

FIG. 4 is an illustrative diagram of a hierarchy of levels of techniques for improving sensibility.

FIG. 5 is an illustrative diagram of embodiments of aspects of hybrid training organized by stages of the training process.

FIG. 6 is a flow chart of an illustrative embodiment of constrained optimization in training.

FIG. 7 is a flow chart of an illustrative embodiment of hidden state space modeling in an aspect of the invention.

FIG. 8 is a flow chart of an illustrative embodiment of the operation of sensible classification with a trained hybrid network and rapid matching.

FIG. 9 is an illustrative diagram of a type of autoencoder used in an aspect of the invention.

FIG. 10 is a diagram of an illustrative embodiment of a robust template model used in an aspect of the invention.

FIG. 11 comprises flow charts for illustrative embodiments for training data exclusion and data delegation in aspects of the invention.

FIG. 12 is a flow chart of an illustrative embodiment for training alignment models in an aspect of the invention.

FIG. 13 is a flow chart of an illustrative embodiment of an aspect of the invention called “conditional hybrid training.”

FIG. 14 is a diagram of an illustrative embodiment of an aspect of the invention for transformation or translation of data spaces.

FIG. 15 is a flow chart of an illustrative embodiment of an aspect of the invention using regression on counts in histogram bins.

FIG. 16 is an illustrative diagram of a hybrid network of units and cells.

FIG. 17 is an illustrative diagram of a multi-processor computer system such as might be used to implement various aspects of the invention.

FIG. 18 is a flow chart of an illustrative embodiment of back propagation of data examples in an aspect of the invention.

FIG. 19 is a flow chart of an illustrative embodiment of parallel or serial computations in a network of cells connected by data communication links.

FIG. 20 is a flow chart of an illustrative embodiment of empirical training.

FIG. 21 is a diagram of illustrative embodiments of aspects of the invention in which an artificial intelligence system comprising one or more hybrid networks implemented on computer system 1700 cooperates with a team of one or more humans on joint tasks.

FIG. 21A is a diagram of a multi-layer, feed-forward neural network.

FIG. 22 is a flow chart of an illustrative embodiment of the training and use of a system for image generation with human guidance.

FIG. 23 is a flow chart of an illustrative embodiment of the process of building and training of an interactive, human-guided writer's assistant.

FIG. 24 is a flow chart of an illustrative embodiment of a process for training a selected node to be more interpretable.

FIG. 25 is a diagram and a flow chart of an illustrative embodiment of a process of replacing an attention block output node with a multi-node unit and of training the nodes in the unit to be interpretable.

FIG. 26 is flow chart of an illustrative embodiment of a process herein called “round robin training.”

FIG. 27 is flow chart of an illustrative embodiment of a process for increasing the security of a text generation system.

FIG. 28 is a flow chart of an illustrative embodiment of a process for training a set of one or more nodes as named-set discriminators and for training and using associated confidence estimators.

FIG. 29 is a flow chart of an illustrative embodiment of targeted systematic growth of a network to improve performance and interpretability.

FIG. 30 is a system diagram of a distributed system comprising a plurality of autonomous modular cooperative subsystems.

FIG. 31 is a flow chart of an illustrative embodiment of a process of training a system comprising one or more autonomous modular cooperative subsystems, such as illustrated in FIG. 30. In preferred embodiments, computer system 1700 may grow the system during initial training and may continue the training and growth during the use of the system by end users. During the training, computer system 1700 may grow the system with the goal of making it easier for a human user to understand and control.

FIG. 32 is a flow chart of an illustrative embodiment of a process by which computer system 1700 may efficiently train a large language model with an arbitrarily large number of trainable parameters comprising transformer models and stochastic models.

FIG. 33 is system diagram of an illustrative embodiment of an aspect of the invention in which computer system 1700 uses diverse types of models cooperatively to efficiently train and rapidly incrementally grow one or more machine learning systems while improving performance, interpretability and control.

FIG. 34 is a flow chart of an illustrative embodiment of an aspect of the invention related to user control and to computer system 1700 tracking data and resources used during the training and use of a system.

FIG. 35 is a flowchart of an illustrative embodiment of a number of optional processes that computer system 1700 may use in some embodiments in system such as illustrated in FIGS. 30 and 33 and/or in processes such as illustrated in FIGS. 31, 32, 36, 37, 38 and 39.

FIG. 36 is a flow chart of an illustrative embodiment of cooperative process using diverse machine leaning systems such as illustrated in FIG. 33 in which the generative system is a transformer-based large language model.

FIG. 37 is a flow chart of an illustrative embodiment of a process for building a large system for text generation based on a hierarchy of ensembles of conditional probability models and joint optimization combining networks. In some embodiments, computer system 1700 may implement the process illustrated in FIG. 37 on a distributed computer system with a plurality of local computers.

FIG. 38 is a flow chart of an illustrative embodiment of an aspect of the invention by which computer system 1700 may expand the state space of a hidden Markov process modeling sequences of text.

FIG. 39 is a flow chart of an illustrative embodiment of a process for incrementally building and training an arbitrarily large, distributed AI system from components that each fit within specified limits on memory and/or on the amount of computation.

FIG. 40 is a flow chart of an illustrative embodiment of text generation that may use a system comprising a stochastic process model.

FIG. 41 is a flow chart of an illustrative embodiment of an aspect of the invention in which may incrementally grow a neural network, or a hybrid network making one or more duplicates of a component to improve the performance of the network or making the network easier to understand and control.

FIG. 42 is flow chart of an illustrative embodiment of computer system 1700 selecting a node to split based on tests of one or more criteria for potential improvements from various reasons and methods of splitting a node.

FIG. 43 is a flow chart of an illustrative embodiment of an aspect of the invention in which computer system 1700 may manage the training, saving and loading of certain types of conditional probability models.

FIG. 44 is a diagram of an illustrative embodiment of an aspect of the invention in which computer system 1700 may use a combining network, data dependent relation regularization links, and selective back propagation for decorrelation of errors for jointly optimizing the performance of a set of networks and training them to be diverse from each other.

FIG. 45 is a flow chart of an illustrative embodiment in which computer system 1700 may generate text using a combination of transformer language models and stochastic models, with cooperation among the AI language models as well as explicit cooperative interaction between the human author, and the AI system, as the writer's assistant.

FIG. 46 is a flow chart of an illustrative embodiment of an aspect of the invention in which, in some embodiments, computer system 1700 may efficiently train a large neural network by first training a smaller neural network.

FIG. 47 is a flow chart of an illustrative embodiment of a process by which computer system 1700 may train a large language model.

FIG. 48 is a flow chart of an illustrative embodiment of a process by which computer system 1700 may generate text using a pretrained large language model.

FIG. 49 is a flow chart of an illustrative embodiment of an aspect of the invention in which computer system 1700 trains a large language model comprising a hidden Markov process model.

FIG. 50 is a flow chart of an illustrative embodiment of an aspect of the invention in which computer system 1700 incrementally increases the size of a transformer by increasing the number of attention heads in a specified attention layer.

FIG. 51 is a flow chart of an illustrative embodiment of an aspect of the invention that uses fictitious play to train guardrails for a generative AI system and to train a system to detect guard rail violations.

FIG. 52 is a flow chart of an illustrative embodiment of the invention in which computer system 1700 trains a translation system using a multi-path chain of one-way translations in which each link in the chain translates from a source language to a target language.

FIG. 53 is a flow chart of an illustrative embodiment of an aspect of the invention in which computer system 1700 uses a multi-path chain of paired language translations to compute a robust composite translation.

FIG. 54 is a flowchart of an illustrative embodiment of an aspect of the invention in which computer system 1700 may add nodes with linear threshold activation functions to a neural network or hybrid network and train the nodes using methods other than gradient descent.

FIG. 55 is a flow chart of an illustrative embodiment of an aspect of the invention, in which, in some embodiments, computer system 1700 may develop, grow, and train an explainable large language model generative A.I. system.

FIG. 56 is a flow chart of an illustrative embodiment of the process of using an explainable large language model text generation system in an interactive deployment.

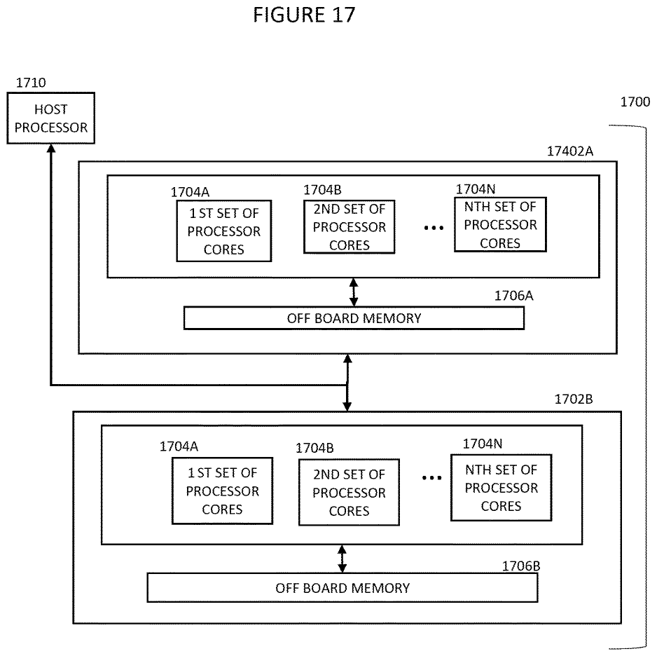

The processes illustrated in the figures may be implemented in a multi-processor computer system 1700, such as shown in FIG. 17. In preferred embodiments, the training and development of the system being developed may be supervised by a cooperative effort of a human team of knowledge engineers and AI systems, herein called the hybrid network learning management system (HNLMS). The AI systems in the HNLMS may also be implemented on a computer system such as computer system 1700.

### DESCRIPTION

The following paragraphs provide definitions for discussion of the figures.

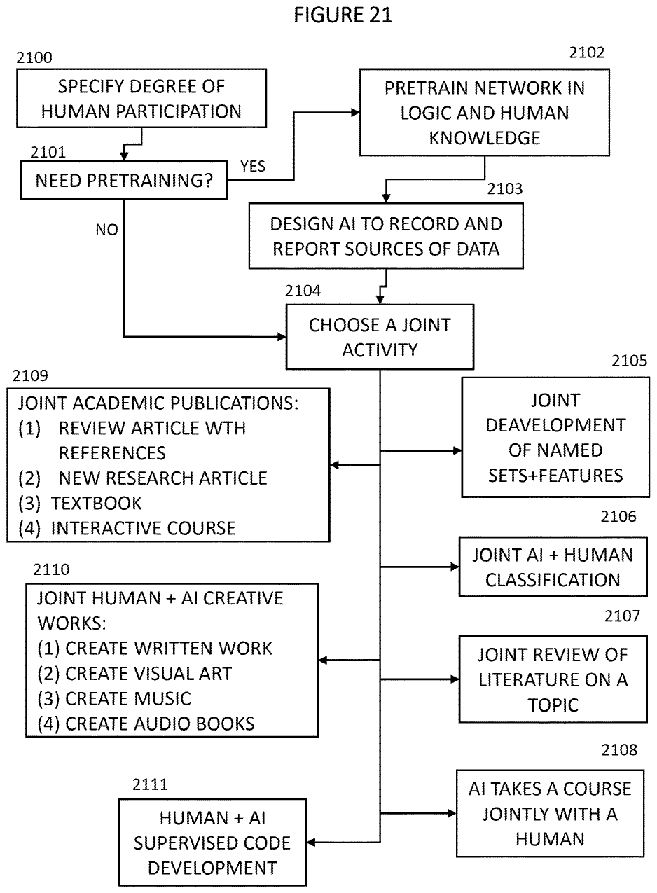

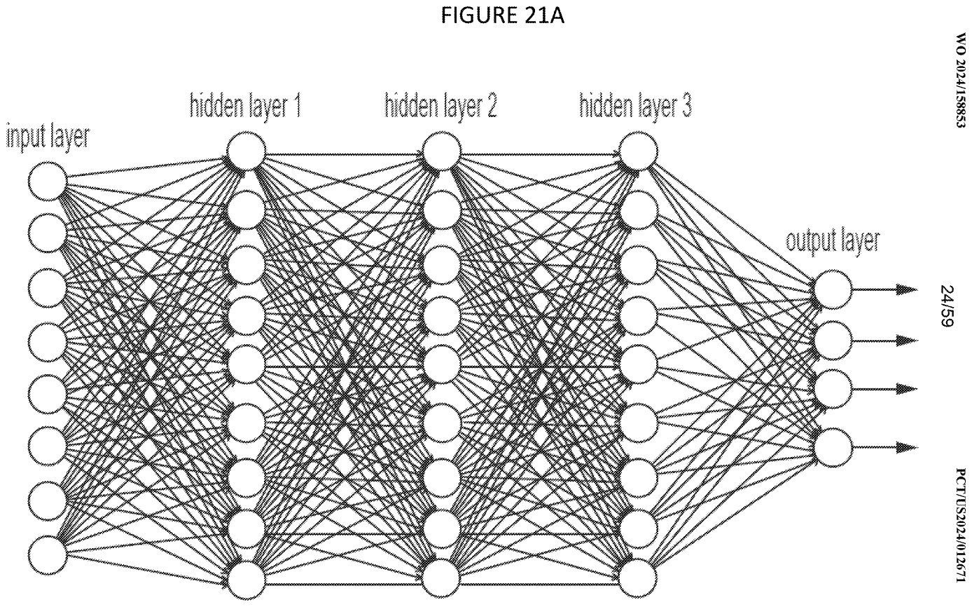

Neural network: A directed graph comprising a set of nodes and a set of directed connections between ordered pairs of nodes. Typically, each connection has an associated learned parameter, called its weight. Typically, computer system 1700 multiplies the output of the source node of the connection by the weight of the connection to compute a value to supply as an input value to the destination node of the connection. FIG. 21A shows a feed-forward neural network with multiple hidden layers.

Most discussions in this disclosure may refer to non-recurrent neural networks for which the graph is a directed acyclic graph. However, computer system 1700 may make multiple copies of a recurrent neural network in which all connection that would create a recurrence are redirected to the next copy of the network. By this means, computer system 1700 may model a recurrent neural network as a large “unrolled” network of non-recurrent copies of the base network so, for practical purposes, there is no loss in generality in assuming that the graph of a neural network is a directed acyclic graph.

Computer system 1700 may also use this unrolling mechanism with a hybrid network. In addition, hybrid networks provide additional ways to train models of recurrent processes. For example, computer system 1700 may model a recurrent process using a hidden state space model in the cells of the hybrid network. In a hybrid network, cells may be connected using bidirectional data communication links. The network of data communication links may contain cycles.

Node: A node in a neural network. In a hybrid network, the elements are called units and cells rather than nodes, except for internal neural nodes within a unit. A node within a unit may receive connections from nodes in other units and may source connections to nodes in other units.

Unit: A unit is a generalization of a neural network node. A unit may have multiple output values as well as multiple connections for each output value. A unit may comprise multiple nodes and subunits. A unit may also comprise special purpose elements called “cells” that are linked by data communication links rather than by network connections. A unit may comprise a single neural node or may comprise a single cell.

Cell: An element in a hybrid network that may store and transmit values of specified variables. Computer system 1700 may store and execute program code associated with a cell upon receiving data as input to the network or transmitted from other cells. A cell may be associated with program code that computer system 1700 may execute when computing the activation and response of the network for a specified input data item.

Hybrid network: A network of units and connections, rather than neural nodes and connections. A hybrid network may also comprise cells and data communication links. Computer system 1700 may change and customize the configuration of a dynamic hybrid network after receiving a data item to be classified.

Components of a neural node: A typical node in a neural network comprises two component operations: an affine summation and an activation function.

Affine sum: In the affine sum operation of a neural node, computer system 1700 computes a weighted sum of incoming values from connections into the node plus a node-specific bias term.

Activation function: In a typical neural node, computer system 1700 computes a specified function of the affine sum. The function is called the “activation function” of the node. The value of the activation function for a data item d, is called “the activation” of the node for data item d. The output value of the node is the output of the activation function for data item d. Examples of activation functions include but are not limited to, sigmoid, softmax, Tanh, and ReLU (Rectified Linear Unit) activation functions.

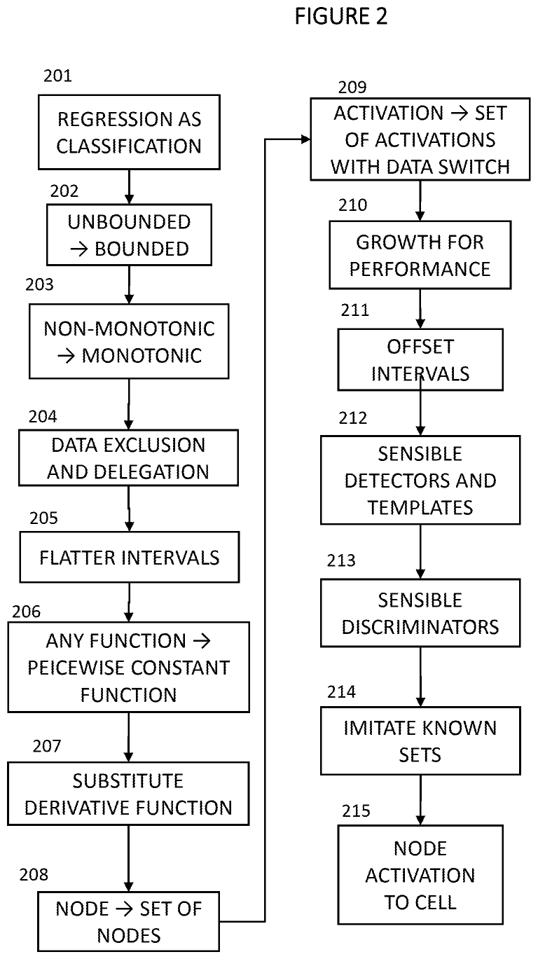

Implicit error: A determination that computer system 1700 may make that an interior node with a standard discriminator activation function (defined in block 203 of FIG. 2) has made an error on a specific data item when computer system 1700 compares the activation of the node relative to a specified threshold with the sign of the back propagated derivative of an objective function.

Known set: A known set is a set of data items for which computer system 1700 can determine for any specific data item, to a specified degree of accuracy, whether the data item is in the known set. For example, the set of training data items for any output category in a classification system is a known set. Any set of items that computer system 1700 may detect, to a specified degree of accuracy, based on an output value of a node, cell, unit, or network being within a specified interval is a known set.

Named set: A named set is a known set for which computer system 1700 has a name that may be easily understood by a human. Generally, the set of data items for any output category is a named set. In some embodiments, a human may supply a name for an unnamed known set.

Network repository: A repository of previously trained nodes, cells, units, and networks that may be implemented by computer system 1700. In some embodiments, computer system 1700 may place a trained network or a partially trained network into a network repository. In some embodiments, computer system 1700 may place the subnetwork that activates a selected node, cell, or unit into a network repository. In some embodiments, computer system 1700 may mutually share some or all the contents of its network repository with other computer systems.

Knowledge engineering: The development of tools for analyzing data and computing useful functions and properties of the data in a specified domain in order to facilitate the development of machine learning systems to classify data items in the domain.

Hybrid Network Learning Management System (HNLMS): A system comprising a cooperation of a team of one or more humans with one or more AI systems. The human team and AI systems guide the training of hybrid networks to improve the sensibility and holistic interpretability as well as the performance of the networks being trained.

Detector: A node, unit, or cell with an output value that computer system 1700 characterizes as attempting to have values in a specified interval for data items in a target acceptance set and values not in the specified interval for data items not in the acceptance set. In some embodiments, the specified interval is the set of values above a specified threshold value. In some embodiments, the target acceptance set is known to computer system 1700, for example for an output node of a classifier for supervised training data. The actual set of data items in the specified interval may be called the “empirical acceptance set.” Where the meaning is clear, either the target acceptance set or the empirical acceptance set may simply be called “the acceptance set.” In some embodiments, the target acceptance set of a network element is not explicitly specified and is not a known set. In some embodiments in which the acceptance set of a detector is not explicitly known, computer system 1700 may tentatively empirically associate the output values with a known set.

Discriminator: A node, unit, or cell with an output value that computer system 1700 characterizes as attempting to have values in a first specified interval for data items in a first target acceptance set and a second specified interval for data items in a second target acceptance set. In some embodiments, computer system 1700 may have no target interval for data items not in either acceptance set. In some embodiments, a unit may have additional output values to characterize data items that are not in either target acceptance set.

Recall: In a data retrieval task or a detection task, the fraction of the number of correct retrievals or detections of target data items made from a specified set of data items by a machine learning system divided by the total number of target data items in the specified set of data items.

Precision: In a data retrieval task or a detection task, the fraction of the number of correct retrievals or detections of target data items made from a specified set of data items by a machine learning system divided by the total number of data items in the specified set of data items that are detected or accepted by the machine learning system, including false or incorrect items.

Association: The association of a specified known or named set with the set of data corresponding to a specified detector node, unit, or cell or to an interval of the activation function of a node is the determination that the specified detection satisfies a specified criterion for recall and/or precision with respect to the specified known or named set.

Knowledge Sharing Links: A knowledge-sharing link is a link between an ordered pair of nodes, a reference node and a receiving node. The nodes may both be nodes in the same network or the nodes may be in two separate networks. Only the receiving network needs to be in a network currently being trained. If the nodes are in separate networks, it must be possible to activate both nodes on the same data item. For example, the two nodes may share a global or local input data space. In some embodiments, computer system 1700 may compute a mapping from one data space to the other. During training of the network comprising the receiving node, for specified data items, computer system 1700 may impose a regularization penalty if the activations of the two nodes fail to satisfy a specified relationship.

The Relation of a Knowledge Sharing Link: A common example relation of a knowledge-sharing link is the “is-equal-to” relation. For the is-equal-to relation between act_{reference}(data) and act_{receive}(data), computer system 1700 may impose the regularization penalty,

α*|act_{reference}(d)−act_{receive}(d)|,

where α is a hyperparameter controlled, for example, by the HNLMS. The hyperparameter α is called the “strength” of the knowledge-sharing link. The HNLMS may also specify that the regularization only be imposed for specified data items. A knowledge-sharing link is not a connection. For example, in a non-recurrent network, a link may go from a reference node in a higher layer to a receiving node in a lower layer, which is not allowed for a connection in a non-recurrent network. Other common knowledge sharing relations include, is-less-than, is-greater-than, and is-not-equal-to. By convention, in the asymmetric relations, the reference node is the first argument.

The inequality relations, is-greater-than and is-less-than, are useful, for example, in sharing knowledge between two nodes in which one node is associated with a known set that is a subset of a known set associated with the other node. For example, the set of horses is a subset of the set of equines, which is a subset of the set of mammals, which is a subset of the set of animals, which is a subset of the set of living things. In some embodiments, computer system 1700 may impose a knowledge-sharing link that the activation of a node associated with a superset should be greater than or equal to the activation of a node associated with a subset. For the is-greater-than relation between act_{reference}(data) and act_{receive}(data), computer system 1700 may impose the regularization penalty:

α*(act_{receive}(d)−act_{reference}(d) if act_{reference}(d)<act_{receive}(d),

where α is a hyperparameter controlled, for example, by the HNLMS. For example, in phonetic recognition, the activation of a node associated with the set of vowels should be should greater than or equal to the activation of a node associated with the set of high front vowels. In some embodiments, computer system 1700 may limit the enforcement of the regularization to data in a specified interval in the reference node.

In some embodiments, computer system 1700 may limit the maximum regularization penalty for the is-not-equal-to relation. For example, for the is-not-equal-to relation, computer system 1700 may impose the regularization penalty:

max(0,β−α*|act_{reference}(d)−act_{receive}(d)|),

with maximum penalty β, where α and β are hyperparameters controlled, for example, by the HNLMS.

In some embodiments, computer system 1700 may impose an is-equal-to knowledge-sharing link or an is-not-equal-to knowledge-sharing link in both directions between a pair of nodes.

The use of an is-equal-to knowledge-sharing link in both directions is also called “soft-tying” of the pair of nodes. The use of an is-not-equal-to knowledge-sharing link in one or both directions is also called “counter-tying” of the pair of nodes. In some embodiments, soft-tying and counter-tying links may be bi-directional, although the counter-tying links are asymmetrical.

In some embodiments, computer system 1700 may use is-equal-to soft-tying and/or is-not-equal-to counter-tying regularization on the weight parameters of one or more of the corresponding connections into a pair of homologous nodes. However, because the values of weight parameters are not data dependent, the knowledge sharing links between weights are also not data dependent.

Flat activation interval: An interval in an activation function that satisfies a specified flatness criterion, such as a limit on the magnitude for the derivative of the function within the interval or a limit on the difference between the maximum and minimum values of the function within the interval. The extreme case of a flat activation interval is an interval in which the function has a constant value throughout the interval.

Data exclusion: A process of excluding data in the training or deployment of a unit in a hybrid network based on a specified criterion.

Data switch: An element of a network that may selectively pass an activation or other incoming variable to only a specified subset of one or more destinations. In some embodiments, the specified subset may be the empty set.

Local data space: An n-tuple of variables in a hybrid network that are the input variables for a specified set of units and/or nodes. The variables of a local data space may be in an inner layer of the network. A local data space may also be called a “local input space” or a “local feature space.” A local data space may be an encoding of a larger set of variables.

Decision element: A specified interval in the range of a computable variable f(d) dependent on the input data d to a network, where a value of f(d) being in the specified interval is interpreted as the variable indicating that the data item d is in a specified set (detection) or that the data item is not in a specified set (rejection).

Decision element group: A set of one or more detection decision elements for which the specified target detection sets are disjoint. Computer system 1700 may interpret a discriminator as a decision element group comprising two intervals, each a decision element detector for one of the discriminator alternatives. Computer system 1700 may interpret a softmax set as a decision element group with each node in the softmax set as a detector for a target set disjoint from the others.

Holistic interpretation: A human understandable explanation of a node or unit in relation to other nodes and units and the whole system. Many of the techniques for improving sensibility also contribute to holistic interpretability and vice versa. For example, association of a node or unit with a named set is directly an aspect of holistic interpretability that also facilitates improving sensibility.

Substitute derivative function: A specified function of the input to the activation function that computer system 1700 uses for one or more specified data item in place of the actual derivative of the activation function. The HNLMS may specify the same substitute derivative function for a selected node for all data items, or may specify different substitute activations for different data items. The HNLMS may change the specified substitute derivative functions during the training.

Template model: A specified computation designed to assign higher values for data items in a specific target set than for data items not in the target set while satisfying specified criteria for elementary sensibility. In an illustrative embodiment, the template model comprises input from a local or global data space, a specified norm in the data space, a specified central point for the target set in the data space, and an output value that is a function of the distance from the central point to an input data item as measured by the norm. A template model may be represented in a node, unit, or cell. Without loss of generality, in illustrative embodiments, computer system 1700 may represent a template model as a dedicated cell since a cell paired with a specified node or unit can represent the same computation as the node or unit comprising the computation of the cell.

Robust template model: A template model designed to satisfy specified sensibility criteria.

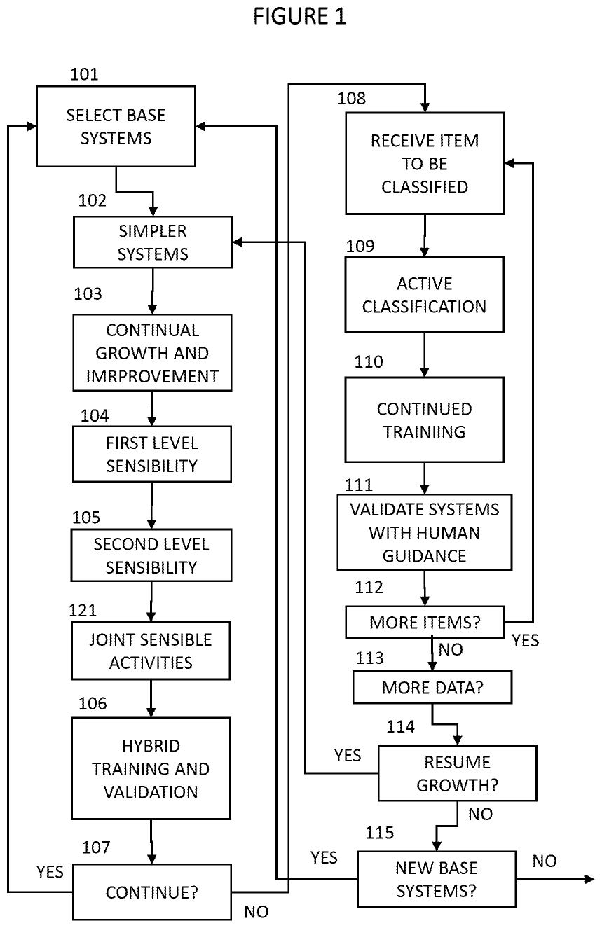

Having now provided various definitions, embodiments of the present invention are further described below. FIG. 1 is a flow chart of an illustrative embodiment of an aspect of the invention. In the embodiment illustrated in FIG. 1, computer system 1700 builds and trains a hybrid network. In terms of equivalent computations, the class of hybrid networks includes the class of neural networks as a strict subset.

In preferred embodiments, the process of building and training the hybrid network is a process of continual growth and improvement of the systems being built and trained with a plurality of training methods. In blocks 101 to 107, computer system 1700 modifies and grows the systems being developed before deployment. In blocks 108 to 114, computer system 1700 continues the growth and training during and after deployment. In various aspects of the invention, computer system 1700 may use a variety of processes to improve the sensibility of a system being developed. For the purpose of discussion, the processes of improvement are divided into two levels. Each level is associated with different criteria for assessing sensibility. Generally, the second level of sensibility involves more complex criteria for sensibility. In some embodiments, computer system 1700 may use a specific process for improvement in a level of sensibility other than the level in which that specific process has been discussed.

In block 101, computer system 1700 selects one or more base machine learning systems. In some embodiments, computer system 1700 may select a base machine learning system that is not represented as a network and use incremental growth to build a hybrid network. In some embodiments, computer system 1700 may select a partially trained or fully trained conventional neural network as a base system. A conventional feed-forward neural network is described below in connection with FIG. 21A. In some embodiments, computer system 1700 may select a hybrid network as a base network. In the processes illustrated in FIG. 1 and other figures, computer system 1700 may make modifications and additions to the base systems in a continual training process.

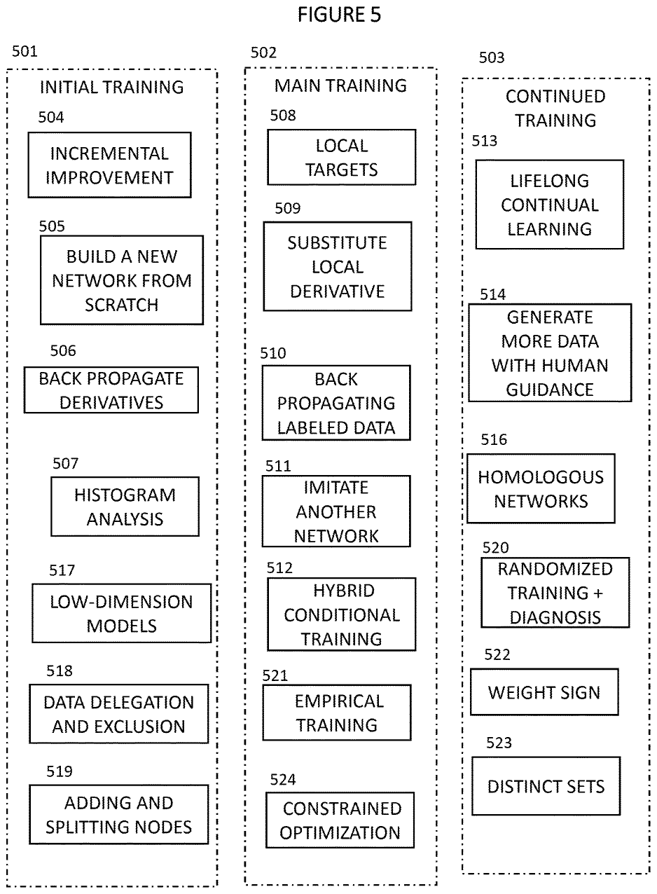

In some embodiments, computer system 1700 may co-train a plurality of networks. In some embodiments, computer system 1700 may co-train a diverse set of homologous networks comprising a diverse set of sensible hybrid networks and a diverse set of canary networks and, optionally, a diverse set of networks optimized for classification accuracy without regard to sensibility as explained in association with FIG. 21 and block 516 of FIG. 5.

In some embodiments, computer system 1700 may select a single base network.

If the base network is a conventional neural network, computer system 1700 may modify and grow the network to become a hybrid network. In some embodiments, computer system 1700 may select an empty network as the starting network, growing a sensible hybrid network from scratch. In some embodiments, computer system 1700 may grow a sensible hybrid network from scratch using a non-network or a network base system as a reference system for knowledge sharing and/or imitation learning. Imitation learning is described in U.S. Pat. Nos. 11,410,050 and 11,531,900, both titled “Imitation training for machine learning systems with synthetic data generators,” and published PCT application WO/2021/194516, titled “Data-dependent node-to-node knowledge sharing by regularization in deep learning,” all of which are incorporated herein by reference in their entirety.

In some embodiments, computer system 1700 may use one or more reference networks as a reference for known or named sets.

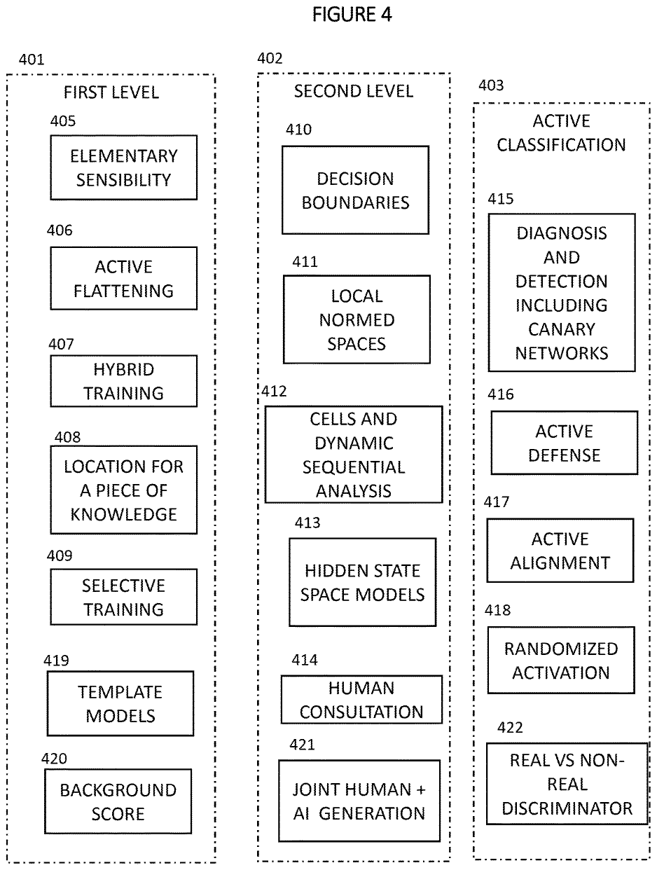

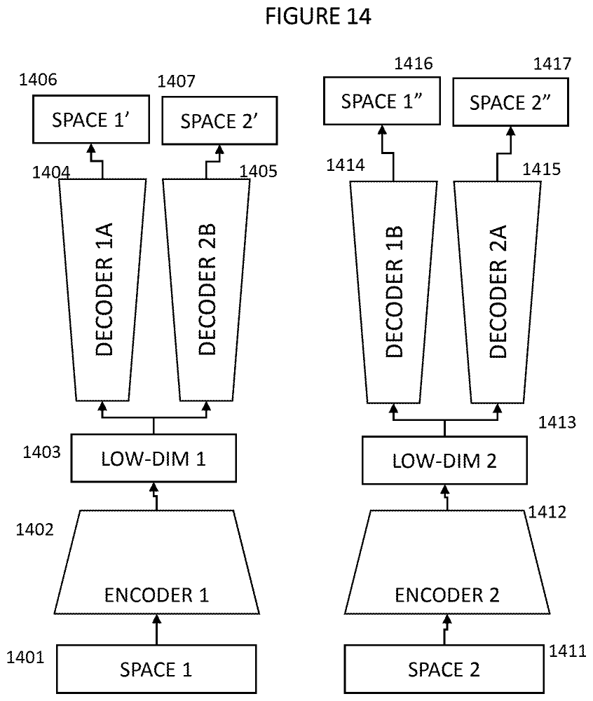

In some embodiments, computer system 1700 may use human consultation to associate a name with a known set. In some embodiments, when computer system 1700 associates a name with a known set, computer system 1700 may then train one or more detectors for the known set to better match detection of the named set. Computer system 1700 may use a named-set detector in a reference system to train a detector in the current system by knowledge sharing and/or imitation learning. In imitation learning, an element in the system being trained is trained with a local training target to match the output of a specified element in the reference system. In some embodiments, computer system 1700 may use a unidirectional or a bidirectional transformation between a data space in the current network and a reference network in order to apply knowledge sharing and/or imitation learning. Human consultation is discussed further in association with block 414 of FIG. 4. Unidirectional and bidirectional transformation of data spaces is discussed in association with FIG. 14.

In block 102, in some embodiments, computer system 1700 optionally obtains and/or builds and trains one or more systems that are smaller or simpler than the current base system. For example, in some embodiments, computer system 1700 may specify a simpler system to facilitate potential human guidance and consultation, as discussed in association with block 414 of FIG. 4. In some embodiments, a human consultant may specify experimental changes to the system. In some embodiments, specifying experimental changes in a simpler system may take less time and effort than in a more complex system. In some embodiments, computer system 1700 may follow specified design rules to make a simpler system easier for a human consultant to understand and control.

In some embodiments, computer system 1700 may specify a simpler network to reduce the amount of computation required for training. In some embodiments, computer system 1700 may specify a simpler network for which it is easier to design and train sensibility. In some embodiments, computer system 1700 may specify a simpler network for better holistic interpretability.

In some embodiments, computer system 1700 may work with one or more simpler systems in parallel with the current base system. In some embodiments, computer system 1700 may temporarily replace the current base system with a simpler system.

In some embodiments, these simpler systems may also be designed to generalize better from limited amounts of training data. The goal of these simpler systems is not to match the classification accuracy of the base systems selected in block 101. Rather the main goal is to be less vulnerable to making non-sensible mistakes. The vulnerability of a classifier system to non-sensible mistakes tends to be proportional to the number of input variables, so it is easier for computer system 1700 to make a simpler system with fewer input variables less vulnerable. In some embodiments, computer system 1700 may use one or more smaller, simpler systems to accelerate the training and use of a larger system.

In an image recognition task, an example of a smaller and simpler system is for computer system 1700 to preprocess the image to obtain a lower resolution image. In a speech recognition task, an example of a smaller and simpler system is for computer system 1700 to use fewer spectral frequencies and/or to compute fewer spectral frames per second of speech. In some embodiments, computer system 1700 may reduce the average number of spectral frames per second by using a variable frame rate. For example, if several successive spectral frames differ by less than a specified amount, computer system 1700 may replace the multiple frames with a single frame.

In a smaller, simpler system, computer system 1700 may use fewer categories in a classification task. More generally, computer system 1700 may use fewer, larger sets at each level of an ontology. In some embodiments, a larger set in the simpler system may be the union of sets in the ontology of the less simple system.

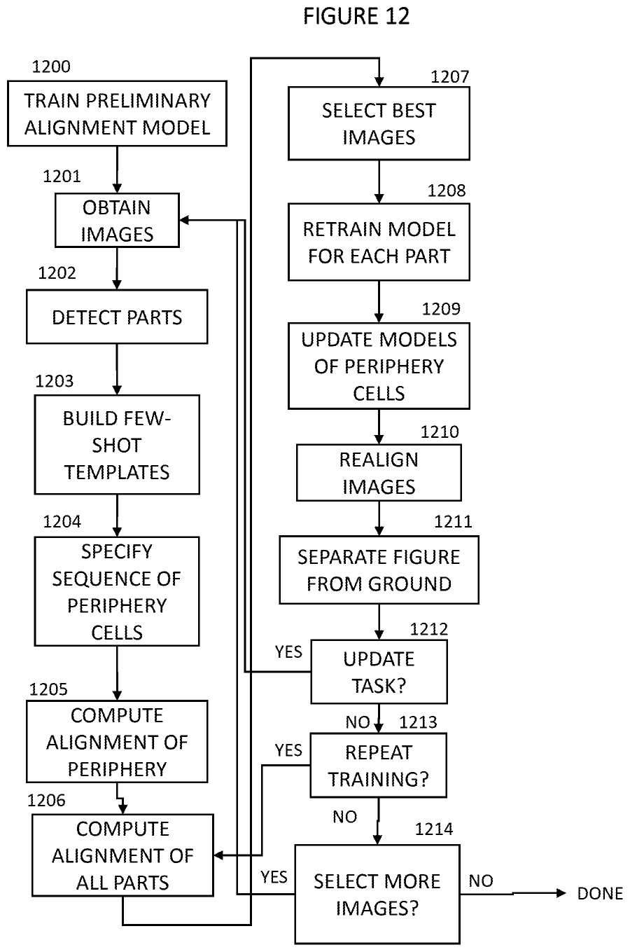

On the other hand, in the case of image recognition, in some embodiments, computer system 1700 may make use of the availability of the higher resolution image in analysis of an input data item for the smaller, simpler base system. For example, in the alignment of a data item to a mereology graph, as discussed in association with FIG. 12, computer system 1700 may use the higher resolution image to verify a tentative alignment of a region in the low-resolution image with a specified part in the mereology. In this example, the system analyzing the higher resolution image is a “simpler” system in the sense of block 102 of FIG. 1.

In block 103, computer system 1700 begins or resumes the process of continual growth and improvement of the current network (i.e., the base system(s) selected at block 101, optionally in combination with the simpler system selected at block 102 if one is selected at block 102). In block 101 and/or block 102, computer system 1700 may have replaced a previous base network with a new base network based on the validation testing in block 106 or block 111.

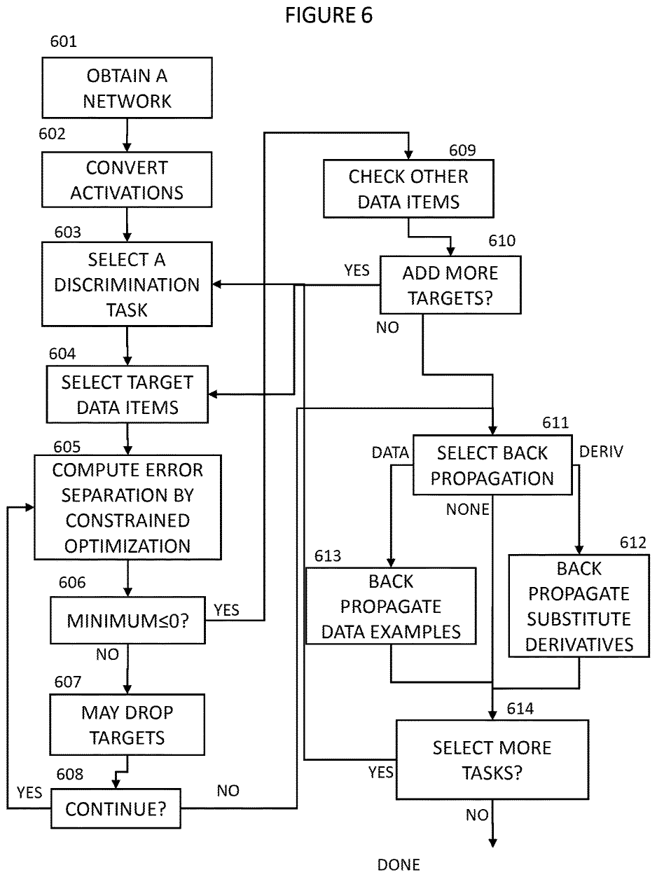

In some embodiments, computer system 1700 may use incremental growth (504 of FIG. 5) to improve classification performance and sensibility by training without using any back propagation, neither back propagation of derivatives (506 of FIG. 5) nor back propagation of labeled data examples (510 of FIG. 5). For example, in some embodiments, computer system 1700 may use constrained optimization (524 of FIG. 5 and FIG. 6) to train each new node incrementally added to the network without use of back propagation. As long as there are any remaining errors on the training data, computer system 1700 may use incremental growth combined with constrained optimization to reduce the number of errors.

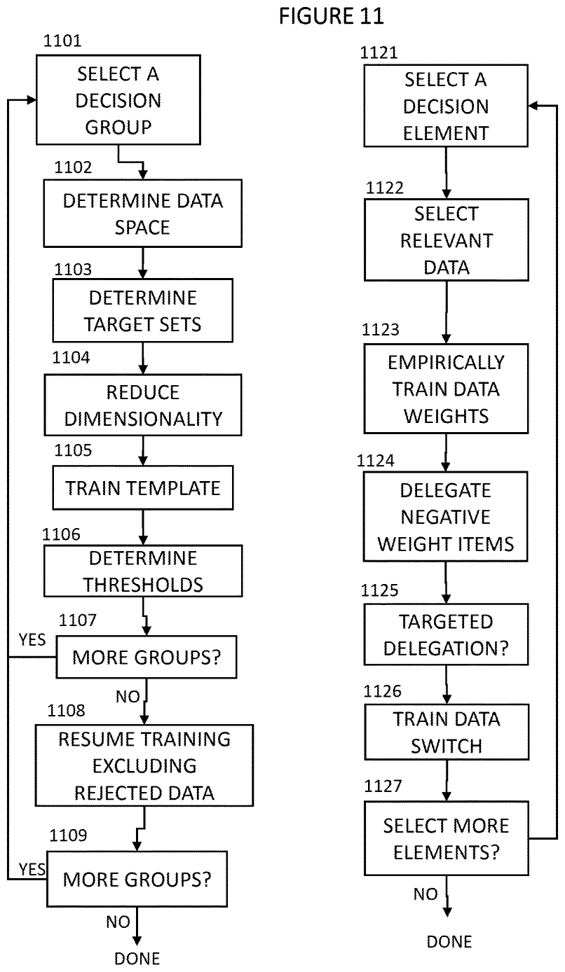

In some embodiments, computer system 1700 may add elements to a network as part of various embodiments of hybrid training, such as data delegation (FIG. 11 and block 518 of FIG. 5), splitting one or more nodes (519 of FIG. 5), adding additional output values to an element, training distinct sets in a discrimination (523 of FIG. 5), adding a local autoencoder to the network or simply adding one or more elements for some other purpose.

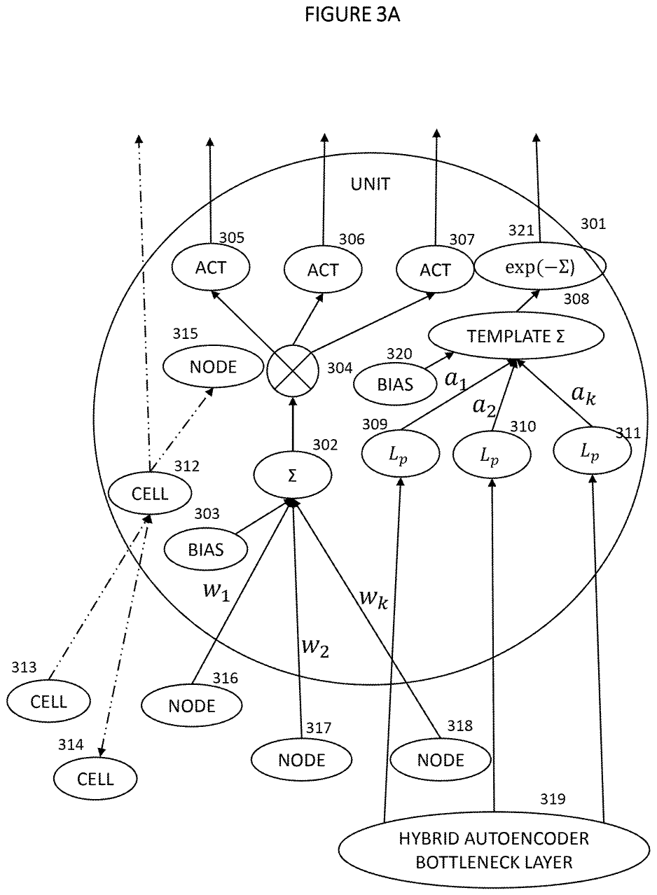

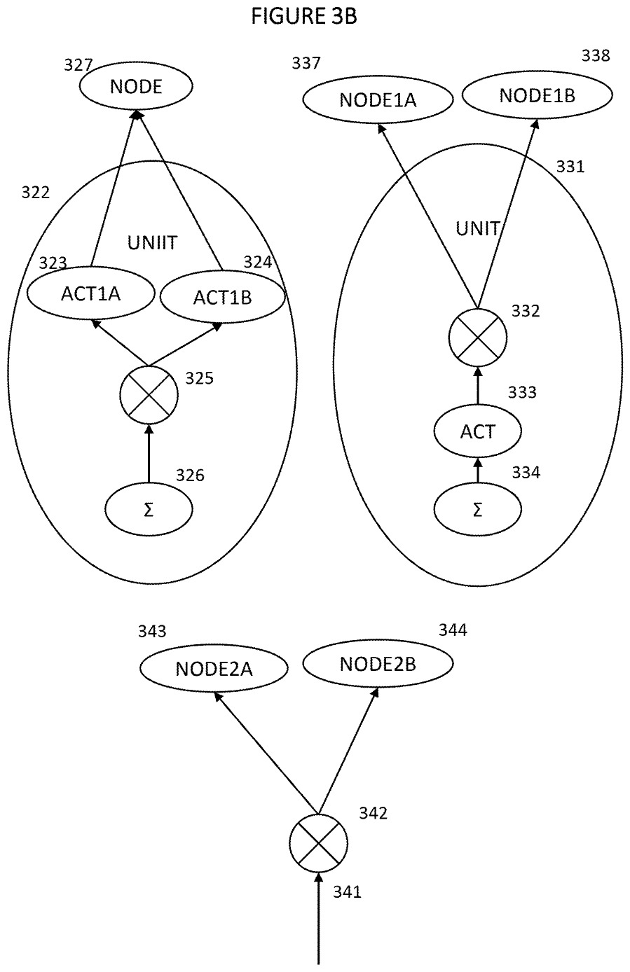

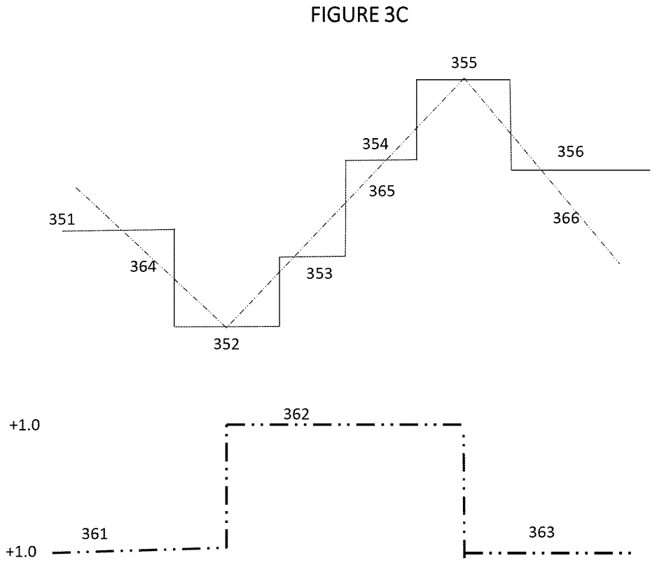

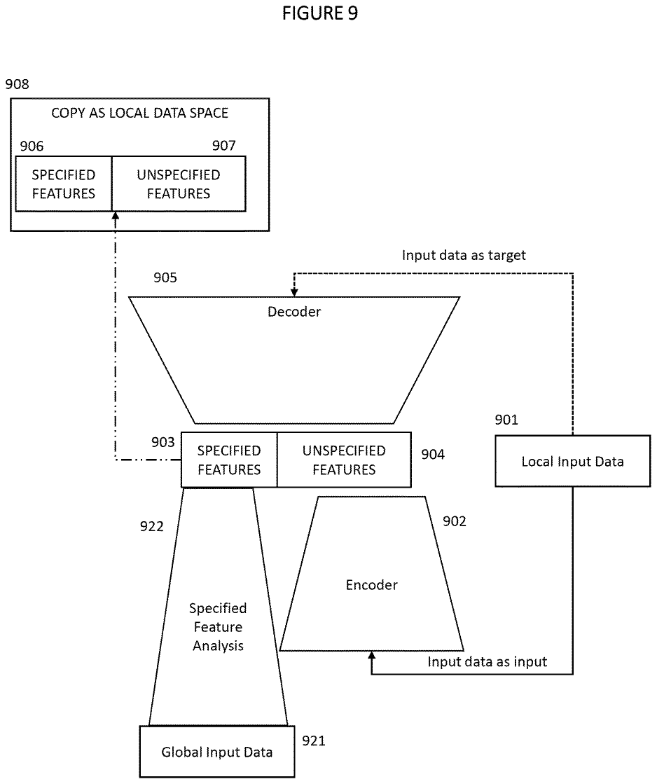

In some embodiments, computer system 1700 may add a local autoencoder to a network to support improved sensibility (FIGS. 2, 9, and 10), as a local data space (FIG. 3C and blocks 411 of FIG. 4 and FIG. 9), or as a data generator (514) of FIG. 5.

In some embodiments, computer system 1700 may create a plurality of networks from the original base network and may continue to grow and improve each of the plurality of networks. For example, computer system 1700 may use one or more simpler systems specified in block 102 in addition to one or more current base systems. As another example, computer system 1700 may develop one or more canary networks in parallel with the development of the current base network. Canary networks are designed to be vulnerable to adversarial attacks and other perturbations to the input as a means of detecting and diagnosing such disturbances. Canary networks are discussed in association with block 415 of FIG. 4.

In some embodiments, in block 103, computer system 1700 may build a hybrid network from scratch.

In blocks 104 and 105, computer system 1700 makes modifications to the base network to improve the network's sensibility in a hierarchy of two levels of sensibility and a plurality of training methods and techniques for improving sensibility. Each level of sensibility has different criteria. Computer system 1700 may use different processes, models, and system designs for improvement in each level. Illustrative processes and models for each level of sensibility are discussed in more detail in association with FIGS. 2, 4, 5, and other figures. However, in some embodiments, computer system 1700 may also use an improvement process or model in a level other than the level with which it is discussed.

In some embodiments, in block 104, computer system 1700 may improve elementary sensibility (FIG. 2 and block 405 of FIG. 4), do active flattening (block 406 of FIG. 4), perform hybrid training (FIG. 5 and block 407 of FIG. 4), find the best location in the network for a piece of knowledge (block 408 of FIG. 4), and/or do data selective training (block 409 of FIG. 4). In some embodiments, computer system 1700 may use randomization training (block 520 of FIG. 5) and randomized activation (418 of FIG. 4) in blocks 104, 105, 106, 109, and/or 110 of FIG. 1 to improve sensibility, robustness, and/or classification performance.

An aspect of preferred embodiments of the invention is a hybrid network learning management system (HNLMS), which comprises a cooperative association of a team of human experts and one or more AI systems to develop tools and models to help computer system 1700 improve the sensibility, classification performance, and holistic interpretability of the system being developed. In some embodiments, the HNLMS may guide the training of the system being developed and may judge its sensibility.

An illustrative criterion for first level sensibility of a detector or discriminator is that, for any data item in an empirical acceptance set and in the interior of the target acceptance set, a change in the input with an L_{∞}norm<ε, for a specified ε, should not cause the data item to no longer be in the empirical acceptance set. In other words, a nearly imperceptible change in an input data item should not cause the system to make a mistake that it did not make before the change. Any successful L_{∞} adversarial attack violates first level sensibility. Techniques for designing L_{∞} adversarial attacks are well known to those skilled in the art of developing deep neural networks.

An important subset of first level sensibility is called “elementary sensibility.” Elementary sensibility (405 of FIG. 4) has criteria that can be checked for each node, unit, or internal variable. For elementary sensibility, computer system 1700 makes changes in the base system to improve elementary sensibility of each node or unit.

Informally, the levels of sensibility differ in the degree to which the HNLMS participates in the development done by computer system 1700 of techniques in each level and/or in judging the sensibility of the developed system.

Level one techniques require the least participation by the HNLMS during the development. The sensibility of a system modified by level one sensibility improvements are also the easiest for computer system 1700 to evaluate objectively, with the HNLMS mainly controlling hyperparameters in the sensibility criteria.

In block 105, in some embodiments, computer system 1700 may modify the current network to improve level two sensibility. In level two techniques, computer system 1700 may utilize more guidance from the HNLMS during development and during evaluation (414 of FIG. 4).

As discussed in association with FIG. 4, in block 105 of FIG. 1, in some embodiments computer system 1700 may analyze and improve decision boundaries (block 410 of FIG. 4) and/or create and train local normed spaces (FIG. 9 and block 411 of FIG. 4).

In some embodiments, in block 105 of FIG. 1, computer system 1700 may compute attributes and other variables the computer system 1700 may store in cells, as discussed in association with block 412 of FIG. 4.

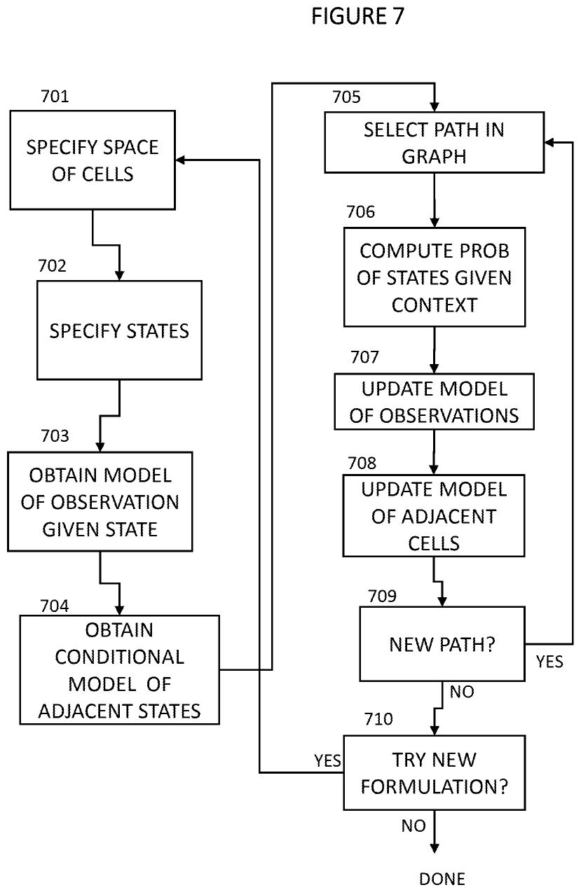

In block 105 of FIG. 1, computer system 1700 may also build and train hidden state space models under direction from, for example, the HNLMS, as discussed in association with block 413 of FIG. 4 and FIG. 7. In some embodiments, computer system 1700 may also use the hidden state space models in active classification as discussed in association with block 109 of FIG. 1 and blocks 403, 416, and 417 of FIG. 4.

Computer system 1700 may specify and/or change the states of a hidden state space model and/or associated learned parameters or hyperparameters under control of, for example, the HNLMS. In some embodiments, computer system 1700 may specify and/or change the states of a hidden state space model and/or associated learned parameters or hyperparameters based on human consultation, as discussed in association with block 414 of FIG. 4.

In block 105 of FIG. 1, computer system 1700 may use human consultation in verifying the sensibility of discriminator and/or classifier decision boundaries, as discussed in association with block 414 of FIG. 4.

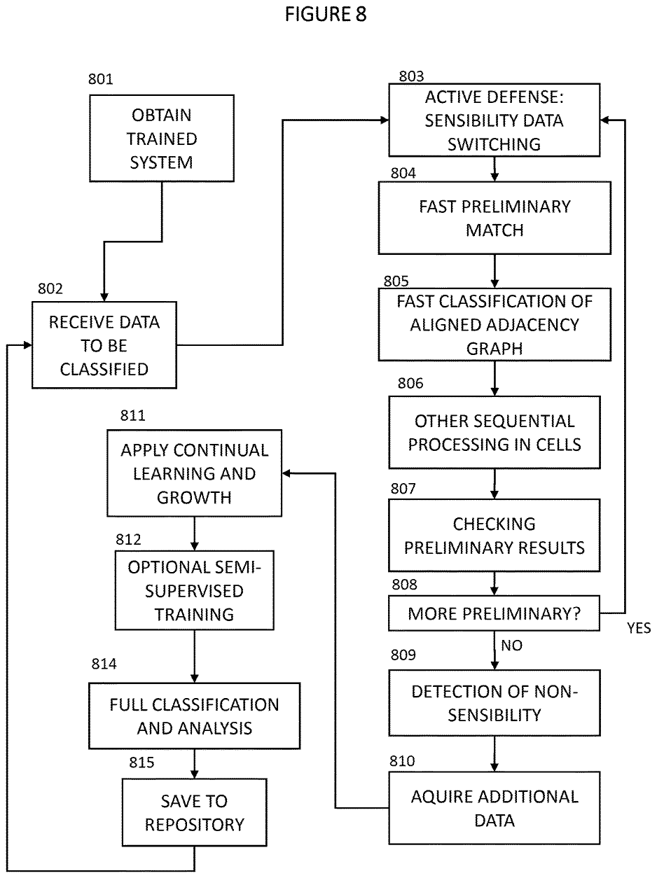

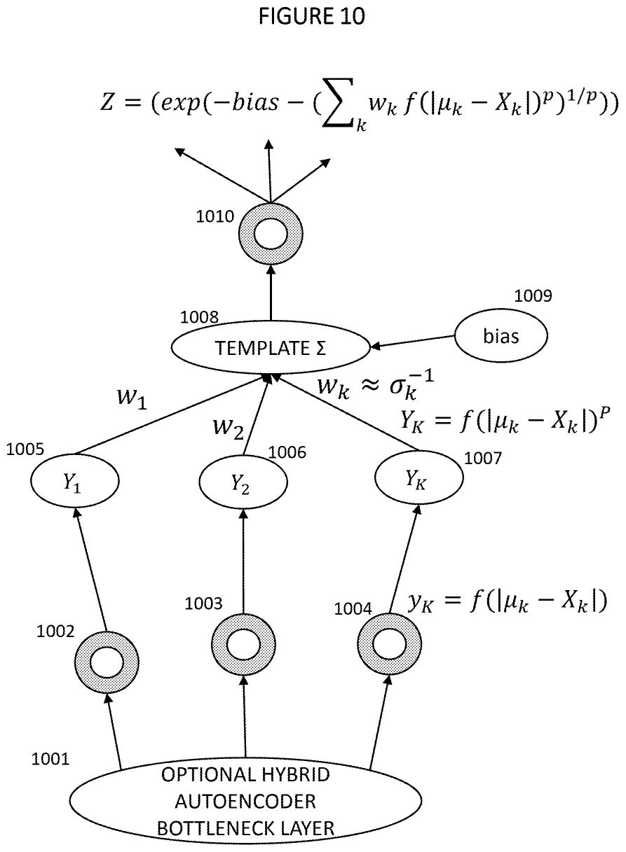

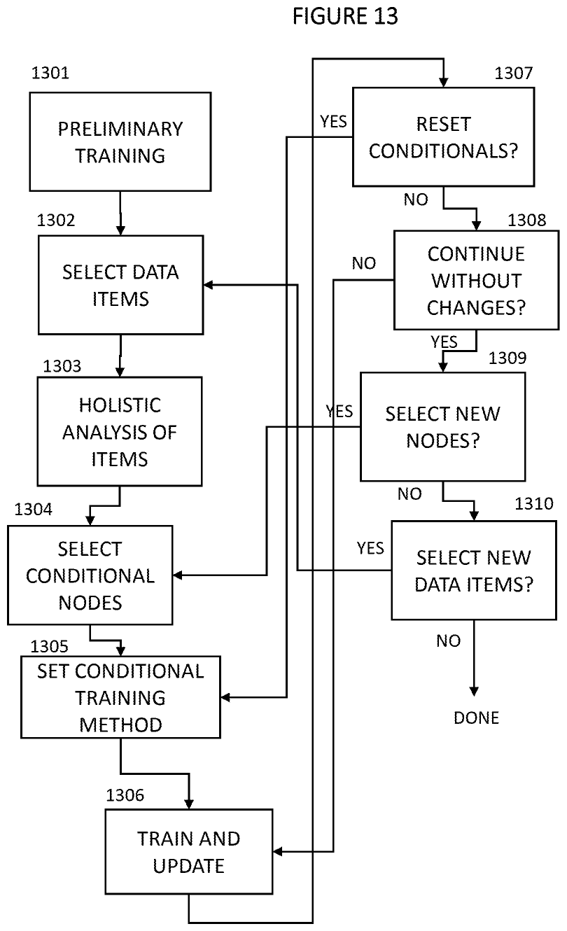

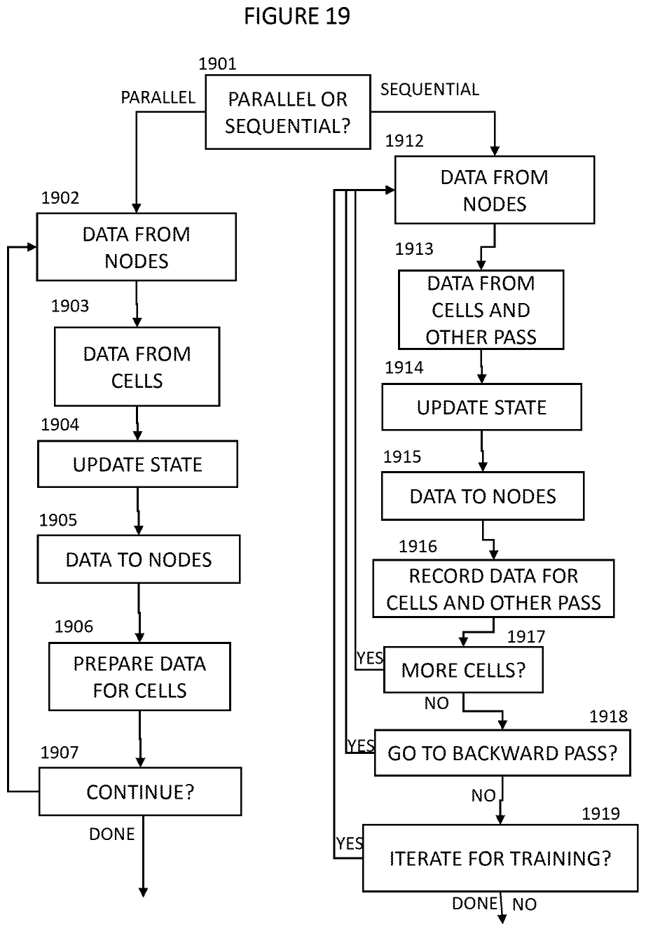

To improve sensibility, in blocks 105 and 106 of FIG. 1, computer system 1700 may analyze decision boundaries (410 of FIG. 4), construct local normed spaces (411 of FIG. 4), computed attributes and cell variables (412 of FIG. 4), construct and train hidden state space models (FIG. 7 and block 413 of FIG. 4), construct and train active defense structures, optionally with data switches (416 of FIG. 4 and 803 of FIG. 8), perform active alignment (FIGS. 12 and 19 and block 417 of FIG. 4), train with randomized activation (418 of FIG. 4), construct and train robust template models (FIG. 10 and block 419 of FIG. 4) and/or use hybrid conditional training (FIG. 13 and block 512 of FIG. 5).

In addition to improving sensibility, some of the illustrative processes and models may improve the holistic interpretability of nodes and units in the system. Some of the illustrative processes and models may improve the performance on an assigned classification or regression task. In one aspect of the invention, computer system 1700 may reformulate a regression task as a classification task. Without loss of generality, in this disclosure, the term “classifier” is used to refer to a system for which the task may be either a classification task or a regression task.

The phrase “neural network,” as described above, is used to refer to a directed network comprising a set of nodes and a set of directed connections between ordered pairs of nodes. The phrase “neural network” refers to the commonly accepted concept that is well known to those skilled in the art of training and using neural networks.

The phrase “hybrid network,” as described above, refers to a generalization of a neural network comprising more complex elements, herein called “units.” A unit may have multiple output values and may comprise multiple internal nodes and connections, as illustrated in FIG. 3A. A unit may also comprise special elements herein called “cells.” On the other hand, in a hybrid network, a unit may consist of only a single neural node, so any conventional neural network is also a simple hybrid network.

The modifications to the base network made by computer system 1700 in blocks 104 and 105 may comprise changing the activation functions of one or more selected nodes. The modifications may include converting one or more nodes to a more complex structure called a “unit.” The modification may comprise adding nodes and units to the network. In some embodiments, the modifications may comprise creating and adding one or more cells to the network. Computer system 1700 may add a cell to a unit or may add a cell to the network external to any unit.

A cell in a hybrid network is distinct from a node. A cell may comprise the values of one or more variables computable by computer system 1700. For example, computer system 1700 may save in a cell the output value of a selected element of the network for the current input data item and/or from the output value of a selected element of the network for a previous data item. Each cell may comprise or be associated with an arbitrary stored program to be executed on computer system 1700. For example, computer system 1700 may execute a serial computation associated with a cell to compute a logical inference or a probabilistic inference. A cell may comprise one or more incoming data communication links and/or one or more outgoing data communication links. Data links are distinct from neural network connections. A data link only transmits data and does not have an associated “weight” parameter. A data link may be unidirectional or bidirectional.

The data transmitted by computer system 1700 on a data link from a first cell to a second cell may comprise any value that computer system 1700 may compute from the values stored in the first cell.

Computer system 1700 may also transmit data via a data link from a neural node to a cell. For example, the data transmitted from a neural node to a cell may be the input to or the output from the activation function of the neural node. In some embodiments, the data transmitted from a neural node to a cell may be the value of a back propagated derivative computed by computer system 1700 during computation of a gradient by back propagation. In some embodiments, the back propagated derivative may be from a substitute local derivative (509 of FIG. 5).

Computer system 1700 may also transmit data via a data link from a cell to a neural node. The data transmitted by computer system 1700 on a data link from a cell to a neural node may be any value that computer system 1700 may compute from the values stored in the cell. In some embodiments, computer system 1700 may use the received data value as an additional input connection to the receiving node with a connection weight of 1.0. In preferred embodiments, computer system 1700 does not back propagate derivatives along a data link from a cell. However, if desired, in some embodiments, computer system 1700 may achieve a similar effect by creating a second node to receive data from a cell and then connecting the second node to the first node by a neural network connection through which computer system 1700 may back propagate derivatives.

The details of the processes used in each level (blocks 104 and 105) are discussed in more detail in association with FIGS. 2, 4, 5, and other figures.

In block 121, in some embodiments, computer system 1700 may train the network for participation in joint human+AI activities, in which one or more humans play a sufficient role to contribute some amount of common sense. An example of a joint+AI activity is the HNLMS. FIG. 21 discusses additional joint activities, including the production of creative works. FIG. 21 also discusses joint educational activities.

In block 106, computer system 1700 trains the modified network and tests the trained network on validation data that has been set aside from the training data. Illustrative embodiments of the process of training a hybrid network, called “hybrid training,” are discussed in association with FIG. 5 and other figures.

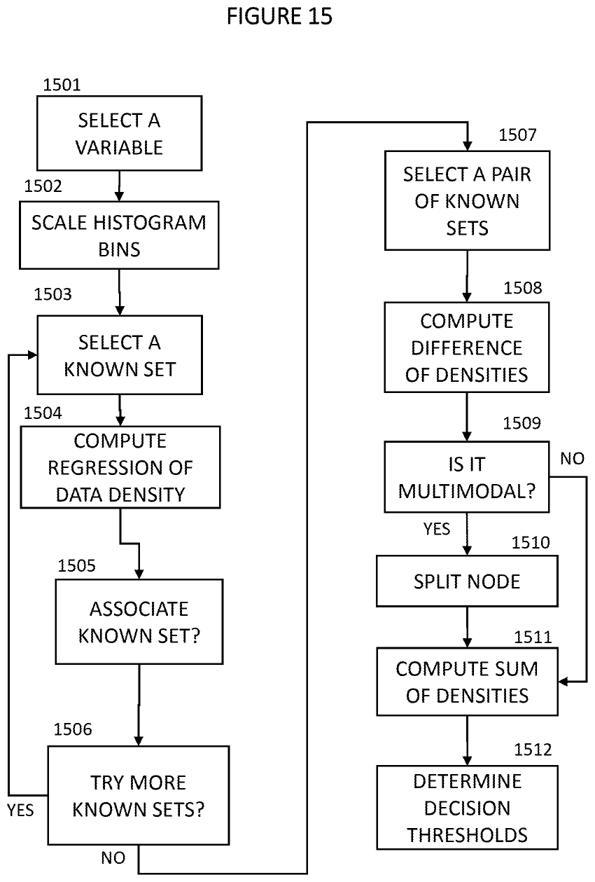

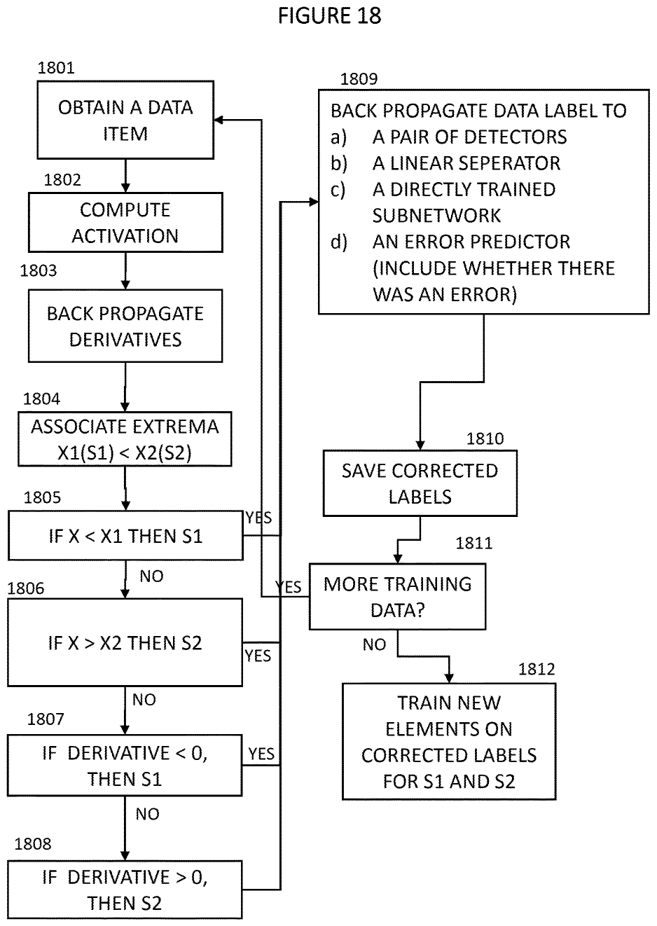

In some embodiments, in block 106, computer system 1700 may perform histogram analysis (FIG. 15 and block 507 of FIG. 5), back propagate derivatives (506 of FIG. 5), create a low dimension local data space and build low dimension models (517 of FIG. 5), perform data delegation and data exclusion (block 420 of FIG. 4, block 518 of FIG. 5, and FIGS. 10 and 11), determine local targets (508 of FIG. 5), use substitute derivative functions (509 of FIG. 5), back propagate labeled data (FIG. 18 and block 510 of FIG. 5), imitate another network (511 of FIG. 5), perform conditional hybrid training (FIG. 13 and bock 512 of FIG. 5), perform empirical training (521 of FIG. 5), generate more data, optionally with human guidance (514 of FIG. 5), build homologous networks (FIGS. 21 and 516 of FIG. 5), do randomized training (520 of FIG. 5), empirically compute weights of individual items to estimate their reliability (522 of FIG. 5), create distinct sets to better represent combinations of known sets (523 of FIG. 5), and/or use constrained optimization (FIG. 6 and block 524 of FIG. 5)

If the validation test done by computer system 1700 in block 106 meets a specified acceptance criterion, then computer system 1700 replaces the previous base network with the network as modified by computer system 1700 in blocks 104, and 105. In some embodiments, computer system 1700 may save the new base network or selected subnetworks in a network repository.

In some embodiments, computer system 1700 may compare the performance of the current base system on validation data with the performance of a simpler system. In some embodiments, computer system 1700 may compare the performance of the current system on data from an adversarial attack on validation data to the performance of one or more canary systems. In some embodiments, based on analysis of these comparative results, computer system 1700 may make experimental changes in the current system and retest, preferably on new validation data. In some embodiments, computer system 1700 may request human consultation, as discussed in association with block 414 of FIG. 4.

In block 107, computer system 1700 checks a stopping criterion for the modifications and training being done in the loop from block 101 to block 107. If the stopping criterion is met, computer system 1700 proceeds to block 108. Otherwise, computer system 1700 returns to block 101 to continue modifying the current base network.

In block 108, computer system 1700 receives an item to be classified. In some embodiments, the phrase “an item to be classified” may include an item for which a regression value is to be computed.

In block 109, in some embodiments, computer system 1700 may perform a process herein called “active classification,” or “active sensible classification.” In preferred embodiments, during active classification, computer system 1700 may make changes to the network and/or may do additional computations other than neural network activation after receiving a data item to be classified. Computer system 1700 may customize these additional computations to the received data item.

Active sensible classification comprises the computation of the activation values of the neural nodes in the network, a process which is called “inference” in neural networks. However, in illustrative embodiments, “active sensible classification” may comprise additional processes that are distinct from neural network inference.

In block 109, computer system 1700 may perform diagnosis and defense against the specific data item received in block 108. For example, computer system 1700 may classify the received item using diverse unprotected canary networks and diverse robust networks to analyze the patterns of difference in the responses, as discussed in association with block 415 of FIG. 4.

In active classification with a hybrid network in block 109, computer system 1700 may do serial computations in the cells after the item to be classified has been received. This ability enables additional capabilities for a hybrid network.

For example, in active sensible classification, computer system 1700 may make changes in the hybrid network, after the item to be classified has been received, as an active defense (416 of FIG. 4 and 803 of FIG. 8), which enables computer system 1700 to make the network sensible for the specific item received. In some embodiments, computer system 1700 may build the hybrid network to have data switches that effectively reconnects the hybrid network in a configuration that is specifically designed to avoid a non-sensible response for the specific data item received in block 108.

In some embodiments, in block 109, computer system 1700 may compute an alignment of the data item to be classified to a model and/or to other data examples (FIGS. 12 and 19 and block 417 of FIG. 4). In some embodiments, computer system 1700 may use cells in the network to store information used in computing the alignment. In some embodiments, computer system 1700 may use a hidden state space model (FIG. 7 and block 413 of FIG. 4) in computing the alignment. In some embodiments, computer system 1700 may retrieve example alignments or other information from a repository in computing an alignment for the data item to be classified. In some embodiments, computer system 1700 may store, for future use, information computed in aligning the data item to be classified.

As another example, computer system 1700 may use a set of cells to model a hidden stochastic process, as discussed in association with FIG. 7 and block 413 of FIG. 4. With a set of cells in a hybrid network, computer system 1700 may do a recurrent computation even though the network of neural nodes is a non-recurrent network.

In block 110, in some embodiments, computer system 1700 may continue training after a machine learning system is deployed. In some embodiments, computer system 1700 may continue to acquire new data while a system is deployed. In some embodiments, computer system 1700 may acquire data from other systems that have been deployed. In some embodiments, computer system 1700 may continue to train a deployed system using data acquired during the development and training of new systems.

In some embodiments, in block 110, computer system 1700 may continue modifying and growing the network to improve classification performance, sensibility, and/or holistic interpretability.

In block 110, in some embodiments, computer system 1700 may compute incremental training using the item received for classification in block 108. Since the item was received for classification, unlike for training data, the correct classification might not be known. In this situation, in some embodiments, computer system 1700 may do semi-supervised training, that is, after classifying the received item, computer system 1700 may do incremental training on the item as if it were training data labeled with the classification computed during the classification.

However, as is well known to those skilled in the art of semi-supervised training, although semi-supervised training often works well, sometimes it may fail catastrophically.

In preferred embodiments, in block 110, computer system 1700 may perform extra processes to improve the reliability of semi-supervised training. For example, computer system 1700, may use the data switches mentioned in association with block 109 to construct a virtual ensemble not only to improve the performance of the classification in general but more specifically to detect and diagnose that the classification of the received item may be unreliable. If computer system 1700 detects that the classification of an item may be unreliable, computer system 1700 may skip that item in semi-supervised training.

In some situations, during deployment, computer system 1700 may know the correct classification from the interaction with the end-user, who may correct errors made by the system. In some cases, computer system 1700 may not know the correct answer but, from the reaction of the user may know that the computed classification is incorrect or unreliable.

In block 111, in some embodiments, computer system 1700, may perform iterative training using the accumulated data acquired from multiple passes through the loop from block 108 to 112. In some embodiments, computer system 1700 may then validate the performance of the trained system on a set of labeled validation data that computer system 1700 has set aside from the set of training data. If the validation test satisfies a specified acceptance criterion, computer system 1700 may replace the current base network with the newly validated network.

In block 112, computer system 1700 checks a criterion for stopping or pausing the process of blocks 108 to 112. If the stopping criterion is satisfied, computer system 1700 proceeds to block 114. Otherwise, computer system 1700 returns to block 108 to process more items to be classified.

In block 113, computer system 1700 may determine whether to add more data to the training data and may determine how much data to select in a specific region. In some embodiments, computer system 1700 may begin training with a selected sample of the data and gradually add more training data as the system grows. In some embodiments, in which there is a large amount of data, the data might not be uniformly distributed among regions of interest. In some embodiments, computer system 1700 may selectively add sample data in a region in which the current sampling is sparse. In preferred embodiments, compute system may keep track of the relative frequency of sampling and properly adjust any estimates of a priori or a posteriori probabilities.

As an example, in some embodiments, computer system 1700 may use selective sampling in histogram analysis, which is discussed in association with FIG. 15. In some embodiments, computer system 1700 may use selective sampling in any procedure that splits the data, for example: (1) data switching of activation intervals (209 and 211 of FIG. 2), (2) interval dependent training (406, 407, 409, 410, and 416 of FIG. 4), (3) node splitting (519 of FIG. 5), and (4) histogram analysis (FIGS. 15 and 507 of FIG. 5).

In some embodiments, computer system 1700 may use selective sampling in other situations that use additional data, such as, (5) back propagation of data (FIG. 18 and block 510 of FIG. 5), (6) adjusting data delegation and exclusion norms (block 420 of FIG. 4, block 518 of FIG. 5, and FIGS. 10 and 11), (7) generation of data with human guidance (514 of FIG. 5), and (8) randomized training and diagnosis (520 of FIG. 5).

In block 114, computer system 1700 checks whether to resume training and growth of the current base network as modified in blocks 103 to 110 as validated in blocks 106 and 111. If so, computer system 1700 returns to block 102. Otherwise, computer system 1700 proceeds to block 115.

In block 115, computer system 1700 checks a stopping criterion. If the stopping criterion is satisfied, computer system 1700 exits the process illustrated in FIG. 1. Otherwise, computer system 1700 returns to block 101.

In some embodiments, if additional training data has been acquired, in block 101, computer system 1700 may resume the training of the current updated base systems. In some embodiments, computer system 1700 may select one or more new base systems.

FIG. 2 is a flow chart of illustrative embodiments of processes for enhancing elementary sensibility in an aspect of the invention. As shown in blocks 401 and 405 of FIG. 4, elementary sensibility is one aspect of level one sensibility. As shown in FIG. 2, there are multiple aspects to elementary sensibility.

In block 201 of FIG. 2, computer system 1700 may modify a regression-type output to be represented as a sensible classification-type output. A regression-type output is a continuous-valued output value from a network or from a unit in which the output value is a parametric function of the input values and in which the parameters are trained to optimize a specified measure of fit between the output of the parametric function and the target values in a set of training data. The regression-type could be, for example, a linear regression, a logistic regression, or some other suitable type of regression.

In some embodiments, in block 201, computer system 1700 may replace the continuous valued output by a piecewise constant function. In the typical case in which the parametric continuous-valued function is monotonic, computer system 1700 may replace the parametric function with a step function.

In some embodiments, in block 201, computer system 1700 may replace the parametric function with a vector of one or more finite discrete-valued variables. The vector of discrete variables may be called a vector embedding of the values of the continuous-valued function. Computer system 1700 may compute the vector embedding as the bottleneck layer of an autoencoder. In some embodiments, computer system 1700 may impose a sparsity constraint or regularization on the bottleneck layer. In some embodiments, computer system 1700 may use a hybrid parametrically controlled autoencoder with some specified features, as discussed in association with FIG. 9. In some embodiments, computer system 1700 may use such a discrete-valued vector embedding for multiple regression of two or more continuous-valued variables. In some embodiments, computer system 1700 may use such a discrete-valued vector embedding for multiple regression of a continuous-valued data space.

With either the piecewise constant function or the vector embedding, computer system 1700 may train a neural network or a hybrid network to imitate the continuous-valued function or the continuous-valued vector to any desired degree of precision, since computer system 1700 may use the continuous-valued function to compute the target value for an unlimited number of examples of input values, making available an unlimited quantity of training data.

However, in some embodiments, computer system 1700 may limit the number of intervals in the piecewise constant function or the discrete vector space of the embedding in order to better satisfy the criteria for sensibility.

In block 202, computer system 1700 may replace one or more unbounded variables with bounded variables. For example, computer system 1700 may replace one or more unbounded activation functions with bounded activation functions. In some embodiments, computer system 1700 may simply impose as constraints a minimum value and a maximum value for the output of the activation function. In some embodiments, computer system 1700 may replace the activation function with a new activation function that approaches limiting values asymptotically, which computer system 1700 may change to a step function later in the training. In some embodiments, computer system 1700 may limit global or local data space values. In some embodiments, computer system 1700 may limit the values stored in and/or transmitted by a cell. In some embodiments, computer system 1700 may limit the value of variables in a local data space.

In some embodiments, with a trained or partially trained network, computer system 1700 may use the minimum and maximum values observed for the activation of a node in the training data to set the limits for the bounded activation function of the node, perhaps allowing some extra margin for the values that might be needed for new data.

In some embodiments, computer system 1700 may implement a semi-automated process with a controlled amount of human consultation to specify or verify the limits, as discussed in association with block 414 of FIG. 4. In some embodiments, computer system 1700 may use empirical training (521 of FIG. 5) to determine the limits.

In some embodiments, computer system 1700 may replace a node or unit that has an unbounded activation function with one or two detectors or with a discriminator, as discussed in association with blocks 211, 212, and 213.

In block 203, computer system 1700 may replace the activation function of each of one or more nodes that have non-monotonic activation functions with a monotonic activation function or a modified monotonic function. For example, computer system 1700 may specify an activation function that is monotonic on a specified interior interval rather than monotonic over the full domain of the activation function.

In some embodiments, computer system 1700 may specify a non-monotonic activation function that is monotonic within a specified interior interval but that computer system 1700 modifies outside the specified interval. For example, for an activation function that computer system 1700 characterizes as a discriminator between a set S1 and a set S2, computer system 1700 may specify an activation function that has a maximum value for the activation value corresponding to the mode in the probability distribution for set S2 and a minimum value for the activation value corresponding to the mode in the probability distribution for set S1. Computer system 1700 may specify an activation function that is monotonic in the interval between the minimum value and the maximum value.

However, if, for example, the mode of either set S1 or set S2 is at an interior point of the data space, computer system 1700 may specify an activation function that has a local maximum for S2 and a local minimum for S1. In some embodiments, computer system 1700 may specify an activation function that outside the monotonic interval between the minimum and the maximum is equal to or asymptotic toward a specified out-of-domain background value, such as used in data exclusion (204 of FIG. 2, 518 of FIG. 5, and FIG. 11). In some embodiments, computer system 1700 may specify an activation function that is monotonic between the background value and the value of the minimum or maximum. An activation function that is monotonic on the interval between a unique minimum value and a unique maximum value and monotonic outside that interval is herein called a “standard discriminator function.” In a standard discriminator function, either the minimum value or the maximum value may occur at an end point (or the limit at infinity), so the monotonic interval may be the whole domain or a half-open interval.

In some embodiments, in block 203, computer system 1700 may convert the activation for any node that computer system 1700 characterizes as a discriminator to become a standard discriminator function.

For a node with a standard discriminator function and specified threshold value T between the minimum value and the maximum value, computer system 1700 may determine if the node has made an implicit error on a specific data item.

Implicit error: In some embodiments, for a node with a standard discriminator activation function f(x) and a specified discrimination threshold T, where x(d) is a function of the input data d, then computer system 1700 may designate that the node has made an implicit error, for an activation value x(d) in the interval between the minimum and the maximum, if the sign of (x(d))*(f(x(d)−T)) is the same as the sign of the back propagated derivative of an error measurement objective function that is to be minimized. In some embodiments, computer system 1700 may reverse the sign test for an activation outside the interval between the minimum and the maximum. In some embodiments, computer system 1700 may apply no test for data that has been delegated or excluded. Computer system 1700s reverses the sign test if the derivative is of an objective function to be maximized.

In some embodiments, computer system 1700 may determine that the node has made a close call on the data item d if the magnitude of |T−act(d)| is less than a specified multiple of the magnitude of the back propagated derivative, where “act(d)” represents the activation value of a node for a datum d. A close call may be either a close call with an implicit error or a close call with an implicitly correct answer.

In some embodiments, computer system 1700 may add regularization penalties, such as knowledge sharing regularizations, soft-tying, and counter-tying to the back propagated derivatives in determining whether a node with a standard discrimination activation function has made an implicit error. Soft-tying is described in U.S. Pat. No. 10,839,294, titled “Soft-tying nodes of a neural network,” and counter-tying is described in U.S. Pat. No. 11,151,455, titled “Counter-tying nodes of a nodal network,” both of which are incorporated herein by reference in their entirety. Data-dependent node-to-node knowledge sharing by regularization is described in published PCT application WO/2021/194516 A1, titled “Data-dependent node-to-node knowledge sharing by regularization in deep learning,” which is also incorporated herein by reference in its entirety.

In some embodiments, computer system 1700 may determine that a node has made an explicit error if the node is being trained to a known set and the data item d has activation x(d) that is on the wrong side of the discrimination threshold T. In some embodiments, when such an explicit error criterion is known, computer system 1700 may use the explicit error criterion rather than the implicit error criterion.

In some embodiments, computer system 1700 may ignore relatively small deviations from monotonicity, such as the dip in a Gaussian error linear unit (GELU). The GELU activation function is well known to those skilled in the art of neural networks. In some embodiments, computer system 1700 may use a replacement activation function that is monotonic except specified dips such as in the GELU function. In some embodiments, for a detector unit, computer system 1700 may use a center-surround function, in which the function has a dip in value for activations close to but not in the acceptance region. Computer system 1700 may make the function value in this dip less than the function value for activations further from the acceptance region as well as from the values in the acceptance region.

In some embodiments, computer system 1700 may partition the domain of a node with non-monotonic activation function into alternating intervals of monotonically increasing and monotonically decreasing values. In some embodiments, computer system 1700 may create a new node for each interval.

In some embodiments, computer system 1700 may create a node for each pair of a monotonically increasing interval followed by a monotonically decreasing interval to create one or more nodes with unimodal activation functions. In some embodiments, computer system 1700 may replace a node with a unimodal activation function with a robust template unit, such as illustrated in FIG. 10.

In some embodiments, computer system 1700 may replace an activation function with a plurality of local maxima with a plurality of robust template units.

In some embodiments, computer system 1700 may partition the domain of a discriminator node into a first interval in which a local minimum in the activation function represents detection of a first target set and a second interval in which a local maximum in the activation represents detection of a second target function. In some embodiments, computer system 1700 may create a first interval for a local maximum and a second interval for a local minimum. In some embodiments, computer system 1700 may replace the discriminator node with a unit comprising a detector for the first target set, a detector for the second target set, and an element that computes a discrimination score from the two detector scores. In some embodiments, for each of the target sets, computer system 1700 may train a template model as a detector of the target set.

In some embodiments, computer system 1700 may create a unit in which a node with a non-monotonic activation function is replaced by a unit with multiple monotonic or unimodal activation functions, separating the computation of the affine sum of the inputs from the computation of the activation functions, with a data switch in between. In some embodiments, computer system 1700 may switch any incoming data item to the monotonic or unimodal activation function corresponding to the interval for the incoming data item. Such a structure within a unit is illustrated in FIG. 3A.

In some embodiments, computer system 1700 may replace the node with the non-monotonic activation function with a set of nodes with the activation function of each node being constant outside a specified interval and monotonic or unimodal within the interval. In some embodiments, computer system 1700 may initialize the incoming connections to each node to copy the incoming connections of the node being replaced. In some embodiments, computer system 1700 may then train the weights on the new connections separately from the weights of the connections to the original node. In some embodiments, computer system 1700 may tie or soft tie one or more of the weights on corresponding connections.

In block 204, in some embodiments, computer system 1700 may implement data exclusion and/or data delegation for detector elements and discriminator elements. In some embodiments, computer system 1700 may implement data trimming, limiting the detection region, and/or data exclusion. In some embodiments, computer system 1700 may adjust the limits for data delegation, data exclusion and/or trimming based on empirical training (521 of FIG. 5).

In some embodiments, computer system 1700 may use data delegation to improve the performance of an element by limiting the training to a proper subset of the training data.

In elementary statistical analysis, a data item may be dropped from the training data as being an outlier. In robust statistics, a substantial fraction of the data may be dropped from the training the sufficient statistics of the parameters in a parametric probability distribution. Typically, in training a neural network, for every training data item, a feed forward computation is performed that computes the activation of every node in the network and a back propagation of derivatives is computed to update every connection into every node.

However, in a large neural network or a large hybrid network, the situation is more complicated. The input that one node received from another node for a specified data item may change as the weights in the network are updated during training. Whether a data item is an outlier for the first node may change.

In some embodiments of the invention, computer system 1700 may build redundancy into the network such that having delegated a data item that is no longer an outlier of the first node does not necessarily degrade performance.

In block 205, in some embodiments, computer system 1700 may replace the activation function of one or more selected nodes with an activation function for which the change in the value of the activation function in one or more selected intervals is less than in the activation function being replaced. In some embodiments, computer system 1700 may make such a change in an activation function to continue training a selected node by back propagation of derivatives, but later in the training may change the activation function to a piecewise constant function, as described in association with block 206.

In block 206, in some embodiments, computer system 1700 may change the activation function of one or more selected nodes to piecewise constant functions. Preferably, computer system 1700 specifies a piecewise constant function that satisfies a specified criterion for approximation of the selected function being replaced. For example, for each constant interval in the piecewise constant function, computer system 1700 may set the value of the piecewise constant function to the value of the selected function averaged over the interval. In preferred embodiments, computer system 1700 may replace a monotonic activation function, or a monotonic interval in any function, with a monotonic step function.

In some embodiments, computer system 1700 may make the value of the piecewise constant function in a specified interval a hyperparameter, which computer system 1700 may change during the training. In some embodiments, computer system 1700 may make the value of the piecewise constant activation function a learned parameter, which computer system 1700 may train using hybrid training methods such as discussed in association with FIG. 5. For example, computer system 1700 may train such a parameter using empirical training.

In block 207, in some embodiments, computer system 1700 may specify a substitute derivative function for a node. An illustrative example of a substitute derivative function is shown in FIG. 3C.

In block 208, computer system 1700 may replace a selected node with a plurality of nodes. One example was discussed in association with block 203. Computer system 1700 may replace a node that has a non-monotonic activation function with a set of nodes with one node for each monotonic interval in the non-monotonic activation function.

As another example, in block 208, computer system 1700 may replace a node with two or more nodes or with a unit comprising two or more nodes. For example, if an interval of the activation function of a specified node is associated with a known set, computer system 1700 may create a unit with a two or more output values, and a node trained to detect data items in the known set and second node trained to detect data items not in the known set.

In some embodiments, computer system 1700 may replace a node that discriminates between two known sets with two new nodes or add two new nodes, with one new node trained to detect one of the known sets and the second node trained to detect the second known set.

In some embodiments, in each of the cases in which computer system 1700 creates two new detector nodes, computer system 1700 may create a unit comprising the two new detector nodes and comprising one or both of two new nodes. Computer system 1700 may create one additional node to detect data items that are not in either of the two known sets and a second additional node to directly detect data items that are in the intersection of the two known sets.

Note that a node that is directly trained on the task of detecting data items that are in the intersection of the two sets or in the intersection of their complements will not necessarily agree with detections of the individual detectors since generally each of the detectors will have a non-zero error rate and the errors may be different under the different objectives. In addition, in some embodiments, computer system 1700 may train the new detectors with a different trade-off between precision and recall than used for the known set detectors. In any case, the two new detectors provide separate outputs to the unit to indicate directly to nodes and units in higher layers of the hybrid network whether a data item near the decision boundary of a discrimination of the two detectors is an equally good match for both detectors, herein called a “BOTH” detector, or an equally poor match to both detectors, herein called a “NEITHER” detector. Computer system 1700 may use the indication of BOTH or NEITHER, as a useful distinction for a higher-level node or unit receiving connections from the discriminator unit. This information is not available from the output of a single node discriminator.

As another example, in block 208, computer system 1700 may replace a node with two or more nodes or with a unit comprising two nodes, where one of the new nodes is trained to detect a known set and the second new node is trained to detect a distinct known set. In some embodiments, computer system 1700 may add a third node comprising incoming connections from the two detector nodes and, optionally, additional incoming connections. Computer system 1700 may train the third node as a discriminator of the two known sets. For example, the activation of the third node may comprise the difference between the scores of the two detector nodes or a smoothed monotonic function of the difference between the scores of the two nodes. The two detector nodes may be newly created nodes that computer system 1700 may initialize from two intervals of the node being replaced. Computer system 1700 may further train the unit or the three-node discriminator to discriminate the two known sets.

In block 208, computer system 1700 may also replace a node having a monotonic activation function and one or more feature-like intervals. A “feature-like” interval is an interval in which the maximum value in the interval is larger than the minimum value in the interval and for which, for example, the HNLMS has determined that replacing the interval with a constant would degrade performance by more than a specified amount. The feature-like interval may comprise the entire range of the node, in which case the node may be called a “feature” node.

In some embodiments, computer system 1700 may treat the extreme values near the ends of the feature-like intervals and/or the values beyond the extremes of the feature like interval as detectors.

In this case, in some embodiments, computer system 1700, controlled by, for example, the HNLMS may choose one or more of several options for the treatment of the feature-like interval:
(1) Computer system 1700 may replace the feature-like interval with a unit comprising one or more of the following detectors, which preferably are sensible in the sense described in association with block 212 of FIG. 2:
   a. A sensible detector for each extreme of the feature-like interval
   b. A sensible detector to detect that a data item is in a “boundary region” in which is it is not clear which, if either of the extreme detectors has correctly made a detection or a rejection
   c. Two sensible detectors to distinguish two reasons for uncertainty about the extreme detectors:
      i. Both detectors have scores above a specified value
      ii. Neither detector has a score above a specified value
   d. Two or more sensible detectors to detect clusters within the boundary region.
(2) Computer system 1700 may replace the node with multiple nodes, splitting the feature-like interval.
   a. Computer system 1700 may create two or more sensible detectors to detect clusters in a detection in a specified interval in the activation function.
(3) Computer system 1700 may replace the node with multiple step functions with different constant intervals, such as discussed in association with block 211 of FIG. 2, block 416 of FIG. 4, and block 803 of FIG. 8.

As another example, in block 208, in some embodiments, computer system 1700 may replace a single node with a plurality of nodes for redundancy. In this example, computer system 1700 may initialize each of the plurality of new nodes to have identical connections and identical weights on their connections as the single node being replaced. Computer system 1700 may then train the network, including the plurality of new nodes allowing the weights of connections incoming to each node copy and the weights of connections outgoing from each node copy to drift away from each other. In some embodiments, computer system 1700 may impose regularization, such as counter-tying or an is-not-equal-to regularization link, to make the node activations and the weights train to be diverse.

In block 209, computer system 1700 may replace a single activation function with a plurality of activation functions and a data switch, such as data switch 325 in FIG. 3B, to select which activation function is to be used for a specific data item. In some embodiments, computer system 1700, may create a node for each activation function and a data switch, such as 342 in FIG. 3, to select between the two nodes. The HNLMS, for example, may specify that computer system 1700 make such a replacement for any of several reasons:
(1) To assign a new node or activation function to detect an associated known set with one or more new nodes to imitate the original node for data that is not in the associated known set
(2) To delegate one or more problematic data items. The HNLMS or computer system 1700 may delegate a specified data away from a first node or activation function by controlling a data switch such that activation from input of the specified data item is blocked from activating the first node or activation function. In some embodiments, computer system 1700 or the HNLMS may control the data switch to send the data item to a specified second node. In some embodiments, computer system 1700 or the HNLMS may create a new node to receive the data item.
(3) To exclude data based on elementary sensibility criteria
   a. Computer system 1700 may base the exclusion on the distance from a specified central point as measured by a specified norm defined on a local data space. The HNLMS, for example, may specify some features for hybrid parametrically controlled autoencoder to create the local data space.
(4) For active defense, as discussed in association with block 416 of FIG. 4 and block 803 of FIG. 8.

In block 210, computer system 1700 may add extra nodes or units to the network to improve classification performance.

In some embodiments, computer system 1700 may add an error prediction node and an error correction node to fix one or more explicit or implicit errors. In some embodiments, computer system 1700 may interpret the activation of a first node in a specified interval as acceptance or rejection of a received data item as belonging to a specified known set. In some embodiments, computer system 1700 may train a second node to predict whether the first node has made a false positive error and may train a third node to predict whether the first node has made a false negative error. In some embodiments, computer system 1700 may create an additional node or cell, called an error correction element, that substitutes a change in the output of the first node when one of the error prediction nodes predicts an error on the received data item. In some embodiments, computer system 1700 may add the outputs of the error prediction nodes as additional output values to the unit comprising the first node. Error prediction nodes are also called judgment nodes and are described in published U.S. patent application Pub. No. 2022/0335296, titled “Deep learning with judgment,” which is incorporated herein by reference in its entirety.

In some embodiments, computer system 1700 may determine that a node has made an explicit error if the activation of the node is in an interval that computer system 1700 interprets as an acceptance or rejection of the received data item being in a known set for a received data item for which computer system 1700 knows the acceptance or rejection to be false.

In some embodiments, computer system 1700 may add one or more nodes to receive data delegation of one or more data items on which a node or unit has makes an explicit or implicit error.

In some embodiments, computer system 1700 may add one or more nodes to represent clusters in a known or named set. In some embodiments, computer system 1700 may add one or more nodes to detect clusters in a specified target set. In some embodiments, computer system 1700 may determine the need to model clusters from the analysis of multiple local maxima in smoothed histogram function, as discussed in block 1509 of FIG. 15.

In some embodiments, computer system 1700 may add one or more nodes to represent clusters in the complement of a detected set. The complement of a detected set may be more diverse than the detected set. In some embodiments, computer system 1700 may represent the complement set by a plurality of clusters to represent diversity in the data.

In some embodiments, computer system 1700 may add one or more nodes to support continual, lifelong learning. For example, computer system 1700 may add one or more nodes to detect and/or discriminate new data that the system encounters during continued use.

Computer system 1700 may add extra nodes in active defense after an item to be classified has been received. Active defense is discussed in association with block 416 of FIG. 4 and block 803 of FIG. 8.

In block 211, in some embodiments, computer system 1700 may partition the domain of an activation function into intervals. In some embodiments, computer system 1700 may replace the activation function with an activation function that satisfies a specified criterion for flatness on each of a specified set of the intervals. For example, the computer system 1700 may specify that the difference between the maximum value and the minimum value of the activation function is less than a specified value. In some embodiments, computer system 1700 may specify that the activation function be constant in a selected interval. In some embodiments, computer system 1700 may select all the intervals in the partition of the activation function to be subject to the requirement to satisfy specified criteria for flatness. In some embodiments, computer system 1700 may specify that the activation function be piecewise constant.

In block 211, in some embodiments, computer system 1700 may create two or more partitions of an activation function. In some embodiments, computer system 1700 may define the partitions such that the end points of some or all the intervals in one partition are offset from the end points in one or more other partitions. In some embodiments, for each partition, computer system 1700 may specify an activation function that satisfies interval flatness conditions for that partition. In some embodiments, computer system 1700 may create a hybrid node with multiple activation functions, with an activation function for each partition and a data switch such as 325 in FIG. 3B. In some embodiments, computer system 1700 may create multiple nodes, with each node having a different one of the plurality of activation functions, with a data switch such as 342 or 362 of FIG. 3B.

In some embodiments, computer system 1700 may control the data switch 325, 342, or 362 based on the relative position of the value of the input to the data switch for a data item compared to the beginning and end points of the associated interval in the respective partition. In some embodiments, computer system 1700 may control the data switch as an active defense, as discussed in association with block 416 of FIG. 4 and block 803 of FIG. 8.

In block 212, in some embodiments, computer system 1700 may replace a detector with a more sensible detector. In some embodiments, in block 212, computer system 1700 may replace a selected detector with a piecewise constant function, preferably with exclusion of some data, both of which properties contribute to greater sensibility.

Computer system 1700 may have replaced an activation function with a piecewise constant function in block 206 or block 212. A piecewise constant function facilitates computer system 1700 making a network more sensible. However, a piecewise constant activation function requires special training techniques, such as a substitute derivative function (207 of FIG. 2 and 509 of FIG. 5), hybrid training (407 of FIG. 4), selective training (409 of FIG. 4), back propagation of data (510 of FIG. 5), imitation (511 of FIG. 5), and/or hybrid conditional training (FIG. 13 and block 512 of FIG. 5).

Exclusion of data is discussed in association with FIG. 11.

However, for a detector node, in some embodiments, computer system 1700 may take a different approach.

In some embodiments, computer system 1700 in block 203 may replace a non-monotonic bounded activation function from block 202 with a bounded monotonic activation function. However, in some embodiments, for a detector node, computer system 1700 may determine that a non-monotonic activation function with a single mode may be a more realistic model for a set of target data items.

In some embodiments, in block 212, computer system 1700 may compute a histogram of the input to the activation function. In some embodiments, computer system 1700 may compute a smoothed function approximation to the histogram. In some embodiments, if there is a single local maximum in the smoothed histogram function, or if one local maximum is larger than the others by at least a specified criterion, computer system 1700 may model the data as a unimodal probability distribution.

In some embodiments, if there is a plurality of local maxima in the smoothed histogram function, computer system 1700 may tentatively split the domain of the activation function into intervals with a new node for each interval and a data switch based on the selected intervals distributing each data item to the corresponding new node. In some embodiments, computer system 1700 may train a unimodal parametric probability distribution for the original node and for each of the plurality of new nodes, using statistical training techniques such as maximum likelihood estimation. In some embodiments, computer system 1700 may train a parametric template model, such as illustrated in FIG. 10. In some embodiments, the parametric template model may comprise parameters comparable to the parameters of a parametric probability model. In some embodiments, the parametric template model may comprise additional parameters or hyperparameters, such as limits on one or more exclusion norms. In some embodiments, computer system 1700 may estimate template parameters using statistical training methods such as maximum likelihood. In some embodiments, computer system 1700 may train template parameters using empirical training (block 521 of FIG. 5). In some embodiments, computer system 1700 may train some of the parameters of a template using gradient descent. In some embodiments, some of the parameters may be specified as hyperparameters controlled, for example, by the HNLMS. In some embodiments, computer system 1700 may specify a local data space of the input values for a detector template. In some embodiments, computer system 1700 may compute a weighted norm in the local data space.

In some embodiments, computer system 1700 may then test the comparative performance of the single node system with the performance of the multi-node system. In some embodiments, computer system 1700 may evaluate the performance of the single node and multi-node systems based on measurements of precision and recall in detection of a specified target set, preferably evaluated on data that has been set aside from the training data. In some embodiments, computer system 1700 may evaluate the performance based on a divergence or other measure of accuracy of the system or subsystem comprising the selected element or its replacement.

In some embodiments, computer system 1700 may repeat the process of dividing the domain of a detector if one or more of the detectors in the multi-node version has multiple modes in its smoothed histogram function.

In some embodiments, computer system 1700 may impose data exclusion limits on the input values and output value of a parametric probability model or of a template model, as illustrated by annuli 1002, 1003, 1004, and 1010 in FIG. 10. In some embodiments, computer system 1700 may use a “center-surround” detection score with a lower score for a data item close to but outside the acceptance distance than for a data further from the central point.

In some embodiments, computer system 1700 may use a flatter function for data within an acceptance norm, such as a super-Gauss trimmed to one standard deviation or less, while using a substitute derivative function such as an L₁ norm for training, as discussed in association with block 207 of FIG. 2. In some embodiments, computer system 1700 may use a constant acceptance score while using a substitute derivative function for training.

In block 213, in some embodiments, computer system 1700 may create sensible discriminators. For example, computer system 1700 may replace a discriminator with two sensible detectors and a combining node with connection weights and an activation function by which computer system 1700 may compute some approximation to the difference or the ratio of the two detection scores.

In block 214, computer system 1700 may train a node or a cell to imitate one or more known sets. In some embodiments, computer system 1700 may train the node to have activations values specified to be above or specified to below a specified threshold value for data items in a known set and to have activation values on the opposite side of the specified threshold for data items that are not in the known set. In some embodiments, for two or more known sets, computer system 1700 may train a node or cell to have values specified to be above or below the specified threshold for one or more of the known sets and on the opposite side of the specified threshold for one or more other known sets.

In block 215, computer system 1700 may convert a node to a cell. The cell may have multiple output values. The cell may store one or more values. In some embodiments, computer system 1700 may pass a value to be stored by the cell from the activation value of a node. In some embodiments, computer system 1700 may pass to a specific cell a value from another cell to be stored in the specific cell. In some embodiments, computer system 1700 may pass a value that represents an attribute of a node stored in a cell associated with the node. Attributes are discussed in association with block 412 of FIG. 4. In some embodiments, computer system 1700 may store in a cell a value inferred from a state-space probability estimate computed by computer system 1700 with a set of cells representing a hidden state space. Hidden state spaces are discussed in association with FIG. 7.

FIG. 3A is an illustrative diagram comprising an illustrative example of a unit 301. FIG. 3A further comprises some external elements including cells 313 and 314, nodes 316, 317, and 318, and a hybrid parametrically controlled autoencoder bottleneck layer 319. FIG. 3A further comprises elements internal to unit 301, including cell 312, node 315, components of a hybrid network node (302, 303, 304, 305, 306, and 307), and components of a template model. A unit may comprise an unlimited number of nodes, cells, template models, and other units.

In FIG. 3A, the illustrative unit also comprises a robust template model comprising input variable norm cells 309, 310, and 311, bias cell 320, and template summation cell 308. Each of the cells 309, 310, and 311 computes a single-variable norm of the form fᵢ(x)=|xᵢ−μᵢ|^{p}, where μᵢ may be a learned parameter or a hyperparameter specified, for example, by the HNLMS.

The norm value p is a hyperparameter specified, for example, by the HNLMS. In some embodiments, computer system 1700 may estimate the μᵢ values by empirical training (521 of FIG. 5). For a network not optimized for sensibility, typical values for p are 1 or 2. For a flatter response and greater sensibility, a larger value of p is preferred. In some embodiments, computer system 1700 may change the value of p during the training, as specified by the system design and/or the HNLMS, for example.

In the template summation cell 308, computer system 1700 may compute

g(x)=S*(Σᵢaᵢfₗ(x))^{1/p},

where S is a scaling hyperparameter set, for example, by the HNLMS. In some embodiments, the output of cell 308 may be −g(x) or exp(−g(x)). The values aᵢ may be learned parameters or may be hyperparameters specified, for example, by the HNLMS. In some embodiments, all the aᵢ are set to 1.0. In some embodiments, computer system 1700 may train the values di and the bias 320 by empirical training (521 of FIG. 5). In some embodiments, computer system 1700 may train the values; and the bias 320 by maximum likehood for a parametric probability distribution model. In FIG. 3A, the weights for the input connections for the inputs to the template are written as di, rather than as the more traditional wₖ to avoid confusion with normal node connection weights wₖ for the connections into element 302. A more detailed illustrative diagram of a template is shown in FIG. 10, in which it is indicated that the wₖ values (corresponding to the aᵢ values in FIG. 3A) may be estimated as the reciprocal of an estimated measure of spread

$${w}_{k} = {σ}_{k}^{- 1} .$$

Internal elements of unit 301 further comprise the internal components of a hybrid network node, including multiple activation functions 305,306, and 307, a data switch 304, an element 302 that computes a weighted sum of input values and a bias 303, with the input values comprising the output value of node 316 multiplied by connection weight w₁, the output value of node 317 multiplied by connection weight w₂, the output value of node 318 multiplied by connection weight wₖ, and bias 303. The solid arrows indicate directional connections like the connections between nodes in a neural network. The dash-dot arrows indicate data communication links between cells and between cell 312 and node 315. Data communication links may be unidirectional or bidirectional, such as the link between cell 314 and cell 312.

In preferred embodiments, computer system 1700 may also impose data exclusion limits (FIG. 11 and block 518 of FIG. 5) on the template summation variable 308 and/or the input variables 309, 310, 311. For example, in some embodiments, computer system 1700 may impose a data exclusion limit on the template with output 321 by substituting a specified background score for the output if one or more of the variables 309, 310, 311, or 308 exceeds a specified limit. In some embodiments, computer system 1700 may impose norm-based data exclusion, substituting a specified background value for the output 321 if, for a specified norm in the data space 319, the norm of the difference between the data item and a specified central data point for the template exceeds a specified limit. In some embodiments, computer system 1700 may impose data exclusion limits both during training and during deployment. A hybrid network template unit with data exclusion limits is illustrated in FIG. 10.

Each of the input variables 309, 310, and 311, may have an incoming connection from a node or cell or, as shown in the illustration, the input variables may receive incoming connections from the bottleneck layer of a conventional autoencoder or of a hybrid parametrically controlled autoencoder 319.

FIG. 3B illustrates three embodiments of data switching that computer system 1700 may use in active defense (block 416 of FIG. 4 and block 803 of FIG. 8).

Element 322 is an illustrative embodiment of a hybrid element comprising two activation functions 323 and 324 with outgoing connections to one or more nodes such as 327. Element 322 further comprises data switch 325, which selectively forwards the result of summation element 326 to one of the activation functions 323 or 324. In illustrative embodiments of active defense (block 416 of FIG. 4 and block 803 of FIG. 8), computer system 1700 may control data switch 325 to choose between the activation functions 323 and 324 to decrease the vulnerability of 322 to data that may cause non-sensible mistakes.

In some embodiments an element may have more than two activation functions. In some embodiments, computer system 1700 may include a probabilistic component in its control of data switch 325 in which the probabilistic component may choose among two or more activation functions that all satisfy a specified sensibility criterion. In some embodiments, computer system 1700 may change the selection probabilities in data switch 325, depending on the value of the data item being switched.

Element 331 is an illustrative embodiment of a unit comprising a summation element 334, an activation function 333, and a data switch 332. In the illustrative embodiment of element 331, in some embodiments, computer system 1700 may control data switch 332 as part of a less direct method of active defense than the illustrative example of 322.

In some embodiments, computer system 1700 may control data switch 332 to control data delegation. Data delegation is discussed in association with block 518 of FIG. 5 and FIG. 11.

Element 342 is a pure data switch that switches data stream 341 between node 343 and node 344. Like the other examples in FIG. 3A, computer system 1700 may use data switch 342 in active defense (block 416 of FIG. 4 and block 803 of FIG. 8) or to control data delegation. The difference is that computer system 1700 may directly control data switch 342 without data switch 342 being tied to a specific node.

In some embodiments, computer system 1700 may use data switch 342 merely to control data flow. For example, computer system 1700 may use data switch 342 to control data distribution in a distributed computing system. As another example, computer system 1700 may use data switch 342 to select a specific member of an ensemble to classify a specified data item.

Because data switch 342 is not internal to an element, computer system 1700 may use the illustrative embodiment represented by data switch 342 in a conventional neural network or in a component of a hybrid network in which the component is specified to only contain conventional neural network nodes.

FIG. 3C is a diagram of an illustrative example of a substitute derivative of an activation function. In some embodiments, computer system 1700 may use as a substitute derivative the derivative of a function that differs from the actual activation function in a selected node in the network. In the illustrative example of FIG. 3C, the substitute derivative is the function represented by the bold dash-double-dot segments 361, 362, and 363, which is the derivative of the function represented by the plain dash-double-dot segments 364, 365, and 366.

In the illustrative example in FIG. 3C, the actual activation function is a piecewise constant function, represented by the segments 351, 352, 352, 354, 355, and 356. In some embodiments, computer system 1700 may use such an activation function for a node that is discriminating a known set S1 associated with interval 352 from known set S2 associated with interval 355. In some embodiments, computer system 1700 may use a step function, as represented by intervals 353 and 354 to represent the lack of a firm decision between 352 and 355. In some embodiments computer system 1700 may use more steps for the middle region. In some embodiments computer system 1700 may use a single intermediate step or may jump with a single discontinuity directly from 352 to 355.

Although the illustrative example is a piecewise constant activation function, in some embodiments, computer system 1700 may use a substitute derivative function for any activation function.

In some embodiments, computer system 1700 may use a piecewise constant activation function as the activation function of a detector node. For example, in some embodiments, computer system 1700 may represent a detector node using an activation function with only the three segments 354, 355, and 356. As another example, for a feature variable with ordinal values, computer system 1700 may use a pure step function, such as segments 352, 353, 354, and 355. In any of these cases, in some embodiments, computer system 1700 may use a substitute derivative function.

FIG. 4 is an illustrative diagram of the hierarchy of the levels of sensibility and of active sensible classification. For the purpose of discussion, the dashed blocks 401, 402, and 403 in FIG. 4 place each illustrative technique into the dashed block that best fits the technique. However, the grouping is not absolute. Many techniques may be useful for more than one dashed block.

Dashed block 401 comprises illustrative examples of models and processes related to first level sensibility. First level sensibility is the first line of defense against non-sensible mistakes in a hybrid network. In some embodiments, computer system 1700 may be able to definitively test whether a system satisfies first level sensibility.

Dashed block 402 comprises illustrative examples of models and processes related to second level sensibility.

Dashed block 403 comprises illustrative examples of models and processed related to active classification, including classification during deployment and continual, lifelong learning.

In block 405, computer system 1700 may use a set of relatively simple first level sensibility techniques, discussed in association with FIG. 2, called “elementary sensibility” techniques. These elementary sensibility techniques may be based on simple criteria based on the properties of (1) the dimensionality of the number of variables, and (2) the derivatives of the output function with respect to the input. In some embodiments, computer system 1700 may evaluate these properties in their relationship to the degree of vulnerability of an element to making non-sensible mistakes. In some embodiments, computer system 1700 may test for violations of elementary sensibility by using simulated adversarial attacks.

A classifier system violates sensibility if a trivial change in the input may change a correct classification to an incorrect classification. In some instances, the small change may be imperceptible or easily ignored by a human observer, or by any sensible animal.

In image recognition, for example, a change is easily ignored by, or imperceptible to, a human observer of a digital image if the change in each color component of a pixel is comparable to or less than the quantization level. The maximum of the magnitude of the change in any one input variable is called the L_{∞} norm of the vector of changes. For a change in the input with L_{∞}≤ε, the maximum change in a function ƒ(x₁, x₂, . . . , xₙ) with continuous derivatives is roughly

$${\sum }_{i} \frac{\partial f ( {x}_{1} , {x}_{2} , … , {x}_{N} )}{{x}_{i}} ε \leq N ε .$$

If N, the number of input variables, is large, a small change in the L_{∞} norm may produce a large change in the output. This property of multivariate functions in high-dimension spaces is the main source of non-sensible mistakes by classifier networks.

Unfortunately, for a classifier system, the number of input variables is a fixed, specified number. Furthermore, in many classification tasks, including image recognition, N may be very large. On the other hand, the number of input variables to an individual element may be specified, for example, by the system design and/or by the HNLMS, and may be much smaller than the number of input variables to the overall system.

In elementary sensibility, computer system 1700 focuses on assuring that each element satisfies specified criteria of sensibility.

An illustrative example of criteria for sensibility for a single element:
1) The derivative of an output of should be less than a specified magnitude, with the possible exception of data items within a specified distance of a decision boundary.
2) For any interval of an activation function that represents detection, the difference between the maximum output value and the minimum output value should be less than a specified magnitude.
3) The difference between the maximum output value and the minimum output value for all data in a “remote region” should be less than a specified value
   a) Where a “remote region” is a specified region where the minimum distance from any point in the region to any point in one or more specified detection regions is greater than a specified criterion.
   b) A detection region may be specified by an interval in an activation function or by a norm with respect to a specified point in a template detector.

In block 405, computer system 1700 may modify activation functions in nodes, add elements to the network, add several kinds of special models, and/or make various other changes to the network to better satisfy several elementary criteria for sensibility that computer system 1700 may check automatically. Illustrative examples of the modifications made by computer system 1700 in block 405 are discussed in association with FIG. 2.

For example, in some embodiments, in block 202 of FIG. 2, computer system 1700 may change an unbounded activation function to a bounded activation function to better satisfy criterion (3) above.

In some embodiments, in block 204 of FIG. 2, one of the reasons that computer system 1700 may exclude data is to better satisfy criterion (3) above.

In some embodiments, computer system 1700 may change an activation function to have flatter intervals in block 205 of FIG. 2 and/or piecewise constant intervals in block 206 of FIG. 2 to better satisfy criteria (1) and (2) above. In some embodiments, computer system 1700 may use a substitute derivative function to accelerate the training process especially after applying the changes made by computer system 1700 in blocks 205 and 206, which might otherwise slow down or halt training in back propagation through a modified element.

In some embodiments, computer system 1700 may make changes in blocks 203, 208, 209, 212, and 213 to better meet elementary sensibility criteria such as the illustrative example above.

In block 406, computer system 1700 may select one or more of several methods to improve sensibility of a node with an activation function that includes one or more intervals that fail a criterion for flatness, that is, in which the change in the value of the activation function within an interval exceeds a specified limit.

In some embodiments, computer system 1700 may first partition the domain of the activation function of a node into intervals. The HNLMS, for example, may specify rules for dividing an activation function into intervals. For example, in some embodiments, computer system 1700 may attempt to find one or more intervals that satisfy a specified criterion for flatness. Computer system 1700 may then divide the domain into alternating flat and non-flat intervals. In some embodiments, computer system 1700 may divide the domain arbitrarily into intervals.

Computer system 1700 may then select a non-flat interval, which in some embodiments may be the entire domain of the activation function.

In some embodiments, computer system 1700 may partition the selected interval into subintervals. Computer system 1700 may then create a unit with a separate activation function for each subinterval, with the input to the activation function of the original node being used as a data switch. This structure with a data switch selecting an activation from among a plurality of activation functions was shown in FIGS. 3A and 3B. In some embodiments, computer system 1700 may use such a structure to partition an activation function into alternating monotonically increasing and monotonically decreasing intervals. In some embodiments, block 406, computer system 1700 may use the same structure in a two-tiered arrangement, first dividing the domain of the original activation function into alternating flat and non-flat intervals, then dividing each non-flat interval into a plurality of subintervals. Computer system 1700 may use other embodiments to achieve a similar result.

Once a non-flat interval has been divided into subintervals, computer system 1700 may approximate the activation function in a subinterval with a function that satisfies a flatness criterion. In some cases, computer system 1700 may approximate the activation function on a subinterval with a constant.

In some embodiments, computer system 1700 may make a separate copy of the subnetwork of the selected node and train the subnetwork for each subinterval separately. In some embodiments, computer system 1700 may use knowledge sharing links with is-equal-to relations to regularize the copies of the subnetwork to have activation values similar to those of the original subnetwork. In some embodiments, computer system 1700 may use knowledge sharing links with is-not-equal-to relations to create diversity among a plurality of copies of the subnetwork.

In some embodiments, possibly under guidance of the HNLMS, computer system 1700 may analyze the selected node as a discriminator. For example, if the selected node is the output node of the network or of a unit with an explicit objective, then computer system 1700 may interpret the node as discriminating data items for one target set from data items of a different target set. In some embodiments, if the node has been associated with two known sets, then computer system 1700 may characterize the node as discriminating between those two known sets. In some embodiments in which the selected node is trained by back propagated derivatives, computer system 1700 may interpret the selected node as discriminating between data items with a negative back propagated derivative from data items with a positive back propagated derivative.

If the selected node does not have a bounded monotonic activation function, in some embodiments, computer system 1700 may modify the node in the steps 201, 202, and 203 in FIG. 2 to obtain a node with a bounded monotonic activation function. With a bounded monotonic activation function, the data items that are correctly discriminated will have activations at the extremes of the domain of the activation function where the activation function is relative flat because the activation function is bounded. That is, the non-flat intervals will be in the middle region of the domain of the activation function. In other words, the data items in a non-flat region are data items that are not yet correctly discriminated at the current state of training. Training each subinterval separately may enable computer system 1700 to successfully discriminate many of the data items in each subinterval.

In some embodiments, under guidance of the HNLMS, for example, computer system 1700 may take advantage of this opportunity to improve classification performance. For example, in some embodiments, computer system 1700 may train a subinterval with the original non-flat activation function until a stopping criterion is met before changing the activation function for the subinterval to be flatter while approximating the original activation function.

In some embodiments, computer system 1700 may partition the domain of the activation function of a selected node in a plurality of different ways. For example, computer system 1700 may first do one partition of the domain into intervals and then do a second partition of the domain in which, except for the open-ended intervals at the extremes, each interval boundary in the second partition is positioned at the center of an interval in the first partition. In some embodiments, computer system 1700 may create more than two ways of partitioning the domain into intervals. In some embodiments, computer system 1700 may also partition each non-flat interval into subintervals in multiple ways. Two confusable data items that are in the same subinterval in one partition may be in separate subintervals in another partition. Thus, the units with different partitions may be diverse with respect to which pairs of confusable data pairs become distinguishable.

In some embodiments, computer system 1700 may use this diversity to improve the classification performance even more than achieved with a single partition. In some embodiments, computer system 1700 may test each partition and choose the one with the best performance. In some embodiments, computer system 1700 may use the set of networks with diverse partitions like an ensemble.

In some embodiments, computer system 1700 may use the set of networks with diverse partitions for diagnosis and detection, as explained in association with block 415 of FIG. 4. In some embodiments, computer system 1700 may use the set of networks with diverse partitions for active defense, as explained in association with block 416 of FIG. 4 and block 803 of FIG. 8.

In some embodiments, in block 406, computer system 1700 may use a different method for making a non-flat interval sensible in place of or, in addition to, the partition into subintervals. In some embodiments, computer system 1700 may verify that the outgoing connections from a non-flat node or interval are only connected into robust template models. In some embodiments, computer system 1700 may impose data exclusion limits on a node or unit receiving a connection from a non-flat node or interval.

In block 407, in some embodiments, computer system 1700 may perform hybrid training. That is, computer system 1700 may use multiple training techniques, not just training by gradient descent computed by back propagation of derivatives. Many example hybrid training techniques are discussed in association with FIG. 5.

In block 408, in some embodiments, computer system 1700, in coordination with the HNLMS, may find the best locations in the network to integrate a selected “piece of knowledge.” The selected piece of knowledge may be from an external source, or it may be knowledge represented in the cells and/or nodes of the network or in a companion network. In some embodiments, the piece of knowledge may be in a network in a network repository.

An example of a “piece of knowledge” is the knowledge of which data items are members of a known set. By definition, a set of data items is a known set only if there is a way for computer system 1700 to determine whether a specified data item is in the set. Although any subset of the training data items is a known set, preferably, in block 408, computer system 1700 may be able to determine whether a data item not in the training data is in the known set. For example, any set that is defined as the set of data that is accepted by a specified detector node or unit is a known set and computer system 1700 may determine whether a specified data item is in the known set by computing the activation of the subnetwork of the detector and observing the output of the detector. In some embodiments, the “piece of knowledge” may relate to the two sets distinguished by a discriminator. Without loss of generality, some illustrative examples may be discussed with respect to a detector element. However, in some embodiments, computer system 1700 may use essentially the same process with a discriminator element.

In some embodiments, in block 408, for a specified piece of knowledge, computer system 1700 may test selected candidate locations in the network to see whether integrating the piece of knowledge in a selected network location may improve classification performance, sensibility, and/or holistic interpretability.

If the piece of knowledge is the detection of a known set, computer system 1700 may integrate the piece of knowledge in any of several ways. In some embodiments, computer system 1700 may connect the detector to one or more nodes or units in a candidate location.

In some embodiments, computer system 1700 may create a new node or unit in the current base network and train the new node or unit to imitate the detector. In imitation training, the new node or unit is trained to match the output of detector for all specified data items. The specified data items do not need to be labeled. The specified data items do not even need to be real data items. They may be generated or synthetic data items. Computer system 1700 may train the new node to match the output of the detector for synthetically generated data. Computer system 1700 is not limited to using the existing subnetwork of the candidate location with the new node. With the unlimited amount of potential training data for imitation, in some embodiments, computer system 1700 may train a completely new subsystem.

In some embodiments, computer system 1700 may test the performance, sensibility, and/or holistic interpretability of each selected candidate location. Computer system 1700, under guidance from the HNLMS, for example, may then select a set of one or more of the candidate locations and integrate the piece of knowledge in those locations.

In some embodiments, computer system 1700 may screen potential candidate locations. For example, in some embodiments, computer system 1700 may compute the correlation of the output of a detector with the back propagated derivative of a global or local objective of a potential candidate node. This correlation indicates the amount that an incremental training update would improve the objective, averaged over the set of data on which the correlation is measured. A high magnitude of correlation would indicate a good candidate location. If a potential candidate node back propagates data examples rather than derivatives, computer system 1700 may compute the degree of agreement between the back propagate data examples and the detected and rejected sets of the detector. In some embodiments, computer system 1700 may limit the measure of agreement to the recall or to the precision, based on analysis of the needs of a candidate location as estimated by computer system 1700 under guidance of the HNLMS, for example.

In block 409, in some embodiments, computer system 1700 may selectively train only a subset of the elements in a network being trained and/or selectively train an element only on a specified subset of the data. Computer system 1700 may use selective training to accelerate or better control hybrid training, which might be applied to any level of sensibility. In FIG. 4, selective training is somewhat arbitrarily placed in block 401.

In some embodiments, computer system 1700 may selectively train an element discriminating two associated known sets only on data items in the union of the two known sets.

In some embodiments, computer system 1700 may selectively train a decision element only on data that is close to a decision boundary. In some embodiments, computer system 1700 may change the selection of training data items as the position of the decision boundary changes during training.

In some embodiments, computer system 1700 may apply selective training by selecting a subset of the elements to be trained for one or more specified data items.

The selectiveness of training a subset of the elements complements two characteristics of hybrid learning for sensibility. The first characteristic of hybrid training in some embodiments is that, computer system 1700 will continually modify the network during training and, in some embodiments, during deployment. In preferred embodiments, when computer system 1700 has modified a trained network, computer system 1700 may temporarily focus training on the modified elements and the other elements most effected by the modified elements.

The second characteristic of hybrid training is that the learning process may be actively controlled by, for example, the HNLMS. Either the AI systems in the HNLMS or the human team, for example, may direct computer system 1700 to focus on training particular elements. Furthermore, the HNLMS may actively monitor the training process and focus the training on elements that most need improvement.

In an illustrative embodiment, computer system 1700 may maintain a list of elements actively being trained.

Computer system 1700 may add an element to the list actively being train or add a data item to the list of data items for an element because of an error or a close call on an explicit or implicit local or global target. In some embodiments, the error or close call may be on data for which the element previously made no error or close call. In some embodiments, the error or the close call may be on new real data or on new generated or simulated data. The error or close call may be on a data item that has modified by a simulated attack or other disturbance.

In some embodiments, computer system 1700 may drop an element from the list based on a specified criterion.

In some embodiments, computer system 1700 may add an element that has been newly created or that has been modified to the list being actively trained.

In some embodiments, for a new element or a modified element, computer system 1700, under direction from, for example, the HNLMS, may temporarily suspend training of elements that have connections to the new or modified element. In other embodiments, computer system 1700 may activate training of elements with connections from a new or modified element.

In block 410, computer system 1700 may test the sensibility of decision boundaries and, if necessary, computer system 1700 may modify the network to move the position of the decision boundary to improve the sensibility of decisions. For the discussion of block 410, a “decision boundary” is the set of points in a local or global data space at which the activation of a discriminator of two target sets is at a specified threshold. Preferably, each target set is a known set. The discriminator may be a node or unit trained as a discriminator or may be a new node or unit created by computer system 1700 by combining the scores of two trained detectors, one for each of two target sets.

For block 410, the desired objective is to have any data point in a selected normed local or global data space that is on or near the decision boundary be reasonable to a human observer as a data example that is on the boundary. The human observer may agree that a data point is reasonable because (1) it is a reasonably good match to both target sets. In some embodiments, the human observe may agree that a data point is reasonably on the boundary because (2) it is such a poor match to either target set that it should not be accepted as an example of either. For the purpose of block 410, in some embodiments, data points that complete a smooth surface connecting data points that satisfy reasonableness condition (1) to data points that satisfy reasonableness condition (2) may also be considered reasonable.

In some embodiments, in block 410, computer system 1700 may build and train a conventional neural network with outputs that are differentiable with respect to the input values from a global or local data space to imitate a hybrid network discriminator for which computer system 1700 is testing and improving the decision boundary. Computer system 1700 may train a neural network or a hybrid network to imitate another network using generated or simulated data as well as unlabeled real data. Using as much data as necessary, computer system 1700 may train the imitating network up to the limits of the capability of the imitating network using as much unlabeled or generated data as necessary. In some embodiments, computer system 1700 may train an imitation neural network that has a node corresponding to each node in hybrid network being trained, with each node in the neural network being trained to imitate the corresponding node in the hybrid network as well as possible. In preferred embodiments, computer system 1700 at least uses the same local or global input space as the discriminator being imitated and trains a node in the neural network to imitate the discriminator as well as possible. The imitation is not expected to be perfect. For example, an imitation neural network with differentiable activation functions can at best only approximate the activation of a node with a discontinuous activation function, and vice versa.

In some embodiments, computer system 1700 may find a data point on the decision boundary of the conventional neural network with differentiable outputs by back propagating to the input data value d an objective to minimize |act(x(d)−T)|, where T is a discrimination threshold for the decision boundary and act(x(d)) is the activation of the discriminator node for the data item d.

Each point on the decision boundary of the imitation neural network will have the value zero for this objective. With many different random starts, computer system 1700 may find a plurality of points on the decision boundary of the neural network that is imitating the hybrid network. In some embodiments, computer system 1700 may locally estimate a tangent hyperplane to the decision boundary of the imitating neural network by fitting a multivariate linear regression model to example points on the decision boundary. In some embodiments, computer system 1700 may then compute an orthogonal line to the estimated decision boundary. In some embodiments, computer system 1700 may then search along this orthogonal line, for example by using a binary search, to find a point in the data space that is on the decision boundary of the hybrid network.

In some embodiments, computer system 1700 may test for reasonableness by testing for consistency. That is, computer system 1700 may train a diverse set of networks. Then, computer system 1700 may measure how much the position of the decision boundary changes from one network to another. If there is significant variation among the networks, computer system 1700 may use that as a diagnostic that at least some of the networks are not finding a reasonable decision boundary.

In some embodiments, computer system 1700 may train a “BOTH” detector and/or a “NEITHER” detector for data points on or near the decision boundary of the hybrid network and/or the imitating neural network. Computer system 1700 may train a BOTH and/or a NEITHER detector as described in association with block 208 of FIG. 2. In some embodiments, computer system 1700 may assign as a unit output value a constant background score for all data items detected by the NEITHER detector.

In some embodiments, computer system 1700 may train a discriminator between the sets “BOTH” and “NEITHER” as well as a detector for each of the sets. In some embodiments, if the discriminator variable associated with the decision boundary comprises input from a detector for each alternative, computer system 1700 may use both detectors being above a specified detection threshold as an initial indication that a data item is in the “BOTH” set. In some embodiments, computer system 1700 may use both detectors being below a specified detection threshold as an initial indication that a data item is in the “NEITHER” set. In some embodiments, computer system 1700 may train a detector for each set being discriminated if the discriminator element does not already comprise such detectors or input from such detectors.

In some embodiments, computer system 1700 may use additional indications to distinguish the “BOTH” set from the “NEITHER” set. For example, in some embodiments, computer system 1700 may compute a histogram for data from the union of the two sets on or near the decision boundary. Computer system 1700 may then determine whether the histogram appears to be unimodal or bimodal, as discussed in association with block 1509 of FIG. 15. In some embodiments, computer system 1700 may compute such a histogram for data projected to a line orthogonal to a hyperplane to the estimated decision boundary. In some embodiments, computer system 1700 may compute such projections to orthogonal lines for a plurality of such orthogonal lines.

As a second example, computer system 1700 may compute the magnitude of the derivative of the discrimination score along the line orthogonal to the decision boundary through the point on the decision boundary for the data input being evaluated. A low magnitude for this derivative is an indication that the data point is in the “NEITHER” set. A high magnitude is an indication that the data point is in the “BOTH” set.

In some embodiments, computer system 1700 and the HNLMS may create one or more new features to discriminate among the data items detected by the BOTH detector. For example, in some embodiments, computer system 1700 may create a new feature by standard training of a discriminator node to discriminate the two sets. In some embodiments, computer system 1700 may train additional new nodes in the subnetwork for the new discriminator node. As another example, computer system 1700 may train a new discriminator using constrained optimization (524 of FIG. 5).

In some embodiments, computer system 1700 may use knowledge of a mereology to refine a decision boundary. In an illustrative embodiment, computer system 1700 may compute the alignment of the parts of an image to the parts represented in a mereology of the object in the image or of an object hypothesized to be in the image. Alignment of parts to a specified mereology is discussed further in association with block 413 and 415 of FIG. 4 and FIGS. 7, 12, 13, and 19.

For example, in some embodiments, computer system 1700 may sample a pair of data items near the decision boundary, one from each of two known sets with mereologies comprising one or more shared components. In some embodiments, a pair of data items from the same category or named set may share identical mereologies. With any shared mereology components, computer system 1700 may than align each of the data items to its mereology and store the alignment information in cells in units that detect specified parts of each image, thus at least partially aligning the two images with each other. Even if the mereologies are not identical, computer system 1700 may then create and train detectors and/or feature variables that discriminate one or more pairs of two aligned parts from each other.

In some embodiments, computer system 1700 may project a set of selected data items to a line that computer system 1700 has computed as orthogonal to the estimated decision boundary of the imitation neural network and/or to the estimated decision boundary of the hybrid network. In some embodiments, computer system 1700 may limit the selected data items to be within a specified distance of the orthogonal line. In some embodiments, computer system 1700 may generate additional data items for each of the two sets being discriminated. In some embodiments, computer system 1700 may generate additional data items by random perturbations and/or adversarial attacks on each selected data item. In some embodiments, preferably, computer system 1700 may augment each selected data items with the same number of generated items. In some embodiments, computer system 1700 may generate additional data items using a pair of generators, one generator trained to generate examples for one of the known sets being discriminated and a second generator trained to generate examples of the second known set. In general, computer system 1700 may use any method to create a proportional number of additional examples of each known set in the vicinity of the decision boundary.

In some embodiments, computer system 1700 may then estimate a probability density function for each of the two sets being discriminated. In some embodiments, computer system 1700 may compute a histogram of the counts of data items as a function of the position of the projection of each selected data item to the line orthogonal to the decision boundary. In some embodiments, computer system 1700 may estimate a regression function for the difference or the ratio of the two estimated density functions. In some embodiments, computer system 1700 may estimate a Bayes minimum error dividing point for the two estimated probability density functions or of the smoothed estimates obtained from the regression estimates or a smoothed approximation to the histogram counts. In some embodiments, computer system 1700 may use this estimated Bayes minimum error point as a point on an updated decision boundary.

In block 411, in some embodiments, computer system 1700 may create local normed spaces. In some embodiments, computer system 1700 may create a local normed space using a neural network autoencoder or a hybrid network parametrically controlled autoencoder with specified features (FIG. 9). In block 411, the specified features may be engineered features specified and/or computed by, for example, the HNLMS. As is well known to those skilled in the art of neural networks, an autoencoder is a network trained, for a specified set of data examples, to encode each input data item with a restricted encoding, called the “bottleneck” layer of the autoencoder, such as a vector with a specified limited number of dimensions, and then, for the specified set of training data, to produce an output for each data example that matches the input as well as possible. For a local autoencoder, computer system 1700 or the HNLMS, for example, may specify a set of nodes as the input data space. For example, the input space of the autoencoder may be the set of nodes connected into a node or unit, such as a detector node or unit or a discriminator node or unit. As another example, the input space may be the union of the elements that are connected into a pair of detectors, or to a classifier or to a set of more than two detectors. The input space may be the union of the input variables to the union of the elements connected to a decision element group.

Hybrid parametrically controlled autoencoders with specified features are discussed in association with FIG. 9.

In some embodiments, computer system 1700 may introduce a local normed space to limit the effective dimensionality of the input to one or more detectors and/or discriminators in order to facilitate improving the sensibility of the detectors and/or discriminators. For example, in some embodiments, local normed spaces are used by computer system 1700 in block 410.

In block 412, in some embodiments, computer system 1700 may manipulate data and perform sequential computation in ways that cannot be represented in a conventional neural network. In some embodiments, each cell has a local memory. In some embodiments, computer system 1700 may perform sequential computations associated with a cell before, during, and/or after the computation of the activations of the units and nodes.

For example, in some embodiments, computer system 1700 may use the cells to compute attributes and features using the cells, as described in the following paragraphs.

In some embodiments, computer system 1700 may use the cells to implement special purpose code developed specifically for the domain in which the hybrid network is to be deployed. Such special purpose code may represent a process called “knowledge engineering.” In some embodiments, computer system 1700 may use the cells to make logical inferences (2102 of FIG. 21). In some embodiments, computer system 1700 may use the cells to represent a probability network, such as a hidden Markov process or a dynamic Bayesian network for probabilistic inference (2102 of FIG. 21). In some embodiments, computer system 1700 may use the cells to represent a cellular automaton. These uses of the cells to do sequential computations after receiving a data item to be classified are discussed in association with FIGS. 19 and 21.

In some embodiments, computer system 1700 may perform sequential computations specified by knowledge engineering on data stored in a cell or in input or output data. For example, if computer system 1700 has generated text, images, or video, in some embodiments, computer system 1700 may compare the proposed generated output to the training data to verify that the proposed output is not close enough to any item data to violate copyright.

As another example, in some embodiments, computer system 1700 performs logic or set theory computations on the input, the output, and or data computed within the network. For example, in a text generator, in some embodiments, computer system 1700 may test the output for logical consistency. For example, computer system 1700 may have program code representing such syllogisms as “If A implies B is true, and A is true, then B is true” and “If A is true and B contradicts A, then B is not true.” In some embodiments, computer system 1700 may have logic based on ontologies, such as “If A is a kind of B and there is an example of A that has a property C, then there is an example of B that has property C.”

As a specific example of violating the use of ontological logic, a state-of-the-art text generator repeatedly asserted that “A perceptron cannot represent the XOR function” while also acknowledging that “An elementary perceptron can represent the XOR function” and even supplying an algorithm to train an elementary perceptron to represent the XOR function. This behavior is neither logical nor sensible.

The statement “A perceptron cannot represent the XOR function” is false, but is widely quoted on the web. The text generator was trained on text from the web but also could quote verbatim from the out-of-print book in which Frank Rosenblatt introduced perceptrons and proved that even an elementary perceptron could be trained to represent any Boolean function, which includes the XOR function. Without explicit logical analysis, it is difficult to get a neural network with trillions of learned parameters to forget something even if it logically contradicts something else that it has learned. In various embodiments, computer system 1700 may overcome this difficulty by explicitly applying logical reasoning in the cells in a computation separate from and/or overriding the computations in the nodes.

In some embodiments, computer system 1700 may store, as a variable in a cell, a known value, called an “attribute,” associated with a specified element. In some embodiments, computer system 1700 may determine whether to store an attribute associated with an element based on the activation value of the element for the current data item. For example, in some embodiments, for a detector or discriminator element, computer system 1700 may only store an attribute if the activation value is in a specified interval, such as a detection acceptance interval.

An example of an attribute is the position within an image of a node in a convolutional network. Another example of an attribute is the orientation of a detected object, such as the angle of rotation of a line segment. Other attributes of an object are the size, the color, and the texture. In a model based on a hierarchical knowledge structure such as a mereology or an ontology, an element may have attributes inherited from other elements in the hybrid network. In some embodiments, cells may be programmed to communicate attributes through the data communication links among the cells and between cells and nodes. In some embodiments, computer system 1700 may control the communication of attributes dependent on node activation values and attribute values of the current data item.

In some embodiments, computer system 1700 may implement software to compute attributes or features specified by, for example, the human team of the HNLMS. In some embodiments, computer system 1700 may store the value of a human specified feature in a cell within a specified unit. An example of a human specified feature is the estimated frequency of a formant in speech analysis. The estimation of formant frequencies is well known to those skilled in the art of speech signal processing. Another example of a human specified feature is explicit detection of edges in an image by a high pass filter. Although convolutional neural networks can detect edges in an image, the edge detection in a convolutional neural network is mixed in with all the other activations of the nodes of the network. In some embodiments, computer system 1700 may explicitly label detected edges as edges. The detection of edges in images is well known to those skilled in the art of digital signal processing of images. In some embodiments, computer system 1700 may use detected edges in a mereology. In some embodiments, computer system 1700 may use detected edges in aligning an image to a model or to another image.

In some embodiments, computer system 1700 may design and train a new feature specifically to improve the discrimination of two known sets. In some embodiments, computer system 1700 may use such a feature as a specified feature in a hybrid parametrically controlled autoencoder with specified features with the bottleneck layer including the new feature among the variables in a local normed space. In some embodiments, computer system 1700, as part of HNLMS, may develop a new feature to discriminate real or generated data item examples near a decision boundary between two known sets, as described in association with block 410 of FIG. 4. For example, computer system 1700 may create and train a new feature to discriminate between data items from the two known sets that are detected by a BOTH detector such as described in association with block 410.

In some embodiments, computer system 1700 may automatically create a new feature by training a new discriminator node on the task of improving the discrimination of an existing discriminator node or unit for a specified pair of target sets. In some embodiments, computer system 1700 may train the new feature node or unit on a selected set of data. In some embodiments, computer system 1700 may select the errors and close calls of the existing discriminator as the training data for the new feature. In some embodiments, computer system 1700 may select the data items near the decision boundary of the existing discriminator as the training data for the new feature.

In some embodiments, computer system 1700 may create and train one or more candidate new features and then test the performance of the system with one or more selected candidate new features added to the specified features in a hybrid parametrically controlled autoencoder with specified features. In some embodiments, computer system 1700 may test the comparative sensibility of the system with a selection of new features as well as the classification performance. For example, in some embodiments, computer system 1700 may implement one or more simulated adversarial attacks on the system and measure the rate of success of the adversarial attacks.

For example, in some embodiments, computer system 1700 may sample a pair of data items near the decision boundary, one from each known set. Computer system 1700 may than align each of the data items to a mereology and store the alignment information in cells in units that detect specified parts of each image, thus aligning the two images with each other. Computer system 1700 may then create and train detectors and/or feature variables that discriminate two aligned parts from each other.

In some embodiments, computer system 1700 may use an attribute as a feature. In some embodiments, a node may have a known potential attribute that is realized for a specified data item if the activation of the node is in a specified interval when the specified data item is used as an input to the global or to a local data space. For example, a node may have a potential position attribute that is activated when the value of the activation of the node is above a specified threshold.

For example, in a convolutional network designed for image recognition, typically each low-level node receives activation connections only for a small number of pixels located at and close to a specified position in the image. Similarly, in a speech recognition system a node receives a sequence of input vectors, each from a limited interval of time. In addition, a node in a speech recognition system may receive values for only a single frequency or a limited range of frequencies. The position of the inputs received by a node in a convolutional image recognition is a constant that does not vary from one input data item to another. However, in some embodiments, computer system 1700 may store in a position attribute cell the position of a detector node that is activated above a specified detection threshold as an attribute for the current data item. Similarly, in a speech recognition system, computer system 1700 may store in a time-frequency attribute cell the time and frequency position of a detector node that is activated above a specified detection threshold.

In some embodiments, when one or more nodes associated with an attribute cell are activated above a specified minimum threshold, computer system 1700 may set the attribute value in the cell to be the known attribute of the associated cell with highest activation level. Such an attribute is not explicitly represented in a node activation and therefore is not available to higher level nodes through the network connections. However, based on the design of the system or as specified by the HNLMS, for example, computer system 1700 may store the attribute in a cell and create data links from that cell to other cells and/or other nodes in the network. In a network that represents a mereology, in a higher-level node or cell, computer system 1700 may match two or more attributes, such as the position of related parts in the mereology of an object to a trained model for the relative values of the attribute in an image of a specified object. In some embodiments, computer system 1700 may scale the position values of components of an object based on the size of the object as seen in an image.

In some embodiments, computer system 1700 may use cells to hold state information in state space modeling (FIG. 7 and block 413 of FIG. 4). In some embodiments, computer system 1700 may do state space analysis for a data item thereby changing the behavior of the system after the data item has been received for classification.

In some embodiments, computer system 1700 may use cells in computing active alignment (FIG. 12 and block 417 of FIG. 4) of a data item, changing the behavior of the system after the data item has been received for classification.

Changing the behavior of the system after a data item has been received may help computer system 1700 make the system more robust against adversarial attacks and other disturbances that may cause non-sensible errors.

In using cells for active alignment and/or other analyses related to mereology and other human knowledge representations, computer system 1700 may make the system easier to understand and may facilitate interaction with the HNLMS and other human consultation.

For example, in some embodiments, as part of the HNLMS, computer system 1700 may train models of attribute combinations while training the weights and biases of the connections of the network.

In block 413, computer system 1700 may build one or more hidden state space models.

In a classification task in which the input data variables can be organized by position in time and/or space, computer system 1700 may add cells to the network connected into a structure that represents the geometry of the relative locations of the input variables. More generally, computer system 1700 may build a structure among cells in the network to represent any adjacency graph among the input variables. In some embodiments, at a higher layer of the hybrid network, computer system 1700 may construct an adjacency graph among sets of cells in the higher layer. In each cell, in each layer, computer system 1700 may store the value of one or more hidden variables. In some embodiments, the cells at a higher layer may have the same adjacency graph as in lower layers, but with different or additional hidden variables.

In some embodiments, in block 413, computer system 1700 may implement probabilistic inference or dynamic Bayesian networks in the cells of the network (2102 in FIG. 21).

Hidden state space models are explained in association with FIG. 7.

In block 414, computer system 1700 may manage the option of human consultation in many aspects of the invention. In preferred embodiments, computer system 1700 may manage the human consultation to maximize the amount of improvement per the amount of human time and labor required. In some embodiments, computer system 1700 may semi-automate a process that would otherwise require human knowledge engineering by humans with expert knowledge and an amount of labor that could grow with the size and complexity of the network. Additional aspect of communication between computer system 1700 and one or more humans are discussed in association with FIG. 21.

There are multiple examples of aspects of the invention in which computer system 1700 may manage human consultation to be efficient and effective. In some embodiments, computer system 1700 may provide information to human team members of the HNLMS and/or to users of the system such that a human may initiate a process of human consultation.

An example in which either computer system 1700 or a human may initiate human consultation is the naming of known sets. Computer system 1700 may ask a human to supply a human understandable name for a known set for which computer system 1700 may provide examples. In preferred embodiments, computer system 1700 may manage the efficiency of this process by only asking for names for known sets that are associated with elements that play vital roles in a hybrid network that is already trained to a degree that satisfies a specified criterion. In some embodiments, a human may volunteer a name for any known set or for any variable at any time at the discretion of the human volunteering the name. For example, a human may volunteer a name if the human consultant believes that a name will enable computer system 1700 to guide the training to learning concepts that will generalize better to new data. A human may also volunteer a name wherever the human believes the supplied name will efficiently improve the holistic interpretability of the hybrid network.

In some embodiments, in associating a set with an element being actively trained, computer system 1700 may give preference to associating the element with a named set to associating the element with an unnamed known set. This preference may help meet the expectation of the human that the naming of the set will help improve the generalization performance of the network. This preference will also increase the holistic interpretability of any element associated with a named set.

Either computer system 1700 or a member of the human team in the HNLMS, for example, may initiate human consultation in defining the initial state space for a hidden state space model such as discussed in association with FIG. 7. In some embodiments, computer system 1700 may largely automate future changes in the state space. However, either computer system 1700 or a human may initiate further human consultation whenever it appears that the consultation will be efficient, worthwhile, and effective.

In preferred embodiments, computer system 1700 may make available data and displays that will aid humans in following and understanding the training process and system being trained. For example, in histogram analysis in FIG. 15 and block 507 of FIG. 5, computer system 1700 may generate plots of the histograms.

In some embodiments, computer system 1700 may provide data from any comparative evaluation that makes a significant improvement or, alternately, that shows a degradation in performance that exceeds a specified criterion.

Humans may supply mereologies and other human knowledge representations and/or provide oversight on the selection of human knowledge representations from publicly available sources by computer system 1700.

Humans may provide oversight on any change in the hybrid network that changes the trade-off between classification performance and sensibility by more than a specified amount.

In some embodiments, for changes that improve both classification and sensibility, computer system 1700 may provide data to keep humans informed although no consultation may be needed.

In some embodiments, humans may provide guidance in decisions of when to use alternatives to back propagation of derivatives in hybrid training. Preferably, to reduce human labor, this human guidance would apply a single decision to a substantial portion of the hybrid network such as one or more complete layers rather than to individual elements. In some embodiments, computer system 1700 may enable a human to intervene on a single element if the element is critically important in overall performance based on a specified criterion. This enablement may include computer system 1700 gathering data and presenting it in a fashion that enables efficient and effective human understanding. In some embodiments, computer system 1700 may enable a human to intervene on a single element if the element is critical to one or more data items that are critically important based on a specified criterion.

In some embodiments of continual lifelong learning, computer system 1700 may continually test performance of new versions of the system on old tasks and prepare a report for humans on any degradation in performance on old tasks.

In some embodiments, computer system 1700 may seek human consultation to verify the sensibility of a decision boundary in a discriminator. If the human consultant does not agree that the supplied example of data items on or near the decision boundary are appropriately characterized as being near the boundary, it is an indication that the system fails to satisfy second level sensibility and that computer system 1700 should take remedial action. In some embodiments, computer system 1700 may take remedial action by delegating and/or excluding data items. For example, computer system 1700 may identify additional data items to delegate by empirically training data weights and delegating data items with negative weights, as discussed in association with blocks 1123-1126 of FIG. 11. If the human consultation indicates that one of the alternatives is a poor match, then computer system 1700 may take remedial action by data exclusion.

In preferred embodiments, computer system 1700 may seek this form of human consultation for only a fraction of examples that is less than a specified criterion for amount of consultation.

In block 415, in some embodiments, computer system 1700 may perform diagnosis and detection of instances that violate sensibility. In some embodiments, computer system 1700 may use a tool called “canary” networks. A canary network is a network designed and trained to be vulnerable to changing its classification output due to an adversarial attack and other small change in the input. In some embodiments, computer system 1700 may train a diverse set of canary networks and a diverse set of robust networks. In some embodiments, computer system 1700 may train multiple networks with the same architectures or similar architectures to be diverse by using counter-tying. The use of counter-tying to increase diversity in a set of networks is described in U.S. Pat. No. 11,151,455, titled “Counter-tying nodes of a nodal network,” which is incorporated herein by reference in its entirety.

Given a classification task, computer system 1700 may create a canary network by training a conventional neural network on the classification task, avoiding any of the methods used to make a neural network resistant against adversarial attacks. For example, in some embodiments, computer system 1700 could avoid training the canary neural network with either random perturbations or simulated adversarial attacks. In some preferred embodiments, computer system 1700 could also avoid any of the steps to improve the sensibility of the network discussed in association with FIGS. 1, 2, 3, 4, 5, and other figures. Further, in some embodiments, computer system 1700 may do the reverse of some of the recommended steps in association with those figures. For example, in some embodiments, instead of replacing unbounded activations with bounded functions, computer system 1700 could replace bounded activation functions, if any, with unbounded activation functions. In some embodiments, computer system 1700 could increase the slope and/or the length of a non-flat interval of an activation function. Preferably, computer system 1700 would select changes that would increase the vulnerability of the canary network to changes in the input while minimizing the impact of the changes on classification performance. In some embodiments, computer system 1700 may retrain the canary networks to get the best performance it can on clean data while allowing it to fail on perturbed data.

In some embodiments, computer system 1700 may create one or more robust networks by the methods recommended in association with FIGS. 1, 2, 3, 4, 5, and other figures.

From one or more examples of a canary network and one or more examples of a robust network, in some embodiments, computer system 1700 may create an arbitrarily large set of diverse networks by continuing or resuming training of multiple copies of a base network with counter-tying between selected pairs of corresponding nodes in any two copies of the same base network. In some embodiments, computer system 1700 may counter-tie a pair of nodes by creating a bi-directional pair of knowledge sharing links with the is-not-equal-to relation. By selecting different subsets of the nodes in different pairs of networks, and/or selecting different subsets of the set of training data on which to enforce the regularization of the link, computer system 1700 may create a wide variety of differences among the pairs of networks in the set of diverse networks.

Once computer system 1700 has trained a diverse set of canary networks and a diverse set of robust networks, computer system 1700 may use the diverse networks to diagnose any data item that is presented for classification. Any adversarial attack or other disturbance to the input data will be more likely to change the answer for a canary network than for a robust network.

In some embodiments, computer system 1700 may test the null hypothesis that there is no difference between the response of the canary networks and the robust networks. Computer system 1700 may continue testing with new selections of one or more canary networks and one or more robust networks until the null hypothesis is rejected or a stopping criterion is reached.

In other embodiments, computer system 1700 may test the differences between the response of the canary networks and the robust networks in other ways. In some embodiments, computer system 1700, to further confirm that the normal input has been disturbed, may perform an untargeted reverse adversarial attack. That is, computer system 1700 may simulate an adversarial attack of the data item presented to be recognized and present the data as changed by the simulated adversarial attack to one or more canary networks. Preferably, in an untargeted attack, computer system 1700 may simulate a form of adversarial attack that attempts to get the canary network to lower the score of the current answer without targeting any one new answer over any other. If, in multiple simulated untargeted attacks, one new answer occurs a plurality of times, that is an indication that the plurality answer is easily accessible by small changes in the input. If the plurality answer from the untargeted simulated attacks agrees with the plurality answer of the robust networks, that is strong evidence that the data item presented was changed by an adversarial attack or other disturbance, and that the plurality answer is the correct answer for the original, unperturbed input.

In block 416, in some embodiments, computer system 1700 may implement an active defense against non-sensible mistakes. In some embodiments of the active defense, computer system 1700 may control one or more units with data switches such as shown in FIG. 3B. In some embodiments, active defense is used in association with block 803 of FIG. 8.

In some embodiments, to implement the active defense, computer system 1700 may train two or more activation functions for a node with the discontinuities and the intervals with high magnitude derivatives offset from each other, separated by intervals with zero derivatives and/or intervals in which the difference between the maximum value and the minimum value is less than a specified value and the magnitude of the derivative is less than a specified value.

In some embodiments, computer system 1700 may implement one or more data-dependent data switches. In some embodiments, computer system 1700 may specify a set of activation functions and data-dependent data switches such that for an input data value d, under control of computer system 1700, the data switch presents d as input to an activation function for which the input is in a relatively flat interval and is no closer than a specified amount to the closest end of the flat interval. In other words, computer system 1700 may be able to control the data switch such that small changes in the input do not cause a change in the output by more than a specified amount. In some embodiments, all the relatively flat intervals in all the activation function have constant values, so for any small change to the input to the element there is no change in the output.

In block 417, in some embodiments, computer system 1700 may perform data item specific active alignment. That is, computer system 1700 may compute an alignment of a data item after that data item has been received for classification. In some embodiments, computer system 1700 may be doing a local classification within a hybrid network and the classification may be to a specified set of known sets rather than to final classification categories.

In active alignment specific to a data item, in some embodiments, computer system 1700 may compute values for variables in a set of cells that specify the alignment of the cells with a human knowledge representation such as a mereology. In an image recognition task, each of the alignment cells may be associated with a specific position in an image that has been received for classification. Thus, in such an embodiment, computer system 1700 is computing an alignment between the received image and the mereology model.

In some embodiments, computer system 1700 may have trained an augmented mereology model that also models the relative positions of parts in the mereology.

The process of training mereology alignment models in discussed in association with FIG. 12.

In some embodiments, computer system 1700 may align a data item with a type of human knowledge representation other than a mereology. For example, in a task involving words, such as speech recognition, handwriting recognition, translation, or text understanding, computer system 1700 may align observed words or hypothesized words with a parse in a specified grammar. In some embodiments, computer system 1700 may align words with a semantic net.

In some embodiments of alignment of images or video, computer system 1700 may first create a lower resolution representation of the image of video in order to do a fast preliminary analysis that may speed up the analysis of the original image or video. Computing a low-resolution representation of a high-resolution image or video is well known to those skilled in the art of image processing.

In some embodiments, computer system 1700 may perform classification of a low-resolution image or video. In some embodiments, computer system 1700 may use the classification of the low-resolution data item to construct a list of the best scoring categories or known sets. In some embodiments, computer system 1700 may use the list of best scoring categories or named sets to partially restrict the possible classifications for the higher resolution data item. In some embodiments, computer system 1700 may add to the list of candidates if the fit of the alignment to the mereology is worse than a specified criterion. In some embodiments, computer system 1700 may have determined a specified criterion for each target category or named set based on measurements of degree of fit in previous alignment of instances of the category or named set.

In some embodiments, computer system 1700, may align the low-resolution image or video with cells in a simpler hybrid network trained on low-resolution images or videos. In preferred embodiments, computer system 1700 may design the mereology alignment cells in the low-resolution model to be homologous to a specified subset of the mereology alignment cells in the high-resolution model. In such an embodiment, computer system 1700 may use the alignment of the low-resolution image to initialize a rough alignment of the high-resolution image. In some embodiments, computer system 1700 may then refine the alignment of the high-resolution image by filling in the alignment for cells that have not yet been aligned. In some embodiments, computer system 1700 may iteratively improve the alignment, changing the alignment of one or more of the cells to fit better with the alignment of cells that are close in the mereology adjacency graph to the cell that is being changed. In some embodiments, computer system 1700 may stop the alignment computation if no changes are made during an iteration of incremental improvements or if computer system 1700 detects a repeating cycle. In some embodiments, computer system 1700 may stop the iterative alignment process if some other specified stopping criterion is met. For example, in some embodiments, computer system 1700 may stop the alignment process if the only changes still being made are so small that they are less than a criterion that computer system 1700 has previously trained to detect changes that are so small that they do not change a classification more than for a specified small error rate.

In some embodiments, computer system 1700 may update the mereology alignment model. In some embodiments, computer system 1700 may save the data and the analysis in a repository.

In block 418, computer system 1700 may implement randomized activation during training and inference, including inference during deployment. In randomized activation, the activation value of one or more elements in a hybrid network may be different on repeated presentation of the same input data item.

In some embodiments, in block 418, computer system 1700 may use one or more of six types of randomizations or noise: (1) additive noise to the output of one or more elements and/or other variables, (2) simulated errors in one or more elements, (3) probabilistic switching of the destination of a data switch, (4) probabilistic switching of the interval of a partitioned activation function, (5) randomized dropout, and/or (6) simulated adversarial attacks on the network input and/or on one or more local data spaces. In preferred embodiments, computer system 1700 may use the same types of randomizations or noise in randomized training and diagnosis (520 of FIG. 5). In some embodiments, computer system 1700 may use higher degrees of randomization and/or noise during training than in inference during deployment.

In some embodiments, in block 418, computer system 1700 may implement any of the six types of randomizations or noise using the techniques explained in association with block 520 of FIG. 5. In some embodiments, in generating the randomizations and/or noise during inference during deployment, computer system 1700 may use control hyperparameters that generate less variation than used in training and/or diagnose.

In some embodiments, in block 418, for a data item received to be classified, for the network or for a selected unit, computer system 1700 may generate randomizations and noise a plurality of times. In some embodiments, computer system 1700 may combine the plurality of sets of output values across the plurality of randomization like the output values from a virtual ensemble. In such embodiments, computer system 1700 may empirically train the hyperparameters that control the randomizations.

In some embodiments, computer system 1700 may use randomized activation to help create a diverse set of canary networks and/or a diverse set of robust networks (415 of FIG. 4). In some embodiments, computer system 1700 may use counter tying and/or is-not-equal-to knowledge sharing regularization links to further increase the diversity. In some embodiments, computer system 1700 may use soft-tying and/or is-equal knowledge sharing regularization links to moderate the differences among the set of diverse networks so that corresponding elements in each network stay in correspondence other than the differences in randomized activation.

In some embodiments, during deployment, computer system 1700, after receiving a data item to be classified, computer system 1700 may randomly select a subset of the diverse canary networks and a subset of the robust networks, using a selection probability distribution that computer system 1700 does not specify until after receiving the data item to be classified.

In block 419, in some embodiments, computer system 1700 may construct and train robust template models, such as illustrated in FIG. 10.

In block 420, in some embodiments, computer system 1700 may substitute in an activation function f(x) a constant background score for values of x less a specified threshold T1 and/or for values of x greater than a specified value T2.

In some embodiments, in block 420, computer system 1700 in a robust template model may substitute a specified constant background score for the output value of the template model if the value of input value Xₖ satisfies |μₖ−Xₖ|>Tₖ for a specified value Tₖ for more than a specified number of the k input values. In some embodiments, computer system 1700 may substitute background score for the output value of the template model if bias+Σₖ w_{K} ƒ(|μₖ−Xₖ|) exceeds a specified value. Robust template models are discussed in association with FIG. 10.

In block 421, in some embodiments, computer system 1700 may build and train one or more generators and/or classifiers jointly with a team of one or more humans, as described in association with FIG. 21. In some embodiments illustrated in this figure, the human participation in the training and development may be more extensive than described in FIGS. 1 to 5. In the joint development of FIG. 21, one or more humans may directly control the training process. In generators discussed in association with FIG. 21, computer system 1700 may implement an interface that allows one or more humans to directly control details of the generation. In the joint development process, rather than minimizing the amount of human labor as in semi-automated knowledge engineering, greater human participation may be used to associate names with more known but unnamed sets and with unnamed features. The additional names make the networks easy to interpret which, in turn, enables more human guidance during training. Additional named features also enable more human control of generators. In some embodiments, in block 412, computer system 1700 may implement logical and/or probabilistic inference in the cells of the network, as discussed in association with block 2102 of FIG. 21.

In some embodiments, joint development and human guidance may be used with cooperative generators, such as used to generate additional training data in block 514 of FIG. 5.

In block 422, in some embodiments, computer system 1700 may train an adversarial generator and a real versus non-real discriminator. In some embodiments, computer system 1700 may also train one or more cooperative generators. In some embodiments, computer system 1700 may train generators such as described in blocks 2109, 2110, and 2111 of FIG. 21. In some embodiments, computer system 1700 may use variable resolution game theory-based training of the real versus non-real discriminator and the adversarial and cooperative generators, as described in international application PCT/US23/64296, titled “Generation and discrimination training as a variable resolution game,” which is incorporated herein by reference in its entirety, for generation and discrimination training/resolution game.

FIG. 5 is a diagram of illustrative embodiments of aspects of hybrid training. In FIG. 5, the topics are grouped by the phase of the training process, shown by the dashed blocks: 501 for initial training, 502 for the main hybrid training phase, 503 for lifelong learning and continued training during deployment (i.e., the model being deployed to perform the task it is trained to perform). However, many of the concepts and techniques apply to more than one phase.

FIG. 5 is not a flow chart. No sequential ordering of the blocks is implied. Computer system 1700 may apply the concepts and techniques in the respective blocks in any order, other than the rough grouping into phases represented by dotted blocks 501, 502, and 503. In some embodiments, computer system 1700 may impose some constraints on the order of application of the techniques' prerequisites in some of the details. In some embodiments, all of the concepts and techniques work together and computer system 1700 may co-develop them.

In some embodiments, to begin the training, in block 504, computer system 1700 may select a base network and incrementally make changes to the network to improve it, as discussed in association with blocks 101 and 103 of FIG. 1 and other blocks in FIGS. 1 and 2. The selected base network may be either a neural network or a hybrid network.

In some embodiments, in block 504, computer system 1700 repeatedly seeks opportunities to improve sensibility, holistic interpretability, classification performance and/or cost/performance. In some embodiments, computer system 1700 may repeatedly test the system on validation data that has been set aside from the training data.

In some embodiments, computer system 1700 may grow a network from scratch. In some embodiments, in block 505, computer system 1700 may grow a neural network from scratch and later convert the neural network to a hybrid network. In some embodiments, computer system 1700, may directly grow a hybrid network from scratch.

In block 506, in some embodiments, computer system 1700 may train the connection weights and node biases of one or more elements using back propagation of derivatives by gradient descent. Back propagation by gradient descent is the standard method for training neural networks. However, for a sensible network, it is essential that not all training be done by gradient descent.

However, in some embodiments, even after the initial training, the training may be partially based on gradient descent. However, in preferred embodiments, training is not based on gradient descent alone. In preferred embodiments, computer system 1700 uses a hybrid of training methods to improve the sensibility of the network being built and trained.

In block 507, in some embodiments, computer system 1700 performs histogram analysis. Block 507 is grouped with initial training for two reasons: (1) histogram analysis is an elementary technique that does not require other techniques as a prerequisite, and (2) histogram analysis is a broadly useful technique that may serve as a preliminary step for other techniques. On the other hand, histogram analysis may also be used during main training (502) and/or continued training (503). For example, computer system 1700 may use histogram analysis to facilitate human consultation (414 of FIG. 4) in any situation in which computer system 1700 uses human consultation. Histogram analysis is discussed further in association with FIG. 15, blocks 202 and 204 of FIG. 2, and block 405 of FIG. 4.

Computer system 1700, in block 507, may compute a histogram of one, two, or more variables. A variable may be a continuous valued real number or may be a discrete variable with values from a specified finite set. A specified finite set may represent a finite number of classification categories, a collection of known sets, or a collection of possible states for a hidden state space model.

For a neural network node, computer system 1700 may compute a histogram using as variables the value of the affine sum or the value of the output of the activation function of the node. Computer system 1700 may also use as a histogram variable the value received from any one of the connections into the node.

For a hybrid network, computer system 1700 may also use as a histogram variable a value supplied by a cell.

Computer system 1700 may also use as a histogram variable the value of a back propagated derivative. The derivative may be the derivative of the classification objective or of some other specified function. In a hybrid network, computer system 1700 may use as a histogram variable a derivative of a local target, such as described in association with block 508 of FIG. 5. Computer system 1700 may also use as a histogram variable a local substitute derivative function, such as described in association with block 509 of FIG. 5.

In some embodiments, computer system 1700 may perform regression on histogram counts to test a set of known sets to determine if any of the known sets satisfy specified criteria to be associated with a specified variable. For example, in some embodiments, computer system 1700 may tentatively associate a variable with a known set if the magnitude of the regression coefficient is greater than a specified value. Use of regression on histogram counts is discussed further in association with FIG. 15.

In some embodiments, computer system 1700 may select an interval of a specified variable to be used to represent detection of a known set, with the selection based on histogram counts.

In some embodiments, computer system 1700 may select a variable to be used as a discriminator between two known sets. In some embodiments, computer system 1700 may use histogram counts to determine initial threshold values to be used with the discriminator. In some embodiments, computer system 1700 may perform comparative performance tests to empirically adjust the threshold values used with a discriminator. In some embodiments, computer system 1700 may perform such comparative performance tests using data that has been set aside from training data. In some embodiments, computer system 1700 may continue to empirically adjust threshold values using data that is gathered from one or more deployed systems.

In testing a selected variable as a detector of a known set or as a discriminator of two known sets, computer system 1700 may find more than one known set for which the variable meets a specified criterion as a detector or as a discriminator. In such a case, in some embodiments, computer system 1700 may make multiple copies of the variable and of the subnetwork that leads to the variable. Computer system 1700 may then train each copy and its subnetwork on a distinct one of the detector and/or discriminator tasks.

In some embodiments, computer system 1700 may use histogram counts to determine bounds for a data dependent variable. The variable may be an output value of a node, cell, or unit. In some embodiments, computer system 1700 may limit the maximum and/or the minimum value for a specified variable in order to better assure the sensibility of nodes or units that directly or indirectly receive an input value that is a function of the variable. In some embodiments, computer system 1700 may limit the minimum and/or the maximum value for a variable based on the most extreme values observed for the variable on a specified set of data, such as the set of training data. In some embodiments, computer system 1700 may set the limiting values for a variable to be the most extreme plus a specified margin. In some embodiments, for some variables, the margin may be zero or negative, reducing the observed range. In some embodiments, computer system 1700 may later adjust the limits for a variable.

In some embodiments, computer system 1700 may use histogram counts to determine the bounds to use in a new activation function when computer system 1700 is replacing an unbounded activation function in block 202 of FIG. 2.

In some embodiments, computer system 1700 may use the histogram counts to determine the initial values to use for the μₖ parameters in a template model. In some embodiments, computer system 1700 may estimate the μₖ parameters as the mean of a set of data items, or as the median, or as the mode. In some embodiments, computer system 1700 may make any of these estimates from the histogram.

In some embodiments, if a selected variable is associated with one or more known sets, computer system 1700 may limit the data selected for the histogram to data in the union of the associated known sets. Computer system 1700 may then set exclusion limits for the selected variable initially based on the histogram, as explained in association with FIG. 15.

In some embodiments, computer system 1700 may use histogram counts in setting decision thresholds, as described in block 1506 of FIG. 15.

In some embodiments, computer system 1700 may compute a joint histogram for two or more variables. In some embodiments, computer system 1700 may use fewer, longer bin intervals for each variable in a multi-variable joint histogram than in a single variable histogram.

In some embodiments, computer system 1700 may do additional low-dimension analysis (block 517 of FIG. 5) if computer system 1700 detects significant correlation or significant clustering in a low-dimension histogram.

In block 508, in some embodiments, computer system 1700 may determine implicit local targets for a node.

In some embodiments, computer system 1700 may determine implicit or explicit local targets from association of one or more intervals of a nodes activation function with a known set. For example, computer system 1700 may set a designated point in the interval as a target for a data item in the known set.

In some embodiments, computer system 1700 may determine an implicit local target based on the sign of a back propagated derivative for a data item. For example, computer system 1700 or the HNLMS may specify a pair of values, such as {0, 1} or {−1, 1}, with the lower value being the target for any data item with a negative back propagated derivative and the higher value being the target for any data item with a positive back propagated derivative. In some embodiments, computer system 1700 may use the lower bound of the activation function as the lower value and the upper bound of the activation function as the higher value.

In some embodiments, computer system 1700 may use one or more intermediate values as targets for data items with a back propagated derivative less than a specified absolute value.

In some embodiments, computer system 1700 may use the determination of the presence or absence of an implicit error to convert a back propagation of a derivative to a back propagation of data (FIGS. 18 and 6 and block 510 of FIG. 5).

In some embodiments, computer system 1700 may make the determination of whether a node has made an implicit error in determining the degree to which the activation of the node in a specified interval agrees with membership in a known or named set. In some embodiments, computer system 1700 may use one or more outputs corrected to fix an implicit error in determining whether to associate the node with the known or named set. When computer system 1700 makes a new association or changes an existing association, in some embodiments, computer system 1700 may thereafter use the new or modified association to determine explicit errors for the node.

The use of implicit errors for training error prediction nodes is discussed in association with block 203 of FIG. 2.

In block 509, in some embodiments, computer system 1700 may create a substitute derivative function for a node. In some embodiments, computer system 1700 may use a substitute derivative function to enable or accelerate the training of a node with one or more intervals with relatively low magnitude derivatives, as illustrated in FIG. 3C. In some embodiments, the computer system 1700 may select a base substitute derivative function that computer system 1700 then multiplies by a back propagated derivative value or by the sign of a back propagated derivative value.

In some embodiments, computer system 1700 may use a continuous substitute derivative function activation during part of the training, such as early training until a criterion is met, and a discontinuous substitute derivative function once the criterion is met. In preferred embodiments of this type of substitute derivative function, computer system 1700 may multiply a base substitute derivative function by a back propagated derivative value or by the sign of a back propagated derivative value. In some embodiments, computer system 1700 may multiply the base substitute derivative function by the back propagated derivative or by the sign of the back propagated derivative only for an input value x, for which T1<x<T2 for specified threshold values T1 and T2. In some embodiments, computer system 1700 may set a constant background score and use that background score for all data with a value outside a specified interval, regardless of the sign or magnitude of a back propagated derivative. In some embodiments, computer system 1700, as controlled by the HNLMS, may customize the criterion for a change of substitute derivative function to an individual node. The HNLMS, for example, may compute a customized criterion for a node based on measurements collected during the training of the node.

In some embodiments, computer system 1700 may design the substitute derivative function to drive activations away from points of discontinuity or high magnitude derivatives in the activation function toward centers of relatively flat intervals, as illustrated by function 361, 362, and 363 in FIG. 3C. In some embodiments, computer system 1700 may delay the use of such a substitute activation function until after a training criterion is met.

In some embodiments, computer system 1700 may use a substitute derivative function in which the value of the substitute derivative function is always positive for input values less than a specified threshold T1 and/or is always negative for input values greater than a specified threshold T2. In some embodiments, computer system 1700 may use such a substitute derivative function for a node that multiplies a base substitute derivative function by a back propagated value for x in the interval T1<x<T2, as illustrated by intervals 353 and 354 of FIG. 3C.

In block 510, in some embodiments, for a specific node, computer system 1700 may back propagate labeled data examples rather than derivatives. In some embodiments, computer system 1700 may continue back propagating derivatives on pre-existing incoming connections while back propagating labeled data examples to one or more new elements.

In some embodiments, for a selected element with a standard discriminator activation function, computer system 1700 may determine, for each data item in a specified set, whether the element has made an implicit error. In some embodiments, computer system 1700 may use this information to back propagate data items with labels with the implicit errors corrected.

In some embodiments, computer system 1700 may back propagate these labeled data items to one or more new elements while optionally continuing to back propagate derivatives to its pre-existing incoming connections.

By correcting implicit errors, computer system 1700 may be able to train the new elements with information that is not available through regular back propagation. An illustrative example of such a training procedure is described below and illustrated in FIG. 18. In the description, set S1 is the set associated with lower values x<X1 in the input of the activation function, and the set S2 is the set associated with the higher values x>X2, where X1<X2. Either S1 or S2 may be associated with the maximum output value of the activation function, with the interior interval of the activation function being correspondingly either monotonically increasing or monotonically decreasing.

In some embodiments, computer system 1700 may use the following process, which is illustrated in FIG. 18:
(1801) Obtain a training data item.
(1802) Compute the activation of the network; call the activation value x.
(1803) Back propagate derivatives.
(1804) Associate X1 with the set S1, X2 with the set S2.
(1805) If x<X1, select the label S1 and go to (1809).
(1806) If x>X2, select the label S2 and go to (1809).
(1807) If the back propagated derivative to the discriminator element is negative, then select S1 and go to (1809).
(1808) Select S2;
(1809) Back propagate the current data item with label S1 or S2 to one or more of
   a. A pair of detector elements;
   b. A linear separator (FIG. 6);
   c. A subnetwork with its output directly trained by the labels S1 and S2;
   d. To an error predictor, back propagate the label and whether there was an implicit error.
(1810) Save corrected labels for S1 and S2 for all training data
(1811) Repeat steps (1801) to (1811) until a stopping criterion is met.
(1812) Train the new elements using the corrected labels for S1 and S2.

In some embodiments, computer system 1700 may delay the saving of corrected labels for S1 and S2 until the training of the selected standard discriminator element has stabilized enough so the corrected sets S1 and S2 are no longer changing by more than a specified criterion.

In some embodiments, computer system 1700 may create a new unit to discriminate S1 and S2 with corrected labels using constrained optimization, as discussed in association with block 524 of FIG. 5. From the solution to the constrained optimization, computer 1700 may create a linear threshold function as a new element. In some embodiments, computer system 1700 may freeze a copy of the subnetwork so that the performance of the linear threshold function will not degrade as the network is changed by further training. In some embodiments, if further training causes the selected standard discriminator element to make new errors, computer system 1700 may train another linear threshold function. If computer system 1700 drops the selected standard discriminator element from the network when or before the training is stopped, there will be no path to back propagate non-zero derivatives of a specified function of the output through the one or more linear threshold functions that computer system 1700 has used to replace the selected standard discriminator element.

In some embodiments, computer system 1700 may create one or more new units, each comprising a pair of detectors trained on the sets S1 and S2 and an associated discriminator node. In some embodiments, computer system 1700, may specify the associated discriminator to compute the difference of the outputs of the two detectors, or a similar combining function, without requiring any training of the connection weights. In some embodiments, the computer system 1700 may use a piecewise constant function as the activation function of the discriminator. In some embodiments, computer system 1700 make the activation function be a standard discriminator function. In some embodiments, computer system 1700 may train two or more of the new units to make their S1 and S2 detectors be diverse. In some embodiments, computer system 1700 may also train a diverse set of canary networks as S1 and S2 detectors and/or a diverse set of discriminators.

In some embodiments, computer system 1700 may connect one or more of the new elements created in block 1809 to elements in higher layers of the network up to and including the output of the network. In some embodiments, computer system 1700 may train the higher subnetwork by backpropagation of derivatives of an output objective without back propagating derivatives to or through the new elements. Furthermore, in some embodiments, computer system 1700 may drop the original standard discriminator element once the new elements have been trained. In such an embodiment, the activation of the network on a new data item through one or more of the new elements has no corresponding back propagation of derivatives, increasing the protection against adversarial attacks.

If the selected standard discriminator element still makes implicit errors when the training of the network has converged, then computer system 1700 may improve the performance of the network by replacing the standard discriminator element by one or more of the new elements trained to the corrected sets S1 and S2. In addition, because the new elements are trained with data explicitly labeled as S1 or S2, they may be easier to interpret than typical inner nodes of a deep network.

In block 511, in some embodiments, computer system 1700 may train a second network partially or approximately to imitate a semi-homologous first network, where every specified node in the second network is associated with a node in the first network to imitate. In some embodiments, computer system 1700 may use the output activation value of a node in the first network as a target for the activation value of one or more specified nodes in the second network. In some embodiments, computer system 1700 will use is-equal-to knowledge sharing links to train the specified nodes in the second network to better agree with the associated nodes in the first network.

In some embodiments, the design of the first network may be less sensible than the design of the second network. In some embodiments, the first network may be a neural network and the second network may be a hybrid network. On the other hand, in some embodiments, the second network may be less sensible than the first network. For example, the first network may be a hybrid network trained to be sensible and the second network may be a canary network (415 of FIG. 4). In each of these situations, computer system 1700 may relax the imitation when the activation in the first network is near a discontinuity or a point of high magnitude derivative of the activation function of the node in the first network.

In some embodiments, the imitation may be limited to specified data items. For example, in some embodiments, the second network may be a new member of an ensemble that is being trained to be diverse on a specified subset of the data but to agree on a disjoint specified subset, and, in some embodiments, to be neutral on a third subset.

In block 512, in some embodiments, computer system 1700 implements conditional hybrid training. In conditional hybrid training, computer system 1700 may customize a hybrid training technique, such as applying the technique only for selected data items and/or only on selected units or nodes.

For example, in block 512, in some embodiments, computer system 1700 may implement conditional flattening. In some embodiments, computer system 1700 may implement conditional flattening customized to each selected data item, using a data switch such as 325 in FIG. 3B. In some embodiments, after an amount of training specified by, for example, the HNLMS, computer system 1700 may begin with a partially trained selected node with an activation function y=act1(x) partitioned into disjoint intervals, such that act1(x) is non-flat for one or more of the intervals. Computer system 1700 may copy act1(x) as act1A(x) (323 in FIG. 3B), perhaps making some of the intervals less flat. Computer system 1700 may then copy act1(x) as act1B(x), making some or all the intervals flatter. In some embodiments, computer system 1700 may make act1B(x) (324 in FIG. 3B) a piecewise constant function. Computer system 1700 may then add a data switch 325 of FIG. 3B to make the unit 322 of FIG. 3B.

In some embodiments, computer system 1700 may conditionally apply any of the techniques discussed in association with blocks 508, 509, 510, 511, and/or 512 of FIG. 5.

In some embodiments, computer system 1700 may apply any of the training techniques 513, 514, and/or 516 as on-going continual training after a system has been deployed. In some embodiments, computer system 1700 may apply one or more of these techniques during main training before deployment.

Hybrid conditional training is discussed further in association with FIG. 13.

In block 513, computer system 1700 may apply continual learning during deployment, that is computer system 1700 may actively update the learned parameters using data acquired during operational use. In some embodiments, computer system 1700 may continue to add elements to the network.

In some embodiments, computer system 1700 may continue to test the performance on previous training and validation data. In some embodiments, computer system 1700 may apply is-equal-to knowledge sharing links from an earlier version of the network to specified nodes in a revised version of the network to maintain performance on specified data items.

In preferred embodiments, computer system 1700 may repeatedly test the performance of the system on data that has been set aside for validation testing. Preferably, computer system 1700 will add new data to the validation data on a specified schedule.

In some embodiments, computer system 1700 may train a new template model to match new data using one-shot or few-shot learning.

For example, in some embodiments, computer system 1700 may set the μₖ values in a new template such as illustrated in FIG. 10 to the values in a single example or to the mean of the values in a plurality of examples. In some embodiments, computer system 1700 may set the wₖ or σₖ⁻¹ values to a value specified by a hyperparameter. In some embodiments, computer system 1700 may tune the hyperparameter to a specified trade-off between precision and recall. Such a template is called a one-shot or few-shot template. In some embodiments, computer system 1700 may continue to train a one-shot or few-shot template as additional data is acquired.

In some embodiments, computer system 1700 may compute an alignment between the current data item and a mereology model or other model of human knowledge represented as graphical structure. Training alignment models is discussed in association with FIG. 12 and block 417 of FIG. 4.

Continual learning during deployment is discussed further in association with FIG. 8.

In block 514, computer system 1700 may generate additional data examples. For example, in some embodiments, computer system 1700 may use a mixture of generators model as described in U.S. Pat. No. 11,354,578, tiled “Mixture of generator models,” which is incorporated herein by reference in its entirety. As another example, computer system 1700 may use a stochastic categorical autoencoder (SCAN) as described in U.S. Pat. Nos. 10,679,129 and 11,461,661, both titled “Stochastic categorical autoencoder network” and both of which are incorporated herein by reference in their entirety. In some embodiments, computer system 1700 may develop a SCAN with a parametrically controlled hybrid autoencoder, as illustrated in FIG. 9. In some embodiments, computer system 1700 may train a mixture of generators system or a SCAN with back propagation from a joint objective to produce data classified as real by a real versus synthetic discriminator.

In some embodiments, computer system 1700 may generate additional data examples as a joint human+AI creative activity as described in FIG. 21 and block 421 of FIG. 4.

In some embodiments, computer system 1700 may generate data from some other form of cooperative generator, where the phrase “cooperative generator” is used in contrast to a generative adversarial generator (GAN). Unlike a GAN, computer system 1700 may train a cooperative generator on examples of real data. In some embodiments, computer system 1700 may train the generator to generate realistic data by using one or more real versus synthetic discriminators. In some embodiments, computer system 1700 may train a real versus synthetic discriminator as the discriminator in a GAN and then use that discriminator with one or more cooperative generators. In some embodiments, computer system 1700 may co-train the real versus synthetic discriminator as hybrid network, co-trained with one or more hybrid classifier networks and sharing known sets and human knowledge representations such as mereologies. In some embodiments, computer system 1700 may use unidirectional knowledge sharing links in either or both directions between classifier hybrid networks and the real versus synthetic discriminator. In some embodiments, computer system 1700 may also share human knowledge representation with one or more cooperative generators.

In some embodiments, computer system 1700 may generate additional data examples using a conventional autoencoder with a stochastic bottleneck layer or a parametrically controlled autoencoder (FIG. 9) with a stochastic layer.

In block 516, computer system 1700 may co-train a set of partially or fully homologous networks. In a set of partially homologous networks, each specified node in a network is homologous in network structure to a corresponding node in one or more other networks. In a set of fully homologous networks, each node in each network is homologous in network structure to each corresponding node in each homologous network.

Computer system 1700 may use co-training of homologous networks during initial training (501 of FIG. 5) and/or during main training (502 of FIG. 5) as well as during continued training (503 of FIG. 5).

In some embodiments, computer system 1700 may use co-training of homologous networks to reduce the amount of computation required to train a plurality of networks. For example, in some embodiments, computer system 1700 may use standard training on a single network or a selected subset of the set of networks. Computer system 1700 may then train the rest of networks by using is-equal-to knowledge sharing links on a specified subset of the nodes using a high value for the strength hyperparameter α. In some embodiments, computer system 1700 may also use is-not-equal-to knowledge sharing links for selected nodes and/or for selected data items to train the networks to be diverse.

In some embodiments, the activation functions in a specified set of nodes in one or more of the homologous networks may have a different activation function than the homologous nodes in other networks. For example, one network may have a continuous activation function for a node and a second network may have a piecewise constant activation function for the homologous node.

In some embodiments, computer system 1700 may create diversity by counter-tying a selected set of nodes in a specified pair of the set of networks. In some embodiments, computer system 1700 may create diversity by having one or more non-homologous nodes in each network.

In some embodiments, computer system 1700 may obtain one or more pretrained networks, such as conventional neural networks that have not been trained for sensibility. In some embodiments, computer system 1700 may then train homologous conventional or hybrid networks using is-equal-to knowledge sharing links in addition to or in place of gradient descent training. In some embodiments, computer system 1700 may decrease the strength hyperparameter α during later stages of training the homologous conventional or hybrid networks.

As another example, computer system 1700 may use co-training to share knowledge among a set of distributed systems. For example, in continued learning during deployment of a distributed set of homologous networks, one specific distributed network may encounter a new data item that causes a misclassification. In some embodiments, computer system 1700 may train the specific distributed network so that it correctly classifies the new data item. In preferred embodiments, computer system 1700 may limit the changes in the specific distributed network to a selected set of nodes. In some embodiments, computer system 1700 may then use knowledge sharing links to train other networks to imitate the selected nodes of the specific distributed network.

Although the corresponding nodes in a set of homologous networks are homologous in network structure, computer system 1700 may co-train a set of diverse homologous networks by applying the is-equal-to regularization link only on a selected subset of the data and applying an is-not-equal-to knowledge sharing link on a selected subset of the data.

For example, computer system 1700 may co-train one or more robust networks and one or more canary network by not enforcing the is-equal-to knowledge sharing link between a robust node and a canary node when the activation of the robust node for a data item is closer than a specified value to a discontinuity of the activation function in the robust network.

In co-training a set of diverse homologous networks, in some embodiments, computer system 1700 may select a subset of the nodes and/or a subset of the data on which not to enforce the is-equal-to knowledge sharing link. In some embodiments, computer system 1700 may select a subset of the nodes and/or a subset of the data and enforce an is-not-equal-to knowledge-sharing link on the selected nodes and selected data. In some embodiments, computer system 1700 may select a different subset of the data for each selected node.

In some embodiments, computer system 1700 may train a set of homologous networks with is-equal-to and/or is-not-equal-to knowledge sharing links on unlabeled data.

In block 517 of FIG. 5, computer system 1700 may perform analysis of two or more variables. Each variable may be the output value of a node, cell, or unit, or may be the input to an activation function or one of the input values to a node or to a template. The set of two or more variables may be a subset of the variables of a local data space.

In some embodiments, in block 517, computer system 1700 may compute the correlation of all pairs of variables in a specified set of variables. In some embodiments, computer system 1700 may compute the covariance matrix of a set of variables. In some embodiments, the specified set of variables may be the set of values of the incoming connections to an element. In some embodiments, the set of variables may be the union of the sets of values of incoming values for a specified set of elements. In some embodiments, the specified set of elements may be two or more detectors for disjoint sets. In some embodiments, computer system 1700 may compute the correlation or covariance evaluated only over a specified subset of the training data. For example, in some embodiments, computer system 1700 may compute the correlation or covariance only over data that is to be discriminated by a specified element. For example, for a discriminator of two known sets, in some embodiments, computer system 1700 may compute the correlation or covariance only for data in the union of the two known sets. In some embodiments, computer system 1700 may compute the correlation or covariance only over data that is to be classified by a specified unit or subnetwork.

In some embodiments, the set of elements may be two detectors whose outputs are the input to a combining node. In some embodiments, the combining node may be a discriminator. In some embodiments, the computer system 1700 may train the combining node to approximate some logic function of its inputs, such as (A AND B), (A OR B), (A=B), (A≠B), or (A implies B).

In some embodiments, computer system 1700 may multiply the set of variables by a matrix to remove one or more of the pairwise correlations. In some embodiments, computer system 1700 may specify a linear order of the variables and may multiply the variables by a matrix to remove the correlations of the pairs variables that are adjacent in the linear order. For example, in a frequency spectrum, computer system 1700 may multiply the spectrum by a matrix to remove the pairwise correlation of spectral amplitudes at adjacent frequencies.

In some embodiments, computer system 1700 may multiply the set of variables by the inverse of the estimated covariance matrix.

In some embodiments, computer system 1700 may replace the original variables with the set variables obtained by multiplication by a decorrelation matrix or by the estimated inverse covariance matrix. In some embodiments, computer system 1700 may copy the set of nodes that receive the original variables and connect the transformed variables to the new nodes while leaving in place the original nodes with untransformed variables. In some embodiments, computer system 1700 may temporarily create two networks, one without a specified variable transform and the second with the specified transform. In some embodiments, computer system 1700 may compare the performance of the two networks and select the one with better performance. In some embodiments, computer system 1700 may keep both networks as members of an ensemble.

In some embodiments, in block 517, computer system 1700 may perform cluster analysis of a specified set of data using a specified set of variables. In some embodiments, computer system 1700 may perform cluster analysis using a set of variables for which computer system 1700 has detected clustering of the data in a histogram analysis done by computer system 1700 in block 507 of FIG. 5.

In some embodiments, in block 517, computer system 1700 may train a discriminator or a classifier in the data space for which computer system 1700 has detected a non-linear decision boundary between two or more known sets. In some embodiments, computer system 1700 may detect such a non-linear decision boundary by a multi-variable histogram analysis, such as discussed in association with FIG. 15 and block 507 of FIG. 5.

In block 518, in some embodiments, computer system 1700 may determine control parameters for excluding or delegating data from training and/or inference for a selected element. Exclusion and delegation of data are discussed in association with FIG. 11.

In block 519, computer system 1700, may add new nodes and/or new connections to the network, as discussed in association with block 208 of FIG. 2. In some embodiments, computer system 1700 may create new nodes to implement node splitting, in which a node is replaced by a set of two or more nodes.

In block 519, in some embodiments, computer system 1700 may make one or more copies of an element and then train the copies to be different from the original element and from in each other. In some embodiments, computer system 1700 may train each copy on a different set of data or may train each copy with data weighting with different weights. In some embodiments, computer system 1700 may implement the distribution of data with a data switch. In some embodiments, computer system 1700 may implement different data weights by a numerical multiplier in the learned parameter update. In some embodiments, computer system 1700 may implement data selection and weighting by specifying data dependent probabilities in a probabilistic data switch. Data weighting is described in U.S. Pat. No. 11,010,671, titled “Iterative training of a nodal network with data influence weights,” which is incorporated herein by reference in its entirety.

In some embodiments, computer system 1700 may split a node in order to create a node to receive data delegation as described in association with FIG. 11.

In block 520, in some embodiments, computer system 1700 may use randomized training and diagnosis. In some embodiments, computer system 1700 may use randomized training to make the system more robust against both external noise, such as noise in the input data, and internal noise, such as noise and/or errors made by individual elements in the network. In some embodiments, computer system 1700 may use randomized training to support randomized activation (418 of FIG. 4) to improve sensibility. In some embodiments, computer system 1700 may use randomized training and randomized activation to improve classification performance, for example, by training and using a virtual randomized ensemble. In some embodiments, in block 520, computer system 1700 may use one or more types of randomizations and or noise to better understand the interdependencies of elements in the network and to diagnose possible vulnerabilities.

In some embodiments, in block 520, computer system 1700 may use one or more of six types of randomization or noise: (1) additive noise to the output of one or more elements and/or other variables, (2) simulated errors in one or more elements, (3) probabilistic switching of the destination of a data switch, (4) probabilistic switching of the interval of a partitioned activation function, (5) randomized dropout, and/or (6) simulated adversarial attacks on the network input and/or on one or more local data spaces. In some embodiments, computer system 1700 may use higher degrees of randomization and/or noise during training than in inference during deployment.

In block 520, for noise type (1) above, in some embodiments, computer system 1700 may apply a technique herein called “additive noisy activation” to one or more variables during the computation of the activation of a hybrid network when presented with a specified input data item to the network global input space or to any selected local data space. In some embodiments, computer system 1700 may apply noisy activation to the output value of one or more nodes, units, or cells. The underlying variable to which noise is being added is called the “underlying activation variable.” The random variable specifying the amount to add to a specified underlying activation variable during a specific activation computation is called the “additive random noise variable.”

In some embodiments, computer system 1700 may use noisy activation during training, in a diagnostic procedure, and/or during inference for classification. Computer system 1700 may use noisy additive activation during initial training (dotted block 501 of FIG. 5) and/or during main training (dotted block 502 of FIG. 5). When a data item d is received for training or for classification, computer system 1700 determines the value of each additive random noise variable as a new random sample.

The probability distribution for an additive random noise variable for a specified noisy activation variable may be any type of probability distribution. For example, it may be a Gaussian distribution, a trimmed Gaussian distribution, or a uniform distribution.

The type of probability distribution may be specified, for example, by the system design, by the HNLMS, or may be selected by computer system 1700 through empirical testing of two or more specified choices for the distribution. In some embodiments, computer system 1700 may use a different type of probability distribution for different noisy activation variables.

Without loss of generality, the mean of an additive random noise variable may be set to zero, since any non-zero mean is merely equivalent to a change in the underlying activation variable.

For each additive random noise variable, computer system 1700 may specify one or more variables or hyperparameters to control the degree of spread of the population of random samples. For example, for a Gaussian distribution, computer system 1700 may specify the standard deviation. For a uniform distribution, computer system 1700 may specify the length of the interval, centered around zero. For a trimmed Gaussian distribution, computer system 1700 may specify the standard deviation and the number of standard deviations at which to trim.

In some embodiments, computer system 1700 may empirically estimate the value of one or more spread parameters for one or more additive random noise variables by empirical training, as discussed in association with block 521 of FIG. 5.

In some embodiments, for error simulation type (2), for an element associated with one or more known sets computer system 1700 may simulate an error on a data item in a known set by randomly selecting a substitute activation value in an interval not associated with the known set. For a data item that is not in an interval associated with a named set, computer system 1700 may randomly select a substitute activation value in an interval that is associated with a known set that is distinct from the named set.

In some embodiments, for randomization type (3), activation interval switching, or type (4), data switch destination switching, compute system 1700 may generate a discrete valued random variable to select the activation interval or the destination of the data switch. The probability distribution for the discrete valued random variable may be specified by parameters or hyperparameters that are specified, for example, by the HNLMS or that computer system 1700 may determine by empirical training (521 of FIG. 5).

In some embodiments, for randomization type (5), dropout, computer system 1700 may determine whether to do the dropout of a selected element for a specific data item at random with a probability specified by a hyperparameter. In some embodiments, the activation value to use in the case of dropout may be specified as zero or may be specified by a hyperparameter. In some embodiments, an element may have an element-specific substitute activation value in the case of dropout.

In some embodiments, for randomization type (6), computer system 1700 may randomly select whether to use a simulated adversarial attack on a specified element for a specified data item with a probability specified by a hyperparameter. In some embodiments, the system design and/or the HNLMS, for example, may specify a plurality of methods of adversarial attack. In such embodiments, computer system 1700 may randomly select which method of adversarial attack to use for a specific element for a specific data item.

In some embodiments, in block 520, computer system 1700 may use randomization and noise to understand and diagnose the interactions among elements in the network. For example, computer system 1700 may add noise and/or change the output of a first designated element to discover and/or evaluate the effect of those changes in the output of the first designated element on a second designated element. In some embodiments, the first designated element does not need to be directly connected to the second designated element. The second designated element may be any element in the network, directly or indirectly affected by the change in the output of the first designated element.

In some embodiments, in block 520, computer system 1700 may determine the amplitude of an additive noise, the probability of one or more of the other changes, and/or the strength of a simulated adversarial attack based on values of a set of hyperparameters. In some embodiments, computer system 1700 may use a separate randomization hyperparameter for each noise or randomization type for each element in the network.

In some embodiments, in block 520, computer system 1700 may use a greater degree of noise and randomization during training than during inference during deployment. In some embodiments, in block 520, computer system 1700 may estimate the best values for the randomization hyperparameters during training by using empirical training of the randomization hyperparameters, as discussed in association with block 521 of FIG. 5.

In some embodiments, as a diagnostic procedure, computer system 1700 may select to study the effects of the randomization and noise of other variables on a specified set of significant elements or variables. For example, in some embodiments, computer system 1700 may select to study the effects of randomization of inner variables on the output nodes of the network. In some embodiments, computer system 1700 may select to study the effects of randomization of other variables on the output values of one or more units. In some embodiments, computer system 1700 may select to study the effect of randomization of other variables on the values of one or more variables in one or more local data spaces.

In some embodiments, in studying the effects on the specified set of significant variables, computer system 1700 may compute the effect of multiple randomizations, randomly varying the value of each of the randomization hyperparameters over a specified range of values. In some embodiments, computer system 1700 may measure the effect of noisy activation or every ordered pair comprising a noisy variable and an influenced variable.

For efficiency, in some embodiments, rather than analyzing every ordered pair of selected significant variables and noisy variables, computer system 1700 may first select a significant variable on which to measure influence and then a set of noisy activation variables that is specific to that affected significant variable, as described below. In some embodiments, computer system 1700 may reverse the order, first selecting a noisy variable and then a set of significant variables affected by the selected noisy variable, as described in a later paragraph.

In some embodiments, as a diagnostic procedure, computer system 1700 may select one of a set of significant variables on which to measure the influence of noisy activation. In some embodiments, computer system 1700 may choose each significant variable in turn. Computer system 1700 may then compute multiple randomizations and compute a regression correlation of the change in the chosen significant variable with respect to the degree of change in one or more of the variables changed in the randomization. In some embodiments, computer system 1700 may use a greater degree of randomization and noise in the diagnostic procedure than in the training.

In some embodiments, for a specified significant variable, computer system 1700 may select one or more noisy variables for which the effect of the randomization of the noisy variables on the specified significant variable is greater than a specified criterion. In some embodiments, computer system 1700 may use a specified criterion that preferentially selects noisy variables that are less directly connected to the significant variable than noisy variables that are more directly connected to the significant variable. In some embodiments, computer system 1700 may make additional changes to further increase the sensibility and robustness of one or more of the selected noisy variables.

In some embodiments, in diagnosing an error or close call of one of the significant variables, computer system 1700 may check the associated noisy variables to determine whether an error or perturbation in one of the associated noisy variables may have caused or significantly contributed to the error or close call of the significant variable. If so, computer system 1700 may take corrective action to improve the accuracy and/or the robustness of the noisy variable.

In some embodiments, computer system 1700 may select one of more candidate noisy variables and compute the effect of randomization and noise in the noisy variable on other variables in the network. In some embodiments, computer system 1700 may select a set of one or more other variables that are significantly affected by the selected candidate noisy variable based on a specified criterion. In some embodiments, computer system 1700 may add the selected candidate noisy variable and the selected significantly affected variable to the set of associated pairs of significant variables and noisy variables.

In some embodiments, computer system 1700 may use the relationship of a noisy variable and one or more of the associated significant variables to aid in the interpretation of the noisy variable. In some embodiments, computer system 1700 may use the relationship of a significant variable and one or more noisy variables to aid the interpretation of the significant variable.

For example, computer system 1700 may determine whether the set of data items with activation values in a specified interval of the activation in one member of a pair of variables approximates to specified degree a defined equality or inequality relationship with the set of data items with activation values for a specified interval in the other member of the pair. If so, in some embodiments, computer system 1700 may create a knowledge sharing link in one or both directions between the specified activation intervals.

In some embodiments, if an interval in a significant variable or a noisy variable is associated with a known or named set, computer system 1700 may check to determine whether the known or named set may be associated with a paired influence or significant variable.

In some embodiments, computer system 1700 may use the pairing of significant variables and noisy variables to diagnose the causes and potential cures to an error or close call on an individual data item. For example, computer system 1700 may attempt to determine the changes that computer system 1700 might be able to make in the network design and/or in the learned parameters of one or more of the noisy variables in order to correct the error or close call of a significant variable on the individual data item. In some embodiments, computer system 1700 may generate simulated adversarial attacks and/or random perturbations in the network input space and/or in a local data space to create one or more examples of errors or close calls by a significant variable.

In block 521, in some embodiments, computer system 1700 may empirically estimate the best value for one or more hyperparameters. In some embodiments, computer system 1700 may empirically estimate the value of one or more learned parameters. In some embodiments, computer system 1700 may use empirical estimation of a learned parameter as an alternative to training by gradient descent and/or as an alternative to training by back propagation of data. In some embodiments, computer system 1700 may alternate empirical estimation of a learned parameter with one or more other methods of training the learned parameter. In some embodiments, computer system 1700 may alternate between training a learned parameter by empirical estimation and/or by another training methods and further alternating with the parameter being a hyperparameter controlled by, for example, the HNLMS. In some embodiments, computer system 1700 may empirically estimate the performance of a hyperparameter as information supplied to the HNLMS for controlling the hyperparameter.

As mentioned in the discussion of block 520 of FIG. 5, computer system 1700 may empirically estimate the value of one or more spread parameters for one or more additive random noise variables. Another example of parameters that computer system 1700 may empirically estimate are the end points of an acceptance or rejection interval in a detector or discriminator node or unit. As another example, computer system 1700 may empirically estimate the background score for any detector or discriminator variable. More generally, computer system 1700 may empirically estimate the value for any constant value interval of a variable. Furthermore, computer system 1700 may empirically estimate the maximum and minimum value for any specified relatively flat interval. As another example, in some embodiments, computer system 1700 may empirically estimate the norm or other limit to the acceptance region of a template model. In some embodiments, computer system 1700 may empirically estimate the norm for data exclusion for a detector or discriminator element. In some embodiments, computer system 1700 may estimate one or more norms for data exclusion for a robust template model.

In some embodiments, computer system 1700 may simultaneously empirically estimate multiple parameters. For example, in some embodiments, computer system 1700 may empirically estimate the spread parameters for one or more or all spread parameters for additive random noise variables. In some embodiments, computer system 1700 may empirically estimate one or more or all the parameters associated with one or more of the constant or relatively flat intervals.

In some embodiments, computer system 1700 may empirically estimate one or more parameters that characterize the position and orientation of a decision boundary.

In some embodiments, computer system 1700 may simultaneously evaluate a plurality of quantifiable objectives or a specified combination of multiple quantifiable objectives.

Without limitation, illustrative examples of quantifiable objectives that computer system 1700 may use in empirical learning for a classification task include: (1) classification performance, (2) sensibility, and (3) holistic interpretability.

Without limitation, illustrative examples of quantifiable objectives that computer system 1700 may use in empirical learning of a generative task include: (1) recall in generating examples of a named set, (2) precision in generating examples of a named set, (3) for either a cooperative or adversarial generator, performance against one or more previously trained real vs synthetic discriminators, (4) performance on new data of a classifier trained with supplementary data produced by a generator, (5) sensibility of a classifier trained with supplementary data produced by a generator.

In some embodiments, computer system 1700 may compute a function of two or more quantifiable objectives as a new quantifiable objective. For example, computer system 1700 may compute a weighted average of classification performance, sensibility, and holistic interpretability that represents a trade-off among the objectives.

In some embodiments, computer system 1700 may evaluate classification performance by running multiple trials with noisy activation and/or random noise added to the input variables.

In some embodiments, computer system 1700 may evaluate sensibility by running multiple trials using simulated adversarial attacks and/or with noisy activation.

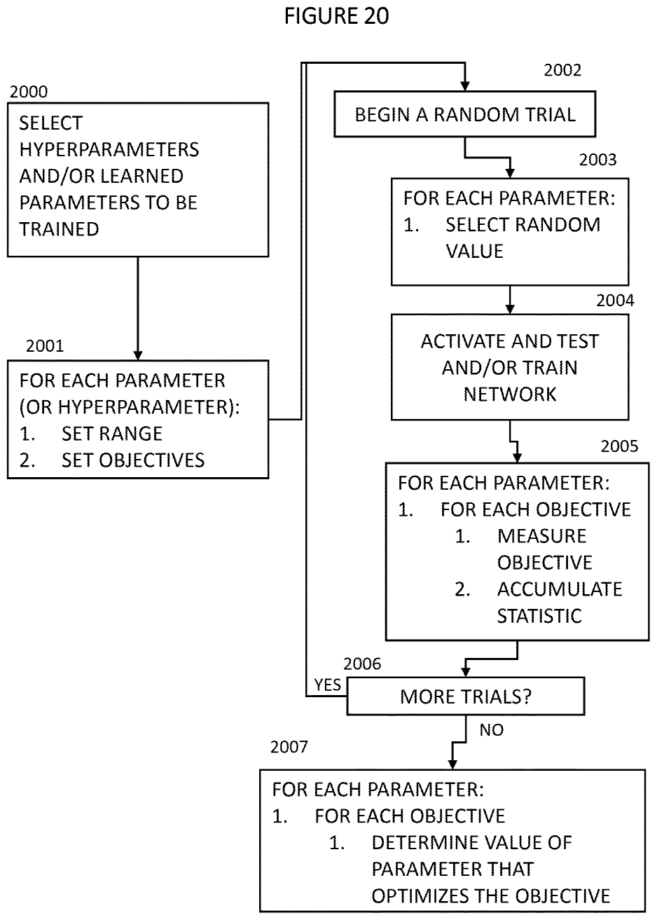

In an illustrative embodiment, computer system 1700 may simultaneously empirically optimize multiple parameters and/or hyperparameters, as discussed in association with FIG. 20.

In some embodiments, during training or during continual learning after deployment, computer system 1700 may repeat the empirical optimization of one or more parameters based on a criterion controlling the frequency of repetitions. In some embodiments, computer system 1700 may repeat the empirical estimation more frequently based on observations of the operation of the system. For example, computer system 1700 may repeat empirical estimation if measures of one or more quantifiable objectives degrade over the course of continued use or training. In some embodiments, computer system 1700 may repeat empirical estimation if continued training on new data examples has changed the values of learned parameters by more than a specified criterion.

In block 522, in some embodiments, computer system 1700 may replace a selected node with a set of three or more nodes. More specifically, computer system 1700 may replace a node with a unit or a set of nodes comprising (1) a first new node created from the selected node and copies of the connections into the selected node that have positive weights, (2) a second new node created from the selected node and copies of the connections into the selected node that have negative weights, and (3) a third new node with connections from the first and second new nodes and copies of the outgoing connections of the selected node. In some embodiments, computer system 1700 may copy connections into the selected node with weights with magnitudes less than a specified value to both the first and second new nodes.

In some embodiments, computer system 1700 may create more new nodes and divide the incoming connections into more sets.

In some embodiments, computer system 1700 may interpret each of the source nodes sending a connection into the selected mode as a detector for data items that produce higher activation values. Thus, computer system 1700 may interpret an incoming connection with a positive weight as evidence for a set of data items in which the source node of the connection has a high activation value. In some embodiments, computer system 1700 may interpret a node with a mixture of negative weights and positive weights as discriminating between the set of data items detected by a consensus of the source nodes with positive weights from the set of data detected by a consensus of the source nodes with negative weights.

In continued training in which the signs of the incoming connections do not change very much, computer system 1700 training back propagation from the selected node will tend to make the source nodes learn toward better matching this interpretation.

In some embodiments, computer system 1700 may create a new unit comprising the new nodes. Each of a pair of the new nodes may have a subset of the incoming connections of the original node and an outgoing connection to a third node. In some embodiments, computer system 1700, may select only connections with weights greater than a specified threshold T1 for the first node in a pair. Computer system 1700 may select only connections with weights less than a threshold T2 as incoming connections to the second node in the pair. In some embodiments, T1≤0≤T2. In some embodiments, computer system 1700 may reverse the signs of weights on all incoming connections to the second node in the pair. In those embodiments, for the second node in the pair, computer system 1700 may replace the activation function the original node with an activation function equal to a constant minus the original activation function. In some embodiments, computer system 1700 may restrict the magnitudes of T1 and T2 to be less than a specified amount. In such embodiments, most of the incoming weights to each of the pair of new nodes will be positive. In some embodiments T1=T2=0.

In some embodiments, computer system 1700 may interpret each of the nodes in the new pair as a detector with higher values of the activation function representing detection.

The third new node may have an activation function that represents some form of difference, such as

ƒ(x,y)=x−y or ƒ(x,y)=(exp(x)−exp(y))/(exp(x)+exp(y)).

In some embodiments, computer system 1700 may associate the third node as a discriminator between two sets, which the discriminator models as disjoint.

In some embodiments, in continued training, computer system 1700 may add or remove an incoming connection if the updated weight of the connection crosses one of the thresholds T1 or T2.

In some embodiments, for two known sets A and B, computer system 1700 may associate one of the pair of new nodes with the set of data in A and not in B and associate the other node in the pair of new nodes with the set of data in B and not in A. In some embodiments, computer system 1700 may train an additional node associated with intersection of A and B and/or train an additional node associated with the set of data not in A and not in B.

If the original node was associated as a detector of a known set, in some embodiments, computer system 1700 may tentatively associate the first node in the pair as a detector of the known set and the second node of the pair as a detector of a subset of the complement of the known set.

If the original node is a discriminator of two known sets, in some embodiments, computer system 1700 may associate each of the nodes in the pair of nodes as a detector of one of the known sets. In this association, each detector has incoming connections with mostly positive weights.

In some embodiments, computer system 1700 may train the nodes with weight decay. That is, at each weight update, computer system 1700 may multiply the revised weight by a specified constant r<1. The process of weight decay is well known to those skilled in the art of training neural networks. In some embodiments, computer system 1700 may prune a connection if the magnitude of the weight is less than a specified magnitude and has been so for a specified number of iterative updates.

In some embodiments, computer system 1700 may replace one or more of the new detector nodes with a template model.

In block 523, in some embodiments, computer system 1700 may select a set of two or more decision elements. In some embodiments, for each selected decision element, computer system 1700 may create a new decision element initialized to duplicate the selected decision element. In some embodiments, computer system 1700 may connect each duplicate element with connections duplicating the incoming connections of the selected decision elements and initialize the connection weights to be the same.

In some embodiments, computer system 1700 may then form a decision element group comprising the duplicates of the selected decision elements. In some embodiments, computer system 1700 may add one or more decision elements representing the set intersection of target sets and complements of target set of the original selected decision elements. In some embodiments, computer system 1700 may then form a softmax relationship on the expanded set of duplicate detectors. Computer system 1700 may then train the system, associating the expanded set of duplicate detectors with disjoint sets.

In some embodiments, computer system 1700 may replace one or more of the disjoint set detectors with a template model and continue training with the softmax relationship.

In block 524, in some embodiments, computer system 1700 may use constrained optimization to train the weights of a linear threshold function, as discussed in association with FIG. 6. Having trained the weights of the linear threshold function, computer system 1700 may then back propagate to the nodes connected into the node of the linear threshold using back propagation of derivatives, back propagation of labeled data examples, or both or neither. With incremental growth (103 of FIG. 1 and 504 of FIG. 5), in some embodiments, computer system 1700 may build and train an entire network without using any back propagation.

FIG. 6 is a flow chart of an illustrative embodiment of constrained optimization in training.

In block 601, computer system 1700 obtains or selects a network.

In block 602, in some embodiments, computer system 1700 may convert activations and/or make other modifications to the selected network, such as discussed in association with FIG. 2.

In block 603, in some embodiments, computer system 1700 selects a discrimination task. For example, computer system 1700 may select an element comprising a standard discriminator activation function. In some embodiments, computer system 1700 may select the target set of a detector element or a known set and specify the discrimination task as discriminating between the selected set and its complement. In some embodiments, computer system 1700 may select the task of discriminating two known sets.

In block 604, in some embodiments, computer system 1700 may select a set of data items with target values for the task selected in block 603. For example, in some embodiments, computer system 1700 may select only data items for which the selected node makes an implicit error. In some embodiments, computer system 1700 may select data items on which the selected node has a close call. In some embodiments, computer system 1700 may avoid selecting a data item that is beyond a specified exclusion limit. In some embodiments, computer system 1700 may avoid selecting a data item that has been delegated from the selected node. In some embodiments, computer system 1700 may avoid selecting a data item that is classified correctly by the network despite being an error for the selected node.

In block 605, in some embodiments, computer system 1700 may determine whether the implicit targets for the node are linearly separable by finding weights that minimize T2-T1, subject to the constraints that the input to the activation function is less than or equal to T2 for any data item with the lower value target and the input to the activation function is greater than or equal to T1 for any data item with the higher value target. For example, if the input to the activation function is a weighted affine sum of the values from the incoming connections to the node, computer system 1700 may find the optimum weights by linear programming. In some embodiments, computer system 1700 may select a non-linear objective function to optimize in block 605. In such a case, computer system 1700 may find the weights by non-linear programming with linear constraints. Linear and non-linear programming subject to linear constraints are well known to those skilled in the art of mathematical programming.

In some embodiments, computer system 1700 may use incremental growth (103 of FIG. 1 and 504 of FIG. 5) to build a hybrid network without any back propagation, neither back propagation of derivatives (612 of FIG. 6) nor back propagation of data examples (613 of FIG. 6 and 510 of FIG. 5). For example, in some embodiments, computer system 1700 may repeatedly drop targets (607 of FIG. 6).

In some embodiments, in block 605, computer system 1700 may create a new element, with an activation function such as a linear threshold function or other monotonic function with the weights and discrimination threshold computed in block 605.

In block 606, computer system 1700 checks whether the minimum for T2−T1 is less than or equal to 0. If so, the selected data items are linearly separable. In this case, computer system 1700 proceeds to block 609. Otherwise, computer system 1700 proceeds to block 607.

In block 607, in some embodiments, computer system 1700 may determine whether to drop some of the selected targets and, if so, which ones. In some embodiments, computer system 1700 may choose to proceed without dropping any of the selected targets.

In some embodiments, the decision of whether to drop selected data items for a node may involve a cost/performance trade-off. In some embodiments, computer system 1700 may make the decision based on fixed criteria specified by the system design. In some embodiments, the HNLMS may do a cost/performance analysis for the specific situation of the selected node or unit. In some embodiments, computer system 1700 and the HNLMS, for example, may test the cost performance trade-off, preferably on data that has been set aside from the training data.

In block 608, computer system 1700 decides whether to repeat the constrained optimization after dropping some of the target data items. If so, computer system 1700 returns to block 605. Otherwise, computer system 1700 proceeds to block 609. In some embodiments, computer system 1700 may repeatedly drop target data items until there is a reduction in the number of errors. Unless there are two identical data items in which one is an error and one is not, as long as there are remaining errors, computer system 1700 can eventually reduce the number of errors because a set of two non-identical data items is always linearly separable.

In block 609, in some embodiments, computer system 1700 may check the performance of the selected unit on data items that were not selected in block 604, if any. Since the weights of incoming connections may have changed, the performance of the selected element on these non-selected data items may have changed.

In block 610, in some embodiments, computer system 1700 may determine whether to select additional data items for the element selected or created in block 603.

In some embodiments, the decision of whether to select additional data items for a node may involve a cost/performance trade-off. In some embodiments, computer system 1700 may make the decision based on fixed criteria specified by the system design. In some embodiments, the HNLMS may do a cost/performance analysis for the specified situation of the selected node or unit. In some embodiments, for example, computer system 1700 and the HNLMS may test the cost performance trade-off, preferably on data that has been set aside from the training data.

In block 611, computer system 1700 selects whether to back propagate data examples, derivatives, or both or neither. If computer system 1700 decides to back propagate data examples, it proceeds to block 613. If computer system 1700 decides to back propagate derivatives, it proceeds to block 611. If compute system 1700 decides to back propagate both, it may proceed in parallel to both block 612 and block 613. If computer system 1700 decides to propagate neither, computer system 1700 proceeds directly to block 614. Computer system 1700 may choose to back propagate neither, for example, if computer system 1700 determines to make and freeze a copy of the subnetwork of the new linear threshold function. If, other than linear threshold functions, every discriminator trained on the task selected in block 603 is eventually dropped from the network having been replaced by one of more linear threshold functions with frozen subnetworks, as suggested in block 510 of FIG. 5, the final trained network will have no paths by which to back propagated derivatives for the selected discrimination task to the input variables, which prevents an adversary from using back propagation of a gradient to compute an adversarial attack. In some embodiments, computer system 1700 may use this strategy for multiple discrimination tasks without limit.

In block 613, in some embodiments, computer system 1700 may back propagate data examples. In some embodiments, computer system 1700 may back propagate only errors and close calls. In some embodiments, computer system 1700 may use a criterion for a data item being a close call for the purpose of back propagation that accepts more data items as close calls than the criterion for being a selected data item in block 604.

In block 612, in some embodiments, computer system 1700 may back propagate derivatives using a substitute derivative function such as illustrated in FIG. 3C.

In block 614, in some embodiments, computer system 1700 may determine whether to select additional discrimination tasks based on a specified stopping criterion.

FIG. 7 is a flow chart of an illustrative embodiment of an aspect of hidden state space modeling in an aspect of the invention. Note that the meaning of the word “hidden” in the phrase “hidden state space model” is very different from the phrases “hidden layer” or “hidden node” in discussions of a layered neural network. In discussions of a layered neural network, all the layers except the output layer and their nodes may be referred to as “hidden.” The input values are also not considered to be “hidden.” However, the values of the state variables in a hidden state space model are hidden more deeply. In a hidden state space model, the activations of all the nodes are considered observable values. In some embodiments, some of the values stored in cells may also be considered as observables values. However, in a hidden state space model in a hybrid network, the state variables are not considered to be observable values, although estimates of their values may be stored in cells.

In some embodiments, computer system 1700 may model the hidden state variables as unobserved random variables. In some embodiments, computer system 1700 may model the observable variables as random variables whose values are conditional on the unobserved hidden state variables. From the values of the observed variables, computer system 1700 may be able to make estimates of hidden variables by applying Bayes' rule.

In block 701, in some embodiments, computer system 1700 may specify a space of cells comprising hidden state variables. For example, for an image, in some embodiments, computer system 1700 may formulate a two-dimensional rectangular grid of cells. A hidden state variable may then represent an interpretation of a local region in the image. Alternately, in some embodiments, computer system 1700 may formulate a two-dimensional hexagonal tiling or other tiling of the plane. In some embodiments, the hidden state space may represent a conditional random field.

For data represented as a sequence, in some embodiments, computer system 1700 may formulate a one-dimensional sequence of cells. A hidden state space variable may then represent the state of a time-varying process at a specified time. In some embodiments, the hidden state space may represent a hidden Markov process.

In some embodiments, computer system 1700 may specify an adjacency graph, that is, a graph in which each cell is connected to its neighboring cells, such as the four neighbors (or eight neighbors if corner neighbors are counted) in a rectangular grid or the six neighbors in a hexagonal grid. In a sequence of cells, computer system 1700 may connect each cell with the preceding cell and the following cell in the sequence of cells.

In some embodiments, computer system 1700 may represent the relationship of adjoining parts in a mereology as an adjacency graph. In some embodiments, computer system 1700 may determine the mapping from elements in a mereology to cells in a hybrid network specifically for each input data item by a process of alignment (FIG. 12).

In block 702, in some embodiments, computer system 1700 may specify one or more hidden state variables. In some embodiments, a hidden state variable may be a variable with values selected from a finite set. In some embodiments, a hidden state variable may be a continuous-valued variable.

In some embodiments, computer system 1700 may represent a hidden state by an n-tuple of variables.

In block 703, in some embodiments, computer system 1700 may obtain a model of the relationship between the hidden state variables and the observable variables. In some embodiments, the relationship may represent an arbitrary numerical relationship. In some embodiments, the model may represent the conditional probability of the observed variables in and around the grid point for a hidden state cell, conditioned on the value of the hidden state variables. In some embodiments, the model may represent relationships of state variables in adjacent cells in an adjacency graph. For example, the graph may be the adjacency graph of the parts in a mereology model of a hypothesized object being detected.

In block 704, in some embodiments, computer system 1700 may obtain a model of co-occurrence of specified state pairs in adjacent cells. For example, computer system 1700 may represent the probability of a specific hidden state variable as a probability conditioned on the value of the hidden state variable in an adjacent position in the adjacency graph.

In some embodiments, computer system 1700 may train an abstract model of the degree of association of state values in cells that are in adjacent positions in the adjacency graph with learned parameters that are not necessarily trained to model conditional probabilities. In some embodiments, computer system 1700 may train a directional learned parameter between the state values in an ordered pair of adjacent cells. In some embodiments, computer system 1700 may train a degree of association parameter in each direction. In some embodiments, computer system 1700 may train a non-directional degree of association between the learned parameters for an unordered pair of adjacent cells.

In block 705, in some embodiments, computer system 1700 may select one or more paths in the state space for evaluation. For example, in a layer in a convolutional neural network, computer system 1700 may select a path of cells corresponding to a path of grid points in an image. In a model of a sequence, computer system 1700 may select a forward sequence or a backward sequence. More generally, in some embodiments, computer system 1700 may choose an arbitrary path through an adjacency graph.

In block 706, in some embodiments, computer system 1700 may compute the probability of a state given the observed context. In some embodiments, computer system 1700 may update learned parameters of an abstract model of the degree of association of ordered or unordered pairs of state values of cells that are adjacent in an adjacency graph.

In block 707, in some embodiments, computer system 1700 may update the model for observed variables given the estimated distribution of hidden state space variables.

In block 708, in some embodiments, computer system 1700 may update the model for the conditional probability model for state values in adjacent cells or for an abstract model of the directional or non-directional association of state values in adjacent cells.

In block 709, in some embodiments, computer system 1700 determines whether to select a new path through the graph, based on specified criteria. If so, computer system 1700 returns to block 705. Otherwise, computer system 1700 proceeds to block 710.

In block 710, in some embodiments, computer system 1700 determines, based on a specified criterion, whether to train a different model for the observed variables and of association of state values in adjacent cells. If so, computer system 1700 returns to block 703. Otherwise, computer system 1700 proceeds to block 711.

In block 711, in some embodiments, computer system 1700 may determine whether to perform an analysis of a different state space formulation. If so, computer system 1700 returns to block 701. Otherwise, computer system 1700 is done with the process illustrated in FIG. 7.

FIG. 8 is a flow chart of an illustrative embodiment of the operation of sensible classification with a trained hybrid network and rapid matching. The illustrative embodiment comprises defenses against potential disturbances in the data. The illustrative embodiment also comprises methods to reduce the amount of computation required for a classification. The illustrative embodiment also provides for continual training while using rapid matching and continual training during inference in an aspect of the invention.

In block 801, computer system 1700 obtains a trained system.

In block 802, computer system 1700 receives a data item to be classified.

In block 803, in some embodiments, computer system 1700 may implement an active defense against perturbed data using sensibility data switching, as discussed in association with block 416. In an active defense, the network comprises one or more data switches by which computer system 1700 selects among a plurality of activation functions or among a plurality of nodes such that the selected activation for the data item received in block 802 is in a relatively flat region and is not near the boundary of the region.

In block 804, in some embodiments, computer system 1700 may perform a fast preliminary classification. In some embodiments, computer system 1700 may compute a preliminary classification using a lower resolution image or other simplified representation of the data item received for classification. In some embodiments, computer system 1700 may use simpler models in place of the full hybrid network or in place of some of the units.

In some embodiments, computer system 1700 may perform a table lookup of a precomputed classification for a low-bit representation of the input to a unit.

In some embodiments, computer system 1700 may perform bottom-up component detection. In some embodiments, computer system 1700 may perform the bottom-up component detection using a simplified network. In bottom-up component detection, computer system 1700 may first perform classification and detection of smaller units, such as smaller objects or parts of an object in an image or short sound segments in speech or other audio. In bottom-up component detection, computer system 1700 may then classify a selected subset of larger units depending on the identities of the best scoring smaller units.

In some embodiments, computer system 1700 may do hypothesis pruning of some larger units based on their scores relative to the best scoring units at a stage in the bottom-up component detection.

In some embodiments, computer system 1700 may create a short list of the best scoring alternative classification for one or more units or for the full classification network. In some embodiments, computer system 1700 may then skip some computations for hypotheses that are not on the computed short list. In some embodiments, computer system 1700 may substitute a specified back-off score for a hypothesis that is not on a short list.

In some embodiments, computer system 1700 may coordinate bottom-up component detection with alignment with an adjacency graph, as described in association with block 805.

In block 805, in some embodiments, computer system 1700 may do a fast classification based on an alignment with an adjacency graph. Training based on alignment of adjacency graphs is discussed in association with FIG. 12.

As an example of alignment as a preliminary to classification by the full hybrid network, computer system 1700 may detect some of the parts in the periphery of an object. Computer system 1700 may then align the detected parts and other elements in the periphery with a mereology of the object. Computer system 1700 may then align and classify parts in the interior of the mereology. In some embodiments, computer system 1700 may coordinate this alignment based fast classification with bottom-up component detection, as discussed in association with block 804.

In block 806, computer system 1700 may do other sequential processing in the cells. For example, computer system 1700 may compute a hidden state space model, as discussed in association with FIG. 7. As another example, computer system 1700 may trace out line segments, curves, and/or contours by sequentially connecting a chain of pairwise associations or similarities of adjacent elements. Computer system 1700 may use this sequential processing for tasks such as: (1) determining if two local regions are connected, (2) finding the contour around an object, (3) finding the boundary separating two regions, or (4) solving a maze.

In block 807, in some embodiments, computer system 1700 may perform checks on the preliminary results.

In some embodiments, computer system 1700 may verify the classification results against results obtained by other means. For example, computer system 1700 may compare the results from the current preliminary match against the results obtained from other preliminary matches.

In some embodiments, in an image recognition task, if the current preliminary match uses a low-resolution representation of an image, computer system 1700 may compare the results of the current preliminary match with the results of classification using a higher resolution image. In some embodiments, computer system 1700 may accelerate the classification of the higher resolution image by pruning the computation based on the preliminary match results.

In some embodiments, computer system 1700 may verify the preliminary results against a higher resolution image at critical points in the mereologies of the short list of best candidate classifications of the preliminary match. For example, computer system 1700 may verify the classification of parts along the periphery of the aligned mereology.

In some embodiments, computer system 1700 may compute a back propagation from the output activation of each candidate classification on the short list of the preliminary match. In some embodiments, computer system 1700 may compute this back propagation using a network other than the network used in the preliminary match and/or may compute the back propagation from a higher resolution image. In some embodiments, computer system 1700 may then check each node in the network to see if the node has made an error relative to an implicit local target, such as described in association with block 508 of FIG. 5. In some embodiments, computer system 1700 may augment the short list of answers from the preliminary match by adding candidate answers obtained by changing the activations of selected nodes that have activations close to a threshold that would change an error or close call on an implicit local target.

In some embodiments, computer system 1700 may verify the results of the preliminary match against the results obtained from classification using a different source of knowledge or a different source of input data. For example, in classification of speech or other audio, computer system 1700 may verify the preliminary results against classification using different signal processing of the audio signal. As another example, in speech recognition or hand writing recognition, computer system 1700 may compare the results obtained from recognizing phonemes or letters with the results obtained using a word sequence language model.

In some embodiments, computer system 1700 may verify the results of the preliminary match by using a parametric generator. In some embodiments, computer system 1700 may adjust the parameters of the parametric generator to fit the observed input data subject to constraints of the parameters of the generator being consistent with one of the choices on the short list of candidate answers from the preliminary match. In some embodiments, computer system 1700 may select the answer for which the output of the parametric generator best matches the input data to the classifier. In some embodiments, computer system 1700 may compare the output of the parametric generator to the input in order to prune the short list of candidate answers or to add to the short list.

In some embodiments, computer system 1700 may add additional answers to the short list from prior experience of errors among confusable output categories. For example, the HNLMS may maintain a confusion matrix of errors made by previous version of the network being developed or by other systems trained for the same classification task.

In some embodiments, computer system 1700 may use abductive reasoning to evaluate each candidate answer on the short list. For example, in some embodiments, computer system 1700 may apply abductive reasoning to explain potential causes for a candidate answer to have a poor score. As a specific example, if a candidate word in a speech recognition task matches well except for one phoneme based on formant tracking, computer system 1700 may check the hypothesis that the identification of the formants in the formant tracking may be errorful because two formants that are close in frequency may form a single peak in the frequency spectrum.

In block 808, in some embodiments, computer system 1700 may determine whether to do additional preliminary classification. If not, computer system 1700 proceeds to block 809. If so, computer system 1700 returns to block 803 to do an additional preliminary classification. In some embodiments, computer system 1700 may do a more complex classification based on a previous preliminary classification. In some embodiments, computer system 1700 may do a new preliminary classification designed to be different and diverse from previous preliminary classifications.

In block 809, in some embodiments, computer system 1700 may conduct tests to detect whether the data item received in block 802 has been disturbed by an adversarial attack or other disturbance that might change the classification. In some embodiments, computer system 1700 may check the network to verify that the nodes and activation functions satisfy the rules for elementary, first-level sensibility as discussed in association with FIG. 2. In some embodiments, to detect a potential adversarial attack or other disturbance, computer system 1700 may use a diverse set of canary networks, as discussed in association with block 415 of FIG. 4.

In block 810, in some embodiments, computer system 1700 may acquire additional data. In some embodiments, the additional data may comprise additional training data. In some embodiments, the additional data may comprise data obtained during operation of the current classifier system or from other deployed classifier systems. In some embodiments, the data may be generated or synthesized data. In some embodiments, computer system 1700 may generate extra data in regions selected by computer system 1700 by analyzing the results of the preliminary classifications.

In block 811, in some embodiments, computer system 1700 may apply the techniques of continual learning and growth such as those discussed in association with FIG. 1.

In some embodiments, computer system 1700 may make additions and modifications to the network that are customized for the data item received in block 802.

In block 814, in some embodiments, computer system 1700 may optionally perform controlled semi-supervised learning using unlabeled data. In some situations, during deployment there may be no verification that a classification is correct. In some embodiments, computer system 1700 may acquire other data that is not labeled or classified. In some embodiments, during deployment a fraction of the classification results may be explicitly or implicitly confirmed by the end users or by another person while other classification results may be unconfirmed.

In some embodiments, computer system 1700 may perform additional training including unconfirmed data obtained during deployment by tentatively labeling each unconfirmed result with the best scoring label from the classifier. This process using unconfirmed labels from the classifier is known as semi-supervised learning, which is well known to those skilled in the art of machine learning. Semi-supervised learning often improves performance of machine learning systems when there is a limited amount of labeled training data. On the other hand, in some circumstances, semi-supervised learning may cause the performance of a machine learning system to degrade, sometimes to an extreme degree. In fact, there is a theorem that as the quantity of unlabeled data in semi-supervised learning goes to infinity, the performance of semi-supervised learning converges to the performance of unsupervised learning.

In some embodiments, computer system 1700 may limit the relative quantity of unconfirmed data relative to the quantity of training data and confirmed labeled data obtained during deployment. In some embodiments, computer system 1700 may use labeled data set aside from the training to validate the performance of the network after semi-supervised learning. In some embodiments, computer system 1700 may check the performance of the network after semi-supervised learning by comparison with classification results obtained from other systems not trained on the unconfirmed semi-supervised labeled data.

In block 815, in some embodiments, computer system 1700 may save the trained network to a network repository and the data to a data repository.

In preferred embodiments, computer system 1700 may return to block 802 to continue lifelong learning.

FIG. 9 is an illustrative diagram of a parametrically controlled autoencoder that computer system 1700 may use in several aspects of the invention.

A conventional autoencoder comprises input data 901, which computer system 1700 supplies as input to an encoder network 902. Computer system 1700 also supplies the input data 901 as an output target to a decoder network 905. In a conventional autoencoder, the output nodes 904 of the encoder 902 are also the input values for the decoder 905. In a parametrically controlled autoencoder, computer system 1700 may add control parameters or specified features 903 as additional input values to the decoder 905.

Because the input data 901 is also the target data for the output of the decoder 905, it is not necessary for computer system 1700 to supply categorical labeling or any other additional information for training an autoencoder. Therefore, computer system 1700 may use unsupervised learning to train an autoencoder. Conventional autoencoders and methods for training autoencoders are well known to those skilled in the art of training deep neural networks.

In designing and training a useful autoencoder, it is necessary to place some restriction of the n-tuple of output values 904 of the encoder 902. If the values 904 are unrestricted, the encoder could simply copy the input values 901 to 904 and the decoder could them copy them to its output, which would then perfectly match the input 901. However, such an autoencoder would not be useful.

One form of restriction is to limit the number of output variables 904 of the encoder 902. Another form of restriction is to impose, for each input data item, a sparsity constraint or regularization on the number of variables in 904 that may have non-zero values. However, different input data items may have different variables in 904 that are non-zero, and the total number of variables in 904 may be equal to or greater than the number of input variables.

The vulnerability of a decision element in a network to small changes in its input data tends to be proportional to the number of input variables. In some embodiments, computer system 1700 may replace the local data space for a decision element group with the bottleneck layer of an autoencoder of that local data space to reduce the number of input variables of the decision element group. In some embodiments, computer system 1700 may train the autoencoder using only data that is in the union of the target sets of the elements in the decision element group. In some embodiments, computer system 1700 may train a detector or discriminator to separate data that is in the union of the target sets of the elements in the decision element group from data that is not the union.

In some embodiments, computer system 1700 may modify the network to replace the connections from the local data space to the elements in the decision element group with connections from the bottleneck layer of the autoencoder to elements in the decision element group.

In some embodiments, computer system 1700 may test the comparative performance of the system before such a modification to the network with the performance after such a modification. In some embodiments, computer system 1700 may generate simulated adversarial attacks and or other perturbations in the data in this comparative evaluation.

In some embodiments, computer system 1700 may also compare the interpretability of the original local data space to interpretability of the variables in the bottleneck layer of the autoencoder. In some embodiments, computer system 1700 may compare the interpretability of the variables in the bottleneck layer to a specified criterion. In some embodiments, computer system 1700 may estimate the interpretability of a variable by measuring the degree to which the variable may be associated with a known set or a named set. Preferably, computer system 1700 will rate association with a named set higher than association with a known, unnamed set.

Because a variable in the bottleneck layer of an autoencoder is a nonlinear function of multiple input variables, a variable in the bottleneck layer may be more difficult to interpret than an input variable.

In some embodiments, computer system 1700 may use a parametrically controlled autoencoder rather than a conventional autoencoder. In preferred embodiments, computer system 1700 may select specified feature variables 903 based on interpretability. Computer system 1700 may use as a specified feature in 903 any variable that computer system 1700 may compute from the global input data space 921 by analysis system 922. In some embodiments, in analysis system 922, computer system 1700 may use the output of elements already in the hybrid network being trained. In some embodiments, computer system 1700 may create and train new elements in the hybrid network.

In some embodiments, computer system 1700 may select, as one or more specified feature variables in 903, variables that are associated with a named sets in the current network being trained or in a previously trained network. In some embodiments, computer system 1700 may train a new node, cell, or unit to detect a named set.

In some embodiments, computer system 1700 may select, as one or more specified feature variables in 903, variables that are associated with features with names known to humans. For example, in speech analysis, the frequencies of the vocal resonances are known as formants. Estimation of formant frequencies is well known to those skilled in the art of speech analysis.

In some embodiments, computer system 1700 may implement knowledge engineering as specified by human domain experts. In some embodiments, computer system 1700 may use as specified feature variables 903 with values computed by knowledge engineering in previously trained systems.

In some embodiments, computer system 1700 may select, as specified feature variables 903, one or more of the control parameters of a parametric synthesizer or data generator.

In some embodiments, computer system 1700 may train a parametrically controlled autoencoder with a stochastic bottleneck layer as a generator. For example, computer system 1700 may use a stochastic categorical autoencoder (SCAN) as a generator. SCANs are described in U.S. Pat. Nos. 10,679,129 and 11,461,661 (previously incorporated by reference). In some embodiments, computer system 1700 may use such a generator to generate additional data, as discussed in association with block 410 of FIG. 4 and block 514 of FIG. 5. In some embodiments, computer system 1700 may use a parametrically controlled autoencoder for style adjustment, as discussed in association with blocks 2109 and 2110. In some embodiments, computer system 1700 may train a parametrically controlled autoencoder to use the decoder as a parametrically controlled generator for speech or music, as discussed in association with block 2110 of FIG. 20. In some embodiments, computer system 1700 may specify parameters in the parametrically controlled autoencoder in terms that can be understood and controlled by an end user when the controls for a speech or music synthesizer may require a trained professional.

In some embodiments, computer system 1700 may train a generator based on a parametrically controlled autoencoder with specified features 903 designed to be understood and controlled by end users. For example, computer system 1700 may design an image generator that can be controlled by professional artists or by amateurs. For a professional artist, computer system 1700 may design the specified feature set 903 to use named features that would be referred to by terms that would be known to a professional artist. For an amateur, computer system 1700 may design the specified feature set 903 to use named features with names that would be understood by an untrained amateur.

In some embodiments, computer system 1700 may design the feature set 903 to be used by an untrained individual to produce items just for their own pleasure and not for other people.

For example, in some embodiments, computer system 1700 may design a parametrically controlled autoencoder with a stochastic layer to control a music synthesizer. In some embodiments, computer system 1700 may design a system to be used by a person who is not trained on any musical instrument but who enjoys music and has strong musical preferences.

In some embodiments, computer system 1700 may design a system to be used by a person who loves music but who has suffered hearing loss such that, for a live or recorded performance, no hearing aid can correct for the hearing loss enough for the person to hear the quality of music that they remember from before their hearing loss. Computer system 1700 may design a parametrically controlled synthesizer with specified individually customized control values that would allow the person to exaggerate aspects of the music to optimize the perceived quality of the music in the hearing of that individual.

In some embodiments, computer system 1700 may use a parametrically controlled autoencoder to back propagate to values of the specified feature variables 903 that produce data items on the decision boundary for a selected decision element. In some embodiments, computer system 1700 may use a stochastic parametrically controlled autoencoder to generate additional data near a decision boundary. In some embodiments, computer system 1700 may use additional data near a decision boundary to test the sensibility of the decision boundary, as discussed in association with block 410 of FIG. 4.

In some embodiments, computer system 1700 may use additional data as training data to improve the classification performance of the system. In some embodiments, computer system 1700 may use as specified features 903 one or more control variables of a parametric synthesizer for which different values of the control parameters may be designed to be or known to be associated with different classification categories or with other named sets.

In some embodiments, computer system 1700 may use the values of the specified feature variables 903 to aid in the interpretation of elements in the network receiving incoming connections directly or indirectly from the set of variables 903.

FIG. 10 is a diagram of an illustrative embodiment of a robust template detector model, which computer system 1700 may use as a more robust replacement for an activation function of a detector node. Computer system 1700 may design the template model to be more robust to reduce its vulnerability to making non-sensible mistakes.

In the illustrative model shown in FIG. 10, in some embodiments, computer system 1700 may replace the original inputs to the detector node with the bottleneck layer (1001) of an autoencoder of a data space comprising those original inputs.

Annuli 1002, 1003, and 1004, comprise connections from the corresponding nodes of the bottleneck layer or other specified local data space and connections to the function elements Y₁, Y₂, . . . , Y_{K}. In some embodiments, for annulus k, computer system 1700 computes |μₖ−Xₖ|, the absolute value of the difference between the input value Xₖ with a parameter μₖ. In some embodiments, computer system 1700 may compute the parameter μₖ as the statistical estimates of parameters of a parametric probability distribution such as the mean values of a Gaussian distribution or the median of a bilateral exponential distribution. In some embodiments, computer system 1700 may determine the value the parameter μₖ by maximum likelihood estimation. In some embodiments, computer system 1700 may determine the value the parameter μₖ by iterative training using gradient descent. In some embodiments, computer system 1700 may estimate the value by empirically comparing the performance of the system with varying values of μₖ. In some embodiments, the value of μₖ may be set by a hyperparameter specified by, for example, the HNLMS.

In some embodiments, computer system 1700 may compute the function ƒ(|μₖ−Xₖ|) for a specified function f(x). For example, in some embodiments, computer system 1700 may use the function f(x)=min (|μₖ−Xₖ|, Sₖ), for some specified value of the constant Sₖ. In some embodiments, for example, the system design or the HNLMS may specify the value of Sₖ. In some embodiments the value of Sₖ may be the same for all k.

In some embodiments, computer system 1700 may enforce a data exclusion limit on the value of |μₖ−Xₖ|. In some embodiments, computer system 1700 may substitute a specified background model value for the output 1010 if more than a specified number of the input magnitude differences |μₖ−Xₖ| exceed a specified data exclusion value. In some embodiments, the computer system 1700 may set the specified number as a fraction of the number of input values. In some embodiments, computer system 1700 may set the specified number as one, which is equivalent to determining the data exclusion based on the L_{∞} norm.

In some embodiments, computer system 1700 may create a non-monotonic dip in the score for values of |μₖ−Xₖ| that are close to but not quite within the acceptance range. Computer system 1700 and/or the HNLMS, for example, may adjust this dip so that training tends to move the score for close calls in this interval toward the acceptance range. In some embodiments, computer system 1700 may use a substitute derivative for such close call data items.

In some embodiments, computer system 1700 may compute yₖ=ƒ(|μₖ−Xₖ|) for input k, for a specified function f(x). In some embodiments, computer system 1700 may not apply such an f(x) or, equivalently, may use the identity function.

Elements 1005, 1006, and 1007 represent K exponentiation elements, one for each of the K input values. For each of the K exponentiation elements, computer system 1700 computes Y_{K}=(yₖ)^{p}=ƒ(|μₖ−Xₖ|)^{p}, for a specified p, 0<p<∞.

In some embodiments, in summation element 1008, computer system 1700 may compute bias+Σₖwₖ ƒ(|μₖ−Xₖ|)^{p}, where bias is a learned parameter in element in 1009. In some embodiments, compute system 1700 may base the model of FIG. 10 on a parametric probability distribution and may determine the value of the weight wₖ as proportional the inverse of a measure of spread of the probability distribution.

$${σ}_{k}^{- 1} ,$$

such as the standard deviation for a Gaussian distribution (p=2). In some embodiments, computer system 1700 may use a super Gaussian (p>2), which for values of ƒ(|μₖ−Xₖ|) has a flatter range of values to better satisfy sensibility criteria. In some embodiments, computer system 1700 may use a non-standard function ƒ(|μₖ−Xₖ|), such as bounded function, for additional robustness and computer system 1700 may estimate wₖ separately from any interpretation of the template as a probability model.

In some embodiments, in output element 1010, computer system 1700 may compute

Z=g(bias+(Σₖ wₖƒ(|μₖ−Xₖ|)^{p})^{1/p}),

where g(x) is a specified function, which may be the identity function.

In some embodiments, in output unit 1010, in computer system 1700 may compute

Z=(exp(−bias−(Σₖwₖƒ(|μₖ−Xₖ|)^{p})^{1/p}),

as in the exponential family of parametric probability distributions.

In element 1010, in some embodiments, computer system 1700 may apply data exclusion if the value of Z is outside a specified interval. In some embodiments, computer system 1700 may substitute a specified background model value for Z in the case of data exclusion.

In training a template model such as illustrated in FIG. 10, computer system 1700 deals with a bias parameter and three parameters, μₖ, Xₖ, and wₖ, for each value of k.

In some embodiments, computer system 1700 may estimate the values of μₖ and wₖ=σ⁻¹ by maximum likelihood estimation for an associated probability distribution model. In some embodiments, computer system 1700 may estimate the values of μₖ and wₖ by local gradient descent, that is gradient descent based on a measure of fit of the data examples to the model without any back propagation from higher levels of the network. For example, in some embodiments, computer system 1700 may iteratively train μₖ to minimize ƒ(|μₖ−Xₖ|)^{p}. In such embodiments, computer system 1700 may control the learning rate for the μₖ to allow training of the μₖ and the Xₖ to track each other.

In some embodiments, computer system 1700 may train the Xₖ by back propagating derivatives based on minimizing the objective f (|μₖ−Xₖ|)^{p}, back propagated to the nodes with connections into the template model. In some embodiments, computer system 1700 may train the Xₖ by back propagating data examples.

In some embodiments, computer system 1700 may train the bias parameter as normalization for a parametric probability model. In some embodiments, computer system 1700 may adjust the bias parameter based on the a priori probability of the set being detected by the template model.

In some embodiments, in which a detector model is used as a detector of one of the sets being discriminated in a discriminator element, computer system 1700 may train the bias parameter to minimize the error rate of the discriminator.

In some embodiments in which a detector model is used as a component in a plurality of discriminator elements, computer system 1700 may train a separate bias parameter for each discriminator.

FIG. 11 comprises flow charts for illustrative embodiments for training data exclusion and data delegation.

Blocks 1101-1109 are a flow chart of an illustrative embodiment of the training of data exclusion. Blocks 1121-1127 are a flow chart of an illustrative embodiment of the training of data delegation. Computer system 1700 may use either data exclusion or data delegation to exclude one or more data items from a selected element of a hybrid network. However, data exclusion and data delegation use different techniques and are designed for different ends.

In some embodiments, computer system 1700 may use data exclusion to make one or more selected decision groups better satisfy one or more specified criteria for sensibility. Computer system 1700 may use data exclusion during training to exclude one or more data items from activating one or more specified elements. In some embodiments, computer system 1700 may also use data exclusion during training and during inference to substitute a specified background score for the output of a specified unit for one or more data items for which an exclusion test triggers the substitution.

In some embodiments, computer system 1700 may use data delegation to remove one or more training data items from the training of one or more elements. In data delegation, computer system 1700 may create a new element to be trained on data including one or more delegated data items. In some embodiments, computer system 1700 may add one or more delegated data items to the training set of one or more existing elements. In data delegation, computer system 1700 may train a data switch to control, for one or more selected data items, whether a specific element of the hybrid network receives the data items during training. In some embodiments, computer system 1700 may use the trained data switch to determine whether to activate a specified element of the hybrid network during inference.

In block 1101, in some embodiments, computer system 1700 may select a decision group or a subset of a decision group on which to train data exclusion. In some embodiments, if computer system 1700 selects a proper subset of a decision group, computer system 1700 may copy the elements in the subset and add a softmax relationship so that the copies of the elements in the subset form a proper decision group. In some embodiments, computer system 1700 may select fewer decision elements to facilitate the implementation of better sensibility. In some embodiments, the decision group may be the two alternatives of a discrimination. In some embodiments, the decision group may be a single detector element. For example, in some embodiments, computer system 1700 may make a template model more robust by data exclusion.

In block 1102, in some embodiments, computer system 1700 may determine a data space for the selected decision group. For example, computer system 1700 may formulate a data space comprising the union of the input variables to the elements in the selected decision group.

In block 1103, in some embodiments, computer system 1700 may determine the target sets of the elements in the decision group. In some embodiments, the training in blocks 1104-1108 may be restricted to training data in the union of the target sets.

In block 1104, in some embodiments, computer system 1700 may train a data space with fewer dimensions than the data space determined in block 1102. For example, computer system 1700 may train a conventional autoencoder or a parametrically controlled hybrid autoencoder with specified features to encode the data in the union of the target sets. Computer system 1700 may then use the bottleneck layer of the trained autoencoder as a data space.

In block 1105, in some embodiments, computer system 1700 may train a template detector of the union of the target sets with one or more norms in the reduced dimension data space.

In block 1106, in some embodiments, computer system 1700 may select the output score of the template trained in block 1105 and/or one or more of the norms in the reduced dimension data space. In some embodiments, computer system 1700 may compute a histogram of the data in the target sets of one or more of the selected variables. In some embodiments, computer system 1700 may then select a threshold value for a selected variable such that a specified fraction of the data in the union of the target sets is within the threshold, which may be called a recall threshold and may be used as an exclusion threshold.

In some embodiments, in ongoing training, computer system 1700 may train the exclusion threshold for a specific decision group more than once. In some embodiments, computer system 1700 may use empirical training (521 of FIG. 5) to set the value of the specified fraction for the recall threshold for the exclusion limit.

In block 1107, computer system 1700 checks a specified criterion to determine whether to select more decision groups before resuming training of the system. If so, computer system 1700 returns to block 1101. Otherwise, computer system 1700 proceeds to block 1108.

In block 1108, computer system 1700 resumes training of the system, excluding from the training of the selected decision groups any data item for which the value of one or more specified norms or the template score is beyond the exclusion threshold determined in block 1106.

In block 1109, computer system 1700 again checks a specified criterion to determine whether to select additional decision groups. If so, computer system 1700 returns to block 1101. Otherwise, computer system 1700 exits the process illustrated by blocks 1101-1108.

Blocks 1121-1127 are a flow chart of an illustrative embodiment of training data delegation.

In block 1121, in some embodiments, computer system 1700 selects a decision element. In preferred embodiments, computer system 1700 may restrict its selection to decision elements that can make a discrimination or classification error, such as a discriminator or one of more elements of a decision element group.

In blocks 1122-1126, in some embodiments, computer system 1700 may determine which, if any data items to delegate from the training of the selected element. Computer system 1700 may choose to delegate a data item if, for example, computer system 1700 determines the data item to be an outlier of the known set of which it is a representative. More generally, computer system 1700 may delegate a specific data item if, for any reason, having the specific data item included in the training data for the element degrades the performance. In some embodiments, computer system 1700 may delegate a data item if the delegation of the data item makes the network more easily interpretable or more sensible. In some embodiments, computer system 1700 may delegate a data item to escape from slow improvement during iterative training such as near a saddle point in the objective function.

The process illustrated in blocks 1122-1126 is one illustrative embodiment for finding candidate data items to delegate and for evaluating the candidates to determine which ones to delegate.

In block 1122, in some embodiments, computer system 1700 selects the relevant data, that is the set of data from which computer system 1700 might select one or more data items to delegate. In some embodiments, computer system 1700 may include in the set of relevant data items all data items on which the selected decision element makes an error or on which the output is close to a threshold that would cause an error. In some embodiments, computer system 1700 may train one or more diverse networks to make the same decision as the selected decision element. Computer system 1700 may then include in the relevant set any data item on which more than a specified fraction of the set of diverse networks makes an error on the data item. In some embodiments, computer system 1700 may include as relevant any data item that has previously been selected to be delegated from any detector for a known set associated with the decision element selected in 1121. In some embodiments, computer system 1700 may designate all training data as relevant. In some embodiments, computer system 1700 may determine that a data item is relevant by comparing the performance of the element when the data item is included with full weight in the training to the performance when the data item is omitted or used with only fractional weight.

In block 1123, in some embodiments, computer system 1700 may use empirical training to train a relative weight for each data item in the set of relevant data items. For each trial in the empirical training, computer system 1700 may train the base network counting each data item in the set of relevant data proportional to its relative weight. In the empirical training, computer system 1700 may allow the relative weight of a data item to be zero or negative. Computer system 1700 may continue running the empirical training of the data item weights until a specified stopping criterion is met. In some embodiments, computer system 1700 may randomly change the weight of each training data item and compute a regression coefficient on the classification error or other objective, as in empirical training.

In block 1124, in some embodiments, computer system 1700 may delegate one or more of the data items for which the empirically learned weight is zero or negative. For each delegated data item, computer system 1700 drops the delegated data item from the set of training data for the selected decision element.

In block 1125, in some embodiments, computer system 1700 may add one or more delegated data items to the training data for a specified decision element, which is called targeted delegation. In some embodiments, computer system 1700 may specify that the delegated data item be given extra weight in training the decision element to which the data item is delegated. In some embodiments, computer system 1700 may create one or more new nodes to which to delegate selected data items to be delegated as targeted delegation.

In some embodiments, in block 1125, computer system 1700 may decide, for one or more data items, not to use targeted delegation, which in effect delegates the one or more data items to the network rather than to a specific node. Such delegation is called untargeted delegation.

In block 1126, in some embodiments, computer system 1700 may train one or more detectors for specified sets of delegated data items. In some embodiments, computer system 1700 may use one or more detectors to control one or more data switches. In some embodiments, computer system 1700 may use these data switches to steer one or more delegated data items to specific nodes during training and/or during inference.

In block 1127, in some embodiments, computer system 1700 may determine whether to select and perform data delegation on more decision elements. If so, computer system 1700 returns to block 1121. Otherwise, computer system 1700 exits the process illustrated by blocks 1121-1127.

FIG. 12 is a flow chart of an illustrative embodiment for training alignment models. In some embodiments, computer system 1700 may train a model to align elements of the hybrid network with elements of a human interpretable representation of knowledge, such as a mereology, ontology, grammar, or semantic network. In some embodiments, computer system 1700 may train a model to align elements of the hybrid network with a model comprising an adjacency graph.

In other embodiments, computer system 1700 may train a model to compute alignment to any representation that can be expressed as a graphic structure comprising edges and vertices or, equivalently, connections and nodes. For example, the alignment may be between a sequence of words and a parse tree.

In preferred embodiments, computer system 1700 may represent the alignment model in the cells of a hybrid network rather than in neural nodes. In some embodiments, computer system 1700 may represent the template models for parts in a mereology in cells. In some embodiments, computer system 1700 may connect the output of a template model in a cell as an input to a neural node. In some embodiments, computer system 1700 may use the output of a template model in a cell as a feature value in a local data space or other feature vector.

In the illustrative embodiment of FIG. 12, computer system 1700 may train a model to align parts of an object in an image with the trained model. In some embodiments, computer system 1700 may use a similar process to train a model of a mereology of input data represented as a graph with a designated external vertex. In such an embodiment, the graph vertices adjacent to the designated external vertex are designated as the periphery.

In some embodiments, computer system 1700 may execute the process of building a mereology-based alignment model as an example of semi-automated knowledge engineering, training models incorporating knowledge represented in a human understandable form using a minimal amount of human labor.

In block 1200, computer system 1700 may train one or more preliminary alignment models for one or more specified categories or known sets. In some embodiments, computer system 1700 may skip training of a preliminary alignment model and may proceed directly to block 1201. In some embodiments, computer system 1700 may train a preliminary alignment model based on a simpler system than the final system to be trained.

In some embodiments, computer system 1700 may train a preliminary alignment model in a data space other the input data space for the model to be trained in blocks 1201-1214. In some embodiments with a geometric arrangement of the input data, such as the 2-dimensional arrangement of the pixels in an image or the 1-dimensional arrangement of the elements in a sequence, computer system 1700 may train a preliminary model in a lower resolution data space.

Approximate translation in both directions between high-resolution and low-resolution images is well known to those skilled in the art of image processing. Approximate translation between a high-sample-rate and low-sample waveform is well known to those skilled in the art of signal processing. More generally, computer system 1700 may translate between two data spaces with representations of the same data categories using the translation technique discussed in association with FIG. 14.

In an illustrative embodiment, computer system 1700 may obtain a first data item with one or more labeled parts. In some embodiments, computer system 1700 may ask a member of the human team in the HNLMS or other human, such as an end user to label one or more parts of a specified data item.

In another illustrative embodiment, computer system 1700 may perform object detection on one or more images to detect objects that may be parts of a larger object to be detected by the network. Computer system 1700 may then select the parts that are most consistently detected for images of the larger object. Computer system 1700 may then map the selected detected parts in one or more images to a mereology for the larger object.

From one or more instances of a labeled part of an object, computer system 1700 may create a template model for the part. For example, in some embodiments, computer system 1700 may set the μₖ values in a template such as illustrated in FIG. 10 to the values in a single example or to the mean of the values in a plurality of examples. In some embodiments, computer system 1700 may estimate the wₖ values as the reciprocals of estimates of a measure of the spread of a probability model

$${w}_{k} = {σ}_{k}^{- 1} .$$

In some embodiments, computer system 1700 may set the wₖ or

$${σ}_{k}^{- 1}$$

values to a value specified by a hyperparameter. In some embodiments, computer system 1700 may tune the hyperparameter to a specified trade-off between precision and recall. Such a template is called a one-shot or few-shot template.

In some embodiments, computer system 1700 may train a neural network or a hybrid network for the higher stages of the system to detect the specified larger object using the output of the part detectors as input to the higher-stage neural network. Computer system 1700 may then further train the part detectors by back propagation from the higher-stage network.

Computer system 1700 may select one or more of the images with labeled detected parts. Computer system 1700 may then construct a preliminary alignment model by training a probability model for correct and incorrect detection of each part in the mereology and training a model for the relative positions of adjacent parts in the mereology.

In some embodiments, computer system 1700 may estimate the probability of each part being on the periphery of the larger object by a frequency count of how often the part is next to a contour curve around the object separating the object from the background. Methods for tracing the contour curve around an object are well known to those skilled in the art of image processing and recognition.

In the illustrative embodiment, in blocks 1201-1214, computer system 1700 may compute the alignment of a set of images to the current alignment model and then may use the alignment on new images and/or an improved alignment on previously aligned images to compute an improved alignment model.

In block 1201, computer system 1700 optionally obtains additional images. The preliminary alignment model may have been trained on a single image or a small subset of available images. In some embodiments, computer system 1700 may do multiple passes through the loop from block 1201 to block 1214, increasing the resolution and/or adding additional images with each pass.

The category of each image may be known or unknown.

In block 1202, in some embodiments, computer system 1700 may label one or more of the parts in one or more of the images. For example, computer system 1700 may perform object detection on all new images using the current models for parts. In some embodiments, computer system 1700 may update the object detection on previously processed images using models that have been revised in previous rounds through the loop from block 1201 to block 1214. In some embodiments, computer system 1700 may relabel previously labeled parts if the models have changed and/or if the image resolution has changed.

In block 1203, in some embodiments, computer system 1700 may build one or more new templates for one or more parts. For example, computer system 1700 may build a template for a part for which no template was trained in the preliminary alignment model or in previous passes through the loop from block 1201 to block 1214. In some embodiments, in block 1203, computer system 1700 may train a new template if an instance of the part in one or more images fails to match any current template to at least a specified degree of accuracy.

In block 1204, in some embodiments, computer system 1700 may specify a sequence of periphery cells in an alignment model to a selected image. Computer system 1700 may select a previously specified sequence of periphery cells. In some embodiments, computer system 1700 may modify or replace a previously specified sequence of periphery cells. For example, computer system 1700 may revise the specification if new part templates have been added, if the resolution has changed to reveal smaller parts, or if the mereology has been revised. Computer system 1700 may revise the mereology as it gathers new information from additional images.

In block 1204, in some embodiments, computer system 1700 may determine the cells on the periphery of a specified image if it has not already done so for the specified image. For different images of two objects with the same mereology, the set of cells that are on the periphery may be a different set. Even for images of the same object, the set of cells that are on the periphery may differ if the point of view is different or if the object has moved.

In some embodiments, in block 1204, computer system 1700 may specify a probabilistic model for the selection of periphery cells and customize the selection of periphery cells to the selected image as part of the alignment computation in block 1205.

In block 1205, in some embodiments, computer system 1700 may compute a sequence-to-sequence alignment of the periphery cells with the parts detected in the selected image. For example, computer system 1700 may use a least cost path algorithm based on dynamic programming to find the sequence alignment that minimizes the deviation of the sequence of detected objects from the templates in the alignment model. In some embodiments, computer system 1700 may represent the periphery of the alignment model as a hidden Markov process. In such embodiments, computer system 1700 may use the forward-backward computation of the Baum-Welch algorithm to compute the probability of the best alignments and the a posteriori probability of a specified part in the model corresponding to a cell associated with a specified position in the image. The forward-backward computation of the Baum-Welch algorithm for training a model of a hidden Markov process is well known to those skilled in the art of training hidden Markov process models.

In block 1206, in some embodiments, computer system 1700 may compute the alignment of the remaining parts in the object consistent with the alignment of the periphery. In some embodiments, computer system 1700 may use trained models for the relative positions of adjacent parts, starting with interior parts that are adjacent to periphery parts. In some embodiments, computer system 1700 may merely use the adjacency constraints if the constraints sufficiently limit the possible interior alignments of the selected image.

In block 1207, in early phases of some embodiments, computer system 1700 may temporarily set aside some images that computer system 1700 judges to be poorly aligned based on the degree of fit with the current model. For the current pass through the loop from block 1201 to block 1214, computer system 1700 may leave these set aside images out of the training in blocks 1208 and 1209.

In block 1208, in some embodiments, computer system 1700 may retrain the template model for each part using the portion of the image aligned with the part in each of the images that have not been set aside.

In block 1209, in some embodiments, computer system 1700 may update the sequence probability modeling parameters for each periphery cell.

In block 1210, in some embodiments, computer system 1700 may realign the current images using the models as updated in block 1208 and 1209.

In block 1211, in some embodiments, computer system 1700 may separate the figure from the background in each selected image. In some embodiments, computer system 1700 may use this figure-ground separation in later passes through the loop from block 1201 to block 1214. In some embodiments, computer system 1700 may use this figure-ground separation in testing sensibility. One of the criteria for sensibility is that changes in the background should generally not affect the classification score of an object.

In block 1212, in some embodiments, computer system 1700 may check a specified criterion to determine whether to update the task. For example, computer system 1700 may determine to obtain higher resolution images. As another example, computer system 1700 may determine to obtain a new set of images to train a new set of models and/or to validate the current models. If so, computer system 1700 returns to block 1201. Otherwise, computer system 1700 proceeds to block 1213.

In block 1213, computer system 1700 checks a specified criterion to determine whether to continue the iterative training of the models on the current set of images. If so, computer system 1700 returns to block 1206. Otherwise, computer system 1700 proceeds to block 1214.

In block 1214, computer system 1700 checks a specified criterion to determine whether to select more images for the current task. If so, computer system 1700 returns to block 1201 to obtain additional images for the current task. Otherwise, the process illustrated in FIG. 12 is complete.

FIG. 13 is an illustrative embodiment of a process herein called “conditional hybrid training” with an illustrative example called “conditional flattening.” The phrase “conditional flattening” refers to the fact that, for each node and for each data item, computer system 1700 may choose from among two or more activation functions that have different degrees of flattening. In preferred embodiments, computer system 1700 may customize the choice for each node for each data item for each epoch of training. Computer system 1700 monitors the state of the training with holistic analysis and may change the selections of activations functions of hybrid training method during the training process.

In block 1301, in some embodiments, computer system 1700 may do preliminary training of the network until a stopping criterion is met. In some embodiments, the stopping criterion may be determined by, for example, the HNLMS. The purpose of the preliminary training is for computer system 1700 to do enough training of the network so that the weights are stable enough so that computer system 1700 may perform holistic analysis of individual data items and/or individual nodes.

In block 1302, in some embodiments, computer system 1700 may select a set of the data items on which to select customized training methods, including conditional flattening alternatives. In some embodiments, computer system 1700 may augment the original set of training data with data generated by simulated adversarial attacks. In some embodiments, computer system 1700 may select a subset of the augmented training data items. In selecting a subset of the augmented set of training data, in some embodiments, computer system 1700 may select a data item because the network or a unit makes an error on the data item. In some embodiments, computer system 1700 may choose a data item because a node makes an error on the data item relative to an implicit local target such as discussed in association with block 508 of FIG. 5. In some embodiments, computer system 1700 may select all the augmented training data items. In some embodiments, computer system 1700 may reverse the order of blocks 1302 and 1303, performing holistic analysis of all the training data items and basing the selection of data items on the holistic analysis.

In block 1303, computer system 1700 performs holistic analysis of the selected data items for the HNLMS to determine the best method for the ongoing hybrid training customized for each node for each data item. In holistic analysis of a data item, computer system 1700 may compute the activations of all the nodes in the network and may compute a back propagation by gradient descent or by a hybrid training method, not only for the current selected hybrid training method but also for other hybrid training methods. In preferred embodiments of block 1303, computer system 1700 may compute the back propagation without doing a learned parameter update.

Computer system 1700 may collect statics on the relationship of the activation by each selected data item of each node and each alternate activation function of each node. For example, computer system 1700 may compare the activation with a target activation and compare the difference between the activation and the target with a back propagated derivative or a local substitute derivative function. Computer system 1700 may also compare the activation with the direction of the update for a minibatch comprising the selected data item. Computer system 1700 may flag a data item and node if the derivative indicates an update in the direction opposite the direction to the target.

In addition, in some embodiments, computer system 1700 may collect and accumulate statistics for each data item for multiple epochs. In preferred embodiments, computer system 1700 may supply these collected statistics to the HNLMS for making decision about changing the choice of activation function for a specific node for a specific data item and, possibly, other changes such as the choice of hybrid training method.

In block 1304, in some embodiments, computer system 1700, for each selected data item, may select specific nodes for which to make conditional choices customized to the data item.

In block 1305, in some embodiments, computer system 1700, as controlled by, for example, the HNLMS, may make the choice of training method and the choice of whether to use a flatter or less flat activation function. Computer system 1700 may choose to make no change from the existing choice.

As an illustrative example, computer system 1700 may choose to use a less flat activation function earlier in the training or in any condition in which the collected statistics satisfy criteria set by, for example, the HNLMS as indicating the need for faster training on a specific node for a specific data item. On the other hand, computer system 1700 may choose to use a flatter activation function, or even a piecewise constant activation function, to increase sensibility for a node and data item when the training of the weights for connections leading to the node seems to have stabilized.

In block 1306, in some embodiments, computer system 1700 may do a specified amount of continued or resumed training of the whole network, including the selected nodes and data items.

In block 1307, in some embodiments, computer system 1700 may check specified criteria to determine whether to reset some of the conditional choices made in block 1305. If so, computer system 1700 returns to block 1305. If not, computer system 1700 proceeds to block 1308.

In block 1308, in some embodiments, computer system 1700 may determine, based on specified criteria, whether to continue training without any changes. If so, computer system 1700 returns to block 1306. Otherwise, computer system 1700 proceeds to block 1309.

In block 1309, in some embodiments, computer system 1700 may determine, based on specified criteria, whether to select new conditional nodes. If so, computer system 1700 returns to block 1304. Otherwise, computer system 1700 proceeds to block 1310.

In block 1310, in some embodiments, computer system 1700 may determine, based on specified criteria, whether to select new data items. If so, computer system 1700 returns to block 1302. Otherwise, computer system 1700 is done with the process illustrated in FIG. 13.

Computer system 1700 may continue regular hybrid training or may be temporarily done with training. In preferred embodiments, however, computer system 1700 may implement continual training, including training during deployment, as discussed in association with FIGS. 1, 8, and other figures. In such embodiments, computer system 1700 may never permanently stop training and may resume the conditional hybrid training process illustrated in FIG. 13.

FIG. 14 is a diagram of an illustrative embodiment of an aspect of the invention for translating or transforming data items in one data space into corresponding data items in a second data space.

The diagram of FIG. 14 comprises two autoencoders with some additional elements. In some embodiments, one or both autoencoders may be a parametrically controlled hybrid autoencoder. The first autoencoder comprises n-tuple (input) 1401, encoder 1402, lower dimensional embedding 1403, decoder 1404, and approximating output 1406. Computer system 1700 trains the first autoencoder on a first data space of dimension n. In training the first autoencoder, computer system 1700 selects a data item from the first data space and represents the data item as an n-tuple in input 1401, which comprises the input to the first autoencoder. Computer system 1700 then uses encoder network 1402 to compute a lower dimensional embedding 1403 of the input data n-tuple. Computer system 1700 then uses decoder 1404 to reconstruct an approximation 1406 to the input 1401. Computer system 1700 may train the first autoencoder by back propagating an error function of the difference between the output 1406 and the input 1401. The training of an autoencoder is well known to those skilled in the art of training neural networks.

The second autoencoder comprises input m-tuple (input) 1411, encoder 1412, lower dimensional embedding 1413, decoder 1415, and approximating output 1417. Computer system 1700 may train the second autoencoder using the same process as training the first autoencoder. In the illustrative cases discussed below, generally m≤n.

In some embodiments, computer system 1700 may do weighted gradient descent in which back propagation from the secondary decoder (1405 or 1414) receives less weight than from the primary decoder (1404 or 1415).

In some embodiments, computer system 1700 may add extra variables to embedding 1403 or embedding 1413 to enable computer system 1700 to train a more accurate decoder 1405 or 1414 to the secondary data space. In some embodiments, computer system 1700 may connect these extra variables only to the secondary decoder (1405 or 1414).

There are several distinct cases in which computer system 1700 may use the two autoencoders and the additional structures decoder 1405, approximating output 1407, decoder 1414 and approximating output 1416.

Case 1: In this case, there is a known invertible mapping from data space 1 (1401 in FIG. 14) to data space 2 (1411 in FIG. 14). In this case, generally m=n. Computer system 1700's task in this case is to train a network to compute an approximate mapping from the embedding 1403 in data space 1 to embedding 1413 in data space 2.

Using the known mapping from data space 1 (1401) to data space 2 (1411), for each n-tuple in 1401, computer system 1700 may determine the corresponding m-tuple in data space 1411. Computer system 1700 may then train the decoder 1405 by back propagating the error function for the difference between corresponding data item 1411 and the approximating output 1407 of decoder 1405.

Similarly, computer system 1700 may train decoder 1414 by back propagating the error function for the difference between the corresponding n-tuple 1401 for a given m-tuple 1411 and the approximating output 1416.

For any data item in the embedding 1403, computer system 1700 may compute a corresponding data item in embedding 1413 by applying decoder 1405, then copying the output 1407 to input 1411, and then applying encoder 1412. Computer system 1700 may similarly compute a mapping from embedding 1413 to embedding 1403 using decoder 1414 and encoder 1402.

Case 2: In this case, computer system 1700 knows a non-invertible mapping from data space 1 (1401) to data space 2 (1411). In this case, m may be less than n. For example, data space 1 (1401) may be a data space of high-resolution images and data space 2 (1411) may be a space of lower resolution images obtained by down sampling.

In this case, computer system 1700 may train the first autoencoder and decoder 1405 in the same way as in case 1. Computer system 1700 may then construct a mapping from embedding 1403 to embedding 1413 using decoder 1405 in the same way as in case 1.

However, since the mapping from space 1401 to space 1411 is not invertible, for a data item in space 1411 there may be more than one corresponding data item in space 1401 or there may be none.

In this case, in some embodiments, computer system 1700 may construct a mapping from embedding 1413 to embedding 1403 by a different method.

Computer system 1700 may first select a data item d in embedding 1413. Computer system 1700 may then apply decoder 1415 to obtain an output 1417 from the selected data item d. Computer system 1700 may then copy the approximating output of 1417 as target values for output 1407.

For any specified data item in the embedding space 1403, computer system 1700 may back propagate the error on that data item back through decoder 1405 and then to derivatives for the variables in embedding 1403. However, rather than using the computed gradient to train learned parameters in decoder 1405, computer system 1700 may use the gradient with respect to the variables in 1403 to modify the variables in 1403 to find a tuple of values that through decoder 1405 produces an output that better matches the target value in 1407 (e.g., the output 1417 from data item d in embedding 1413). Computer system 1700 may iterate this gradient descent in the embedding 1403 to find a tuple in 1403 that minimizes the error between the output 1407 and the target from 1417 for data item d.

In some embodiments, computer system 1700 may continue the back propagation through encoder 1402 to the input n-tuple 1401. Computer system 1700 may then compute the corresponding tuple in 1403 by applying encoder 1402. Computer system 1700 may use this method to compute a mapping from an item in data space 1411 to an approximately corresponding item in data space 1401.

In some embodiments, computer system 1700 may then train decoder 1414 using the approximate mapping from 1413 or 1411 to 1401 to provide targets for output 1416.

Case 3: In this case, computer system 1700 does not know an accurate mapping either from data space 1401 to data space 1411 or from 1411 to 1401.

In this case, in some embodiments, computer system 1700 may specify any mapping, accurate or not, from one space to the other. Without loss of generality, assume that computer system 1700 specifies a mapping from data space 1401 to data space 1411. In some embodiments, computer system 1700 may then proceed as in case 2 to compute a mapping from data space 1411 to data space 1401.

Computer system 1700 may then use the mapping 1411 to 1401 and apply the method of case 2 to compute an improved mapping from 1401 to 1411. Computer system 1700 may iterate this process of improving the mappings until a stopping criterion is met.

FIG. 15 is a flow chart of an illustrative embodiment of an aspect of the invention using regression on counts in histogram bins and other analyses of the histogram data.

In block 1501, in some embodiments, computer system 1700 selects a variable for which computer system 1700 can compute a value for each of a specified set of data items. In some embodiments, computer system 1700 may select the input to the activation function of a selected node. In some embodiments, computer system 1700 may select a variable in a selected cell. In some embodiments, computer system 1700 may select an output value of a node or unit. In some embodiments, computer system 1700 may select a pair of data items represented as points in a specified local data space. Computer system 1700 may then compute the value of the selected variable by projecting any point in the specified data space to the line through the two points corresponding to the two selected data items and measuring the relative positions of the projections on the line.

In block 1502, in some embodiments, computer system 1700 may determine boundaries for histogram bins for the selected variable such that each bin holds roughly the same number of projected data items.

In block 1503, in some embodiments, computer system 1700 may select a known set.

In block 1504, in some embodiments, computer system 1700 may compute a linear regression on the number of counts of data items in the selected known set per bin.

In block 1505, in some embodiments, computer system 1700 may determine whether to specify the known set as a set associated with the selected variable. In some embodiments, computer system 1700 may accept the known set as associated with the variable if the magnitude of the regression coefficient is greater than a specified value. In some embodiments, computer system 1700 may tentatively accept the known set as associated with the variable if the magnitude of the regression coefficient is greater than the magnitude of any previously tested known set for which the sign of the previously tested regression coefficient is the same as the sign of current regression coefficient.

In some embodiments, computer system 1700 may select any associated known set as initial training data for a template detector. In some embodiments, computer system 1700 may perform histogram analysis of each input variable to a template detector to assist in determining the boundary between the detection interval and the background and the relative a priori probabilities. In some embodiments, a template model initially may model the background based on the same μₖ values as for the detector, until a separate model is created for the background, such as by node splitting in block 1510.

In block 1506, in some embodiments, computer system 1700 may check a stopping criterion to see whether any additional known set should be tested for selection as an associated set. If so, computer system 1700 returns to block 1503. Otherwise, computer system 1700 proceeds to block 1507.

In block 1507, in some embodiments, computer system 1700 may select a pair of associated known sets. In some embodiments, computer system 1700 may select the known set with the maximum regression coefficient and the known set with the minimum regression coefficient. In some embodiments, computer system 1700 may select among all the known sets for which the magnitude of the regression coefficient exceeds a specified value. In some embodiments, computer system 1700 may make the selection giving preference to named sets over unnamed known sets. In some embodiments, computer system 1700 may secondarily give preference to larger sets. In some embodiments, computer system 1700 may avoid selecting any pair of known sets for which the union of the two selected sets exceeds a specified fraction of the total set of data. In these embodiments, a discrimination between a known set and its complement may be treated as a detection of the known set, not as a discrimination.

In some embodiments, for the histogram counts in block 1508-1512, computer system 1700 may compute a histogram with uniform bin intervals rather than equal count intervals.

In block 1508, in some embodiments, computer system 1700 may compute the difference in the counts of the two selected known sets. In some embodiments, computer system 1700 may compute the difference of normalized counts. That is, computer system 1700 may weight the count of each data item so that each of the two known set has the same total count.

In block 1509, in some embodiments, computer system 1700 may determine whether a smoothed version of the function computed in block 1508 is multimodal. If so, in some embodiments, computer system 1700 may proceed to block 1510. If not, computer system 1700 may proceed directly to block 1511.

In block 1510, in some embodiments, computer system 1700 may create a separate node for an interval around each local maximum in the function and create a data switch to direct any incoming activation to the node corresponding to the interval of the incoming activation value. Computer system 1700 may then proceed to block 1511 for each of the new nodes.

In some embodiments, in block 1510, for a unit with a template detector model, computer system 1700 may create a background model detector with distinct μₖ values from the detector of the template unit if there are multiple maxima in the histograms of one or more input variables that are more significant than a specified criterion.

For the background model and the template model as well as for any other type of detector, computer system 1700 may perform node splitting and create one or more new detectors for subsets of the same target set as the original detector. In some embodiments, computer system 1700 may then create a combining node that computes the maximum or the sum of the scores of the set of subset detectors with the same target set.

In block 1511, in some embodiments, computer system 1700 may compute the sum of histogram bin counts for the two selected known sets.

In block 1512, in some embodiments, computer system 1700 may determine decision boundaries for the selected variable for the two selected known sets.

In some embodiments, if there are two distinct maxima in the sum function at input values corresponding to the maxima in the separate histograms counts for the two sets, then computer system 1700 may interpret the selected variable as a discriminator for the two known sets with disjoint acceptance intervals. In some embodiments, computer system 1700 may determine the ends of each acceptance interval by specified criterion such as acceptance of a specified fraction of the data, subject to an additional limit on the minimum acceptable ratio of the count of the set being detected to the count of the other set in the separate smoothed histogram counts. In some embodiments, computer system 1700 may use each acceptance interval as an initial detector to select data for training a template model for each of the two known sets.

In some embodiments, if there is a single maximum in the sum function at a value between the input values corresponding to the maximum in the separate histogram counts for the two sets, then computer system 1700 may interpret the selected variable as a discriminator of two known sets with overlapping probability distributions. In some embodiments, computer system 1700 may determine a decision threshold for a discriminator of the two known sets by finding the point at which the separate unnormalized smoothed counts are equal.

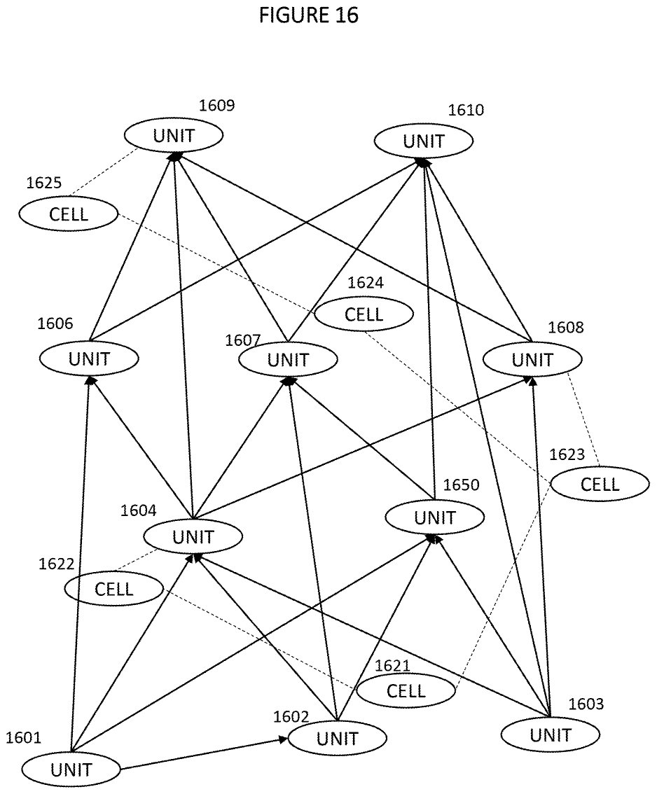

FIG. 16 is an illustrative diagram of a hybrid network of units and cells. Although the illustrative diagram only shows 10 units, 1601, 1602, 1603, 1604, 1605, 1606, 1607, 1608, 1609, and 1610 and five cells, 1621, 1622, 1623, 1624, and 1625, there is no limit to the number of units or to the number of cells in a hybrid network. Although no nodes are shown in the diagram, a hybrid network may comprise one or more stand-alone nodes. However, a unit may comprise a single node. In a unit comprising a single node, computer system 1700 may implement any operation that can be implemented with a stand-alone node and additional operations. Thus, there is no loss of generality to restrict a hybrid network to not contain any stand-alone nodes although it may have one or more units consisting of a single node.

Each arrow from one unit to another is a connection in a directed graph or network. During activation, for each input data item, for each connection, computer system 1700 may transmit one or more values from the source node to the destination node. In some embodiments, computer system 1700 may use the received data value as an additional input connection to the receiving node with a connection weight of 1.0. During training, for each input data item, for each connection, computer system 1700 may back propagate a derivative of a global or local objective, or back propagate a data target, or may back propagate a substitute derivative. In some embodiments, computer system 1700 may store information in one or more cells to implement more complex control of the back propagation process. In some embodiments, computer system 1700 may use this capability to coordinate asynchronous back propagation. In some embodiments, computer system 1700 may use this capability to implement iterative back propagation in the processing of a single data item or a mini batch of data items.

In FIG. 16, there is no cycle among the illustrated network connections, so the network is a directed acyclic graph. However, as mentioned in a comment in the definition of a neural network, there are multiple ways for computer system 1700 to represent a recurrent process in a hybrid network. For example, computer system 1700 may model a fully connected hidden Markov process as a hidden state space model in the cells of a hybrid network. Although the hidden Markov process transition corresponds to a fully connected, cyclic graph, computer system 1700 may train the model for the hidden Markov process using the well-known forward-backward computation of the Baum-Welch algorithm. This computation requires only one forward pass and one backward pass for each parameter update. Furthermore, as mentioned above, computer system 1700 may store information in one of more cells to implement an iterative back propagation computation.

As illustrated in FIG. 3A, a unit may comprise one or more nodes, one or more cells, one or more data switches or other specialized elements, and one or more units. Thus, a single unit may be as complex as a full hybrid network. With unit-specific training data, in some embodiments, computer system 1700 may train a unit to be a module in a modular hybrid network.

The dashed lines in FIG. 16 indicate data communication links from or between cells, liked the dashed-dot communication links shown in FIG. 3A. The data communication links may be unidirectional or bidirectional.

FIG. 17 is a diagram of a computer system 1700 that could be used to implement the embodiments described above, such as the processes described above in connection with various figures. The illustrated computer system 1700 comprises multiple processor units 1702A-B that each comprises, in the illustrated embodiment, multiple (N) sets of processor cores 1704A-N. Each processor unit 1702A-B may comprise on-board memory (ROM or RAM, including, for example, VRAM (RAM particularly suited for GPUs)) (not shown) and off-board memory 1706A. The on-board memory may comprise primary, volatile and/or non-volatile, storage (e.g., storage directly accessible by the processor cores 1704A-N). The off-board memory 1706A-B may comprise secondary, non-volatile storage (e.g., storage that is not directly accessible by the processor cores 1704A-N), such as ROM, HDDs, SSD, flash, etc. The memory computer system 1700 may also include or utilize cloud storage and/or processing, for example. The processor cores 1704A-N may be CPU cores, GPU cores and/or AI accelerator cores. GPU cores operate in parallel (e.g., a general-purpose GPU (GPGPU) pipeline) and, hence, can typically process data more efficiently that a collection of CPU cores, but all the cores of a GPU execute the same code at one time. AI accelerators are a class of microprocessor designed to accelerate artificial neural networks. They typically are employed as a co-processor in a device with a host CPU 1710 as well. An AI accelerator typically has tens of thousands of matrix multiplier units that operate at lower precision than a CPU core, such as 8-bit precision in an AI accelerator versus 64-bit precision in a CPU core. As used herein, data can be “transmitted” by, for example, transmitting the data via a data bus and/or electronic data network, and/or by storing the data in a memory of the computer system 1700, at an address location of the memory, such that a recipient of the data can retrieve the transmitted data from the memory using the address location. The various repositories described herein may be implemented with a database (or databases) of the computer system 1700. The database(s) may be stored in primary memory (e.g., ROM), secondary memory (e.g., optical or magnetic memory), and/or cloud storage, for example.

In various embodiments, the different processor cores 1704 may implement different steps of various processes and procedures. For example, in one embodiment, the cores of the first processor unit 1702A may implement the training loop of blocks 101 to 107 of FIG. 1 and the second processor unit 1702B may implement the classification and continuing training of blocks 108 to 112 of FIG. 1. Further, different sets of cores in the first and/or second processor unit 1702A, 1702B may be responsible for stand-alone training of different sets of units within a hybrid network. As another example, a plurality of base systems may be selected for processing in block 101 of FIG. 1 and one or more additional multiple processor units 1702C may implement the training loop of blocks 101 to 107 of FIG. 1 for different selections of the base unit. Further, different sets of cores in the first and/or second processor unit 1702A, 1702B may be responsible for different hybrid training methods. As a further example, in block 415 of FIG. 4, additional multiple processor units 1702D may train a diverse set of canary systems and other multiple process units may train a diverse set of robust systems. As further example, additional multiple processor units 1702E may implement the AI systems in the HNLMS.

One or more host processors 1710 may coordinate and control the processor units 1702A-E. The process depicted in various figures can be embodied as a set of instructions stored within a memory (e.g., an integral memory of the processing units 1702A, 1702B or an off board memory 1706A coupled to the processing units 1702A, 1702B or other processing units) coupled to one or more processors (e.g., at least one of the sets of processor cores 1704A-N of the processing units 1702A, 1702B or another processor(s) communicatively coupled to the processing units 1702A, 1702B), such that, when executed by the one or more processors, the instructions cause the processors to perform the aforementioned process by, for example, controlling the machine learning systems 701, 711 stored in the processing units 1702A, 1702B.

In other embodiments, the computer system 1700 could be implemented with one processor unit. In embodiments where there are multiple processor units, the processor units could be co-located or distributed. For example, the processor units may be interconnected by data networks, such as a LAN, WAN, the Internet, etc., using suitable wired and/or wireless data communication links. Data may be shared between the various processing units using suitable data links, such as data buses (preferably high-speed data buses) or network links (e.g., Ethernet).

The software for the various computer systems described herein and other computer functions described herein may be implemented in computer software using any suitable computer programming language such as .NET, C, C++, Python, and Julia, and using conventional, functional, or object-oriented techniques. Programming languages for computer software and other computer-implemented instructions may be translated into machine language by a compiler or an assembler before execution and/or may be translated directly at run time by an interpreter. Examples of assembly languages include ARM, MIPS, and x86; examples of high-level languages include Ada, BASIC, C, C++, C#, COBOL, CUDA, Fortran, Java, Julia, Lisp, Pascal, Object Pascal, Haskell, ML; and examples of scripting languages include Bourne script, JavaScript, Python, Ruby, Lua, PHP, and Perl.

FIG. 18 has been discussed in association with block 510 of FIG. 5.

FIG. 19 is a flow chart of an illustrative embodiment of parallel or serial computations in a network of cells connected by data communication links. In this illustrative embodiment, the term “parallel” refers to the fact that a computation is done for many cells in parallel. For each cell there may be serial computations.

In block 1901, in some embodiments, computer system 1700 determines whether to perform computations on cells in parallel or sequentially. The choice may be specified, for example, by the HNLMS or one or more other humans as part of knowledge engineering. In some embodiments, the choice may be based on the type of model. In some embodiments, computer system 1700 may use one or more parallel computations on cells and one or more sequential computations on cells.

For example, a human knowledge engineer or the HNLMS may specify the use of parallel processing of cells to represent a conditional random field or to simulate a cellular automaton.

As another example, a human knowledge engineer or the HNLMS may specify the use of parallel processing of cells to represent the determination of whether a specified subset of an image is connected, which is a well-known example of a geometric property that a perceptron network of any fixed finite size cannot compute without supplemental sequential processing. In the embodiment of FIG. 9, the sequential processing comprises the multiple passes through the loop from block 1902 to 1907. In addition, although the number of nodes and units may have a fixed finite limit, in some embodiments, computer system 1700 may increase the number of cells and/or the number of variables stored in a cell if a specified task requires it.

On the other hand, in some embodiments, computer system 1700 may use sequential processing of cells to determine whether a specified subset of an image is connected or to solve the related problem of finding a path through a maze.

In some embodiments, computer system 1700 may use either parallel or sequential processing of cells to compute an alignment between a received data item and a model or another data item.

As another example, in some embodiments, computer system 1700 may use sequential processing to represent, train, and use a hidden Markov process model. A hidden Markov process model is inherently sequential in nature. Although the state values at adjacent steps in time affect each other, for inference or for each iteration of training, only one forward pass and one backward pass of blocks 1912 to 1917 needs to be done.

In block 1902, in some embodiments, computer system 1700 may acquire, for each cell, data from nodes with data communications links into the cell.

In block 1903, in some embodiments, computer system 1700 may acquire, for each cell, data from other cells with data communications links into the cell.

In block 1904, in some embodiments, computer system 1700 may run a specified sequential program and update the internal state variables and other data stored in the cell.

In block 1905, in some embodiments, computer system 1700 may send data from each cell to nodes with data communication links from the cell.

In block 1906, in some embodiments, computer system 1700 may prepare data from each cell to send to other cells with data communication links from the cell. Computer system 1700 may have the recipient cell retrieve the data during block 1903 of the next pass through the loop from block 1902 to 1907.

In block 1907, in some embodiments, computer system 1700 may determine, based on a specified criterion, whether to continue executing the loop from 1902 to 1907. If so, computer system 1700 returns to block 1902. Otherwise, the process of FIG. 9 is complete.

If computer system 1700 determines in block 1901 to do sequential processing of cells, computer system 1700 proceeds to block 1912. For inference and for each iteration of training a hidden Markov process, for example, computer system 1700 may do one forward pass through the specified cells and one backward pass through the cells. In some embodiments, computer system 1700 executes blocks 1912 to 1917 for each cell for the forward pass and then executes blocks 1912 to 1917 for each cell for the backward pass.

In block 1912, in some embodiments, computer system 1700 may acquire, for each cell, data from nodes with data communications links into the cell.

In block 1913, in some embodiments, computer system 1700 may acquire, for each cell, data from other cells with data communications links into the cell. In the backward pass, this data may include data that cells, including the receiving cell may have recorded in block 1916 during the forward pass.

In block 1914, in some embodiments, computer system 1700 may run a specified sequential program and update the internal state variables and other data stored in the cell.

In block 1915, in some embodiments, computer system 1700 may send data from each cell to nodes with data communication links from the cell.

In block 1916, in some embodiments, computer system 1700 may prepare data from each cell to send to other cells with data communication links from the cell. Computer system 1700 may have the recipient cell retrieve the data during block 1913 of the next pass through the loop from block 1912 to 1917.

In block 1917, in some embodiments, computer system 1700 determines whether all the cells have been processed for the current pass. If so, computer system 1700 proceeds to block 1918. Otherwise, computer system 1700 returns to block 1912. In some embodiments, computer system 1700 may implement a process of beam pruning, in which computer system 1700 processes only a select group of cells, called “active” cells. In such embodiments, in blockm 1917, computer system 1700 may update the selection of cells to be in the active beam.

In block 1918, in some embodiments, computer system 1700 may determine whether to proceed from a forward pass to a backward pass. If the backward pass has already been done, or in an embodiment that does not require a backward pass, computer system 1700 proceeds to block 1918. Otherwise, computer system 1700 returns to block 1918.

In some embodiments, a back pass is not necessary. For example, a best path search may only require tracing back through back pointers to retrieve the best path. As another example, a pruned beam search or a search with a priority queue may only need a forward pass.

In block 1918, in some embodiments, computer system 1700 may determine whether to iterate for training. If only inference is being done or if a criterion for stopping training has been met, then the process of FIG. 9 is complete. Otherwise, computer system 1700 returns to block 1912 to continue training.

FIG. 20 is a flow chart of an illustrative embodiment of empirical training of hyperparameters and/or learned parameters, both of which are simply called “parameters” in the figure for the sake of convenience, and persons skilled in the art of machine learning will know the difference between parameters, which learned as part of the machine learning process, and hyperparameters, which control aspects of the machine learning process.

In block 2000, computer system 1700 selects one or more hyperparameters and/or learned parameters to be trained by empirical training. In some embodiments, computer system 1700 may select an arbitrarily large number of parameters to be trained simultaneously. In some embodiments, computer system 1700 may select a small number of parameters to train. In some embodiments, computer system 1700 may do empirical training multiple times. In some embodiments, in repeated empirical training, computer system 1700 may select different hyperparameters and/or learned parameters to train and/or may select to repeat the training of one or more previously trained hyperparameters or learned parameters.

In block 2001, in some embodiments, computer system 1700 may set a range of allowed values for each selected hyperparameter or learned parameter that computer system 1700 has selected for empirical training.

In some embodiments, in block 2001, computer system 1700 may specify one or more measurable objectives for each selected hyperparameter or learned parameter. For example, computer system 1700 may measure the classification performance and/or the sensibility of the network: (1) in setting the bound of an activation function (202 of FIG. 2), (2) in determining the limit for data delegation or data exclusion (204 of FIG. 2), (3) for training template parameters (212 of FIG. 2), and/or determining parameters associated with the probability distributions used in randomized training (520 of FIG. 5).

Computer system 1700 may use empirical training for setting the value of any hyperparameter that controls an aspect of the training. For example, computer system 1700 may individually and/or collectively control the strength of any knowledge-sharing link, such as for soft-tying or counter-tying. The objective may be a measure of diversity of a trained set of diverse networks or may be the resulting classification and sensibility performance on a validation set. An objective may also be a measure to the amount of training required to get a specified amount of diversity.

In block 2002, computer system 1700 begins a randomized trial in which computer system 1700 randomly picks a value for each selected hyperparameter or learned parameter and evaluates each of the measurable objectives.

In block 2003, computer system 1700 randomly selects a value for each selected hyperparameter or learned parameter.

In block 2004, computer system 1700 activates one or more networks for each data item in a specified set of data. In some embodiments, computer system 1700 may train the networks until a specified stopping criterion. In some embodiments, computer system 1700 may measure the efficiency and effectiveness of the training as well as testing the result after training.

In block 2005, for each specified object of each selected hyperparameter or learned parameter, computer system 1700 measures the value of the objective in the current activation and/or training. Using the measured value of the objective, computer system 1700 updates one or more statistics, such as the average value of the objective for the random value of the hyperparameter or learned parameter selected in block 2003. Note that, for each value of a specific hyperparameter or learned parameter, the average value of a measured objective is averaged over multiple random selections for each of the other hyperparameters or learned parameters.

In block 2006, computer system 1700 checks a specific stopping criterion to determine whether to do more random trials. If so, computer system 1700 returns to block 2002. Otherwise, computer system 1700 proceeds to block 2007.

In block 2007, for each objective of each selected hyperparameter or learned parameter, computer system 1700 determines the value of that hyperparameter of learned parameter that optimizes the objective and records that value. In some embodiments, computer system 1700 may record additional information, such as the average value of the objective for parameter values other than the optimum. In some embodiments, computer system 1700 may record other statistics, such as the standard deviation.

Using the process illustrate in FIG. 20, computer system 1700 may determine optimum values for an arbitrarily large number of hyperparameters and learned parameters for one or more objectives.

In some embodiments, computer system 1700 may save the recorded statistics for later use and not change the selected hyperparameters and learned parameters all at once.

FIG. 21 is a diagram of illustrative embodiments of aspects of the invention in which an artificial intelligence system comprising one or more hybrid networks implemented on computer system 1700 cooperates with a team of one or more humans on joint tasks.

In some embodiments of these joint tasks, computer system 1700 may implement the hybrid networks to represent, learn, and use logical reasoning and logical and probabilistic inference. In some embodiments, rather than attempting to minimize the amount of human labor, computer system 1700 may instead increase the amount of human involvement in order to increase the amount of human control and understanding of the process and of the resulting trained classifier or generator. In some embodiments, the additional human involvement may improve both the sensibility and the understandability of the networks. In some embodiments, additional human participation during the use of a generator may help assure the correctness and truthfulness of the generated output. In some embodiments, human participation may help avoid plagiarism and/or copyright infringement.

In some embodiments, in block 2100, and/or separately in generator blocks 2107, 2109, 2110, and/or 2111, the human team may specify one or more hyperparameters controlling the amount of human participation in generative process.

In block 2101, computer system 1700 obtains or selects an AI system comprising one or more hybrid networks and determines whether to do pretraining of the system. For example, computer system 1700 may skip the pretraining for a network or set of networks that have already been pretrained in a previous use of the process illustrated in FIG. 21. On the other hand, in some embodiments, under control of the human team, computer system 1700 may do additional pretraining of hybrid networks that have previously been pretrained.

In block 2102, in some embodiments, computer system 1700 implements data and algorithms for logical, probabilistic inference, dynamic Bayesian networks, and/or causal networks in one or more cells of a hybrid network. Mathematical representations of logical and probabilistic inference have been known to mathematicians and philosophers for hundreds to thousands of years. Computer implementations of these concepts and of dynamic Bayesian networks and causal networks are well known to those skilled in the art of implementing formal inference and the statistics of causality on computers. In some embodiments, computer system 1700 may implement these logical and probabilistic concepts in computer code in one or more of the cells of a hybrid network.

In some embodiments, in block 2102, for checking text data to be used in training a generator or classifier (blocks 2105, 2107, 2108, 2109, 2110, and 2111), computer system 1700 may apply syllogisms and other elementary logic to detect when two written statements contradict each other or when a single statement is self-contradictory. Computer system 1700 may then drop these sources from the training data, give them less weight, or flag them as unreliable. In some embodiments, computer system 1700 may create a database of such detected problems to enable human input on resolving such conflicts. In some embodiments, computer system 1700 may leave the initiation of such human interaction to the discretion of the humans. For example, computer system 1700 may provide an interface for a human to research a topic including an option of retrieving contradictory sources.

In some embodiments, in block 2102, computer system 1700 may train a plurality of hybrid networks. In some embodiments, computer system 1700 may do additional training in block 2102 after receiving or obtaining data relevant to a particular joint task in block 2105, 2106, 2107, 2108, 2109, 2110, or 2111.

In some embodiments, in block 2102 and in text generators associated with blocks 2109 and 2110, computer system 1700 may apply syllogisms and other elementary logic to detect and avoid contradictions in the output text that it generates. In some embodiments, computer system 1700, in an interactive chat, may apply logic to both sides of a conversation. In some embodiments, computer system 1700 may apply logic to the totality of text that computer system 1700 generates.

In a classification task in any medium, in some embodiments, in block 2102, computer system 1700 may develop logical inference and/or probabilistic inference implementations to use in blocks 412, 413, and 415 of FIG. 4. In some embodiments, computer system 1700 may apply logical inference and/or probabilistic inference to assist in blocks 512, 513, 514, 518, 519, and 521 of FIG. 5.

In block 2102, in some embodiments, computer system 1700 may train the hybrid network to have explicit representations of human knowledge such as mereologies, ontologies, syntax, semantics, published data and books of facts such that in blocks 2105, 2106, 2107, 2108, 2109, 2110, and/or 2111, a human may communication with computer system 1700 in terms of those knowledge representations. For example, in image generation, in some embodiments, a human may interactively specify that the image be of, say, a horse and then be able to specify characteristics of one or more parts of the horse.

In some embodiments, computer system 1700 may implement one or more parametrically controlled autoencoders with specified named features. In some embodiments, computer system 1700 may then be able to implement human commands and/or advice that may be expressed in terms of one or more of the named feature variables. In some embodiments, a named feature may, for example, refer to the color of a part of an object in the foreground or the background of an image being generated by computer system 1700.

In some embodiments, in block 2102, computer system 1700 may incorporate named sets, named features, and autoencoders with named features that have previously been developed as a joint human plus AI task in block 2105 into the hybrid networks currently being developed.

In block 2103, in some embodiments, computer system 1700, may design one or more of the hybrid networks in the AI system to record and report of sources of data used in training generator systems in blocks 2107, 2108, 2109, and 2110 and/or the classifier systems in block 2111. In some embodiments, computer system 1700 may use these records to make citations in the academic publications (block 2110) and wherever else appropriate. In some embodiments, computer system 1700 and/or one or more of the human participants may use these records to adjust hyperparameters and/or other controls to make sure that generated output is different enough from any source material that it does not violate copyrights or constitute plagiarism in any other way.

In block 2104, computer system 1700 and/or the human team may choose one or more of the joint tasks, 2105, 2106, 2107, 2108, 2109, 2110, and/or 2111.

In block 2105, in some embodiments, computer system 1700 may train one or more hybrid classifier networks with named sets and named features. In block 2105, the purpose of the task is to develop the named sets and the named features and to save the named sets and named features along with the subnetworks that implement them in a repository for later use. In block 2105, in some embodiments, computer system 1700 and the human team may increase the amount of human involvement rather than attempt to minimize the amount of human labor in the development.

In block 2105, computer system 1700 may use any of the embodiments discussed in FIGS. 1 to 20, except that in block 2105, computer system 1700, under guidance from the human team, may more actively take advantage of opportunities to request a human name for any unnamed known set or unnamed feature. In some embodiments, greater human guidance for a technique or embodiment discussed in FIGS. 1 to 20 may add extra capabilities, better interpretability, and/or greater sensibility.

In block 2105, in some embodiments, one or more humans may control the training of one or more elements in a network and may specify a named target set for a detector and/or one or both target sets for a discriminator. In some embodiments, the human naming of a target set may replace the search for associated known sets for an element.

In block 2105, in some embodiments, one or more humans may develop software implementing knowledge engineering to be implemented by computer system 1700 in the units and cells for the purpose of placing the knowledge engineering and any network elements necessary to support the knowledge engineering into a repository. In some embodiments, the knowledge engineering may not necessarily be needed for the current system being developed.

In block 2105, in some embodiments, under guidance of the human team, computer system 1700 may develop a parametric synthesizer. For example, computer system 1700 may develop a formant synthesizer for speech. In some embodiments, computer system 1700, may develop a parametrically control autoencoder with a decoder comprising the parametric synthesizer, optionally with additional features.

In block 2105, in some embodiments, computer system 1700 may select a pretrained hybrid network. In some embodiments, computer system 1700 may select one or more discriminator or detector elements not associated with a named set. Computer system 1700 may then provide data item examples of the output of the selected element to one or more humans. In some embodiments, a human may specify a name for the accepted set and/or for the rejected set.

In some embodiments, a human may further label one or more data examples supplied by computer system 1700 as being correct or incorrect instances of the named set. In some embodiments, computer system 1700 may then add an element to the network, in place or in addition to the original selected discriminator or detector element. In some embodiments, computer system 1700 may then train the modified network with the named labels supplied by the human for some of the data items. In some embodiments, computer system 1700 may then supply data examples of the output of a new element in the network to a human for confirmation that the new element correctly classifies the named set to a specified accuracy.

In some embodiments, computer system 1700 may supply examples of the output of a feature variable, such as a variable in a local data space and/or in the bottleneck layer of an autoencoder or of a parametrically controlled hybrid autoencoder. In some embodiments, computer system 1700 may supply additional means to identify the data example that produces the value of the variable, such as the label of the example in training data and/or the full vector of the example in the data space and/or the full input vector to the network.

In some embodiments, computer system 1700 may then request a human name for the feature. Upon request from a human, computer system 1700 may then supply additional examples of the value of the feature variable for data examples from training data with labels as requested by the human. In some embodiments, computer system 1700 may translate from a data space in a first network being analyzed to a data space in a second network, as explained in association with FIG. 14. In some embodiments, computer system 1700 may supply a human with examples from the second network as well as the examples supplied from the first network.

In some embodiments, the human may then specify a name for the feature variable. In some embodiments, computer system 1700 may store in a repository confirmed examples of a named feature variable and of one or more of the subnetworks that can compute the variable from data in a specified data space or a specified mapping to a second data space.

In block 2106, in some embodiments, computer system 1700 may develop one or more hybrid networks to perform a classification task. In block 2106, in some embodiments, computer system 1700 may use named sets and/or named features developed in block 2105. In some embodiments, computer system 1700 may retrieve a named set or feature and its subnetwork from a repository. In some embodiments, computer system 1700 may create one or more named sets and/or named features for elements in the new networks in the context of the specific classification task.

In some embodiments, in block 2106, computer system 1700 may use techniques discussed in association with FIGS. 1 to 20. However, in block 2106, in some embodiments, the development decisions and hyperparameter controls may increase the amount of human involvement and human guidance, as in block 2105, and in contrast to the priorities in many of the embodiments discussed in association with FIGS. 1 to 20. For example, rather than trying to minimize the amount of human labor required for knowledge engineering, in block 2106, computer system 1700 may seek additional opportunity for human knowledge engineering.

In some embodiments, in block 2106, one or more humans may closely monitor and guide the training process. In some embodiments, this guidance may be facilitated by the increase in interpretability of the inner elements in a hybrid network, especially as further enhanced by additional names sets and named features such as developed in block 2105 and block 2106. In turn, the additional human guidance to the development and training process may create additional opportunities to create named sets and named features and to incorporate more human knowledge representations.

In block 2107, an AI system in cooperation with one or more humans may jointly work on a task of reviewing the literature on a specified topic. In block 2107, this review task is for internal use, not for publication as in example (1) in block 2109. As such, the joint task may operate under the standards for free use for research as opposed to the standards for republication of passages from material under copyright.

In some embodiments, the objective of the task in block 2107 is for both the AI system and the human participants to learn from the references found in the review process.

In an illustrative embodiment, the process may start by one or more humans specifying a topic. In some embodiments, a topic may be specified by example of one or more publications on the topic.

In some embodiments, a topic may be specified by one or more key words or phrases. In some embodiments, computer system 1700 may retrieve one or more articles based on occurrence of key words or phrases. In some embodiments, one or more humans may label one or more articles retrieved by computer system 1700 as on topic or as not on topic.

In some embodiments, from an initial set of articles, computer system 1700 may retrieve more articles that are cited in one or more of the retrieved articles. In some embodiments, this retrieval of cited articles may continue with citations from newly retrieved articles until a stopping criterion is satisfied. In some embodiments, one or more humans may label one or more of the articles newly retrieved by computer system 1700 as on topic or as not on topic.

In some embodiments, computer system 1700 may implement the retrieval process in stages intermixed with analysis stages.

In some embodiments, in an analysis stage, computer system 1700 and/or one or more humans may read an article and write a succinct statement of the content of the article. A succinct statement may comprise an abstract of the article, a short summary of the article, a statement of the conclusion of the article, and/or a statement of a new contribution made by the article.

Especially in scientific and engineering research publications, an academic research article may describe the body of previous work and then present only a small number, perhaps only one, new idea or result. In some embodiments, computer system 1700 may represent, in one or more hybrid networks, the new results and links to the prior work. Generally, discussion of prior work will be accompanied with citations, which computer system 1700 may retrieve as additional references, as described in a previous paragraph.

In some embodiments, in block 2107, computer system 1700 may train a text generator to construct a paraphrase of an example phrase, sentence, or set of sentences. In some embodiments, computer system 1700 may train the paraphrase generator on example paraphrases used in the set of retrieved articles. For example, computer system 1700 may train a syntax model and/or a hidden stochastic process model in the cells of a hybrid network to represent the rewordings and word substitutions used when a first article paraphrases a passage from a second article cited by the first article. In some embodiments, computer system 1700 may find multiple instances of such paraphrases in the set of articles retrieved for the target topic. In addition, in some embodiments, computer system 1700 may obtain from a repository a paraphrase model that has been trained on a larger collection of research articles.

The text generated by computer system 1700 in block 2107 is intended to be read by one or more human users during development. In some embodiments, in block 2107, one or more humans may be intended users of the system as well as co-developers of the AI system. In some embodiments, one or more users may be being trained in the use of the AI system. In some embodiments, one or more human users and/or developers may correct a paraphrase and the corrected paraphrase may be used as an example for computer system 1700 to use in further training of one or more of the hybrid networks.

More generally, in some embodiments, one or more human users and/or developers may correct any error in the text generated by computer system 1700.

In some embodiments, one or more human users may read one or more of the cited articles and report one or more passages that the human believes should have been quoted or paraphrased but that were not. In some embodiments, computer system 1700 may use such examples in additional training for one or more of the hybrid networks.

In some embodiments, the main goal may be to train a human student in the art of finding and succinctly summarizing the publications on a specified topic. In such an embodiment, the human student and the AI system implemented on computer system 1700 may work together as a study team, as discussed further in association with block 2108. In some embodiments, a faculty member or senior student may supervise the process of block 2107, assisting both the human student and helping guide the training of the AI system implemented by computer system 1700.

In block 2108, computer system 1700 may implement an AI system that, jointly with one or more human students, forms a study group for a specified course or research topic.

In some embodiments, in block 2108, computer system 1700 may simulate a human student member of a study group for the course.

In some embodiments, computer system 1700 may implement a speech recognition system to transcribe any spoken lectures or videos associated with course. In some embodiments, in block 2108, computer system 1700 may download or otherwise obtain computer readable copies of any written lecture notes or other written material associated with the course, including any textbook or assigned readings. In some embodiments, computer system 1700, like a diligent student, may obtain published work cited in the textbook or assigned reading. In some embodiments, computer system 1700 may also obtain other published work on one or more topics covered in the course. In some embodiments, computer system 1700 may analyze any of the obtained text in the manner described in association with block 2107.

In some embodiments, in block 2108, computer system 1700 may simulate an active member of the student group, with computer system 1700 and one or more human students sharing with each other citations of related work and their analyses of the lectures, written course material and other related work that they may have found.

In some embodiments, in block 2108, computer system 1700 and one or more human students may prepare quiz questions and test each other and fellow members of the study group.

In some embodiments, the AI system participating in a course study group may still be under development. In some embodiments, the human team developing the AI may make corrections to the generation of text by system 1700 in analyses of written material, in draft quiz questions, and/or in answers to quiz questions. In some embodiments, a member of the human development team may also be a student in the course and may be a member of the study group.

In block 2109, in some embodiments, computer system 1700 may implement an AI system that, jointly with one or more human co-authors, may write an academic publication.

In some embodiments, in blocks 2107 and 2109 and example (1) of block 2110, computer system 1700 may include a “style” parameter or hyperparameter in one or more the hybrid networks of the text generator. In some embodiments, computer system 1700 may train a style adjustment subsystem. In some embodiments, a style adjustment subsystem may comprise a subnetwork with an architecture such as illustrated in FIG. 9 for a parametric autoencoder, except, in some embodiments, computer system 1700 may train the style adjustment network with a sentence in one style as the input and an equivalent sentence in a second style as the target of the output, rather than the input being the target as in an autoencoder. In some embodiments of a style adjustment subsystem, computer system 1700 may impose no limit on the number of variables in the set of variables 904 in FIG. 9 because, unlike for an autoencoder, training style adjustment will not train the encoder 902 in FIG. 9 and decoder 905 in FIG. 9 to simply represent the identity function.

In example (1) of block 2109, in some embodiments, computer system 1700 may write, jointly with a human team, a review article on a specified topic. In some embodiments, in block 2109, computer system 1700 may use techniques similar to the techniques used in block 2107, with a few important differences. In block 2109, the human co-authors will take responsibility for correctness of the published review article and certify that it does not comprise plagiarism or infringe any copyrights. Thus, in block 2109 there will be a higher standard, such as putting quotations marks around any text that is a quotation rather than a paraphrase, citing each source, and assuring that each paraphrase correctly characterizes the source. In some embodiments, in block 2109, computer system 1700 may contribute to checking any of these higher standards and may present a draft with backup material and derivations to the human co-authors. However, the human co-authors bear the responsibility and will need to make the final check that everything meets the standards, and that the draft says what the human co-authors wish to say.

In example (2) of block 2109, in some embodiments, computer system 1700, jointly with a human team, may write a research article with new results rather than review article. Even in a research article, most of the text may be a review of prior work on the topic of the research paper. In some embodiments, computer system 1700 may co-author the review part of the article in the same way as a review article, as described in association with example (1). In some embodiments, one or more humans may write a draft and/or the final text of a section describing any new concepts, any new experimental design, and/or the new results. In some embodiments, computer system 1700 may control the experiment and collect the results. In some embodiments, the experiment itself may be implemented in software and the entire experiment may be conducted on a computer system. In some embodiments, there may be a standard format in which a computer conducting an experiment writes up the results. In some embodiments of block 2109, computer system 1700 may write the description of the experiment and the results, with human confirmation of any conclusions or comparisons with prior work.

In example (3) in block 2109, computer system 1700 may co-author a textbook. In an illustrative embodiment, one or more humans may write a list of topics for the textbook. In some embodiments, the list of topics may be like a table of contents, with a list of chapters and, for each chapter, a list of sections, with a topic associated with each section. In addition, in some embodiments, a human may supply one or more references for each topic. In some embodiments, computer system 1700 may also have a set of lecture notes or transcripts of lectures. In some embodiments, computer system 1700 may use speech recognition of an audio or video recording of a lecture to obtain a lecture transcript.

In some embodiments, computer system 1700 may generate the text for each section using a process such as the process described for generating a review article in example (1) of block 2109. In some embodiments, in generating the text of a section of a textbook, computer system 1700 may use a style adjustment subsystem trained to generate in the style of a textbook, which may be different from the style of a review article (example 1) or of a research article (example 2). In some embodiments, the style adjustment subsystem may be trained on examples of textbooks written in the desired style but on different topics.

In some embodiments, computer system 1700 may implement multiple rounds of iterative improvement. In some embodiments, computer system 1700 and the human co-authors may do a first draft of a section and then additional drafts until the human team is fully satisfied. In some embodiments, computer system 1700 and the human team may finish early drafts of multiple sections and paragraphs and then return each section for further improvement. In some embodiments, computer system 1700 and the human team may deploy a draft in a course to collect data to guide further improvements.

In example (4) of block 2109, computer system 1700, jointly with a human team, may produce material for an interactive course. In some embodiments, computer system 1700 may base the interactive course on one or more existing textbooks. In some embodiments, computer system 1700 may first create a textbook, as described in example (3). However, a textbook produced by computer system 1700 in example (3) for use in example (4) will not necessarily be published, which may simplify the production of such an internal-use-only textbook. In some embodiments, computer system 1700 may make substantial modification to the presentation of the course material based on measuring the effectiveness of the material in interactive presentations to students, as will be discussed further in the following paragraphs.

In some embodiments, computer system 1700 may break the material into shorter units than sections in a textbook. A unit may be a snippet, a paragraph, or longer. However, in some embodiments the maximum size of a unit may be limited to the amount that can be displayed on a computer screen or may be limited to the amount that can be displayed on the screen of a handheld device such as a smart phone.

In some embodiments, computer system 1700 may incorporate some interaction with the student for each unit. For some units, the interaction may be as simple as having the student press a key or click a mouse button to continue to the next unit.

In some embodiments, in some units, computer system 1700 may require the student to select from a menu of choices.

In some embodiments, in some units, computer system 1700 may ask a question and require the student to type or speak an answer or to select an answer from a multiple-choice menu.

In some embodiments, after a longer unit or a plurality of shorter units, computer system 1700 may present the student with a short quiz comprising a plurality of questions.

In some embodiments, computer system 1700 may allow the student the choice of what to do next. For example, in some embodiments, computer system 1700 may allow the student to request additional information on the current subject. In some embodiments, in a course about computer science or a course in any subject in which computers are used, computer system 1700 may allow a student to ask for an example of software related to the current lesson. In some embodiments, computer system 1700 may allow a student to ask a question. In some embodiments, computer system 1700 may allow a student to request that one or more previous units be repeated.

In some embodiments, the human instructors and/or computer system 1700 may prepare more advanced optional material. In some embodiments, computer system 1700 may allow a student to choose to receive more advanced material.

In some embodiments, the human instructors and/or computer system 1700 may prepare more elementary material. In some embodiments, computer system 1700 may allow a student to choose to receive the more elementary material.

In some embodiments, computer system 1700 may let each student proceed at their own pace.

In some embodiments, computer system 1700 may present longer quizzes or tests.

In some embodiments, computer system 1700 may record the answers to individual questions, short and long quizzes, and tests. In some embodiments, computer system 1700 may use the answers to questions, quizzes, and selected tests to judge the effectiveness of the presented material rather than, or in addition to, judging the progress of the student. In some embodiments, computer system 1700 may flag one or more pieces of material to be rewritten and improved. In some embodiments, computer system 1700 may present a different version of a piece of material to measure the relative effective of each version. In some embodiments, computer system 1700 may implement an incremental improvement process. In some embodiments, computer system 1700 may coordinate the selection of versions of multiple pieces of the material. In some embodiments, computer system 1700 may use a systematic exploration process such as reinforcement learning to find the best sequence of versions of the material. In some embodiments, computer system 1700 may customize the sequence of presentation of material to the individual student.

In some embodiments, computer system 1700 may prepare alternate paths through the material for a course. In some embodiments, computer system 1700 may allow the student to choose an individualized path. For example, in some embodiments, computer system 1700 may allow a student at the end of a topic to choose which topic to do next. In some embodiments, computer system 1700 may allow a student to choose whether to do a more advanced version. In some embodiments, computer system 1700 may allow a student to choose whether to do a more elementary version.

In some embodiments, for selected lessons, computer system 1700 may work with a student like co-members of a study group, as discussed in association with block 2108.

In some embodiments, computer system 1700, for some lessons, may allow a student to choose between a written presentation, an audio presentation, or a video presentation.

In some embodiments, computer system 1700 may judge the quality and effectiveness of the material as much as, or more than, the performance of individual students. Providing multiple versions of each lesson not only provides each student with more control, but it also provides computer system 1700 with more information to compare alternate presentations and to continually improve the course material.

In some embodiments, computer system 1700 may implement an on-going development process in which computer system 1700 and the human faculty and senior student developers continue to make step-by-step improves to the instructional material based on the data collected during the use of the interactive system by students in the course. In some embodiments, computer system 1700 may enable the students to suggest and/or test changes during the course.

In block 2110, in some embodiments, computer system 1700, jointly with a human team, may produce a creative work, which, by way of example, may be (1) written, (2) visual, (3) music, or (4) an audio book.

In example (1) of block 2110, computer system 1700, jointly with a human team, may produce a creative written work. For example, the written work may be a poem, a short story, or a novel.

In training an AI system comprising one or more hybrid networks to generate poetry, in some embodiments, computer system 1700 may train a first hybrid network to translate the statements in a poem to prose. In various embodiments, computer system 1700 may use one or more of several methods for the translation of poetry to prose.

In some embodiments, computer system 1700 may train a general-purpose translation system to translate from poetry to prose as if translating from one language to another.

In some embodiments, computer system 1700 may train a hybrid network to represent the grammar of prose in the cells of the network. Computer system 1700 may then train the hybrid network to rearrange the word order and, perhaps, make some word substitutions to generate the most probable word sequence from the words in the poem.

In some embodiments, computer system 1700 may model the difference between a poem and the corresponding prose as a change of style. In some embodiments, computer system 1700 may train a style adjustment network to convert a poem to prose.

With any of the methods of converting a poem to prose, in some embodiments of joint development with a human team, a human may review and edit the prose produced from a specified piece of poetry. In some embodiments, computer system 1700 may do additional training of one or more hybrid networks with the edited text as the target output.

In some embodiments, computer system 1700 may use the examples of paired poetry and prose produced by translating poetry to prose as training data for training a system to translate prose to poetry. In some embodiments, computer system 1700 may use this and other training data to train a style adjustment system to convert prose to poetry. In some embodiments, in producing poetry, computer system 1700 may represent, in a hybrid network, human knowledge representations of some of the rules of specific forms poetry, such as rules of rhyme, rhythm, a meter.

In some embodiments, computer system 1700 may train a style adjustment network for a plurality of prose writers and a plurality of poets. In some embodiments, computer system 1700 may train a separate style adjustment network for each of a plurality of selected pairings of a prose writer and a poet. In some embodiments, computer system 1700 may train multiple style adjustment networks. In some embodiments, computer system 1700 may co-train a plurality of style adjustment network using soft-tying or knowledge sharing links between corresponding variables in blocks 903 and 904 of a style adjustment network using the architecture illustrated in FIG. 9.

In some embodiments, computer system 1700 may train a customized style model for a selected poet. In some embodiments, computer system 1700, from a single specified piece of prose, may produce poems in the style of each of a plurality of poets by using a customized decoder 905 trained to each poet.

In some embodiments, computer system 1700 uses a similar process to translate the prose of an author with a distinctive style to the style of a different author.

In example (2) of block 2110, computer system 1700, jointly with a human team, may train an AI system to produce images, videos, and/or other creative visual works.

In some embodiments, computer system 1700 may first train an image classifier with mereology models for an arbitrarily large specified set of objects. In some embodiments, computer system 1700 may train a mereology with attributes modeling the relative positions of pairs and sets of parts as viewed from a plurality of viewpoints.

In some embodiments, computer system 1700 may then train a parametrically controlled generator comprising parameters from a mereology with associated attributes.

In some embodiments, computer system 1700 may include additional parameters specifying additional attributes such as color and texture. In some embodiments, computer system 1700 may train a network to produce an image with a plurality of objects and include parameters specifying the relative positions of the objects.

In some embodiments, computer system 1700 may implement a user interface such that a user may specify named the objects to be included in the image. In some embodiments, computer system 1700 may implement in the user interface a capability for the user to specify a location within the image by pointing. In some embodiments, computer system 1700 may present a draft image to a user and enable the user to move objects around and to make other changes to the image.

In some embodiments, rather than computer system 1700 generating a complete image to which a human co-created make request changes, computer system 1700 may organize the user interface as a step-by-step interaction with the co-creator, with the co-creator able to make changes at each step.

In example (3) of 2110, computer system 1700, jointly with a human team, may train an AI system to produce music customizable by an individual end user.

In some embodiments, computer system 1700 may obtain or train a music synthesizer. Computer based music synthesizers are well known to those skilled in the art creating digital simulations of musical instruments.

In some embodiments, computer system 1700 may then train a parametrically controlled autoencoder with a decoder comprising the music synthesizer.

In some embodiments, computer system 1700 may train a second parametrically controlled autoencoder with parameters that may be easily understood and controlled by an amateur user without expert training. In some embodiments, computer system 1700 may construct and train a compound autoencoder with two parametrically controlled encodings. In some embodiments, computer system 1700 may train a mapping from the amateur encoding to the synthesizer encoding using the data space mapping procedure illustrated in FIG. 14.

In some embodiments, computer system 1700 may then construct a generator with input from the amateur encoding mapped to the synthesizer encoding and then decoded to music.

In some embodiments, computer system 1700 may construct a user interface by which a music aficionado can customize a musical rendition to their personal pleasure. In some embodiments, computer system 1700 could use a parametrically controlled autoencoder with a selected musical piece as input. In such an embodiment, the user may adjust the performance to optimize it for their personal listening pleasure by changing parameters in the amateur encoding in the parametrically controlled synthesizer. For example, a music aficionado who has become hard of hearing could adjust the performance with different customized enhancements for specified instruments and/or customized adjustments for specified musical passages. Such a system would give the user much greater control of the music as they perceive it. It would be better than would be achievable by any system with more limited controls, such as a hearing aid.

In some embodiments, the system may be used by a professional composer to orchestrate an original composition. In some embodiments, a professional composer may participate in training a customized AI music generation system.

In some embodiments, rather than computer system 1700 generating a complete musical to which a human co-created make request changes, computer system 1700 may organize the user interface as a step-by-step interaction with the co-creator, with the co-creator able to make changes at each step, as in example (2).

In example (4), computer system 1700, jointly with a human team, may create a recording of an audio book.

In some embodiments, computer system 1700 may obtain the text of a selected book with the task being to reduce the time and labor required to produce a quality audio recording of the book. In some embodiments, the task may be to produce a recording of the text in a particular person's voice. For example, the recording might be in the voice of a grandparent as a gift to a grandchild.

Even audio books recorded by professional recording artists typically require hours of human labor to listen to the recording, edit out mistakes and noise, and rerecord selected passages as needed.

In some embodiments, computer system 1700 may train a network to align a recording of a known script, for example, by using the methods discussed in association with FIG. 12 and block 417 of FIG. 4. From the known script and the alignment, computer system 1700 can easily detect noise and deviations from the specified script. Even with rerecording of some passages, this embodiment would greatly reduce the additional labor of post-production.

In some embodiments, computer system 1700 may also avoid the labor of the person reading the book to make the recording.

In some embodiments, computer system 1700 may train a speech synthesizer for an individual's voice. For example, in some embodiments, computer system 1700 may train a parametrically controlled autoencoder for an individual's voice from sample recordings of that individual's voice. In some embodiments, the parametrically controlled autoencoder may include parameters that determine prosodics and other things that may change details of sound of the same word in the same person's voice in different contexts.

In some embodiments, computer system 1700 may use the decoder of the parametrically controlled autoencoder as a parametric speech synthesizer.

In some embodiments, computer system 1700 may also train a model mapping from written text to controls for a parametrically controlled synthesizer in order to learn features that depend on the text, such as prosodics. In some embodiments, computer system 1700 may train this mapping from a database of thousands audio books recorded by a wide variety of readers.

In some embodiments, computer system 1700 may combine the mapping from written texts to the controls of a parametrically controlled speech synthesizer to a speech synthesizer customized to an individual's voice. Then computer system 1700 may produce one or more new personal audio books in the individual's voice without the labor of reading the books and of rerecording errorful passages. This system may be used by self-published authors who wish to reduce the expense of producing audio books for books that they write. It may be used by publishers to reduce the cost of producing audio books. It could be used by a grandparent to produce recording of out-of-copyright children's classics as keepsakes for their grandchildren. An author or grandparent might need to record several hours, perhaps one book, as training data to train the parametric speech synthesizer to their voice. After that they could produce additional audio books in their voice without additional recording.

In block 2111, in some embodiments, computer system 1700 may train an AI system to jointly produce computer code with a student such that the student is an active participant in the process and learns from the experience, in contrast to the use of a fully automatic code generator.

In some embodiments, computer system 1700 may obtain a repository of books, articles, blogs, and tutorials with example code. In some embodiments, computer system 1700 may use the techniques discussed in association with blocks 2107, 2108, and example (4) of block 2109 to make the joint production of the code a good learning experience for the student.

In some embodiments, computer system 1700 may verify that the student understands the algorithm being implemented, how it is used, and what it does, by asking the student questions as in example (4) of block 2109.

In some embodiments, computer system 1700 may provide controls to the instructor of a course with documentation to verify that the student is learning the material and not just copying online code or using an automatic code generator without understanding anything.

In some embodiments, computer system 1700 may keep track of and cite the sources of code samples, as discussed in association with blocks 2107 and 2109.

In some embodiments, in block 2111, computer system 1700 may train and/or use an AI system to jointly produce computer code with a more experienced code developer, such as an experienced software engineer. In such embodiments, the human code developer may exercise greater control of the software development process. In some embodiments, the human developer may write specifications for the program to be developed. In some embodiments, the human developer may specify unit tests that are to be performed to verify the correctness of the developed software. In some embodiments, the human developer may write pseudo-code to specify the functionality of the software.

In some embodiments, in block 2111, computer system 1700 may use an AI system trained to jointly produce computer code with a scientist or engineer who is experienced in specifying algorithms, but who is not a professional software engineer. In such an environment, the scientist of engineer may express the desired program in terms of mathematical equations or other forms that the scientist or engineer might use to communicate the ideas to a human colleague. In some embodiments, computer system 1700 may train the AI system to translate such equations into program code. In some embodiments, computer system 1700 may train the AI system to use existing software libraries and frameworks that are designed for scientific and engineering computations. In preferred embodiments, the scientist or engineer would not need to know or learn the calling conventions of the library functions or even the names of the library functions. In some embodiments, the AI system may also specify and code unit tests.

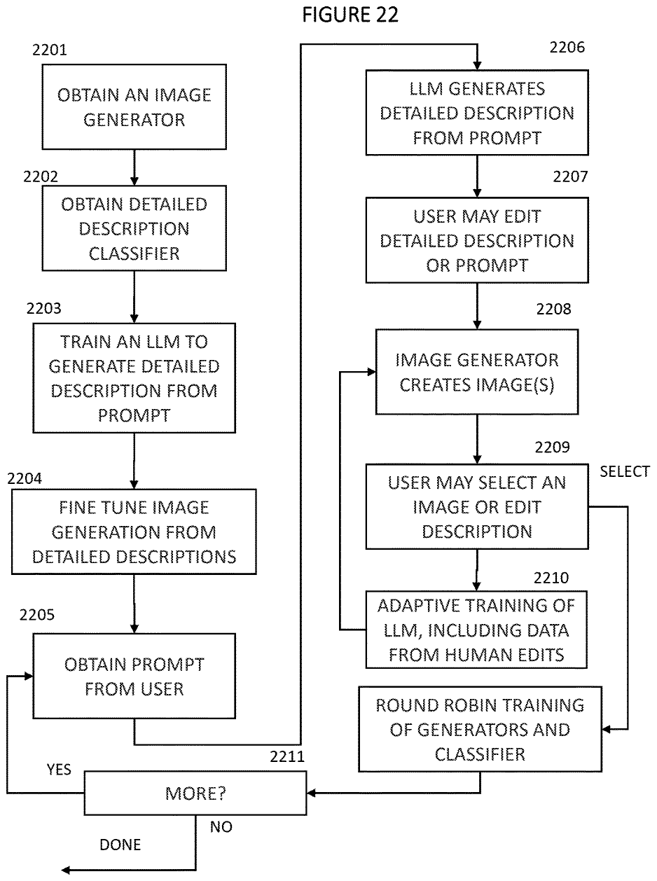

FIG. 21A is a drawing of an example of a feed forward neural network. In this discussion, a neural network comprises a network of nodes organized into layers: a layer of input nodes, zero or more inner layers of nodes, and a layer of output nodes. There is an input node associated with each input variable and an output node associated with each output variable. An inner layer may also be called a hidden layer. A given node in the output layer or in an inner layer is connected to one or more nodes in lower layers by means of a directed arc from the node in the lower layer to the given higher layer node. A directed arc may be associated with a trainable parameter, called its weight, which represents the strength of the connection from the lower node to the given higher node. A trainable parameter is also called a “learned” parameter. Each node is also associated with an additional learned parameter called its “bias.” Other parameters that control the learning process are called “hyperparameters.” The neural network illustrated in FIG. 22 has an input layer, an output layer, and three hidden layers.

A conventional neural network node is essentially a computational unit. In the context of a typical neural network layer, each node performs two main operations: an affine transformation and an activation function. The affine transformation involves taking a weighted sum of the input values along with their respective weights and adding a bias term. After the affine transformation, the node applies an activation function, which introduces non-linearity to the output. Common activation functions include ReLU (Rectified Linear Unit), sigmoid, tanh, etc. This function helps the network learn complex patterns and relationships within the data. Together, these operations enable each node to process incoming information and produce an output that is then fed into the next layer of the neural network.

A neural network, such as shown in FIG. 21A, is typically trained via gradient descent or stochastic gradient descent. In both, learned parameters are updated in an iterative manner to minimize and error function. Training a neural network by gradient descent involves adjusting the networks parameters to minimize a chosen loss function. Backpropagation, a key step in this process, computes the gradient of the loss function with respect to each parameter using the chain rule of calculus. In a forward pass, during training, input data propagates forward through the network layer by layer. Each layer performs computations using its weights, biases, and activation functions to generate an output. Then, the output of the neural network is compared to the actual target values using a loss function, which measures the network's performance. Common loss functions include mean squared error or cross-entropy, depending on the problem. Then, a backward pass or “backpropagation” phase is undertaken. After calculating the loss, the network works backward to compute the gradient of the loss function with respect to each parameter in the network. This is done using the chain rule to calculate how much each parameter contributed to the overall error. This process involves computing partial derivatives at each layer while moving backward through the network. The chain rule allows for the calculation of how much each parameter affects the final error. Derivatives indicate the rate of change of a function concerning its variables. In this case, they show how much the loss function changes concerning small changes in the network's parameters. These derivatives are fundamental in guiding the updates made to the parameters during the gradient descent process. By adjusting parameters in the direction opposite to the gradient, the network aims to minimize the loss, thus improving its performance. With the gradients known, the network parameters can be updated in the opposite direction of the gradient to minimize the loss function. This step involves multiplying the gradients by a learning rate (a hyperparameters that controls the size of the update) and subtracting this from the current parameter values. These steps can be repeated for multiple epochs or iterations until the network converges to a state where the loss is minimized, or until a stopping criterion is met.

While with gradient descent, all of the training samples in the training set are run through to do a single update for a parameter in a particular iteration, with stochastic gradient descent, on the other hand, only one or a subset of training sample are used from the training set to do the update for a parameter in a particular iteration. If a subset is used, it is called “Minibatch Stochastic gradient Descent.” Thus, if the number of training samples are very large, then using gradient descent may take too long because in every iteration when you are updating the values of the parameters, you are running through the complete training set. On the other hand, using stochastic gradient descent will be faster because one training sample is used and it starts improving itself right away from the first sample. Stochastic gradient descent often converges much faster compared to gradient descent but the error function is not as well minimized as in the case of gradient descent.

FIG. 22 is a flow chart of an illustrative embodiment of the training and use of a system for image generation with human guidance.

In block 2201, computer system 1700 obtains a pretrained prompt-based image generator or trains a prompt-based image generator. For example, the image generator may be based on diffusion, latent space diffusion (also called “stable diffusion”), or consistency modeling, all of which are methods of image generation from prompts that are well known to those skilled in the art of artificial intelligence for image generation. In some embodiments, computer system 1700 may train such a system from scratch. In some embodiments, computer system 1700 may obtain an image generation system by fine-tuning a pretrained image generation system. Fine-tuning an image generation system is well known to those skilled in the art of generative AI.

In block 2202, computer system 1700 may obtain a system trained to analyze an image, classify the objects in the image, and write a detailed description of the image.

In some embodiments, computer system 1700 may train such a system from scratch. In some embodiments, computer system 1700 may combine multiple subsystems specialized in aspects of the task of generating a detailed description of the image and then fine-tune the combined system.

In block 2203, computer system 1700 trains a large language model (LLM) text generator to generate a detailed description of an image that is to be generated given a prompt or a less detailed description. LLMs for text generation from a short prompt are well known to those skilled in the art of large language models. In some embodiments, computer system 1700 may fine tune a pretrained LLM, such as GPT-3, GPT-4, LaMDA, BLOOM and/or LLaMA, or some other LLM, using examples of pairs of short descriptions and longer, detailed descriptions.

In block 2204, computer system 1700 optionally fine tunes an image generation system to generate images from detailed descriptions. In some embodiments, computer system 1700 may use as training data a set of images with each image paired with a detailed description produced by the system obtained by computer system 1700 in block 2202. In some embodiments, computer system 1700 may obtain a pretrained system for generating an image from a detailed description.

In block 2205, computer system 1700 obtains a prompt or short description from a user.

In block 2206, computer system 1700 uses the text generation system trained in block 2203 to generate a detailed description of the desired image from the prompt or short description obtained from the use in block 2205.

In block 2207, computer system 1700 enables the user to edit the detailed description.

In block 2208, computer system 1700 uses the image generation system fine tuned or obtained in block 2204 to generate one or more images based on the detailed description.

In block 2209, computer system 1700 presents the images generated in block 2208 to the end user and enables the end user to select an image or to edit the detailed description. If the user selects an image, computer system 1700 proceeds to block 2211. If the user edits the detailed description, computer system 1700 proceeds to block 2210.

In block 2210, computer system 1700 does additional fine tuning to adaptively train the LLM obtained in block 2204 using the edited detailed description created in block 2209 as training data. In training during use or lifelong training, in some embodiments, computer system 1700 may include data from user edits in the training data. In some embodiments, computer system 1700 may use contrastive training to increase the likelihood of generating a detailed description similar to the edited detailed description and to decrease the likelihood of generating a detailed description like the unedited description. Contrasting training is well known to those skilled in the art of machine learning. From block 2210, computer system 1700 returns to block 2208.

In block 2211, computer system 1700 determines whether to obtain an additional prompt from either the current user or from a new user based on the desire of the user and/or other specified criteria.

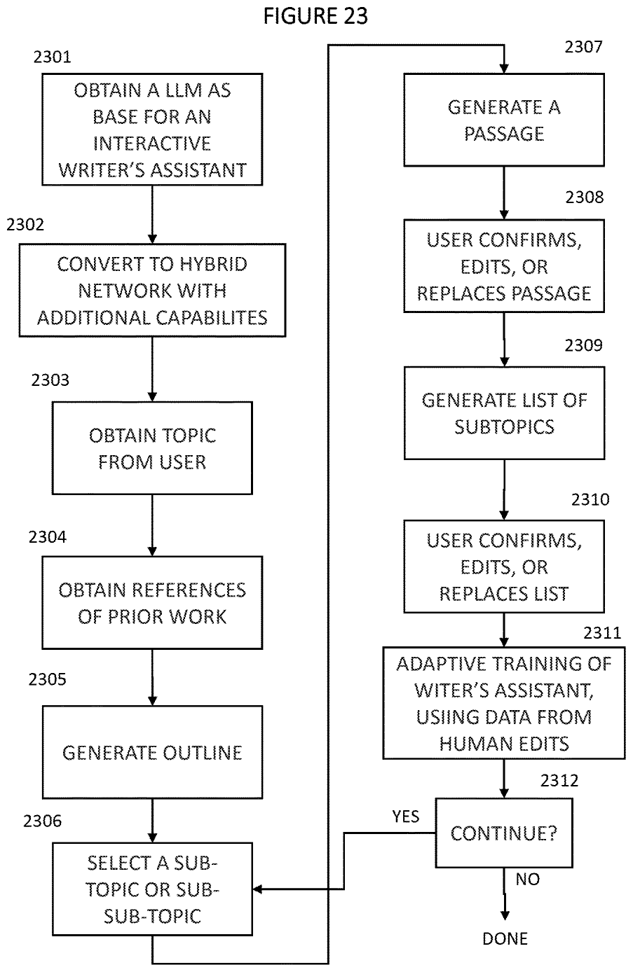

FIG. 23 is a flow chart of an illustrative embodiment of the process of building and training of an interactive, human-guided writer's assistant.

In block 2301, computer system 1700 obtains a large language model (LLM) to use as the base for building and training an interactive, human-guided writer's assistant. The large language model may be a pretrained large language model or may be a more specialized language model obtained by fine tuning a pretrained large language model to a domain selected by the user. In some embodiments, computer system 1700 may also fine-tune a general-purpose large language model to the task of generating a list of relevant subtopic for a specified topic, a capability that may be used in block 2305.

In block 2302, computer system 1700 optionally converts the large language model network to a hybrid neural network. For example, computer system 1700 may use cells in the units of the hybrid network to represent a context-free or finite state probabilistic grammar. For example, computer system 1700 may use cells to represent a probabilistic finite state grammar. In some embodiments, computer system 1700 may train a hidden Markov process to represent the probabilities of the finite state grammar and to compute the maximum likelihood parse of any example sentence. In some embodiments, computer system 1700, train a model for a probabilistic context free grammar using the inside-outside algorithm [ref: J. Baker (1979): Trainable grammars for speech recognition. In J. J. Wolf and D. H. Klatt, editors, Speech communication papers presented at the 9^{7t}h meeting of the Acoustical Society of America, pages 547-550, Cambridge, MA, June 1979. MIT.]

In some embodiments, computer system 1700 may use cells in the hybrid network to represent part-of-speech labels. In some embodiments, computer system 1700 may use cells in the network to represent alternate definitions of a written word. In some embodiments, computer system 1700 may use m-gram, skip-gram, and other context-based word count statistics to supplement the attention-based weights in a LLM with a transformer architecture.

In block 2303, computer system 1700 obtains a topic from the user. In preferred embodiments, the topic is the overall topic of the planned document. The intended document may be a few paragraphs, or it may be an entire book.

In block 2304, computer system 1700 may obtain references to prior works. In some embodiments, the prior works may comprise prior works by the current user. In some embodiments, computer system 1700 may use these prior works by the current user to learn the style and word usage of the current user. In some embodiments, the prior works may comprise works by other authors on the topic obtained in block 2303 and related topics.

In block 2305, computer system 1700 generates a high-level outline and/or table of contents for the planned document. In some embodiments, computer system 1700 may use the topic obtained in block 2303 as the prompt for a subtopic generator as described in block 2301. In some embodiments, computer system 1700 may generate a list of subtopics from one or more of the prior works obtained in 2304.

In 2306, computer system 1700 may select a subtopic from the list generated in block 2305. In later passes through the loop from block 2306 to block 2312, computer system 1700 may select a sub-subtopic from a list generated in block 2309 in a previous pass through the loop from block 2306 to block 2312. In some embodiments, computer system 1700 may select a subtopic in a specified order from the tree of subtopics generated so far. In some embodiments, computer system 1700 may select a subtopic at random or based on some criterion specified by the user or by the cooperative learning management system.

In block 2307, computer system 1700 generates a passage of text of specified length, such as a paragraph. In some embodiments, the specified length may be less than a paragraph. In some embodiments, the length of the passage may be more than a paragraph. In some embodiments, computer system 1700 may determine the length of the passage through the LLM generating an end-of-passage symbol.

In block 2308, computer system 1700 enables the user to confirm the passage as generated in block 2307, to edit the passage, or to replace the entire passage. That is, the user may maintain complete control of the final document being created with no more intervention than the user desires.

In block 2309, computer system 1700 selects the main topic or a subtopic and generates a list of subtopics of the selected topic or subtopic.

In block 2310, computer system 1700 enables the user to confirm, edit, or replace the list of subtopics generated in block 2309.

In block 2311, in some embodiments, computer system 1700 may perform adaptive training of the large language model based on the changes or lack of changes made by the user in blocks 2308 and/or 2310.

In block 2312, computer system 1700 determines whether to continue or terminate the generation process. In some embodiments, the determination may be made by the end user. In some embodiments, the termination may be determined by computer system 1700 based on a criterion controlled by hyperparameters specified by the system design or by the cooperative learning management system. In some embodiments, the user may override a termination determined by computer system 1700. If the determination is to continue, computer system 1700 returns to block 2306, otherwise the process illustrated in FIG. 23 is done.

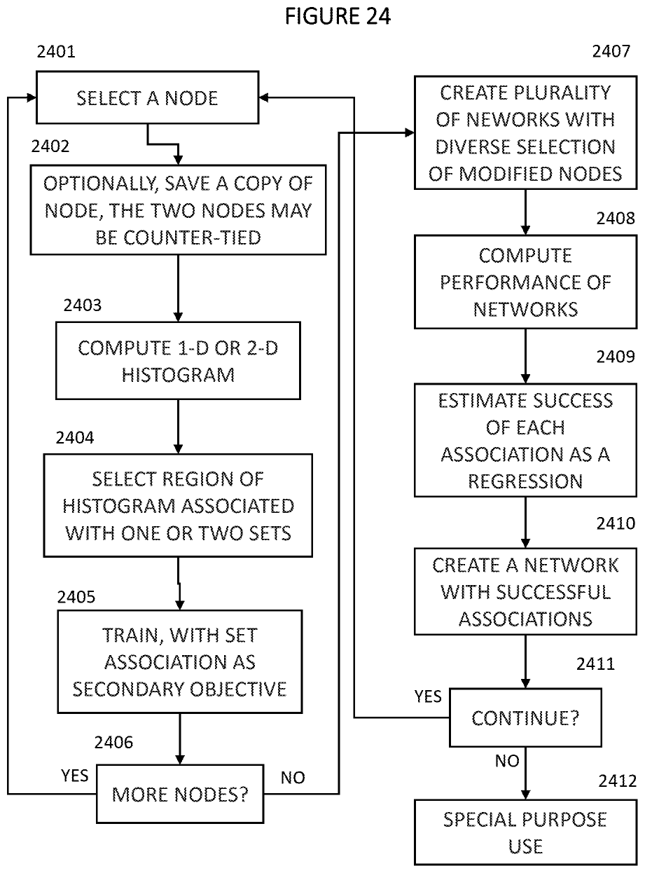

FIG. 24 is a flow chart of an illustrative embodiment of a process for training a selected node to be more interpretable.

In block 2401, in some embodiments, computer system 1700 selects a node to be made more interpretable. The selected node may be a node in the original network, or it may be a node that has been added to the network in block 2402 during a previous pass through the loop from 2401-2406.

In block 2402, in some embodiments, computer system 1700 optionally adds an additional node to the network and initializes the new node to have the same connections and weights as the selected node. In some embodiments, computer system 1700 may counter-tie the two nodes during subsequent training. In some instances, computer system 1700 may also counter-tie the new node to other nodes from previous passes through loop 2401-2406.

In block 2403, in some embodiments, computer system 1700 computes a 1-dimensional or a 2-dimensional histogram. For example, for each of a specified set of data items, computer system 1700 may determine the value of the input to the activation function of the node and/or the value of the back propagated derivative of the network objective function. Computer system 1700 may then accumulate counts for a 1-dimensional or 2-dimensional histogram. In some embodiments, computer system 1700 may determine a name to be associated with each data item. For example, in a classification task, for each item of training data, computer system 1700 may associate with a data item the name of the target category for the output. In the case of a generative AI system that generates text or an image from a natural language prompt, the name may be one or more key words in the prompt. In some embodiments, computer system 1700 may also associate one or more key words from the prompt with any text or image that is generated from the prompt.

In block 2404, in some embodiments, computer system 1700 may select a region of the histogram comprising examples of one or more selected sets. Preferably, each set will be a named set. In some embodiments, a selected set may be a known set that has been selected to become a named set. For each of the selected sets, computer system 1700 may specify whether the new node is to be associated with the set or the complement of the set.

In block 2405, in some embodiments, computer system 1700 may continue or resume the training of the system with regularization imposed on the new node to train to have an activation value for each data item that is in better agreement with the data item being a member or not being a member of the corresponding selected set. In some embodiments, computer system 1700 may impose a regularization on the new node to discriminate between two named sets or sets to be named.

In block 2406, based on specified criteria, computer system 1700 determines whether to add an additional node to the set of nodes. For example, the system design or the HNLMS may specify a parameter limiting the maximum number of nodes before testing the modified network comprising the new nodes with tentative associations with known sets. In some embodiments, computer system 1700 may check a stopping criterion based on precision and recall measurements for the tentatively associated sets within the selected region of the histogram.

In block 2407-2410, computer system 1700 tests the tentative associations made in block 2401-2406.

In block 2407, in some embodiments, computer system 1700 may create a plurality of networks. In some embodiments, for each specific network in the plurality of networks, for each node selected in block 2401, computer system 1700 may randomly select whether the specific network is to comprise only the original node, to comprise only the new node, or to comprise both.

In block 2408, computer system 1700 may test the performance of each of the plurality of networks.

In block 2409, computer system 1700 may compute a regression on the measured performance of a network in the plurality of networks as a function of the Boolean variables indicating for each selected node whether the selected node and/or the corresponding new node has been included in the network. In some embodiments, computer system 1700 may then use the regression coefficients of performance to decide, for each node selected in block 2401 whether to include the only the selected node, only the new node, or both in the network to be created in block 2410.

In block 2410, computer system 1700 creates and further trains a new network with nodes selected made in block 2409. In some embodiments, computer system 1700 may create and train a plurality of networks making varying choices for alternate node selections based on measurements made in blocks 2408 and 2409. In some embodiments, computer system 1700 may use each of the plurality of networks separately. In some embodiments, computer system 1700 may fine tune each of the plurality of networks for a different task or on different data. In some embodiments, computer system 1700 may form an ensemble of a plurality of the networks tested in blocks 2408 and 2409. In some embodiments, computer system 1700 may build a single network out of a plurality of networks by adding connections from nodes in one network to another.

In block 2411, computer system 1700 determines, based on specified criteria, whether to continue the process of selecting nodes for which to apply the process of improving the interpretability of the selected nodes. If so, computer system 1700 returns to block 2401, otherwise computer system 1700 proceeds to block 2412.

In block 2412, in some embodiments, computer system 1700 may use the networks created in blocks 2407 and 2410 for one or more special uses. For example, in some embodiments, computer system 1700 may use the plurality of networks created in block 2407 or a selected subset of those networks as an ensemble. In some embodiments, computer system 1700 may repeatedly select the same node in block 2401 and thus create and train more than two homologous nodes associated with distinct named sets. In some embodiments, computer system 1700 may use either an ensemble or the single network with additional nodes for a training process of incremental growth, such as discussed in association with blocks 101 and 103 of FIG. 1, blocks 504 and 524 of FIG. 5, and block 605 of FIG. 6.

In some embodiments, in block 2401, computer system 1700 may select a node in a latent variable space, such as the latent variable space in an autoencoder. In some embodiments, computer system 1700 may add some or all of the new nodes without limiting the nodes based on the performance test of blocks 2409 and 2410. The addition of nodes to a latent variable space always increases the representation ability of the space. In subsequent training of the autoencoder, the association of nodes with specific sets may usefully restrict the representation in ways complementary to the restriction of lower dimensionality. In some embodiments, computer system 1700 may use nodes associated with named sets as named features. In some embodiments, computer system 1700 may use the named features as features in a parametrically controlled autoencoder, as discussed in association with FIG. 9.

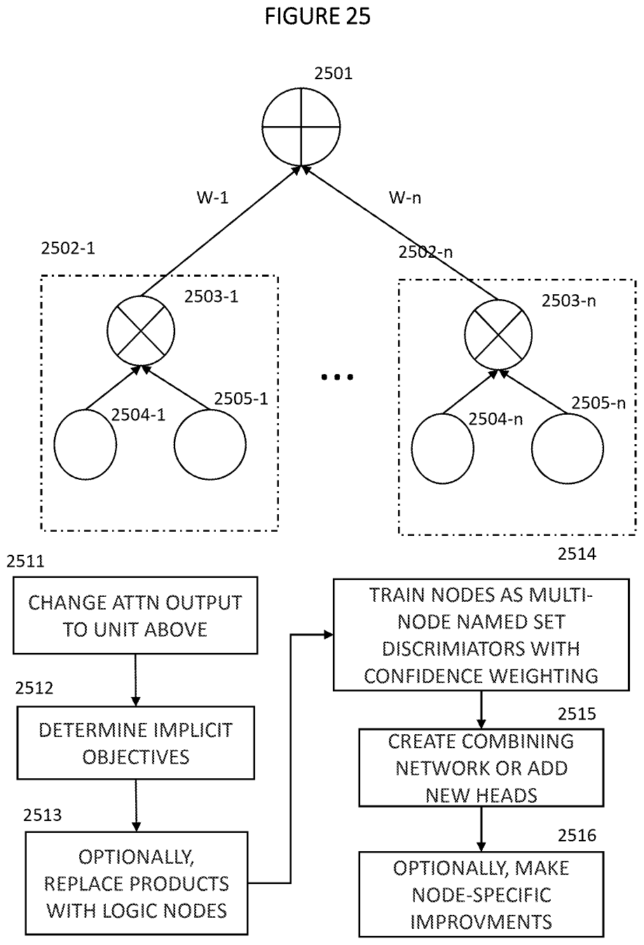

In some embodiments, computer system 1700 may use an autoencoder with labeled features or the encoder of an autoencoder for word embedding as used in prompt-based generative AI systems. In some embodiments, computer system 1700 may use an autoencoder with labeled features as a denoising autoencoder such as used in image generation by diffusion. Word embeddings and denoising autoencoders are well known to those skilled in the art of generative AI. In some embodiments, computer system 1700 may use multi-node named-set discriminators in the output of an attention block in a transformer, as discussed in association with blocks 2514 and 2515 of FIG. 25. Transformer networks are well known to those skilled in the art of large language model neural networks.

FIG. 25 is a diagram and a flow chart of an illustrative embodiment of a process of replacing an attention block output node with a multi-node unit and of training the nodes in the unit to be interpretable. An attention block output node computes a weighted correlation between two n-tuples of the form

$$V = {\sum }_{i = 1}^{n} {w}_{i} {X}_{i} {Y}_{i} ,$$

where Xᵢ and Yᵢ are data n-tuples, and wᵢ are a set of weights. In some embodiments, the weights are learned parameters to be trained.

Element 2501 represents the summation of the product terms in the weighted autocorrelation computation.

Dash-dot blocks 2502-1 to 2502-n represent the n product terms.

Nodes 2504-1 to 2504-n represent the n values in the n-tuple X.

Nodes 2505-1 to 2505-n represent the n values in the n-tuple Y.

Elements 2503-1 to 2503-n represent the n element-by-element products.

The connections weights w-1 to w-n represents the multiplication by the n weights

In block 2511, in some embodiments, computer system 1700 may change one or more output nodes in an attention block to a multi-node unit in the form illustrated by 2501 and 2502-1 to 2502-n, representing n subunits, one for each term in the weighted correlation.

Representing the weighted correlation computation as a multi-node unit enables computer system 1700 to apply many of the techniques discussed in this disclosure for computer system 1700 to improve the performance and/or the interpretability of a node. For example, computer system 1700 may determine the derivative of a back propagated objective and thus a local target for any of the nodes in FIG. 25. Other examples are discussed in association with blocks 2512 and 2514.

In block 2512, in some embodiments, computer system 1700 may determine an implicit local objective and implicit errors for any of the nodes in FIG. 25 based on the activation value and the value of the back propagated derivative, as discussed, for example, in the definitions and blocks 203 and 210 of FIG. 2.

In block 2513, computer system 1700 may optionally replace the product elements 2503-1 to 2503-n with logic nodes. For example, if the incoming values are in the interval [0, 1], computer system 1700 may replace the product node with a neural node trained to approximate the logical AND function. If the incoming values are in the range [−1, 1], computer system 1700 may replace the product node with an XOR node or with an activation function such as 1−|X−Y|. The logic nodes approximate the qualitative aspects of the product in these value ranges and may be easier to interpret. Other techniques in this invention may also more easily apply to the logic nodes.

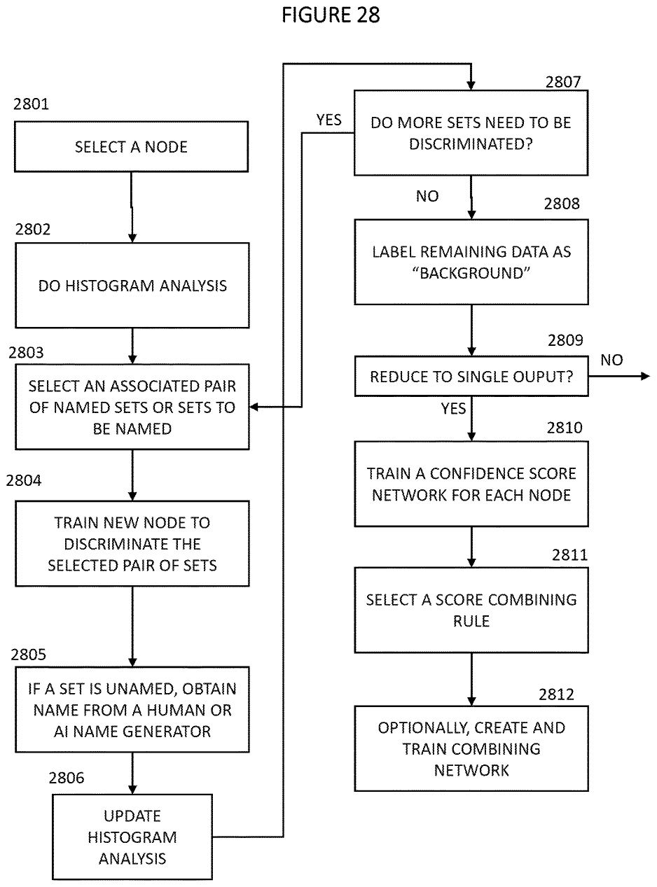

In block 2514, in some embodiments, computer system 1700 may replace any node represented in FIG. 25 with a set of one or more named-set discriminator nodes, as discussed in association with FIG. 28, thereby improving the interpretability of the network. In some embodiments, computer system 1700 may replace a node with a plurality of nodes by the process of node splitting (block 519 of FIG. 5), by the addition of error prediction and judgment nodes (block 210 of FIG. 2), and/or by other methods discussed in this document. In some embodiments, computer system 1700 may estimate confidence scores as described in association with block 2810 of FIG. 28. In some embodiments, computer system 1700 may use these confidence scores to compute a single output value, as described in block 2515.

In block 2515, if computer system 1700 has replaced any node in FIG. 25 with a plurality of nodes, computer system 1700 may add a combining node to compute a single output value to replace the plurality of values. In some embodiments, computer system 1700 may train a neural network to compute the combining function. In some embodiments, computer system 1700 may compute a confidence score for each node in a multi-node named-set discriminator. For example, computer system 1700 may compute a confidence score for a specific discriminator or detector node by training a sub-neural network to approximate the data-dependent probability that specified node makes the correct set assignment.

In some embodiments, computer system 1700 may then use the confidence scores and a specified combining rule to produce a single value as the output of the combination. Examples of combining rules include: (1) Use the value of the node with the highest confidence score; (2) Compute a weighted average of the node values with each node weighted by its confidence score; (3) A weighted average of the scores of nodes that have confidence scores above a specified threshold value. Various methods of constructing and training a combining network are discussed in association with blocks 2810, 2811, and 2812 of FIG. 28.

In a transformer, using a combining rule enables the use of multi-node named set units without increasing the number of attention heads. However, in some embodiments of training by incremental growth, computer system 1700 may start training a transformer with a smaller number of attention heads and using multi-node named set units as one of the mechanisms for systematically increasing the number of attention heads. In some embodiments, computer system 1700 may increase the number of attention heads in higher attention layers without increasing the number of attention heads in the lower attention layers.

In block 2516, computer system 1700 may optionally make node-specific improvements to any of the nodes in FIG. 5 using methods discussed in association with FIGS. 1, 2, 4, 5 and other figures.

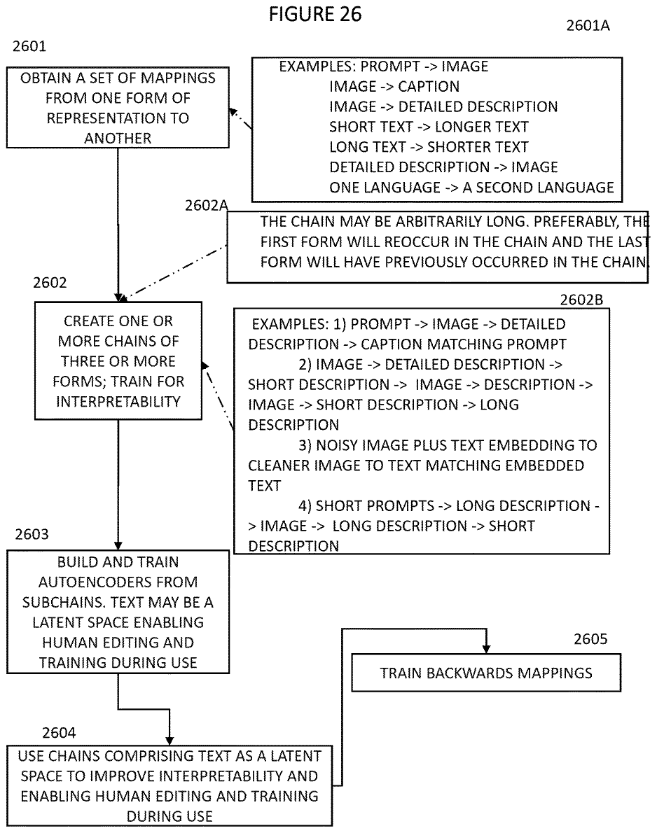

FIG. 26 is flow chart of an illustrative embodiment of a process herein called “round robin training.”

In block 2601, in some embodiments, computer system 1700 may obtain one or more mappings from one form of representation to another form of representation. Each mapping may be in the form of a neural network or of a hybrid network. In some embodiments, computer system 1700 may obtain a mapping in a form other than a neural network or hybrid network but may train a neural network or hybrid network to approximate the mapping as part of the process illustrated in FIG. 26. Some examples of such mappings, shown in box 2601A are: (1) from a prompt to an image, such as may be done by a generative AI system for images, (2) from an image to a caption, as may be done by an image recognition system, (3) from an image to a detailed description, as may be done by a collection of image recognition and analysis systems, (4) from a short text, such as a caption or prompt for an image generator to a longer text, such as a detailed description of an image, such as may be create by a prompt-based text generator, (5) from a long text to a short text, such as may be done by a text summarization system, (6) from a detailed description to an image, such as may be done by a generative AI system for images, or (7) translation from one language to another. There are many additional examples such as speech to text (speech recognition) and text to speech (speech synthesis). Systems such as those described in these examples are well known to those skilled in the arts of machine learning and generative AI.

In block 2602, in some embodiments, computer system 1700 may construct one or more chains of mappings from the mappings obtained in block 2601. Preferably, as specified in box 2602A, the first form of representation reoccurs in the chain and the last form in the chain also occurs earlier in the chain. In general, within the chain there should be one or more ways for a mapping in the chain to go from a later form in the chain back to a form that occurs earlier in the chain. In some embodiments, computer system 1700 may use an instance of a form at one point in the chain as the instance for the same type of form that occurs elsewhere in the chain. In some embodiments, computer system 1700 may construct a chain of mappings that jumps forward or backward within the original chain. Thus, computer system 1700 may proceed through a sequence of mappings represented in the chain such that the sequence of mappings comprises a closed loop. Preferably, one or more of the mappings in the loop is a generator.

In block 2603, in some embodiments, computer system 1700 may build and trains one or more autoencoders by constructing a sequence of mappings that begins and ends with the same form of representation and training all the mappings in the sequence with the objective of the instance of the final form matching as well as possible the instance of the first form in the sequence. In some embodiments, computer system 1700 may construct an autoencoder with an arbitrarily long sequence of mappings by using one or more loops. In some embodiments, computer system 1700 may create an arbitrarily large amount of training data if the constructed chain comprises a generator. In some embodiments, computer system 1700 may train the constructed autoencoder and each of its component mappings, using an arbitrary amount of training data even though one or more of the component mappings is based on a classifier-type mapping for which there is a limited amount of labeled training data. In some embodiments, computer system 1700 may train a sequence of mappings forming an autoencoder without requiring or without using labels on the training data items.

In block 2604, in some embodiments, computer system 1700 may use text as a latent space to improve the interpretability of one or more other mappings in the chain. In some embodiments, computer system 1700 may present the text associated with one or more latent variables to a human user during training and/or during use to enable the user to better understand the network. In some embodiments, computer system 1700 may enable a human user to edit the text in one or more latent variables to allow the human user to guide the training process and/or the end use.

In block 2605, in some embodiments, computer system 1700 may train one or more backward mappings as explained in association with FIG. 14.

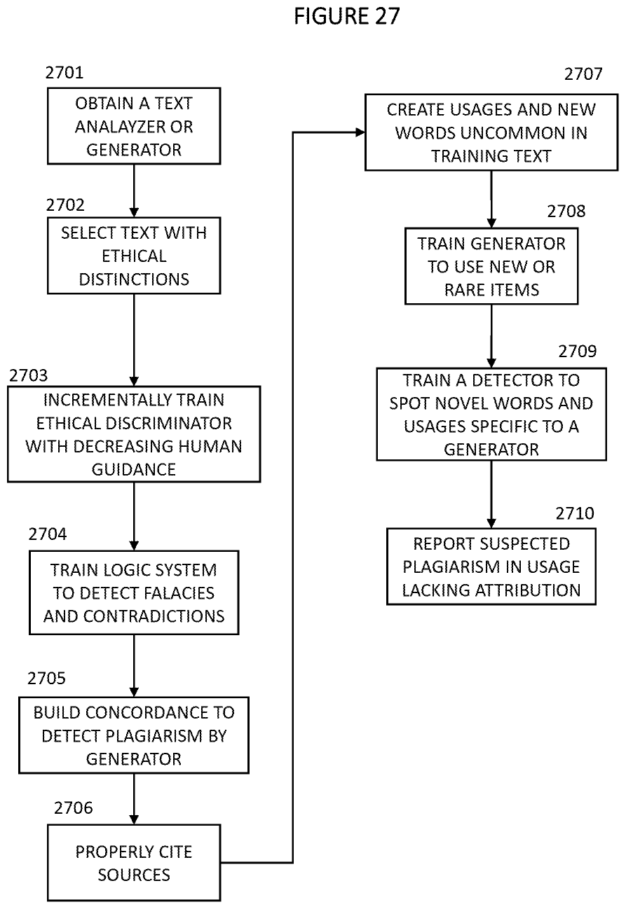

FIG. 27 is flow chart of an illustrative embodiment of a process for increasing the security of a text generation system.

In block 2701, computer system 1700 obtains a text analyzer or generator.

In block 2702, in some embodiments, computer system 1700 may select text with clear ethical distinctions. For example, children's stories, fairy tales, and some novels have clear heroes and villains. Some publications may explicitly state that certain things are ethical or unethical.

In block 2703, in some embodiments, computer system 1700 may incrementally train an ethical discriminator. In some embodiments, computer system 1700 may use human guidance. For example, a human may review selections by computer system 1700 of examples of ethical or unethical text. Hopefully, as the incremental training proceeds, humans will need to make fewer corrections. In preferable embodiments, as fewer corrections are needed computer system 1700 may decrease the frequency of human review.

In block 2704, in some embodiments, computer system 1700 may train a logical reasoning system to detect fallacies and contradictions. In some embodiments, computer system 1700 may use forms of logical reasoning other than neural networks or hybrid networks. For example, computer system 1700 may use syllogisms and deductions from formal logic. In some embodiments, human knowledge engineering may be used to develop components of the logical analysis system.

In block 2705, in some embodiments, computer system 1700 may construct a concordance of all the training data used to train a text generator. In some embodiments, computer system 1700 may construct a hash code or other indexing system such that, for any sequence of one or more words, computer system 1700 may determine whether that sequence of words has occurred in the training corpus. In some embodiments, computer system 1700 may use the concordance to detect when generated text is the same as text in the training corpus. Preferably, computer system 1700 then changes the generated text and/or provides proper citations such that the generated text does not constitute plagiarism.

In block 2707, in some embodiments, computer system 1700 may create one or more made-up words. In some embodiments, computer system 1700 may create one or more novel word usages. In some embodiments, computer system 1700 may use the concordance built in block 2705 to verify that a novel word or word usage does not occur in the training corpus. In some embodiments, computer system 1700 may enable a human user to suggest new or novel words or word usages. For example, computer system 1700 may enable a human author or artist to suggest words or phrases that will be a watermark for works by the author or artist.

In block 2708, in some embodiments, computer system 1700 may train a generator to occasionally use novel words or phrases in passages that computer system 1700 generates for a user of the text generation system. In some embodiments, computer system 1700 may also use words or word usages that occur in the training corpus but that are extremely rare.

In block 2709, in some embodiments, computer system 1700 may train a detection system to spot instances of the novel or rare words or word usages in external text that is being checked for possible plagiarism, such as published text or text written in a school assignment in which all references used are to be cited.

In block 2710, in some embodiments, computer system 1700 may report suspected instances of text generated by the generative AI system being used in published text or school assignments.

FIG. 28 is a flow chart of an illustrative embodiment of a process for training a set of one or more nodes as named-set discriminators and for training and using associated confidence estimators.

In block 2801, computer system 1700 selects a node for computer system 1700 to analyze to improve the interpretability of the selected node by training the selected node or associated new nodes to discriminate selected named sets.

In block 2802, in some embodiments, computer system 1700 may do a histogram analysis, as discussed in association with block 507 of FIG. 5 and FIG. 15. The process illustrated in FIG. 28 is like the process illustrated in FIG. 24. In the process of FIG. 28 computer system 1700 uses confidence nodes and a combining network to add nodes to an existing network rather than creating additional networks.

In block 2803, based on the histogram analysis, computer system 1700 may select a pair of known sets of data items to be associated with the selected node as a pair of sets to be discriminated. Preferably, the selected sets of data items are named sets or are known sets for which computer system 1700 intends to obtain names, for example, in block 2805.

In block 2804, in some embodiments, computer system 1700 may create a new node to discriminate the selected pair of sets. In some embodiments, computer system 1700 may make the connections of the new node homologous to those of the node selected in block 2801 and may initialize the connection weights of the new node to be the same as those of the selected node. However, in subsequent training, the new node will be regularized to discriminate the selected pair of sets of data items, so the weights of the two nodes will be trained differently. In some embodiments, the training of the new connections may be gradual, using moderate regularization during the on-going training of the other learned parameters in the network.

In block 2805, if a set is unnamed, in some embodiments, computer system 1700 may obtain a name for the set from a human or from an AI text generator. In some embodiments, computer system 1700 may obtain a name for one or both sets before doing the training in block 2804. However, in the embodiment illustrated in FIG. 28, the training done by computer system 1700 in block 2804 may clarify the distinction between the two sets, making it easier for a human or AI text generator to supply a name. With the addition of the new node, the two sets may be better distinguished than by the selected node alone. In addition, with the new node, the network may do better at separating the selected sets of data items from other data items.

In block 2806, in some embodiments, computer system 1700 may update the histogram analysis. In some embodiments, computer system 1700 may update the histogram analysis one or more times during the training in 2804.

In block 2807, computer system 1700 decides, based on the histogram analysis and specified criteria, whether to discriminate additional pairs of sets of data items. If so, computer system 1700 returns to block 2803. Otherwise, computer system 1700 proceeds to block 2808.

In block 2808, in some embodiments, computer system 1700 may optionally label the remaining data as “background” data relative to the discrimination between the two selected sets.

In block 2809, in some embodiments, computer system 1700 may determine whether to combine a plurality of output values into a single output value. In so, computer system 1700 proceeds to block 2810. If not, the process illustrated in FIG. 28 is done.

In block 2810, in some embodiments, computer system 1700 may train a confidence score network for the selected node and each of the new nodes. In some embodiments, a confidence score network may be a new subnetwork of the network comprising the selected node. In some embodiments, a confidence score network may be a separate network. In some embodiments, a confidence score may be computed by other means. In a hybrid network, a computed confidence score may be stored in a cell in the unit comprising the selected node.

In block 2811, in some embodiments, computer system 1700 may select a combining rule to derive a single output value representing the output values of the selected node and the new nodes. For example, computer system 1700 may derive a single value if the network architecture requires and single value and the model or training specification does not allow the architecture to be changed.

Some examples of combining rules are: (1) taking the output value of the node with the highest confidence score, (2) take a weighted average of the output values of the nodes, (3) take a weighted average of the output values of the k highest ranked nodes, or (4) take a weighted average of the output values excluding nodes with confidence scores below a specified acceptance threshold.

In block 2812, in some embodiments, computer system 1700 may create and

train a network to compute the combined score.

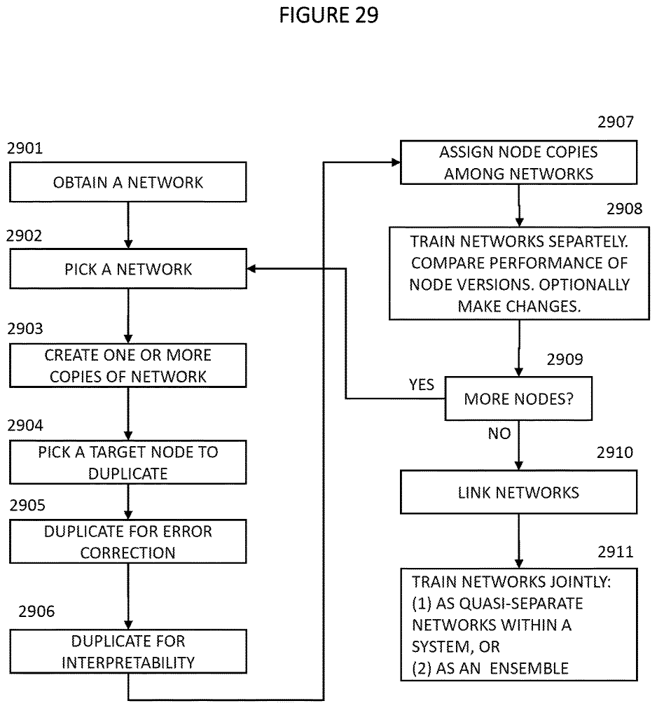

FIG. 29 is a flow chart of an illustrative embodiment of targeted systematic growth of a network to improve performance and interpretability.

In block 2901, computer system 1700 obtains one or more networks.

In block 2902, computer system 1700 picks a network if more than one network is available.

In block 2903, in some embodiments, computer system 1700 may create one of more copies of the network picked in block 2902.

In block 2904, computer system 1700 picks one or more target nodes to duplicate. In some embodiments, computer system 1700 may pick a node based on implicit errors made by the node. In some embodiments, computer system 1700 may pick a node for enhancement of its interpretability. In some embodiments, computer system 1700 may pick a node for a different reason or may pick a node at random.

In block 2905, in some embodiments, computer system 1700 may duplicate a node for error correction. For example, computer system 1700 may duplicate a node for general improvement in performance as discussed in association with block 210 of FIG. 2. As another example, computer system 1700 may duplicate as node as part of a strategy of continual growth as discussed in association with block 103 of FIG. 1. In some embodiments, computer system 1700 may duplicate a node for other specific reasons, such as error prediction and correction as discussed in association with block 210 of FIG. 2, or delegation as discussed in association with block 518 of FIG. 5, or node splitting as discussed in association with node 519 of FIG. 5. In some embodiments, computer system 1700 may duplicate a node as part of an attack defense, as discussed in association with FIG. 8.

In block 2906, in some embodiments, computer system 1700 may duplicate a node for improved interpretability, as discussed in association with FIGS. 24 and 28.

In block 2907, computer system 1700 assign respective copies of the node among the network copies created in block 2903.

In block 2908, in some embodiments, computer system 1700 may optionally train each network separately and measure its performance. In some embodiments, computer system 1700 may use this comparative network performance to estimate comparative performance of different node duplication methods. Optionally, computer system 1700 may make changes in the network to further improve performance and/or interpretability.

In block 2909, computer system 1700 decides whether to pick additional nodes for duplication, based on the performance results of block 2908 and/or specified criteria.

In block 2910, in some embodiments, computer system 1700 may add links between the networks, such as knowledge sharing links or a link for a node to an associated judgment node. In some embodiments, computer system 1700 may make network connections between networks.

In block 2911, computer system 1700 may train the networks jointly. In some embodiments, computer system 1700 may arrange the networks sequentially and make connections from the output of each network to input of the next network. In some embodiments, computer system 1700 may also add connections from an inner node of a first network to second network and/or from a second network to an inner node of the first network.

In some embodiments, computer system 1700 may arrange the networks in a parallel structure, with cross connections between networks. In some embodiments, computer system 1700 may merge a node in one network with a node in another network.

In some embodiments, computer system 1700 may arrange the networks in a mixture of sequential and parallel arrangements.

In some embodiments, computer system 1700 may treat the networks as an ensemble. In some embodiments, computer system 1700 may add a combing network to jointly optimize the performance of the networks in the ensemble, as described in U.S. Pat. No. 11,222,288, titled “Joint Optimization of Ensembles in Deep Learning”.

In some embodiments, computer system 1700 may keep one or more of the networks as a separate network instead or in addition to combining the network with the other networks.

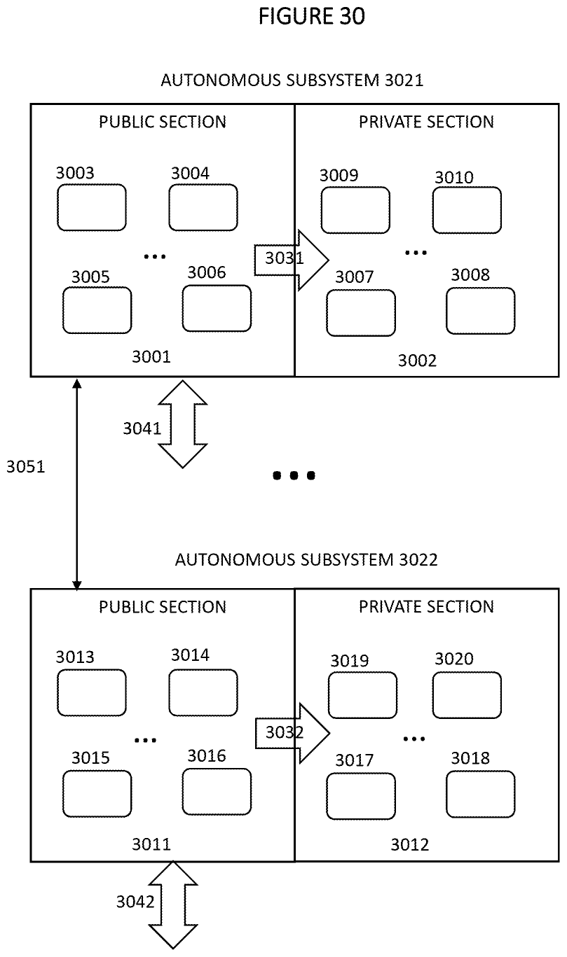

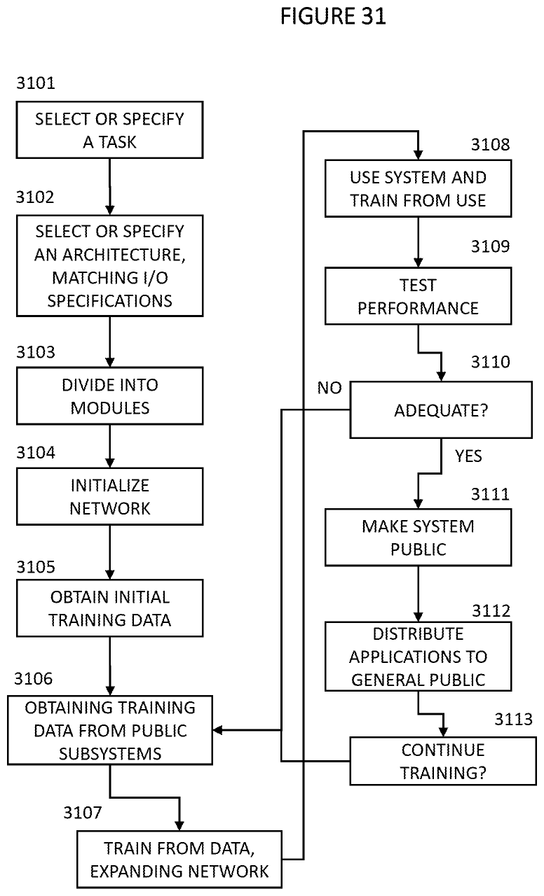

FIG. 30 is a system diagram of a distributed system comprising a plurality of autonomous modular cooperative subsystems. The processes by which the subsystems interact and the processes by which the system and subsystems are trained with human guidance are explained in association with FIG. 31.

In FIG. 30, two autonomous subsystems 3021 and 3022 are shown. However, as indicated by the ellipse in the diagram, the system may comprise any number of subsystems.

In preferred embodiments, each autonomous subsystem may comprise a public section, such as section 3001 of subsystem 3021 and section 3011 of subsystem 3022. In some embodiments, an autonomous subsystem may also comprise a private section, such as section 3002 of subsystem 3021 and section 3012 of subsystem 3022.

In some embodiments, as indicated by double arrows 3041 and 3042, an autonomous subsystem may receive input from and/or send output to other autonomous subsystems. In some embodiments, a subsystem may also share data with another autonomous subsystem. In some embodiments, a subsystem may also have knowledge sharing links from or to another autonomous subsystem.

In some embodiments, the private section of an autonomous subsystem may receive network connections, directed knowledge sharing links and/or data from the public section of the same autonomous subsystem, as indicated by arrows 3031 and 3032. However, for security, in preferred embodiments, the connections, directed knowledge sharing links, and data flow is always from the public section to the private section, not from the private section to the public section. In addition, even if there is a connection from the public section to the private section, there is no back propagation from the private section to the public section.

Each section of each autonomous subsystem may have one or more modules. In this discussion of FIG. 30, a “module” is any specified set of nodes or units in a specified neural network or in a hybrid network with internal connections and with a specified set of input variables and/or a specified set of output variables. The specified set of input variables may be the activation values of a specified set of nodes in the specified network. In some embodiments, there are no further restrictions in the definition of a module. Examples of modules are 3003, 3004, 3005, and 3006 of public section 3001; 3007, 3008, 3009, and 3010 of private section 3002; 3013, 3014, 3015, and 3016 of public section 3011; and 3017, 3018, 3019, and 3020 of private section 3012.

As explained in association with FIG. 31, in preferred embodiments, the training of a system of autonomous modular cooperative subsystems may continue indefinitely during use of the system, with guidance from the human user and/or other humans. During the lifelong learning computer system 1700 may increase the number of modules in a section and/or may increase the number of autonomous subsystems. In some embodiments, a subsystem may initially have only a single subsystem and/or a subsystem may initially have only a single module. However, during lifelong learning, computer system 1700 may grow the system to whatever size is desired.

Communication between public sections, indicated by double arrow 3051, may be local, such as by Ethernet, or remote, such as via the World Wide Web.

FIG. 31 is a flow chart of an illustrative embodiment of a process of training a system comprising one or more autonomous modular cooperative subsystems, such as illustrated in FIG. 30. In preferred embodiments, computer system 1700 may grow the system during initial training and may continue the training and growth during the use of the system by end users. During the training, computer system 1700 may grow the system with the goal of making it easier for a human user to understand and control.

In block 3101, in some embodiments, computer system 1700 may select or specify a task of the system of which the subsystem being developed is to be a part. Since a module may be any section of any neural network, the task may be any task done by a neural network, including classification, regression, or generative AI, such as image generation or text generation by a large language model. Because there is no limit to the number of autonomous modular cooperative subsystems, the size of the distributed system sharing the task may be arbitrarily large.

In block 3102, in some embodiments, computer system 1700 may select or specify an architecture for the subsystem to be built and trained. Computer system 1700 may specify the input variables and output variables for the subsystem to match the corresponding or complementary elements in existing subsystems with which the new subsystem is to interface.

In block 3103, in some embodiments, computer system 1700 may divide the specified architecture into modules.

In block 3104, in some embodiments, computer system 1700 may initialize the learned parameters in the network.

In block 3105, in some embodiments, computer system 1700 may obtain initial training data.

In block 3106, in some embodiments, computer system 1700 may obtain training data from the public section of one or more other autonomous modular cooperative subsystems.

In block 3107, in some embodiments, computer system 1700 may train the network from the data obtained in blocks 3105 and 3106. During this training and during subsequent training, computer system 1700 may grow the network while improving the interpretability and/or performance of selected nodes, as discussed in association with FIGS. 28 and 29.

In block 3108, in some embodiments, computer system 1700 may enable a human to use the system and may use the data obtained from interaction with the user for further training of the system, as explained in association with blocks 2207, 2208, and 2209 of FIG. 22, blocks 2308, 2310, and 2311 of FIG. 23, and blocks 2603 and 2604 of FIG. 26.

In block 3109, in some embodiments, computer system 1700 may test the performance of the system. In some embodiments, computer system 1700 may test the performance of one or more systems built using the subsystem being trained in combination with one or more public autonomous cooperative subsystems.

In block 3110, in some embodiments, computer system 1700 may determine whether the performance is adequate for public release, based on specified criteria. If the performance is adequate, computer system 1700 may proceed to block 3111. Otherwise, computer system 1700 may return to block 3106 for additional training and growth.

In block 3111, in some embodiments, computer system 1700 may make the subsystem public. If computer system 1700 has developed some or all the modules of the subsystem in the private section, computer system 1700 may move a copy of some of the modules into the public section, upon approval of the human owner of the autonomous subsystem. In some embodiments, computer system 1700 may retain in the private section a copy of one or more modules transferred to the public section for further training and development in the private section without changing the version of the corresponding module in the public section.

In block 3112, in some embodiments, computer system 1700 may release one or more applications based on the system to the public. For example, in addition to a multi-modality large language model computer system 1700 may make public in block 3112, computer system 1700 may train one or more specialized applications at the same time or after additional development.

In block 3113, in some embodiments, based on specified criteria, computer system 1700 may determine whether to continue training and developing the system. If so, computer system 1700 returns to block 3106. Otherwise, the process illustrated in FIG. 31 is done.

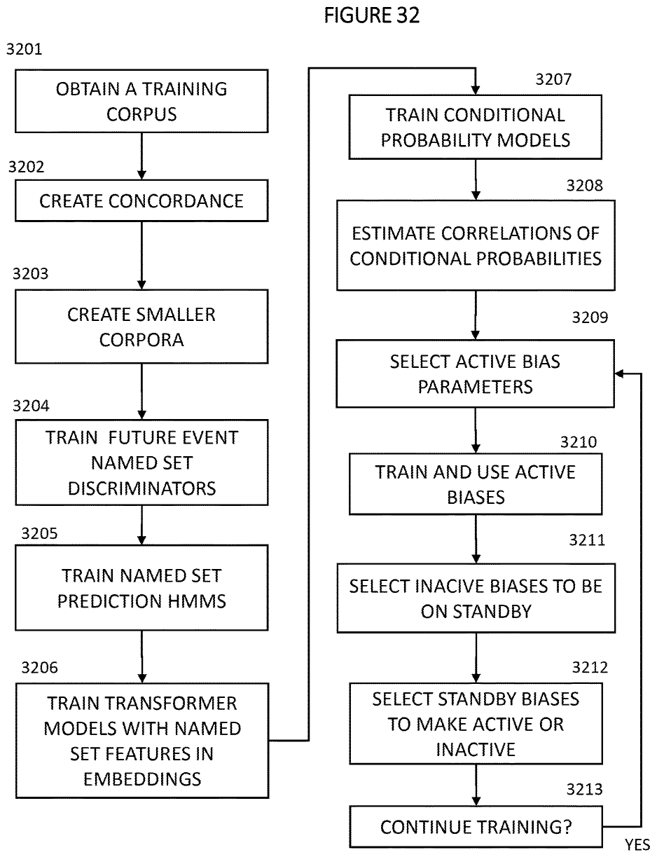

FIG. 32 is a flow chart of an illustrative embodiment of a process by which computer system 1700 may efficiently train a large language model with an arbitrarily large number of trainable parameters comprising transformer models and stochastic models.

In block 3201, in some embodiments, computer system 1700 may obtain a training corpus of text. In some embodiments, computer system 1700 may tokenize the training corpus. In some embodiments, computer system 1700 may include letters and some prefixes and suffixes as tokens. In addition, in some embodiments, computer system 1700 may include some number of the most common words. For example, in some embodiments, computer system 1700 may include, say, 25,000 words in a set of 30,000 tokens. In some embodiments, computer system 1700 may rewrite any word that is not a token as a sequence of tokens. In some embodiments, all letters in the alphabet are tokens, so any word can be written as a sequence of tokens, using letters if necessary.

In block 3202, in some embodiments, computer system 1700 may create a concordance to the training corpus. In some embodiments, computer system 1700 may index the concordance by token. In some embodiments, computer system 1700 may index the concordance by full word identity. In some embodiments, computer system 1700 may also create one or more multi-token or multi-word sequences, herein called “semantic units.” In some embodiments, computer system 1700, may index the concordance by semantic unit.

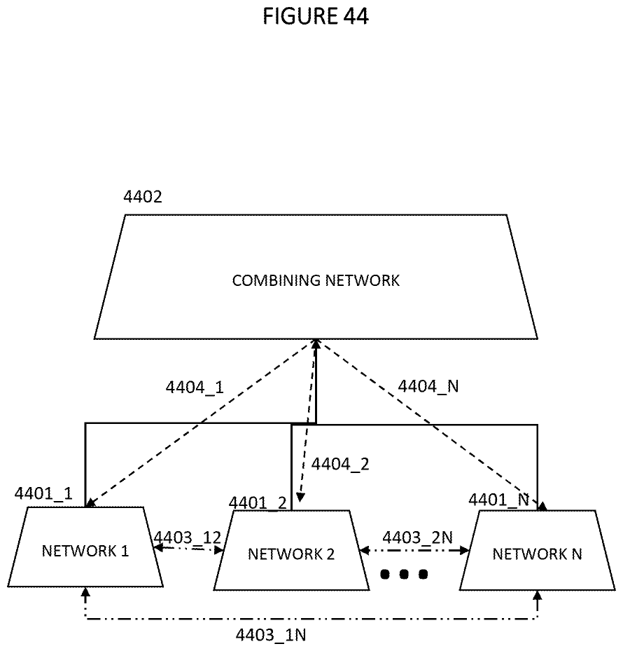

In block 3203, in some embodiments, computer system 1700 may create a plurality of smaller corpora. In some embodiments, computer system 1700 may distribute the smaller corpora among the subsystems of a distributed computing system. In some embodiments, whether the smaller corpora are distributed to multiple subsystems or not, computer system 1700 may train one or more models for each smaller corpus, coordinating the training of the subsystems using soft-tying, as described in U.S. Pat. No. 10,839,294 titled “Soft Tying Nodes of a Neural Network”, counter-tying as described in U.S. Pat. No. 11,151,455 titled “Counter Tying Nodes of a Neural Network”, data dependent node-to-node relationship regularization as described in U.S. Pat. No. 11,610,130 titled “Knowledge Sharing for Machine Learning Systems”, soft-tying learned parameters as described in U.S. Pat. No. 11,321,612 titled “Soft Tying Learned Parameters such as Connection Weights”, decorrelation of errors as described in U.S. Pat. No. 10,885,470 titled “Selective Training for Decorrelation of Errors”, data splitting as described in U.S. Pat. No. 11,195,097 titled “Building Ensembles for Deep Learning by Parallel Data Splitting”, and ensemble-combining networks for jointly optimizing diverse, robust ensembles of models built from the collection of smaller corpora as discussed in association with FIG. 44 and as described in U.S. Pat. No. 11,270,188 titled “Joint Optimization of Ensembles in Deep Learning”. In some embodiments, computer system 1700 may create such ensembles without dividing the large corpus into smaller corpora.

In block 3204, in some embodiments, computer system 1700 may train future-event named-set discriminator models using a process such as described in association with FIG. 28. In some embodiments, computer system 1700 may train a node in a word or token embedding or in a transformer network to discriminate two named sets of tokens or semantic units as more likely versus less likely to occur in a specified future interval in a sequence of tokens comprising an instance of the word or token associated with the embedding. In some embodiments, computer system 1700 may interpret the property “more likely” or “less likely” as a probability estimate that is respectively greater than or less than the a priori probability of the event being compared. A node trained as a named-set discriminator of the relative likelihood of a token or semantic unit in the future interval of a sequence is also called a “future-event predictor node.”

In block 3205, in some embodiments, computer system 1700 may train one or more hidden Markov process models. In some embodiments, computer system 1700 may train a Markov process model to track the state of one or more specified future-event predictor nodes as function of the position in the token sequence. In some embodiments, computer system 1700 may initialize and/or regularize a hidden Markov process model for a future-event predictor node to have a relative high probability of remaining in the same state for the next position in the sequence if the specified interval for the event prediction begins more than a specified number of positions in the future of the current position being generated by computer system 1700. In contrast, in some embodiments, computer system 1700 may initialize or regularize the hidden Markov process to have a relatively low probability of remaining in the same state if the specified interval for the event comprises the position currently being generated.

In block 3206, in some embodiments, computer system 1700 may train one or more transformer models comprising nodes that are future-event named-set discriminators. In some embodiments, computer system 1700 may train a transformer model as usual with the addition of regularization to maintain or improve the performance of a future-event named-set discriminator.

In block 3207, in some embodiments, computer system 1700 may estimate conditional probability models that are conditioned on the occurrence of a specified token or semantic unit at a specified position in a sequence relative to the position of the observations that are conditionally predicted by the conditional model. In some embodiments, computer system 1700 may estimate both forward and backward conditional probability estimates, as indicated in the following definitions, in which the sequence of random variables W₀, W₁, . . . , W_{T} may be a sequence of tokens and/or of semantic units:

### Forward Conditional Probability:

F₁:Pr(Wt+n=j|Wt=i)

F_{many}:Pr(Wₜ₊ₙ=j₀,Wₜ₊ₙ₊₁=j₁, . . . ,W_{t+n+K}=j_{K}|Wₜ=i)

### Backward Conditional Probability:

B₁:Pr(Wₜ₋ₙ=j|Wₜ=i)

B_{many}:Pr(Wₜ₋ₙ=j₀,Wₜ₋ₙ₊₁=j₁, . . . , W_{t-n+K}=j_{K}|Wₜ=i)

In some embodiments, computer system 1700 may proceed during training from the beginning of a sequence t=0 to increasing values of t. Similarly, during generation computer system 1700 may generate a sequence of values Wₜ in order of increasing values of t. Thus, when computer system 1700 is computing values for Wₜ, the values of Wₜ₋ₖ for k>0 are known.

Let E_{Context} represent a subsequence of prior observations
E_{Context}=Wₜ₊ₙ=j₀, Wₜ₊ₙ₊₁=j₁, . . . , W_{t+n+K}=j_{K}, so B_{many} may be expressed as B_{many}:Pr(E_{Context}|(Wₜ=i).

In some embodiments, computer system 1700 may use B_{many} to estimate the probability Pr(Wₜ=i), given the context E_{Context}, using Bayes rule as follows:

Pr(Wₜ=i|E_{Context})=Pr(Wₜ=i)*Pr(E_{Context}|Wₜ=i)/(ΣₖPr(Wₜ=k)Pr(E_{Context})|Wₜ=k)

In some embodiments, computer system 1700 may use any events observable in the context as part of E_{Context}. In some embodiments, computer system 1700 may use the activation of one or more future named-set discriminators as part of E_{Context}. In some embodiments, computer system 1700 may use one or more future named-set discriminators that activate above a specified threshold for named-sets containing Wₜ=i.

In block 3208, in some embodiments, computer system 1700 may select a pair of events (E₁, E₂) in E_{Context} and compute the average value of

$${B}_{E 1 , E 2 , i} = log ( \frac{Pr ( {E}_{1} \vert {W}_{t} = i ) * Pr ( {E}_{2} \vert {W}_{t} = i )}{Pr ( {E}_{1} , {E}_{2} \vert {W}_{t} = i )} ) .$$

In some embodiments, computer system 1700 may train a pair of nodes to estimate log(Pr(E₁|Wₜ=i)) and log(Pr(E₂|Wₜ=i)), respectively. In some embodiments, computer system 1700 may then create a node that sums the estimates of log(Pr(E₁|Wₜ=i)) and log(Pr(E₁|Wₜ=i)) and subtracts B_{E1,E2} as a bias to the sum node. In some embodiments, computer system 1700 may use counts of the occurrence of the respective events in the training corpus as maximum likelihood estimates of the conditional probabilities. In some embodiments, computer system 1700 may use gradient descent or other training methods of this invention to further tune the parameters to the overall objective of the network.

In some embodiments, computer system 1700 may use the identity of the semantic units at a specified relative position in the sequence as an observable event that can be directly detected from the input text without any additional neural nodes. Thus, just estimating B_{many} for K=2 and 1≤n≤N, computer system 1700 may potentially estimate as many as S*S*S*N learned parameters in one pass through the training corpus, where S is the number of distinct semantic units. With a vocabulary of one million semantic units and a context sequence of 100 semantic elements, computer system 1700 may theoretically estimate as many as 10²⁰ learned parameters. In some embodiments, computer system 1700 may specify a specific smaller number as a limit on the number of learned parameters to train. In some embodiments, computer system 1700 may increase the number of learned parameters during the training.

In some embodiments, computer system 1700 may estimate the backward conditional probability for (B_{many}) Pr(W_{t-N}=j₀, W_{t-N+1}=j₁, . . . , W_{t-N+K}=j_{K}|Wₜ=i), for values of K>2. In some embodiments, computer system 1700 may estimate B_{many} as Π_{k=0, . . . , K} Pr(W_{t-N-1}=|Wₜ=i). In some embodiments, computer system 1700 may compute logarithms of the conditional probabilities with summation nodes with biases to represent one or more pairwise correlations, extending the process described above K=2. In some embodiments, computer system 1700 may compute a maximum likelihood estimates for all the K=1 conditional probabilities and the biases for all active pairs.

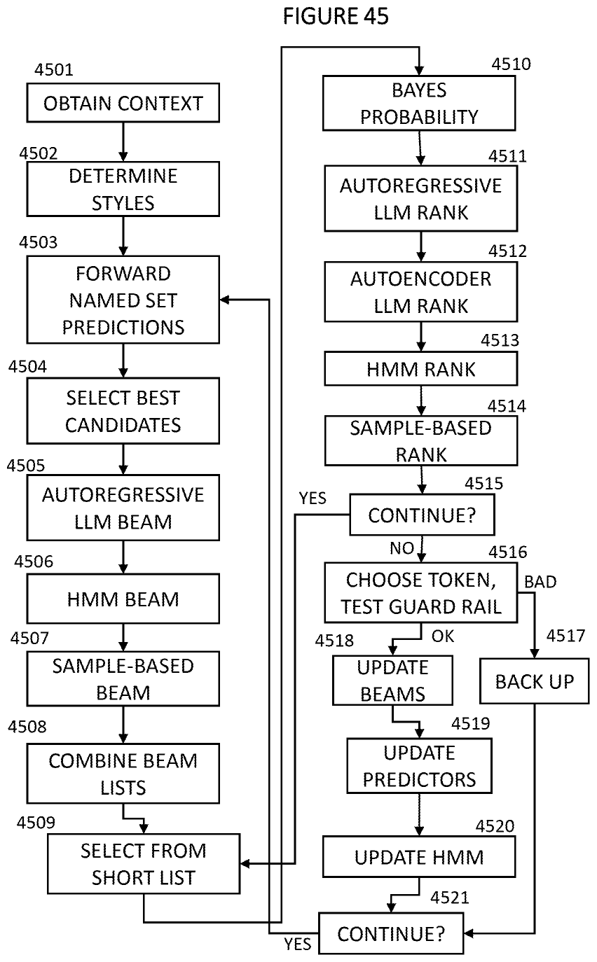

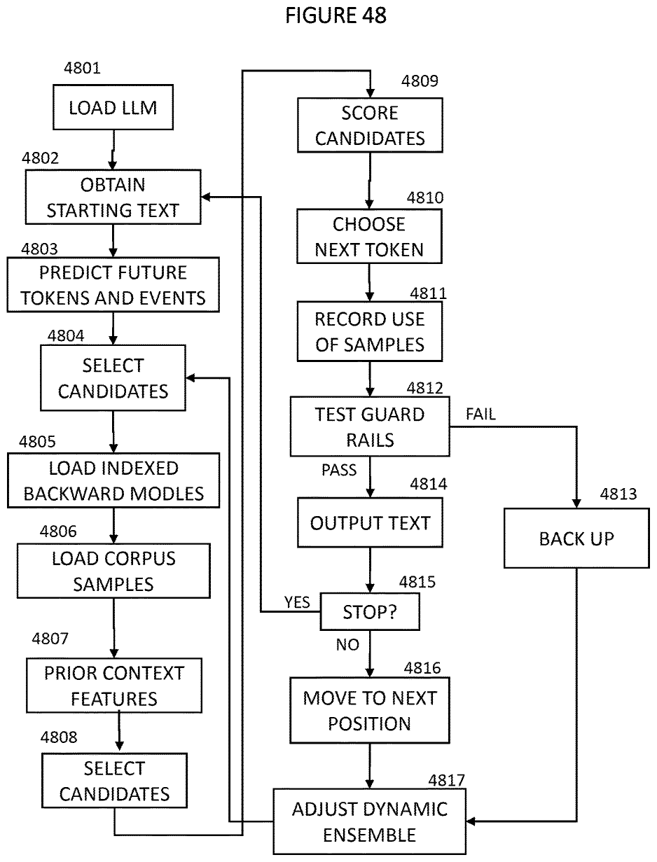

In some embodiments, computer system 1700 may train a system with a specified limited number of non-zero bias correlation corrective bias parameters. In some embodiments, computer system 1700 may compute the derivative of the objective with respect to a bias parameter for a selected set of inactive node tuples for K≥2. In some embodiments, computer system 1700 may repeatedly increase the number of active parameters by selecting one or more inactive parameters to make active based on the magnitude of the derivative with respect to the bias parameter and a specified criterion. In some embodiments, computer system 1700 use a data structure indexed by the value i of the conditioning variable Wₜ=i. In some embodiments, computer system 1700 may store the indexed data structure on secondary storage and load the data structure into CPU RAM or GPU RAM only when needed. In some embodiments, computer system 1700 may preload the indexed data structures for the candidates in the beam. Candidate beams and preloading are discussed further in association with FIGS. 45, 48,49, and 55. In some embodiments, computer system 1700 may preload the indexed data structure only for an initial portion of the beam sufficiently long so that the preload time is sufficient to cover the secondary storage access delay. In some embodiments, computer system 1700 may only limit the number of non-zero bias parameters by the amount of available secondary storage.

In block 3209, in some embodiments, computer system 1700 may make a preliminary estimate of the values of B_{E1,E2,i} and select a subset of learned parameters for which the magnitude B_{E1,E2,i} is significantly different from zero. In some embodiments, computer system 1700 may make the highest magnitude potential bias parameters active and make the remainder inactive. In some embodiments, computer system 1700 may partition the bias parameters into three sets: active, standby, and inactive. In some embodiments, computer system 1700 may compute the derivate of the network object with respect to an active bias and update the value of the active parameter during training by gradient descent. In some embodiments, computer system 1700 may compute the derivate of the network object with respect to a bias on standby but not update the value of the standby parameter unless the standby parameter is made active. In some embodiments, compute system 1700 may compute the derivative of the objective for a selected set of inactive bias parameters but not for the rest of the inactive bias parameters.

In block 3210, in some embodiments, computer system 1700 may use and train the active biases by gradient descent or other training procedures discussed in this document.

In block 3211, in some embodiments, computer system 1700 may randomly select one or more inactive bias parameters and compute the derivative of the objective with respect to each of the selected bias parameters. In some embodiments, computer system 1700 may select one or more of the inactive bias parameters to put on standby based on specified criteria.

In block 3212, in some embodiments, computer system 1700 may select one or more of the bias parameters on standby to make active. In some embodiments, computer system 1700 may select one or more of the active bias parameters to put on standby.

In block 3213, computer system 1700 determines whether to continue training, based on specified criteria. In some embodiments, computer system 1700 may continue lifelong training during deployment. In some embodiments, a human end user may control whether computer system 1700 is to continue training. If computer system 1700 determines to continue training, computer system 1700 returns to block 3209. Otherwise, the process illustrated in FIG. 32 is complete.

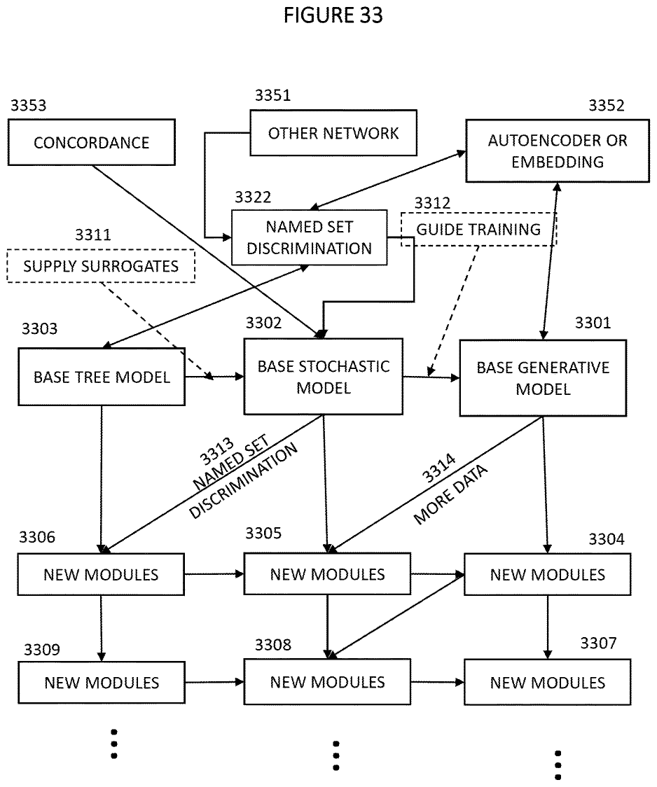

FIG. 33 is system diagram of an illustrative embodiment of an aspect of the invention in which computer system 1700 uses diverse types of models cooperatively to efficiently train and to rapidly grow one or more machine learning systems while improving performance, ease of interpretation, and control.

Block 3301 represents a base generative model such as transformer-based large language model for text generation or a diffusion model for image generation, especially image generation based on text or spoken prompts. Transformer models and diffusion models are well known to those skilled in the art of generative AI. In some embodiments, computer system 1700 may obtain a pretrained model as block 3301. In some embodiments, computer system 1700 may train a base generative model from scratch.

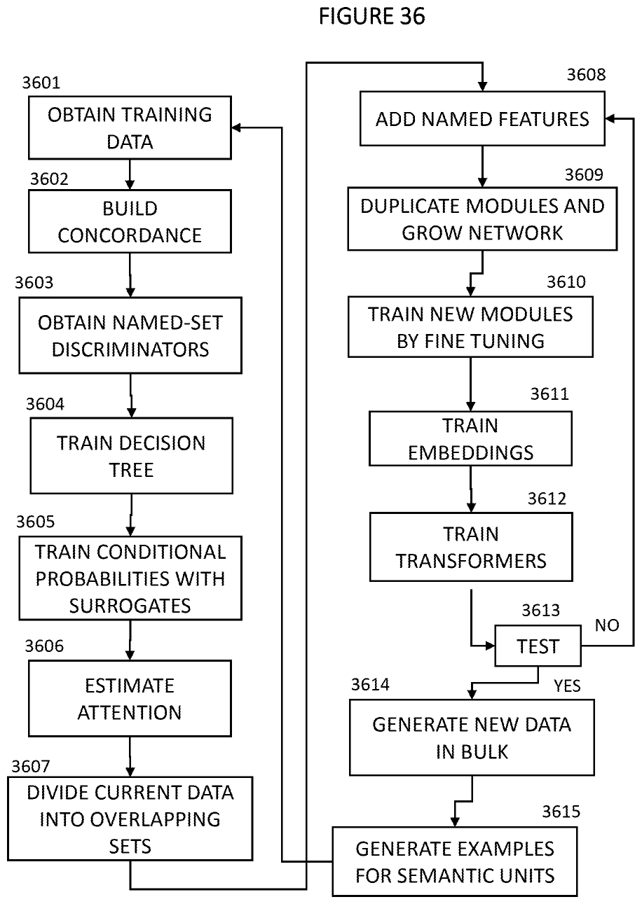

Block 3302 represents a base stochastic model obtained or trained by computer system 1700, such as a model by which computer system 1700 may estimate the conditional probability of a specified word occurring, given that one or more specific words have occurred in the preceding context. In some preferred embodiments, block 3302 may also comprise a model by which computer system 1700 may estimate the conditional probability or one or more words of context, given that a specific word occurs in a specified position in a sequence of words. In some embodiments, the context word or words may occur earlier in the sequence of words than the non-context word. In some embodiments, the non-context word may occur earlier. In some embodiments, context words may occur both earlier and later in the sequence of words than the non-context words. An illustrative embodiment of such models is discussed further in association with FIG. 32 and blocks 3602-3605 of FIG. 36.

Block 3303 represents a base tree-type model obtained or trained by computer system 1700, such as a decision tree, an ensemble of decision trees, or a random forest. Decision trees and random forests are well known to those skilled in the art of machine learning.

Block 3304 represents one or more new modules which computer system 1700 may add to the base generative model 3301 during the course of incremental growth and training. In some instances of some embodiments, the combined size of the new modules may be as large as, or larger than, the base generative model 3301. Thus, in some embodiments, computer system 1700 may rapidly train a very large model from a moderate size base model.

Block 3305 represents one or more new modules that computer system 1700 may use to add to or replace the base stochastic model 3302.

Block 3306 represents one or more modules that computer system 1700 may add to base tree-type model 3303.

Block 3307 represents additional new modules which computer system 1700 may add to the model of block 3304.

Block 3308 represents new stochastic models that computer system 1700 may use to add to or replace model 3305.

Block 3309 represents new modules that computer system 1700 may add to model 3306.

The ellipses below the blocks 3307, 3308 and 3309 represent that computer system 1700 may continue adding new modules to the generative model, to the stochastic model and to the tree-type model indefinitely. For example, computer system 1700 may itself be a distributed system of computers to which new computers may be added, and computer system 1700 may continue the process of incremental growth and training during use of by end users after the system is deployed.

Box 3311 is a label to indicate that the connection from base tree model 3303 to base stochastic model 3302 may comprise computer system 1700 supplying one or more sets represented by terminal or non-terminal nodes in a decision tree as a surrogate for a word for which there is insufficient data for training a word-specific conditional probability model. Although not explicitly labeled, the connections between the pairs 3306->3305 and 3309->3308 may also comprise computer system 1700 supplying one or more potential surrogates from a tree-type model to a stochastic model.

Labeled connection 3312 from block 3302 to block 3301 indicates that, in some embodiments, computer system 1700 may use a stochastic model to guide the training of the same generation of generative models. In some embodiments, training a stochastic model requires much less computation than training a generative model such as a transformer. In some embodiments, computer system 1700 may use the conditional probabilities to make initial estimates of attention weights. In some embodiments, computer system 1700 may use knowledge sharing regularization from a node in a stochastic model to a node in a generative model. In some embodiments, computer system 1700 may use stochastic models as modules in a generator, as explained in association with FIG. 36.

Labeled connection 3313 from block 3302 to block 3306 indicates that, in some embodiments, computer system 1700 may transfer a named-set discrimination from a stochastic model to the next generation of tree-type models.

Labeled connection 3314 indicates that, in some embodiments, computer system 1700 may transfer additional data from a generator model to the next generation of stochastic models.

Block 3322 represents a repository of named-set discriminators which, in some embodiments, computer system 1700 may train as described in association with FIGS. 28, 36 and 45. The double-headed arrow between block 3322 and block 3303 indicates that, in some embodiments, computer system 1700 may transfer a name set discriminator either from a tree-type model, 3303, 3306, 3309, . . . to the repository 3322 or from the repository 3322 to a tree-type model. The connection from block 3322 to block 3302 indicates that, in some embodiments, computer system 1700 may transfer one or more named-set discriminators from repository 3322 to a stochastic model 3302, 3305, 3309, . . . and so on.

Block 3351 represents any type of neural network or hybrid network. The arrow from block 3351 to block 3322 indicates that a named-set discriminator, which may be any element of any neural network or hybrid network, as discussed in association with FIG. 28, in some embodiments may be transferred by computer system 1700 into repository 3322. Although not shown, in some embodiments, computer system 1700 may train some other type of neural network or hybrid network as a generator, stochastic model, or tree-type model to supplement or replace block 3301, 3302 or 3303. In some embodiments, a more general network 3351 may comprise an autoencoder or an embedding which computer system 1700 may use like block 3352.

Block 3352 is a repository of autoencoders and/or embeddings. In some embodiments, computer system 1700 may have trained one or more autoencoders and/or embeddings as components of a generative model, such as in an attention block of a transformer. In some embodiments, computer system 1700 may have trained one or more autoencoders and/or embeddings as part of a more general network trained for some other purpose.

The doubled headed arrow between block 3322 and block 3352 indicates that, in some embodiments, computer system 1700 may transfer a named-set discriminator in either direction between repository block 3322 and autoencoder and embedding management system 3352, from which computer system 1700 may further transfer to or from any of the generative models 3301, 3304, 3307, . . . , and so on.

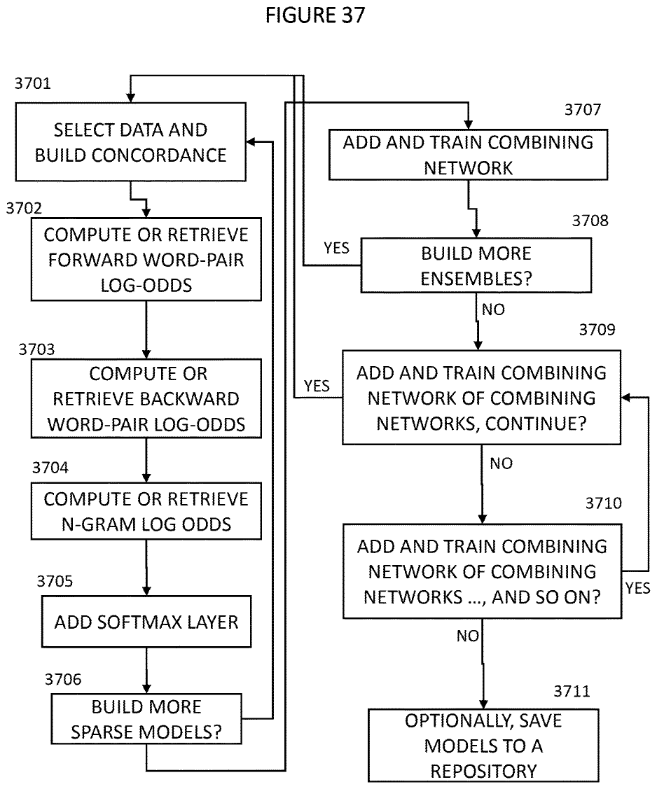

Block 3353 is a repository of one or more concordances. In some embodiments, computer system 1700 may compute and store in block 3353 a concordance for all the training data to be used in training a generative AI text generation system. In some embodiments, a concordance may include synthetically generated text as well as human written text. In some embodiments, computer system 1700 may create a separate concordance for each of a plurality of divisional sets of training data, such as the semi-autonomous subsystems of FIG. 31 or the local systems of FIG. 37. In some embodiments, in such a divisional concordance, computer system 1700 may deliberately select a disproportionately large number of passages comprising instances of one of more rare words, that is words with a low frequency of occurrence in the full set of training data. In preferred embodiments, computer system 1700 may keep a record of the ratio of over sampling each rare word and may adjust the estimated conditional probability of the word that computer system 1700 may derive from frequency counts. However, for estimating a conditional probability conditioned on a rare word, computer system 1700 may use more instances of the conditioning word and make no adjustment to the estimated conditional probability of a second word that is not rare and is not deliberately oversampled. The connection between block 3353 and block 3302 indicates that, in some embodiments, the repository of concordances may be used by computer system 1700 is the estimation of probability models in blocks 3302, 3305, 3308, and so on.

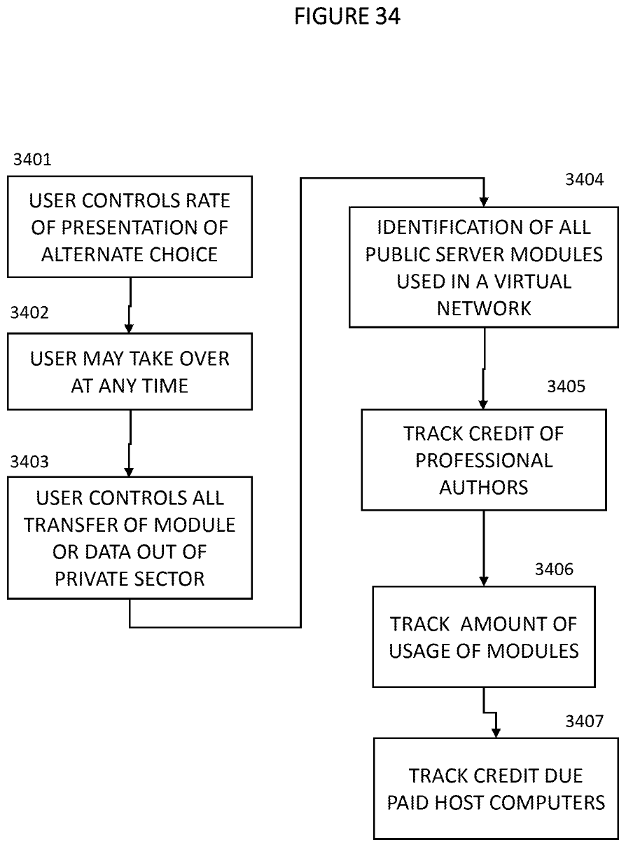

FIG. 34 is a flow chart of an illustrative embodiment of an aspect of the invention related to user control and to computer system 1700 tracking data and resources used during the training and use of a system.

In block 3401, in some embodiments, computer system 1700 may allow the user of a generative AI system to control the frequency of computer system 1700 presenting the user with a plurality of choices for the next part of an on-going generation. For example, a user that has strong preferences in writing style may choose to have the ability to choose more frequently as may a user who is an expert in the subject matter. On the other hand, a user who is less familiar with AI text generation or less expert in the subject matter may choose to have computer system 1700 present a single alternative except on rare occasions.

In block 3402, in some embodiments, computer system 1700 may enable the user to take over the generative process at any time. For example, in some embodiments, computer system 1700 may allow the user to substitute different text for text the computer system 1700 has generated.

In block 3403, in preferred embodiments, computer system 1700 may prevent any transfer of a module or of data out of a private section such as illustrated FIG. 30 without explicit permission of the user.

In some embodiments of a distributed system such as illustrated in FIG. 30, computer system 1700 may identify and keep a record of all the public server modules in a distributed implementation of a virtual network. In some embodiments, computer system 1700 may keep sufficient records and archived copies of modules and data such that a distributed virtual network may be reconstructed.

In block 3405, in some embodiments, computer system 1700 may keep track of the amount of monetary credit that has been earned by a professional writer who has assisted in the creation of a document, under terms previously agreed to by the participants.

In block 3406, in some embodiments, computer system 1700 may keep track of the amount of usage of a module. For example, in some embodiments, computer system 1700 may track the amount of usage of a module so that the module may be supplied for a fee in a Software as a Service arrangement.

In block 3407, in some embodiments, computer system 1700 may track the monetary and/computation credits due to each computer host that supplies computing resources to other users.

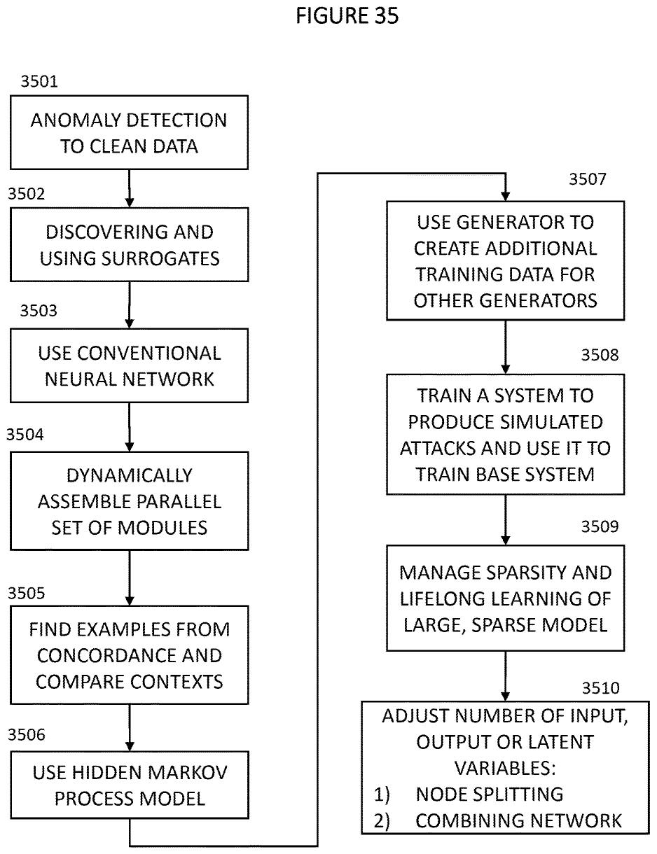

FIG. 35 is a flowchart of an illustrative embodiment of several optional processes that computer system 1700 may use in some embodiments in systems such as illustrated in FIGS. 30 and 33 and/or in processes such as illustrated in FIGS. 31, 32, 36, 37, 38 and 39.

In block 3501, in some embodiments, computer system 1700 may process the training data using an anomaly detection system. Computer system 1700 may obtain a pretrained anomaly detection system or computer system 1700 may train an anomaly detection system by presenting a classifier network with examples of normal text and examples of anomalies. In some embodiments, text in a foreign language may be regarded as an anomaly in the sense that the word frequency and word co-occurrence statistics will be different from those of the nominal language. In some embodiments, if a system is being trained or used in a specific domain, computer system 1700 may train an anomaly detection system to discriminate text in the domain from text outside the domain. In some embodiments, computer system 1700 may clean the set of training data by removing text that is detected to be anomalous.

In block 3502, computer system 1700 may discover and use surrogates for specific words. For example, for two rare words, computer system 1700 may easily estimate that the probability of occurrence for each word is low but may have insufficient data to determine which word is more likely in a specific situation. As another example, if a rare word has occurred in a preceding context, there may be little information about the most likely words to occur after that rare word. In each of these situations, computer system 1700 may use one or more other words as a surrogate for the rare word.

In some embodiments, in predicting the relative probability of each of two rare words in a specified context, computer system 1700 may use a decision tree that discriminates all words in the vocabulary. In some embodiments, computer system 1700 may determine a branch point from which both rare words are descendants. In some embodiments, computer system 1700 may then use an attention block to estimate the probability of either of the two rare words in the set of situations in which the correct word is also a descendant from that branch point. This embodiment is an illustrative embodiment of the principle of cooperation of diverse types of systems discussed in association with FIG. 33.

In some embodiments in which computer system 1700 is attempting to estimate the conditional probabilities of specific words when a rare word occurs in the conditioning context, may, for example, use a word cluster as a surrogate for the rare word. In some embodiments, computer system 1700 may compute clusters in the space in which the elements of the vector are the conditional probabilities of occurrence of words given a specified word in the context. In some embodiments, computer system 1700 may compute clusters in a space of word or token embeddings.

In block 3503, in some embodiments, computer system 1700 may use a conventional neural network in a cooperative system of diverse machine learning systems, such as block 3351 of FIG. 33. More generally, in some embodiments, computer system 1700 may obtain a neural network pretrained for some tasks other than the task for which computer system 1700 is currently training the set of cooperative machine learning systems. In some embodiments, computer system 1700 may train a new network. In some embodiments, computer system 1700 may then select to improve the interpretability of a specific node in the new network. In some embodiments, computer system 1700 may then determine a possible association of the specific node with two named sets in which each named set is associated with a set of words. In some embodiments, computer system 1700 may train the specified node as a named-set discriminator. In some embodiments, computer system 1700 may compute a transformation of the input space of the conventional neural network in block 3351 of FIG. 33 comprising the named-set discriminator of block 3322 of FIG. 33 and the input space of a tree-type system in block 3303 of FIG. 33 and/or an autoencoder in block 3352 of FIG. 33 by the method illustrated in FIG. 14.

In some embodiments, computer system 1700 may add a named-set discriminator as a named feature as an addition to the latent variables of an autoencoder, thereby making the autoencoder and its encoder and decoder easier to interpret. In some embodiments, after adding one or more named features to an autoencoder, computer system 1700 may retrain the autoencoder. In some embodiments, computer system 1700 may add one or more features to a word or token embedding.

In block 3504, in some embodiments, computer system 1700 may dynamically assemble a parallel set of modules. In some embodiments, computer system 1700 may represent each head in a multi-head attention block in a transformer as a module. In some embodiments, for example in the system illustrated in FIG. 30, computer system 1700 may represent a different number of attention heads in a first subsystem than in a second subsystem. In some embodiments, computer system 1700 may select a subset of the modules in the public section of an autonomous subsystem as the modules that are currently active. In some embodiments, computer system 1700 may store some of the inactive modules in CPU RAM rather than in GPU RAM or on secondary storage rather than in CPU RAM.

In some embodiments, computer system 1700 may continually test the performance of each module and select the subset of modules to be active based in part on an estimate of performance on the current task. In some embodiments of a generative or classification task, computer system 1700 may anticipate the future need for a module and preload the module for faster access.

In some embodiments, computer system 1700 may create one or more ensembles from the plurality of modules. In some embodiments, computer system 1700 may add a combing network to jointly optimize the performance of the networks in an ensemble, as described in U.S. Pat. No. 11,222,288, titled “Joint Optimization of Ensembles in Deep Learning” and discussed in association with FIG. 44. In some embodiments, computer system 1700 may use a combining network to adjust the number of input variables or the number of output variables of the autonomous subsystem, as discussed further in association with block 3510.

In block 3505, in some embodiments, computer system 1700 may compute or revise the score of a candidate word in a text generation system by comparing examples of the use of the candidate in context. For example, in some embodiments, computer system 1700 may select N₁ examples of a specified word, W₁, using a concordance from a concordance repository such as block 3353 of FIG. 33. In some embodiments, computer system 1700 may specify the number of examples of each word based in part on having enough samples to satisfy a criterion limiting the sample variance. In some embodiments, computer system 1700 may select the same number of examples of each word regardless of the frequency of occurrence of the word in the training text. In some embodiments, computer system 1700 may use examples of rare words from synthetically generated text and/or may over sample instances for human written text to have enough instances of a rare word. In some embodiments, computer system 1700 may sample additional instances of a rare word from a divisional training set other than the designated divisional training set for which computer system 1700 is constructing a concordance.

In block 3506, in some embodiments, computer system 1700 may use a model of a hidden Markov process. In some embodiments, computer system 1700 may train a hidden Markov process to represent the probabilities of a finite state grammar and to compute the maximum likelihood parse of an example sentence. In some embodiments, computer system 1700, may train a model for a probabilistic context free grammar using the inside-outside algorithm [ref: J. Baker (1979): Trainable grammars for speech recognition. In J. J. Wolf and D. H. Klatt, editors, Speech communication papers presented at the 97th meeting of the Acoustical Society of America, pages 547-550, Cambridge, MA, June 1979. MIT.] In some embodiments, computer system 1700 may use a grammar model to estimate syntactic properties of words in a sentence. For example, in some embodiments, computer system 1700 may determine the head word of each clause or phrase. In some embodiments, computer system 1700 may use the relationship between head words as an alternative to relative position in computing attention in a transformer model. In some embodiments, computer system 1700 may use the relationship between headwords as an alternative to relative position in estimating conditional probabilities in stochastic models. In some embodiments, computer system 1700 may add the syntactic role of a word as part of the identification of the word as a token and may train a word embedding based on syntactically augmented word tokens. In some embodiments, computer system 1700 may use probabilistic grammar in a stochastic model such as in blocks 3302, 3305, and 3308 of FIG. 33.

In block 3507, in some embodiments, computer system 1700 may use a first generator to create training text for a second generator.

In block 3508, computer system 1700 may obtain a first text generation system and then may train a second text generation system on examples of prompts that cause the first text generation system to have some undesirable behavior. In some embodiments, computer system 1700 may obtain examples of undesirable behavior from reports of such behavior from human users. In some embodiments, computer system 1700 may obtain examples of undesirable behavior from instances of a text generation system violating one or more specified guardrail tests. In some embodiments, if the second text generation system detects that a prompt is classified as likely to cause undesirable behavior, computer system 1700 may send a warning message to the first text generation system and/or may alert a human operator.

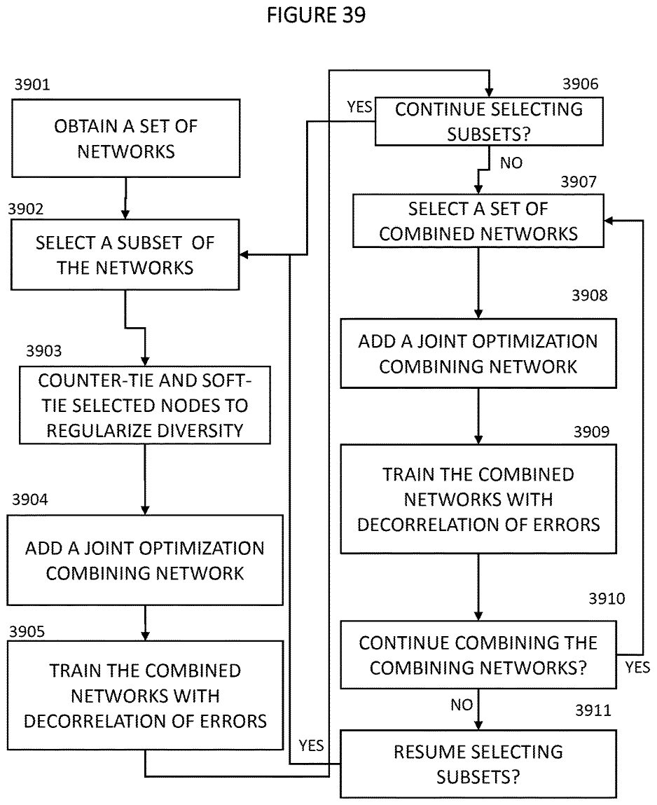

In block 3509, computer system 1700 may manage the sparsity, and lifelong training of a large, sparse model. In some embodiments, computer system 1700 may start with a sparse network and incrementally grow the network by repeatedly selecting an individual node to be replaced by a plurality of nodes as discussed in association with block 208 of FIG. 2, block 519 of FIG. 5, and block 1510 of FIG. 15. In some embodiments, computer system 1700 may replace a node with a plurality of nodes for a specific purpose, such as reducing errors on a local implicit objective or on a network objective (block 208 of FIG. 2, block 519 of FIG. 5, block 2905 of FIG. 29), or to improve interpretability by association with known or named sets (FIG. 28, block 2906 of FIG. 29), or to separate modes in a multi-modal distribution (block 1510 of FIG. 15). In some embodiments, computer system 1700 may grow the network and improve its performance and ease of interpretation and control while maintaining its sparsity. FIGS. 37 and 39 describe methods of efficiently growing arbitrarily large networks. In some embodiments, computer system 1700 may specifically design the networks to be sparse and to remain sparse. In some embodiments, computer system 1700 may grow any network architecture to be arbitrarily large.

In some embodiments, computer system 1700 may use node-to-node relationship links and repeated testing on new data to support incremental growth in lifelong training during deployment of a system.

In block 3510, in some embodiments, computer system 1700 may adjust the number of input variables and/or the number of output variables in an individual module. In some embodiments, computer system 1700 may adjust the number of input variables and/or the number of output variables of a public section of an autonomous subsystem. In some embodiments, computer system 1700 may adjust the number of variables in a latent variable space, such as the bottleneck layer or an autoencoder. In some embodiments, computer system 1700 may adjust the number of variables in an embedding, such as the word embedding in an attention block of a transformer.

In some embodiments, computer system 1700 may increase the number of nodes in any selected set of nodes of a neural network while simultaneously improving performance and/or making the network easier to interpret. Adding additional nodes to improve performance has been discussed in association with many figures of this disclosure, for example, block 103 of FIG. 1, blocks 208 and 210 of FIG. 2, block 519 of FIG. 5, and block 1510 of FIG. 15.

To make an inner node of a network easier to interpret, the node may be associated with the discrimination of two known sets, as mentioned throughout this disclosure and discussed in detail in association with FIG. 28. In some embodiments, computer system 1700 may replace a node associated with the discrimination of two named sets with a set of two to four nodes, further clarifying the interpretation. Computer system 1700 may replace the single discrimination node with: (1) a pair of detection nodes, one for each named set, (2) the pair of detector nodes plus a third node to indicate no decision, or (3) four detector nodes, with one node indicating that a data item seems to be in both named sets and another node indicating that a data item seems to be in neither named set. In some embodiments, computer system 1700 may retain the original node as well as adding the two to four new nodes.

In some embodiments, if computer system 1700 associates a node in a latent variable space as a discriminator of two named sets, computer system 1700 may designate the node and/or any replacement detector nodes as a named feature and may add the node as a new feature in a latent variable space. The presence of one or more named features in a latent variable space may improve the ease of interpreting the latent variable space. Similarly, in some embodiments, computer system 1700 may add nodes to the set of nodes that are output nodes of one module and input nodes to another module by associating selected nodes with pairs of named sets and replacing or supplementing them by two to four named-set detection nodes.

FIG. 36 is a flow chart of an illustrative embodiment of a cooperative process using diverse machine leaning systems such as illustrated in FIG. 33 in which the generative system is a transformer-based large language model.

In block 3601, in some embodiments, computer system 1700 may obtain training data, such as text from written documents and websites.

In block 3602, in some embodiments, computer system 1700 may build a concordance. That is, for each word in the vocabulary of a set of training text, computer system 1700 may make a record of the position of every instance of that word in the training corpus. In some embodiments, computer system 1700 may limit the maximum number of instances recorded for any one vocabulary word.

In block 3603, in some embodiments, computer system 1700 may obtain or train a repository of named-set discriminators which discriminate between subsets of the vocabulary.

In block 3604, in some embodiments, computer system 1700 may build a decision tree with named-set discriminators as the branch points. In some embodiments, computer system 1700 may obtain a set of named-set discriminators sufficient for the decision tree to have a unique leaf for each word in the vocabulary. In some embodiments, computer system 1700 may designate a leaf in the decision tree as a surrogate for a rare word. In some embodiments, computer system 1700 may designate an inner branch point as a surrogate for a rare word.

In block 3605, computer system 1700 may train conditional probability models for the co-occurrence of specified words of the vocabulary. In some embodiments, computer system 1700 may estimate forward and backward conditional probability models and log odds as described in association with FIG. 32.

In block 3606, in some embodiments, computer system 1700 may make an initial estimate of the attention weight for one or more new attention modules for the word in position t-k predicting the word in position t using one of the estimates of influence estimated in block 3605 averaged over a set of candidate words. In some embodiments, computer system 1700 may use different attention weights for different candidate words. In some embodiments, computer system 1700 may soft-tie the different initial estimated attention weights. In some embodiments, computer system 1700 may increase the strength hyperparameter of the soft-tying to get the estimated attention weights to converge during the iterative gradient descent training of the transformer model.

In block 3607, in some embodiments, computer system 1700 may divide the current data into overlapping subsets. In some embodiments, computer system 1700 may use a different subset of the current data for training each of a plurality of new models, including one or more transformer models with additional attention modules.

In block 3608, in some embodiments, computer system 1700 may add named features to one or more latent variable spaces such as word embeddings. In some embodiments, computer system 1700 may associate one or more other nodes in the transformer network with named sets. In some embodiments, computer system 1700 may add extra nodes as explained in association with FIG. 28 and block 3510 for FIG. 35.

In block 3609, in some embodiments, computer system 1700 may duplicate one or more modules except, in some embodiments, for one or more nodes that have been replaced by a plurality of nodes computer system 1700 may select a different one of the plurality of new nodes for one of the duplicates than for another of the duplicates.

In block 3610, in some embodiments, computer system 1700 may train one or more new modules. In some embodiments, computer system 1700 may train one or more new modules by fine tuning from the current transformer or from another large language model.

In block 3611, in some embodiments, computer system 1700 may train one or more word embedding networks, including word embedding networks to which computer system 1700 may have added nodes associated with named sets.

In block 3612, in some embodiments, computer system 1700 may train the complete transformer network.

In block 3613, in some embodiments, computer system 1700 may test the performance of the transformer network. In some embodiments, computer system 1700 may also test the performance of the transformer network in generalizing to data not in its training set. Based on the results of the test and specified criteria, computer system 1700 may return to block 3608 to add additional named features. Otherwise, computer system 1700 may proceed to block 3614.

In block 3614, in some embodiments, computer system 1700 may generate new data in bulk. In some embodiments, computer system 1700 may use this new data in training additional modules. In some embodiments, computer system 1700 may use this new data for training a stochastic model such as model 3302, 3305, or 3308 in FIG. 33. In some embodiments, computer system 1700 may use this new data for training a tree-based model such as model 3303, 3306, or 3309 is FIG. 33.

In block 3615, in some embodiments, computer system 1700 may generate additional examples of sentences and passages that contain specified rare words. In some embodiments, computer system 1700 may use these additional examples in training conditional probabilities involving rare words, as explained in association with FIG. 33.

In some embodiments, computer system 1700 may return to block 3601. In some embodiments, based on a specified stopping criterion, computer system 1700 may terminate the process illustrated in FIG. 36. In some embodiments, computer system 1700 may be using the process illustrated in FIG. 36 during lifelong learning. In such a case, in some embodiments, computer system 1700 may continue returning to block 3601 indefinitely.

FIG. 37 is a flow chart of an illustrative embodiment of a process for building a large system for text generation based on a hierarchy of ensembles of conditional probability models and joint optimization combining networks. In some embodiments, computer system 1700 may implement the process illustrated in FIG. 37 on a distributed computer system with a plurality of local computers. In some embodiments, computer system 1700 may implement the process illustrated in FIG. 17 on one or more computers co-located in a data center.

In the illustrative embodiment of FIG. 37, in some embodiments, computer system 1700 may create a plurality of sets of sparse conditional probability models in 3702-3705 by selecting a plurality of different subsets of the training data. However, in blocks 3707-3710, in some embodiments, computer system 1700 may treat the elements of the matrices of estimated conditional probabilities as the connection weights in a neural network with a connection for each non-zero entry in one of the matrices of conditional probability estimates. In some embodiments, computer system 1700 may then further train these connection weights by back propagation.

In block 3701, in some embodiments, computer system 1700 may select a set of training data and build a concordance. In some embodiments of a distributed system, computer system 1700 may select a set of training data in one local system that is distinct from the set of training data selected by computer system 1700 in a second local system.

In block 3702 in some embodiments, in one or more local systems, computer system 1700 may compute estimated forward conditional probabilities and log odds, as described in association with FIG. 32, or may retrieve precomputed estimates. In some embodiments, some or all the retrieved estimated conditional probabilities and log odds may be retrieved from a repository of sparse matrices with parameters, that is, matrix elements, updated by back propagation in the training of an ensemble of probability models using a joint optimization combining network as discussed in association with FIG. 44.

In block 3703, in some embodiments, computer system 1700 may compute estimated backward word-pair conditional probabilities and log odds or may retrieve precomputed estimates.

In block 3704, in some embodiments, computer system 1700 may compute sparse backward n-word estimated conditional probabilities and log odds, as described in association with FIG. 32, or may retrieve precomputed estimates.

In block 3705, in some embodiments, computer system 1700 may add a softmax layer to the log odds or a probability normalization to the conditional probability estimates in the neural network implementation of the estimated probability matrices. In some embodiments of 3701-3705, computer system 1700 may compute the entries in the sparse matrices by counting word co-occurrence statistics for sets of data selected by computer system 1700 with any training by back propagation or gradient descent having yet be applied in the process from block 3702 to block 3705. In some embodiments, however, back propagation and gradient descent training may have been applied to models retrieved from a repository.

In block 3706, in some embodiments, computer system 1700 may determine whether to compute or retrieve additional sparse probability estimates, based on specified stopping criteria. If so, computer system 1700 returns to block 3701. Otherwise, computer system 1700 proceeds to block 3707.

In block 3707, in some embodiments, computer system 1700 may treat the set of sparse matrices estimated from any one selection of data in block 3701 as an initial neural network model (not yet trained by gradient descent) and may treat the set of these initial neural network models as an ensemble. In block 3703, in some embodiments, computer system 1700 may add a joint optimization combining network to the ensemble of models computed or retrieved by computer system 1700 in blocks 3701-3706. In some embodiments, computer system 1700 may then train the network comprising the combining network with the networks built in blocks 3701-3706 as subnetworks.

In block 3708, in some embodiments, computer system 1700 may determine whether to build more ensembles with associated combining networks. If so, computer system 1700 returns to block 3701. Otherwise, computer system 1700 proceeds to block 3709.

In block 3709, in some embodiments, computer system 1700 may add and train a combining network of combining networks.

In block 3710, in some embodiments, computer system 1700 may determine whether to continue the process and add more levels to the hierarchy of combining networks of ensembles of combining networks of ensembles, and so on. If so, computer system 1700 returns to block 3701. Otherwise, computer system 1700 proceeds to block 3711.

In block 3711, in some embodiments, computer system 1700 may save the network models as trained by joint optimization into a repository. Note that these networks have the architecture of a network representation of conditional probability matrices and log odds. In some embodiments, these saved models may be retrieved by computer system 1700 in later instances of the process illustrated in FIG. 37 or in later use as a generator or classifier.

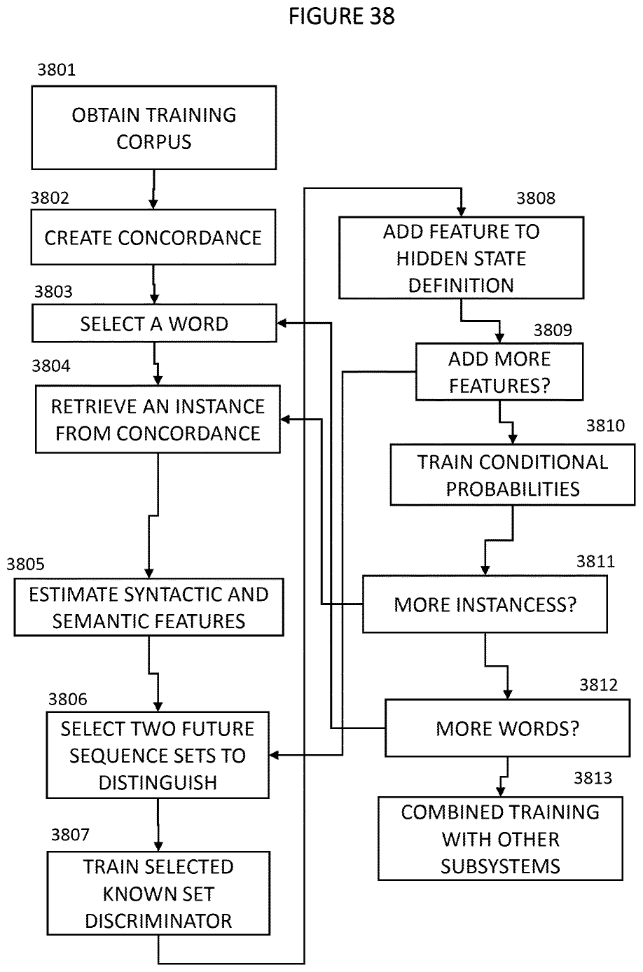

FIG. 38 is a flow chart of an illustrative embodiment of an aspect of the invention by which computer system 1700 may expand the state space of a hidden Markov process modeling sequences of text.

In block 3801, in some embodiments, computer system 1700 may obtain a training corpus. In some embodiments, computer system 1700 may distribute a distinct subset of a training corpus to each of a plurality of autonomous subsystems. Blocks 3803 to 3812 are an illustrative embodiment of the training process for an individual subsystem, with the results being combined in block 3813.

In block 3802, in some embodiments, computer system 1700 may create a concordance for the training corpus obtained in block 3801.

In block 3803, in some embodiments, computer system 1700 may select a word to be modeled. In some embodiments, computer system 1700 may implement the process of blocks 3803-3811 for each word in the vocabulary.

In block 3804, in some embodiments, computer system 1700 may retrieve an instance of the selected word and its context from the concordance.

In block 3805, in some embodiments, computer system 1700 may compute attributes or features specific to the retrieved instance. For example, computer system 1700 may compute the part of speech of a specific instance of the selected word. In some embodiments, computer system 1700 may parse the sentence containing a specific instance of the selected word and may add one or more features, such as the position of the instance of the word in the parse tree. In some embodiments, for a word with multiple definitions, computer system 1700 may estimate the definition associated with a specific instance of the word.

In block 3806, in some embodiments, for the selected instance of the word, computer system 1700 may consider the future context, that is, the sequence of words that follow the selected instance. In some embodiments, computer system 1700 may select a pretrained feature that distinguishes two known or named sets of future context sequences, using as input the word identity of the selected word and the preceding context of the selected instance. In some embodiments, computer system 1700 may use the selected instance of the word to select a new pair of known or named sets of future context sequences to train a subnetwork or a separate network to distinguish.

In block 3807, in some embodiments, computer system 1700 may use the context of the selected instance to update the training of the selected pretrained feature. In some embodiments, computer system 1700 may initialize and begin training a model for a new pair of known sets to distinguish.

In block 3808, in some embodiments, computer system 1700 may add a new feature initialized in block 3807 to the set of features characterizing the set of possible hidden states for instances of the selected word.

In block 3809, in some embodiments, computer system 1700 may determine, based on specified criteria, whether to add more hidden state features to the hidden state model of the selected word. If so, computer system 1700 returns to block 3806. Otherwise, computer system 1700 proceeds to block 3810.

In block 3810, in some embodiments, computer system 1700 may update the training of conditional probabilities of the selected word occurring given the preceding context of the selected instance. In some embodiments, computer system 1700 may use conditional probabilities computed as discussed in association with FIG. 32. In some embodiments, computer system 1700 may update similar conditional probability estimates based on the features determined in blocks 3805 and 3807. Since the features are not arranged in a sequence, in some embodiments, computer system 1700 may arbitrarily assign an index, such as the sequence in which the features are initialized and defined as features for the selected word.

In block 3811, in some embodiments, computer system 1700 may determine, based on specified criteria, whether to retrieve more instances of the selected word. If so, computer system 1700 returns to block 3804. Otherwise, computer system 1700 proceeds to block 3812.

In block 3812, in some embodiments, computer system 1700 may determine, based on specified criteria, whether to process more words. If so, computer system 1700 returns to block 3803. Otherwise, computer system 1700 proceeds to block 3813.

In block 3813, in some embodiments, computer system 1700 may create a combining network for the probability estimates for the word selected in 3803 estimated in a plurality of autonomous subsystems. In some embodiments, computer system 1700 may update the training of the combined network. In some embodiments, computer system 1700 may back propagate from the combining network to the network representation of the sparse matrices of conditional probabilities.

FIG. 39 is a flow chart of an illustrative embodiment of a process for incrementally building and training an arbitrarily large, distributed AI system from components that each fit within specified limits on memory and/or on the amount of computation.

In block 3901, in some embodiments, computer system 1700 may obtain an arbitrarily large set of generator or classifier networks. In some embodiments, computer system 1700 may select networks that may be trained by gradient descent. In some embodiments, computer system 1700 may select some set of two or more networks that are homologous. In some embodiments, for any pair of networks, computer system 1700 may determine one or more pairs of corresponding nodes with one of each pair of corresponding nodes in each of the pair of networks. In some embodiments, computer system 1700 may obtain a set of networks such that each of the set of networks satisfies specified limits on the amount computer memory and the amount of computation required to train and use the network. For example, in some embodiments, computer system 1700 may obtain a set of networks such that the required processing for each network can be done on a workstation with specified hardware. In some embodiments, computer system 1700 may obtain a set of networks such that the required processing for each network can be done on a personal computer.

In block 3902, in some embodiments, computer system 1700 may select a subset of the networks. In some embodiments, computer system 1700 may limit its selection of a subset such that the subset is disjoint from all previously selected subsets. In some embodiments, computer system 1700 may select subsets that overlap.

In block 3903, in some embodiments, computer system 1700 may select one or more pairs of nodes with one of each selected pair of nodes in one network in a selected pair of networks and the other of the selected pair of nodes in the other of the selected pair of networks. In some embodiments, computer system 1700 may specify a node-to-node relationship regularization link. In some embodiments, computer system 1700 may specify, for each selected pair of nodes, an asymmetric or antisymmetric knowledge sharing link or a counter-tying link to create diversity during training.

In block 3904, in some embodiments, computer system 1700 may treat the subset of networks selected in block 3902 as an ensemble and may add a joint optimization combining network to jointly optimize the performance of the networks in the ensemble, as described in U.S. Pat. No. 11,222,288, titled “Joint Optimization of Ensembles in Deep Learning” and discussed in association with FIG. 44.

In block 3905, in some embodiments, computer system 1700 may train the combined network comprising the combining network and the set of networks selected by computer system 1700 in block 3902. In preferred embodiments, computer system 1700 may back propagate the combined objective to the members of the combined ensemble to jointly optimize the member networks, as described in U.S. Pat. No. 11,222,288, titled “Joint Optimization of Ensembles in Deep Learning”. In some embodiments, computer system 1700 may back propagate extra penalties when two members of the ensemble make the same mistake on a data item, as described in U.S. Pat. No. 10,885,470, titled “Selective Training for Decorrelation of Errors” as discussed in association with FIG. 44.

In block 3906, in some embodiments, computer system 1700 determines whether to continue selecting subsets based on specified criteria. If so, computer system 1700 returns to block 3902. Otherwise, computer system 1700 proceeds to block 3907.

In block 3907, in some embodiments, computer system 1700 may select a set comprising a subset of the set of jointly optimized networks created by computer system 1700 in block 3904. That is, each network in the selected set comprises a joint optimization network and its ensemble of subnetworks.

In block 3908, in some embodiments, computer system 1700 may add a joint optimization combining network as a combining network for the set of previously combined networks selected in block 3907, as discussed in association with FIG. 44.

In block 3909, in some embodiments, computer system 1700 may train the combined set of previously combined network back propagating to and jointly optimizing the set of combined networks. In some embodiments, computer system 1700 may selectively back propagate asymmetric penalties for decorrelation of errors.

In block 3910, in some embodiments, computer system 1700 determines whether to continue combining previously combined networks based on specified criteria. If so, computer system 1700 returns to block 3907. Otherwise, computer system 1700 proceeds to block 3911.

In block 3911, in some embodiments, computer system 1700 may determine to select more subsets of the set of networks. If so, computer system 1700 returns to block 3902. Otherwise, the process illustrated in FIG. 39 is done.

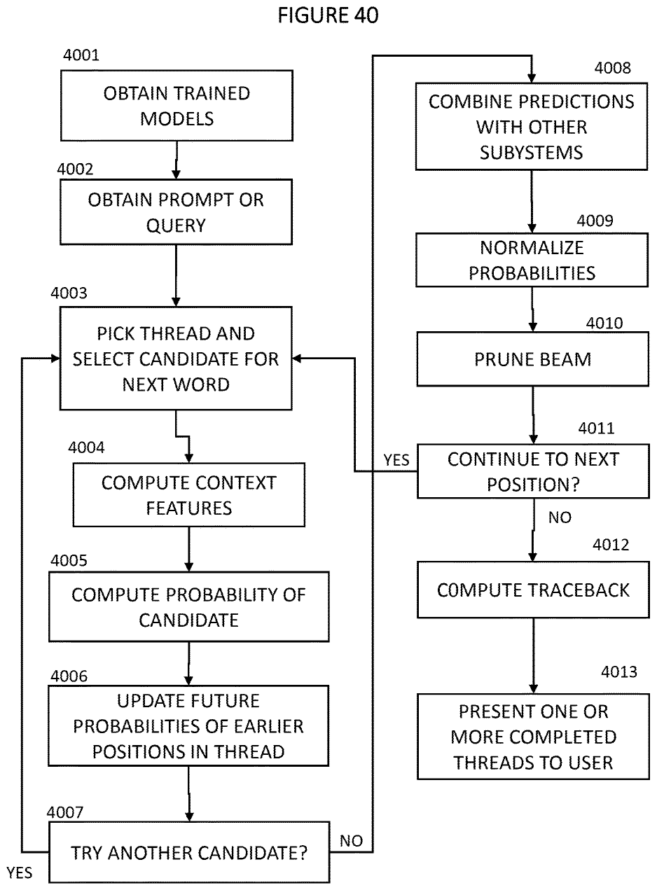

FIG. 40 is a flow chart of an illustrative embodiment of text generation that may use a system comprising a stochastic process model.

In block 4001, in some embodiments, computer system 1700 may obtain models such as those trained as described in association with FIGS. 32 and 38.

In block 4002, in some embodiments, computer system 1700 may obtain a starting prompt or query from a user.

In block 4003, in some embodiments, computer system 1700 may select a sequence of tokens herein called “a thread” and a candidate token as the next token to add to the selected thread. If computer system 1700 has come to block 4003 before going to block 4011, then the only thread will be the prompt or query computer system 1700 obtained in block 4002. Otherwise, the set of threads will be all the sequences not pruned from the beam of threads in block 4010.

In block 4004, in some embodiments, computer system 1700 may compute context features for the selected candidate token such as the features trained in blocks 3805-3808 of FIG. 38.

In block 4005, in some embodiments, computer system 1700 may estimate the probability of the candidate token based on the context preceding the position of the candidate token selected in block 4003 and the conditional probability models trained in block 3810 of FIG. 38.

In block 4006, in some embodiments, computer system 1700 may update the probability of the thread by including, for any previous position in the thread, any conditional probabilities of future sequence features that have been confirmed as satisfied or as not satisfied.

In block 4007, in some embodiments, computer system 1700 may determine, based on specified criteria, whether to try another candidate for the current position in the sequence being generated. If so, computer system 1700 returns to block 4003. Otherwise, computer system 1700 proceeds to block 4008.

In block 4008, in some embodiments, computer system 1700 may combine its probability estimates for its threads with those of other autonomous subsystems. In some embodiments, the participating subsystems may synchronize the selection of threads and token candidates in block 4003, so that all participating subsystems evaluate the same set of threads.

In block 4009, in some embodiments, computer system 1700 may normalize the probabilities to sum to 1.0 or some other specified constant.

In block 4010, in some embodiments, computer system 1700 may prune the beam. That is, computer system 1700 may drop from the list of threads any threads that fail specified criteria. In some embodiments, a specified criterion may be that the normalized probability of the thread be greater than a specified value. In some embodiments, a specified criterion may be that the normalized probability of the thread be at least a specified fraction of the probability of the most probable thread. In some embodiments, a specified criterion may be that the probability of the thread be among the N best, for a specified number N.

In block 4011, in some embodiments, computer system 1700 may determine whether to continue to the next position in the sequence based on specified criteria. If so, computer system 1700 returns to block 4003. Otherwise, computer system 1700 proceeds to block 4012.

In block 4012, in some embodiments, computer system 1700 may compute a traceback. That is, computer system 1700 may retrieve a record of the token candidates that computer system 1700 has selected. In some embodiments, computer system 1700 may reconstruct such a record from back pointer data structures in which computer system 1700 stores a pointer pointing back from each selection to its immediate predecessor.

In block 4013, in some embodiments, computer system 1700 may present one or more completed threads to the user. In some embodiments, computer system 1700 may only present the highest probability thread sequence to the user. In some embodiments, computer system 1700 may present one or more additional sequences to the user, based on specified criteria. In some embodiments, the user may control the criterion for having more than one alternative presented and/or may control the frequency of such presentations.

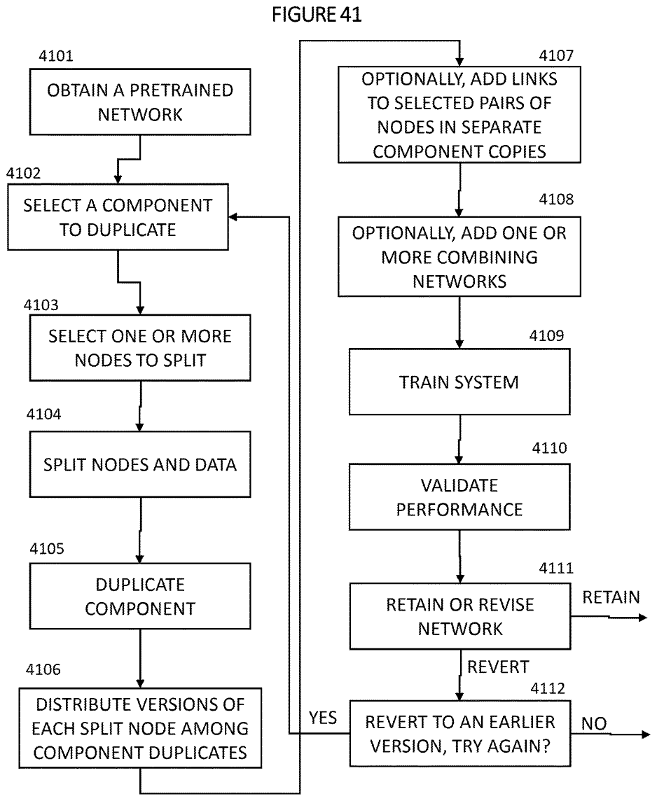

FIG. 41 is a flow chart of an illustrative embodiment of an aspect of the invention in which computer system 1700 may incrementally grow a neural network, or a hybrid network making one or more duplicates of a component to improve the performance of the network or making the network easier to understand and control.

In block 4101, in some embodiments, computer system 1700 may obtain a pretrained network.

In block 4102, in some embodiments, computer system 1700 may select a component to duplicate. The selected component may be one or more nodes in a set of nodes, a connected portion of a network, a subnetwork, or the full network.

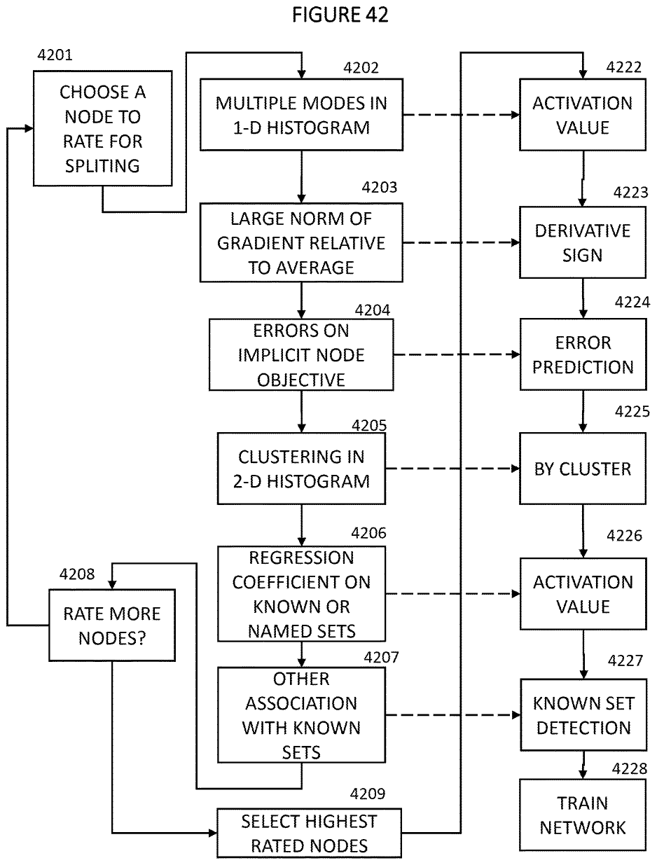

In block 4103, in some embodiments, computer system 1700 may select one or more nodes to split. In some embodiments, computer system 1700 may select node based on any of the selection methods discussed in association with blocks 4202-4207 of FIG. 42.

In block 4104, in some embodiments, computer system 1700 may split each of the selected nodes. In some embodiments, computer system 1700 may split a node by making copies of the node and training each copy of the node on a distinct set of data. In some embodiments, computer system 1700 may add data switching nodes to the network to distribute the desired data respectively to each copy of the node. In some embodiments, computer system 1700 may split a node by creating a copy of the node and then training each copy of the node on a distinct task, such as a task of discriminating a distinct selection of a pair of named sets.

In block 4105, in some embodiments, computer system 1700 may make one or more copies of the selected component.

In block 4106, in some embodiments, computer system 1700 may distribute copies of the split nodes among the copies of the duplicated component. In preferred embodiments, computer system 1700 may distribute a copy of the data switches associated with a node to any copy of the component receiving a copy of the node.

In block 4107, in some embodiments, computer system 1700 may optionally add data-dependent relationship regularization links to selected pairs of nodes that are in separate copies of the component. In some embodiments, computer system 1700 may select copies of a split node as a pair of nodes to link. In some embodiments, computer system 1700 may select copies of a node in the duplicated component that is not a split node. In some embodiments, computer system 1700 may link one or more pairs of nodes with an is-not-equal-to regularization link. In some embodiments, computer system 1700 may link one or more pairs of nodes with an is-equal-to regularization link. In some embodiments, computer system 1700 may use both types of links for one or more component pairs.

In block 4108, in some embodiments, computer system 1700 may optionally add one or more combining networks to combine the outputs of the copies of the duplicated component as discussed in association with FIG. 44.

In block 4109, in some embodiments, computer system 1700 may train the system.

In block 4110, in some embodiments, computer system 1700 may validate the performance of the system on a set of data set aside from the training data.

In block 4111, in some embodiments, computer system 1700 may determine whether to retain the network with the duplicated components or to revert to an earlier version of the network based on specified criteria and the comparative validation performance. If computer system 1700 decides to retain the new network or networks, the process illustrated in FIG. 41 is done. However, in some embodiments, computer system 1700 may continue to train the new network or networks and may again duplicate one or more components or duplicate the full network. If computer system 1700 determines to revert to an earlier version of the network, computer system 1700 proceeds to block 4112.

In block 4112, in some embodiments, computer system 1700 reverts to an earlier version of the network and determines whether to again try to improve the network by duplicating one or more components. If computer system 1700 determines not to try again, the process illustrated in FIG. 41 is done. If computer system 1700 determines to try again, computer system 1700 returns to block 4102 and makes different selections in blocks 4802 and 4803.

FIG. 42 is a flow chart of an illustrative embodiment of computer system 1700 selecting a node to split based on tests of one or more criteria for various reasons and methods of splitting a node.

In block 4201 of FIG. 42, in some embodiments, computer system 1700 may select a node to rate for potential improvement from duplicating or “splitting” the node. In some embodiments, computer system 1700 may rate each selected node based on the expected amount of improvement in a specified criterion for each of the situations described in association with blocks 4202-4207.

In block 4202, in some embodiments, computer system 1700 may rate one or more one-dimensional histograms associated with the node selected in block 4201. In some embodiments, if the histogram of the activation function of the selected node is multi-modal based on specified criteria, computer system 1700 may set a threshold value T to separate data for a first mode from data for a second mode.

The dashed lines from blocks 4202-4207 to blocks 4222-4227 indicate that, for each of the rating criteria in blocks 4202-4207, in some embodiments, computer system 1700 may apply the node splitting operation described in association with the corresponding block in 4222-2227 for each node selected as among the highest rated in block 4209.

In block 4203 of FIG. 42, in some embodiments, for a partially trained network, computer system 1700, may compute Dₙ(dᵢ), the derivative of the network objective with respect to the activation value of the selected node d for each training data item dᵢ. In some embodiments, computer system 1700 may compare the average of the absolute value of the derivative to the absolute value of the average of the derivative, such as by

$$( \frac{{\sum }_{i} \vert {D}_{n} ( {d}_{i} ) \vert}{m} ) / Max ( ε , \vert \frac{{\sum }_{i} \vert {D}_{n} ( {d}_{i} ) \vert}{m} \vert ) .$$

In some embodiments, computer system 1700 may specify a value of ε so that the magnitude of the denominator of the fraction does not become too small as the training converges or approaches a stationary point. In some embodiments, computer system 1700 may choose a larger value for ε of may set the denominator of the fraction to a specified constant. In some embodiments, if the fraction is larger than a specified criterion, in block 4209, computer system 1700 may create copies of the node and create a data switch that assigns data items with negative derivative values to one of the two new copies and data items with positive derivative values to the second of the two new copies.

In block 4204 of FIG. 42, in some embodiments, for a specified set of data items, dϵD, and a specified set of nodes nϵN. computer system 1700 may compute the activation actₙ(d) and the back propagated derivative

$$\frac{dY ( d )}{{dact}_{n} ( d )} ,$$

where Y(d) is the network objective evaluated for data item d. In some embodiments, computer system 1700 may then compare the sign of

$$\frac{dY ( d )}{{dact}_{n} ( d )}$$

to the sign of the difference between actₙ(d) and a specified threshold value T. In some embodiments, if

$$( {act}_{n} ( d ) - T ) * \frac{dY ( d )}{{dact}_{n} ( d )} < 0 ,$$

computer system 1700 may signify that, for data item d, actₙ(d) is an error relative to the implicit local objective. In some embodiments, computer system 1700 may rate the severity of the errors as |actₙ(d)−T|. In some embodiments, computer system 1700 may rate the severity of the error as

$$\vert ( {act}_{n} ( d ) - T ) * \frac{dY ( d )}{{dact}_{n} ( d )} \vert .$$

In block 4205, in some embodiments, computer system 1700 may compute a 2-dimensional histogram based on a specified pair of variables. In some embodiments, one of the variables may be the activation of a specified node. In some embodiments, the second variable may be the derivative of a network objection or of a local objective with respect to the activation of the selected node. In some embodiments, one variable may be the activation of a first node that is specified as the node that is being rated for possible node splitting and the second variable may be the activation of a second node. In some embodiments, computer system 1700 may cluster a specified set of data items based on a specified clustering algorithm. In some embodiments, computer system 1700 may use any of many clustering algorithms that are well known to those skilled in the art of machine learning, such as k-means clustering or Gaussian mixture models. In some embodiments, computer system 1700 may use the mixture of generators model described in U.S. Pat. No. 11,354,578 titled “Mixture of Generators Model.” In some embodiments, computer system 1700 may rate the node as a candidate for splitting by any of many methods for evaluating the performance of clustering that are well known to those skilled in the art of machine learning, such as mutual information, the variance ratio criterion, the silhouette score, or the rand index.

In block 4206, in some embodiments, computer system 1700 may compute a regression coefficient for the number of data items in one or more known sets as a function of the activation value of a node candidate for splitting. In some embodiments, computer system 1700 may use the magnitude of the regression coefficient for a specified known or named set as the node selection rating. In some embodiments, computer system 1700 may select pairs of known sets in which one member of the pair has a positive regression coefficient and the second member of the pair has a negative regression coefficient and use the difference between the regression coefficients as the node rating.

In block 4207, in some embodiments, computer system 1700 may rate a node candidate with a monotonic activation function by finding the threshold value for the activation function that optimizes a specified measure of precision and recall for the detection of a specified known set. In some embodiments, computer system 1700 may select a pair of known sets and rate a node candidate based on the precision and recall in discriminating data from one of the known sets from data in the other known set.

In block 4208, in some embodiments, computer system 1700 may determine whether to rate more nodes based on specified criteria. In some embodiments, computer system 1700 may rate all the nodes in a network or all the nodes in a specified subset of the network. In some embodiment, computer system 1700 may randomly select candidate nodes until a specified number of nodes have been rated. In some embodiments, computer system 1700 may continue rating nodes until a specified number of nodes have ratings that satisfy a specified selection criterion, or all the nodes have been rated. If computer system 1700 determines that more nodes are to be rated, computer system 1700 returns to block 4201. Otherwise, computer system 1700 proceeds to 4209.

In block 4209, in some embodiments, computer system 1700 may select the highest rated node splitting candidates based on specified criteria. In some embodiments, computer system 1700 then proceeds to block 4222 and blocks 4223-4227 to perform node splitting operations customized to each of node splitting candidate rating methods.

In block 4222, in some embodiments, after selecting the highest rated nodes in block 4209, for each node rated in block 4202 and selected in block 4209, computer system 1700 may create two copies of the selected node. In some embodiments, computer system 1700 may create each copy of a selected node with the same incoming and outgoing connections as the selected node. In some embodiments, computer system 1700 may initialize the weights on the outgoing connections to zero. In some embodiments, computer system 1700 may train each of the node copies with data items with activations on the specified side of the threshold value T corresponding to the mode assigned to the node copy. In some embodiments, computer system 1700 may make a copy of the selected node to use as a data switch. In some embodiments, computer system 1700 may copy the subnetwork of the selected node, including the connection weights, and use the subnetwork copy as a subnetwork for the data switch. In some embodiments, for later training and inference, computer system 1700 may send data to the node copy controlled by the data switch and the threshold T. In some embodiments, in later training, the threshold T may be a tunable hyperparameter.

In block 4223, in some embodiments, after selecting the highest rated nodes in block 4209, for each node rated in block 4203 and selected in block 4209, computer system 1700 may create two copies of one or more of the nodes selected based on the rating computed in block 4203. In some embodiments, computer system 1700 may create for each copy a selected node with the same incoming and outgoing connections as the selected node. In some embodiments, computer system 1700 may initialize the weights on the outgoing connections to zero. In some embodiments, computer system 1700 may train each of the node copies with data items having a back propagated derivative in the original network with the sign of the derivative agreeing with assigned sign value for the respective node copy.

In block 4224, in some embodiments, after selecting the highest rated nodes in block 4209, for each node rated in block 4204 and selected in block 4209, computer system 1700 may train one or more new nodes to detect or discrimination sets of data related to predicting or analyzing errors of the selected node on an implicit local objective, such as: (1) detect the set of data d such that

$$( {act}_{n} ( d ) - T ) < 0 and \frac{dY ( d )}{{dact}_{n} ( d )} > 0 , ( 2 )$$

detect the set of data d such that

$$( {act}_{n} ( d ) - T ) > 0 and \frac{dY ( d )}{{dact}_{n} ( d )} < 0 , or ( 3 )$$

discriminate the set d for which

$$( {act}_{n} ( d ) - T ) > 0 and \frac{dY ( d )}{{dact}_{n} ( d )} > 0$$

from the set for which

$$( {act}_{n} ( d ) - T ) < 0 and \frac{dY ( d )}{{dact}_{n} ( d )} < 0.$$

In block 4225, in some embodiments, after selecting the highest rated nodes in block 4209, for nodes rated in block 4205 and selected in block 4209, computer system 1700 may add one or more nodes to the network with each new node trained to detect a specified cluster in the 2-dimensional histogram.

In block 4226, in some embodiments, after selecting the highest rated nodes in block 4209, for each node rated in block 4206 and selected in block 4209, computer system 1700 may create a new node as a detector for a known or named set that, in block 4206, computer system 1700 associated with a regression coefficient with a magnitude above a specified value. In some embodiments, computer system 1700 may create a new node as a discriminator of a pair of known or named sets that, in block 4206, computer system 1700 associated with a regression coefficient with a magnitude above a specified value. In some embodiments, computer system 1700 may create two new nodes with one of the new nodes trained to detect one of a pair of sets associated with a regression coefficient with a magnitude above a specified value and the second node trained as a detector of the second set in the pair of sets of data.

In block 4227, in some embodiments, after selecting the highest rated nodes in block 4209, for a node rated in block 4207 and an associated known or named set, selected in 4209, computer system 1700 may train a new node as a detector of the associated known or named set for each known or named set rated in block 4207 and selected in block 4209. For a node rated in block 4207 and an associated pair of known or named sets, selected in 4209, computer system 1700 may train a new node as a discriminator of the associated pair of known or named sets for each pair of known or named sets rated in block 4207 and selected in block 4209.

In some embodiments, computer system 1700 may do preliminary training of each new node as the node is created in blocks 4222-4227. In block 4228, computer system 1700 may do further training of the expanded network comprising all the new nodes. In some embodiments, computer system 1700 may postpone the training of one or more of the new nodes to the be done in block 4228 rather than as the new node is created.

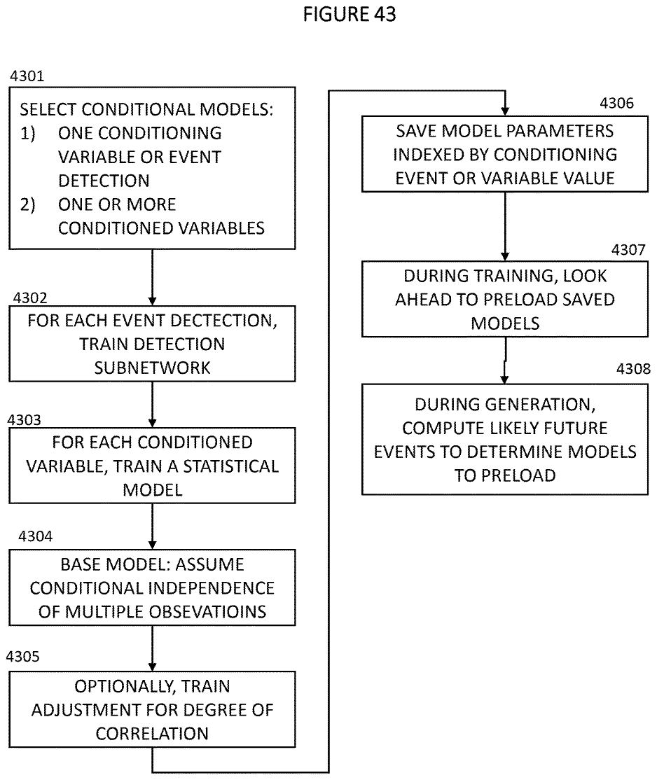

FIG. 43 is a flow chart of an illustrative embodiment of an aspect of the invention in which computer system 1700 may manage the training, saving, and loading of certain types of conditional probability models.

In block 4301, in some embodiments, computer system 1700, for one or more locations in neural network or hybrid network, may select to construct and train conditional probability models satisfying the following two properties: (1) the probability model is conditional on a single event detection or the value of a single observed random variable, and (2) the model estimates the probability of one or more events or the sufficient statistics or one or more random variables. For example, the conditioning event may be that for a data item d, a specified node has an activation value in a specified range, such as the range of values above a specified detection threshold.

In block 4302, in some embodiments, for an event that is determined by means other than the activation value of a specified node relative to a specified threshold, computer system 1700 may train a node and a subnetwork as a detector of the defined event. In some embodiments, even for a specified event that is indicated to some degree by the activation value of a specified indication node relative to a specified threshold, computer system 1700 may create a new node and new subnetwork and train the new node and its subnetwork as a dedicated detector of the specified event. In some embodiments, computer system 1700 may subsequently train the network training the new node to detect the defined event while training the original indication node without constraining the original node to avoid drifting from the being an indicator of the selected event.

In block 4303, in some embodiments, for each conditioning variable, computer system 1700 may train a statistical model for the probability distribution of one or more variables dependent on the value of the conditioning variable. In some embodiments, computer system 1700 may estimate sufficient statistics for a parametric probability distribution. In some embodiments, computer system 1700 may estimate a discrete probability distribution of one or more discrete-valued random variables dependent on the value of the conditioning variable.

In block 4304, in some embodiments, computer system 1700 may model the probability of a plurality of random variables dependent on the same event or variable by assuming conditional independence, given the value of the conditioning event or variable.

In block 4305, in some embodiments, computer system 1700 may optionally train additional learned parameters, such as an estimate of the correlation of two variables dependent on the same conditioning variable. In some embodiments, computer system 1700 may use such an estimate of the correlation to make a numerical adjustment in the estimate of the probability of a specified joint observation.

In block 4306, in some embodiments, computer system 1700 may save the model parameters in a data structure indexed by the conditioning event or by the value of a conditioning variable. In some embodiments, computer system 1700 may store the model in a storage means with higher capacity but slower retrieval time, such as CPU memory rather than GPU memory or secondary storage rather than CPU memory.

In block 4307, in some embodiments, during training on sequential data such as text, computer system 1700 may look ahead in the sequence of data to determine what conditioning event or conditioning variable values are going to occur soon in the known training sequence. In some embodiments, computer system 1700 may asynchronously preload into faster memory the models that will be needed soon to have them ready by the time they are needed.

In block 4308, in some embodiments, during generation of sequential data such as text, computer system 1700 may use one or more future prediction models to estimate the most likely future events and preload those models. In some embodiments, computer system 1700 may comprise multiple GPUs, multiple CPUs, and multiple storage subsystems capable of accessing data independently of each other. In some embodiments, computer system 1700 may store multiple copies of one of more conditional probability distributions and may retrieve models that are estimated to be needed soon. In some embodiments, computer system 1700 may do the retrieval as a task done by multiple subsystems in parallel, each subsystem retrieving an assigned subset of the models to be retrieved.

FIG. 44 is a diagram of an illustrative embodiment of an aspect of the invention in which computer system 1700 may use a combining network, data dependent relation regularization links, and selective back propagation for decorrelation of errors for jointly optimizing the performance of a set of networks and training them to be diverse from each other.

In some embodiments, for a set of N>1 classifier networks 4401_1, 4401_2, . . . , 4401_N, trained on a shared classification task, computer system 1700 may add a combining network 4402, as described in U.S. Pat. No. 11,222,288, titled “Joint Optimization of Ensembles in Deep Learning” to create a composite network for the shared classification task. In some embodiments, computer system 1700 may train the composite network comprising combining network 4402 and component networks 4401_1, 4401_2, . . . , 4401_N.

In some embodiments, computer system 1700 may obtain one or more of the networks 4401_1, 4401_2, . . . , 4401_N pretrained on a task different from the shared task of the system in FIG. 44.

In some embodiments, to increase the diversity among the N networks, computer system 1700 may back propagate from a shared classification objective of the composite network to optimize the joint performance of the N networks on the shared task.

In some embodiments, computer system 1700 may create data dependent relation regularization links among the networks, as illustrated by the dash-dot arrows 4403_12, 4403_1N, and 4403_2N. In some embodiments, computer system 1700 may specify any of the data dependent relation regularization links to be bi-directional or to be uni-directional in either direction. In some embodiments, computer system 1700 may specify the relation of one or more of these links to regularize a pair of linked nodes toward having different activations when their networks receive the same input. For example, the relation may be “is-not-equal-to.” In addition, in some embodiments, computer system 1700 may specify the relation of one or more of these links to be “is-equal-to” to regularize and moderate the diversity induced by “is-not-equal-to” links.

In some embodiments, computer system 1700 may also use selective back propagation, indicated by dash arrows 4404_1, 4404_2, and 4404_N, to asymmetrically penalize a pair of subnetworks when both of the pair of subnetworks make the same mistake on a specific data item, as described in U.S. Pat. No. 10,885,470 titled “Selective Training for Decorrelation of Errors.”

FIG. 45 is a flow chart of an illustrative embodiment in which computer system 1700 may generate text using a combination of transformer language models and stochastic models, with cooperation among the AI language models as well as explicit cooperative interaction between the human author, and the AI system, as the writer's assistant.

In block 4501, in some embodiments, computer system 1700 may obtain a prompt, a query, or an instruction from the user. Any of these forms of initial input text may be referred to as the “starting context.” In some embodiments, computer system 1700 may tokenize the text in the training corpus. In some embodiments, computer system 1700 may preprocess the training corpus to determine semantic units. In some embodiments, computer system 1700 may use a pretrained large language model to determine the semantic units.

In block 4502, in some embodiments, computer system 1700 may determine the intended writing style for the document to be generated and the working style that the user prefers for the interaction between the human author and the AI writer's assistant. In some embodiments, computer system 1700 may deduce the writing style from the style of the prompt or from explicit instructions from the human writer. In some embodiments, computer system 1700 may ask the user for confirmation of a deduced writing style.

In blocks 4503-4508, in some embodiments, computer system 1700 may use one or more of several language model subsystems to determine a list of tokens that are likely to occur in an interval of text following the current context.

In block 4503, in some embodiments, computer system 1700 may use one or more forward named-set prediction nodes. A named-set prediction node is a node that computer system 1700 has trained to discriminate between two sets of tokens. In some embodiments, one of the two sets of tokens comprises tokens that are more likely to occur in a specified interval following the current context than their average rate of occurrence and the second set of tokens comprises tokens that are less likely to occur in the specified interval following the current context than their average rate of occurrence. In some embodiments, computer system 1700 may have trained a node to have an activation that estimates the logarithm of the ratio of the probability of occurrence given the current context to the unconditioned probability of occurrence of a token in the specified set. In some embodiments, computer system 1700 may use forward named-set prediction nodes for a plurality of specified intervals. In some embodiments, computer system 1700 used named-set prediction nodes that predict future occurrences of words rather than tokens. In some embodiments, computer system 1700 may specify as a future interval the single-position interval consisting of just the current token to be generated. In some embodiments, computer system 1700 may specify as a future interval the interval from the token following the current token to a specified maximum position for the beams generated in blocks 4505-4507.

In block 4504, in some embodiments, computer system 1700 may select the best candidate tokens for one or more specified intervals. In some embodiments, computer system 1700 may determine the probability of a specified token in a specified interval as the product of the unconditioned probability of the token occurring multiplied by a ratio estimated in block 4503.

In block 4505, in some embodiments, computer system 1700 may generate a list of candidate tokens generating or extending a beam of token sequences using an autoregressive autoencoder. In some embodiments, computer system 1700 may use a text generator to produce a beam of token choices by successively selecting each of a plurality of candidate tokens in each successive position in the sequence. In some embodiments, after generating a position in the sequence, computer system 1700 may prune the beam by accepting only the best candidates as determined by a specified criterion. In some embodiments, computer system 1700 may accept only up to a specified number of candidates. In some embodiments, computer system 1700 may accept only candidates with an estimated probability greater than a specified fraction of the estimated probability of the candidate with the highest estimated probability. In some embodiments, computer system 1700 may prune the beam for previously processed token positions by eliminating any candidate token for which there is no continuation that has not been pruned. In some embodiments, computer system 1700 may use similar beam pruning in blocks 4506 and 4507.

In block 4506, in some embodiments, computer system 1700 may generate a list of candidate tokens extending a beam of state space values for one or more hidden Markov process models. In some embodiments, computer system 1700 may model the value of one or more future named-set discriminator nodes as the observations of a hidden Markov process. In some embodiments, computer system 1700 may model one or more named-set discriminators that that each discriminate two or more named sets of tokens for the position currently being generated. In some embodiments, computer system 1700 may model sequences of semantic units rather than tokens. In some embodiments, computer system 1700 may model one or more named-set discriminators that discriminate named sets for positions in the sequence starting beyond the current position and extending a specified number of positions beyond. In some embodiments, the state of the hidden Markov process predicting the current position may have a high probability of changing state for each step in the sequence. In contrast, the state of the Markov process predicting named sets in the more distant future may have a high probability of staying in the same state during any one step in the sequence, resulting in only a few changes in the beam.

In block 4507, in some embodiments, computer system 1700 may generate or extend a beam based on samples from the corpus. In some embodiments, for each semantic unit, computer system 1700 may keep available, or retrieve on demand, a set of sample passages, each comprising an instance of the semantic unit. In some embodiments, for each specific semantic unit in the context, computer system 1700 may generate or extend a beam of token candidates from counts of words that occur in the text following instances of the specific semantic unit in samples of the corpus.

In block 4508, in some embodiments, computer system 1700 may build a list of tokens or semantic units for each position in a specified interval of the sequence being generated. In some embodiments, computer system 1700 may compute a combined score for each candidate and prune the list of candidates for each position in the sequence based on the combined score.

In block 4509, in some embodiments, computer system 1700 may select a candidate token from the short list of candidates for the current position in the pruned beam.

In block 4510, may compute the probability of the selected candidate using Bayes rule as discussed in association with FIG. 32.

In block 4511, in some embodiments, computer system 1700 may compute a score and relative rank for the candidate token selected in block 4510 based on the score and rank of the candidate token in one or more autoregressive large language models.

In block 4512, in some embodiments, computer system 1700 may compute a score and relative rank for the candidate token selected in block 4510 based on the score and rank of the candidate token in one or more autoencoder large language models. In some embodiments, computer system 1700 may select one or more token sequences from the beam lists computed in block 4508 as the future context for a masked token for the current position.

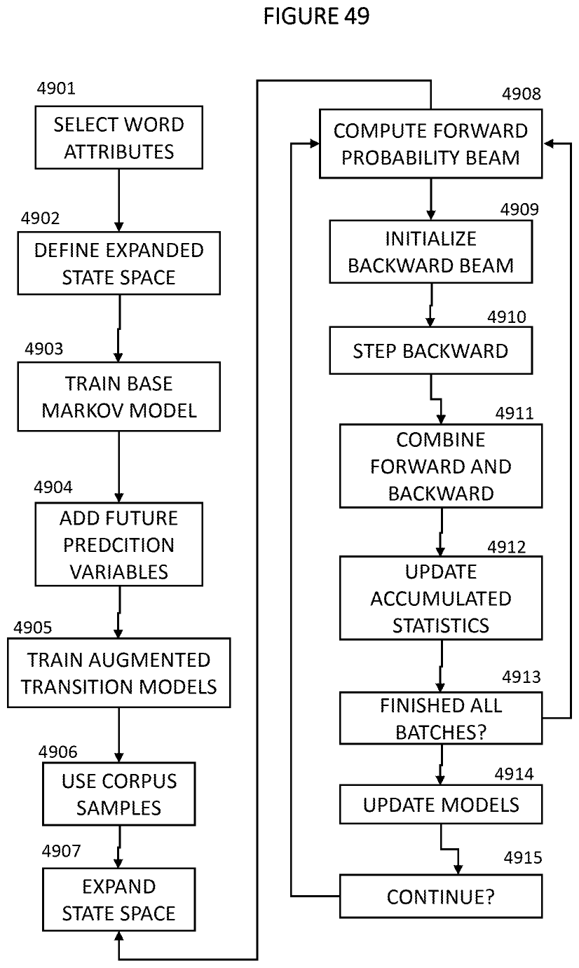

In block 4513, in some embodiments, computer system 1700 may compute a score and relative rank for the candidate token selected in block 4510 based on the score and rank of the candidate token in one or more hidden Markov process models. In some embodiments, computer system 1700 may estimate, for the current sequence position, the probability of each state of one or more of the hidden Markov processes using the forward alpha computation as discussed in association with block 4908 of FIG. 49. In some embodiments, computer system 1700 may estimate, for the current sequence position, the probability of each state of one or more of the hidden Markov processes using the gamma computation as discussed in association with block 4911 of FIG. 49.

In block 4514, in some embodiments, computer system 1700 may estimate the probability and rank of a specified candidate token based on samples from the training corpus comprising instances of the token or instances of a sematic unit comprising the specified token. In some embodiments, computer system 1700 may compare the context of an instance of a token in a randomly selected sample with the context of the current generation process. In some embodiments, computer system 1700 may compare a vector of node activations for selected nodes in an autoregressive transformer and/or selected nodes in an autoencoder transformer with the corresponding the node values precomputed for one or more selected samples and stored in a data structure indexed by the token or semantic unit. In some embodiments, computer system 1700 may include node activations for a neural network with an architecture other than a transformer. In some embodiments, computer system 1700 may include some future named-set discriminator nodes. In some embodiments, computer system 1700 may rank the token candidates based on the average of the correlations of the vector of node activations for the current sequence comprising the specified candidate token with the vector of node activations of the selected samples from the training corpus.

In block 4515, in some embodiments, computer system 1700 determines whether to select and rank additional candidate tokens. If so, computer system 1700 returns to block 4510. Otherwise, computer system 1700 proceeds to block 4516.

In block 4516, in some embodiments, computer system 1700 may choose a candidate token for the current position. In some embodiments, computer system 1700 may select the highest ranked token from a combination of the rankings computed in blocks 4510-4514. In some embodiments, computer system 1700 may randomly select the token from the K highest ranked tokens for a specified value of K. In some embodiments, computer system 1700 may select the token from the K token candidates with a probability proportional to each token's estimated conditional probability of occurrence given the current context. In some embodiments, computer system 1700 may estimate the conditional probability of each candidate token as discussed in association with FIG. 32. In some embodiment, computer system 1700 may then test to see if the sequence with the selected token violates any specified guardrail test. If the sequence violates a guardrail test, computer system 1700 proceeds to block 4517. Otherwise, computer system 1700 proceeds to block 4518.

In block 4517, in some embodiments, computer system 1700 may back up the generated sequence to an earlier state. In some embodiments, computer system 1700 backs up to the previous position in the sequence with regularization specified according to the guardrail violation. In some embodiments, computer system 1700 may back up to a previously saved earlier position as determined by criteria associated with the guardrail violation. Computer system 1700 then proceeds to block 4521. In some embodiments, computer system 1700 may back up to redo the selection for the current position but eliminating from consideration the candidate that computer system 1700 selected in block 4516.

In block 4518, in some embodiments, computer system 1700 may advance each beam by one position and update the pruning of the beams.

In block 4519, in some embodiments, computer system 1700 may update the future-event named-set discriminators.

In block 4520, in some embodiments, computer system 1700 may advance the hidden Markov process model by one position, increasing the index in the alpha computations by one.

In block 4521, computer system 1700 determines whether to continue the process of generating the sequence of tokens. In some embodiments, one of the set of tokens may be a signal to end the current sequence generation process. In some embodiments, computer system 1700 may determine to end the current generation process based on guardrail tests and specified criteria. In some embodiments, computer system 1700 may provide a means for the end user to terminate the current generation process. If computer system 1700 determines to terminate the current generation process, the process illustrated in FIG. 45 is suspended until reactivated with a new context in block 4501. In some embodiments, computer system 1700 may output the generated sequence by a specified means during the ongoing generation process. In some embodiments, if computer system 1700 determines to terminate the generation process, computer system 1700 may output any remaining sequence by the specified means. If computer system 1700 determines to continue the current generation process, then computer system 1700 returns to block 4503.

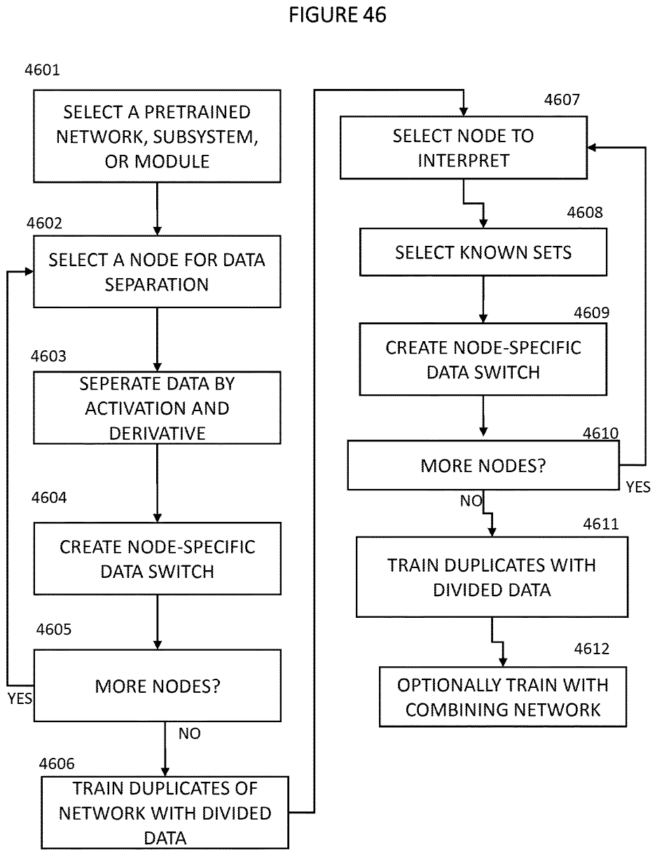

FIG. 46 is a flow chart of an illustrative embodiment of an aspect of the invention in which, in some embodiments, computer system 1700 may efficiently train a large neural network or hybrid network by first training a smaller neural network. In some embodiments, computer system 1700 may then repeatedly double the size of a component or double the size of the whole network and efficiently train the doubled network by use of data-dependent relation regularization links and other techniques to guide the training of the new network components.

In block 4601, in some embodiments, computer system 1700 may select a pretrained network, subsystem or module. In some embodiments, computer system 1700 may select a network, subsystem or module that is only partially trained and that still makes errors on the training data. In some embodiments, computer system 1700 may select a network, subsystem or module that is fully trained such that the training has converged and the magnitude of the gradient of the objective is close to zero, but the task of the system is sufficiently difficult that computer system 1700 still makes errors on the training data. In some embodiments, computer system 1700 may select a network, subsystem or module that has been trained to produce no errors on the training data.

In block 4602, in some embodiments, computer system 1700 may select a node for data separation.

In block 4603, in some embodiments, computer system 1700 may divide the data based on node activation value and on the value of the derivative of the network objective for the node selected in block 4602. In some embodiments, computer system 1700 may use the values of the activation and the derivative to determine for each data item whether the activation value and derivative value correspond to an error on an implicit local objective and, if so, whether the error is a false positive or a false negative. Even if the gradient averaged over the full epoch of training data is zero, in general the derivative on an individual data item is non-zero. Typically, even if a network is fully trained, computer system 1700 may detect nodes on which there is an error on the implicit local node target for individual data items. In some embodiments, computer system 1700 may divide the data into sets such as (1) the set of data d such that

$$( {act}_{n} ( d ) - T ) < 0 and \frac{dY ( d )}{{dact}_{n} ( d )} > 0 , ( 2 )$$

the set of data d such that

$$( {act}_{n} ( d ) - T ) > 0 and \frac{dY ( d )}{{dact}_{n} ( d )} < 0 , or ( 3 )$$

the set d such that

$$( {act}_{n} ( d ) - T ) > 0 and \frac{dY ( d )}{{dact}_{n} ( d )} > 0.$$

In block 4604, in some embodiments, computer system 1700 may create and train a set of one or more detector nodes to detect any of the sets (1), (2) and/or (3) above. In some embodiments, computer system 1700 may train one or more new nodes to discriminate between a specified pair of the three sets. In some embodiments, computer system 1700 may use these trained detectors and/or discriminators as a data switch for training copies of the network, subnetwork, or module in block 4606. In some embodiments, computer system 1700 may record sets such as (1), (2) and (3) and directly control the training of copies of the network, subnetwork, or module in block 4606.

In block 4605, in some embodiments, computer system 1700 may determine, based on specified stopping criteria, whether to test additional nodes. If so, computer system 1700 returns to block 4602. Otherwise, computer system 1700 proceeds to block 4606.

In block 4606, in some embodiments, computer system 1700 may create duplicates of the network, subnetwork or module selected in block 4601. In some embodiments, computer system 1700 may assign different sets of training data for each copy of each node. In some embodiments, computer system 1700 may use the data switches trained in block 4604 to control the training data sent to each copy of any node selected in block 4602. In some embodiments, computer system 1700 may directly control the subset of the training data used in training each copy of a node selected in block 4602.

In block 4607, in some embodiments, computer system 1700 may select a node for which computer system 1700 will make copies of the selected node to train on different sets of data to make the node copies easier to interpret than the original node.

In block 4608, in some embodiments, computer system 1700 may select one or more named sets to be associated with copies of the node selected in block 4607.

In block 4609, in some embodiments, computer system 1700 may create a node-specific data switch. In some embodiments, computer system 1700 may control the data switch such that different copies receive sets of data from different selections of known sets or of complements of known sets.

In block 4610, in some embodiments, computer system 1700 determines, based on specified criteria, whether to select more nodes for which to make copies that are easier to interpret. If so, computer system 1700 returns to block 4607. Otherwise, computer system 1700 proceeds to block 4611.

In block 4611, in some embodiments, computer system 1700 may make duplicates of the network, subnetwork, or module selected in 4601 and train each duplicate such that each node selected in block 4607 is trained on data selected as specified in blocks 4608 and 4609.

In block 4612, in some embodiments, computer system 1700 may optionally train a combing network for the duplicates of the network, subnetwork, or module selected in block 4601. In some embodiments, computer system 1700 may train the composite network comprising the combining network and all the duplicate networks.

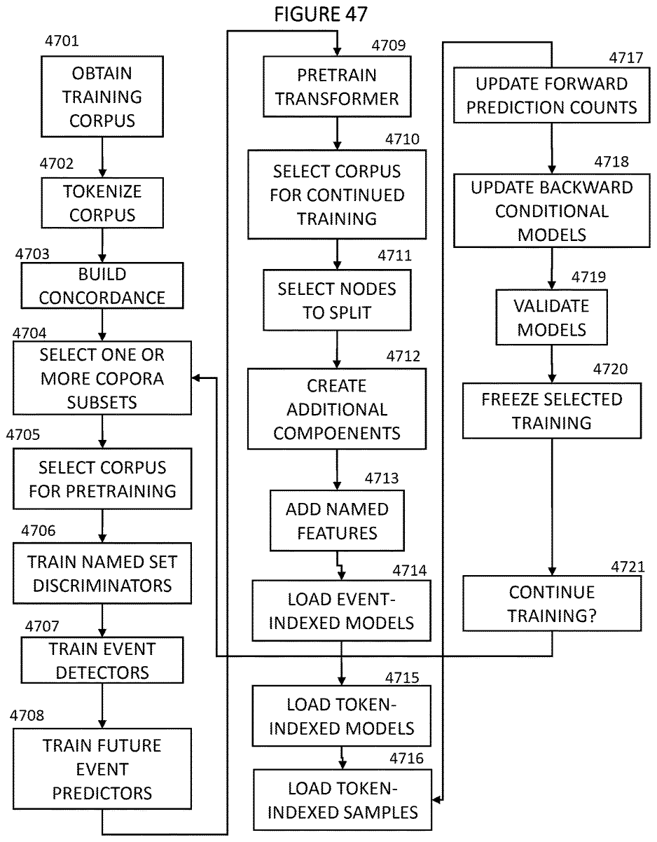

FIG. 47 is a flow chart of an illustrative embodiment of a process by which computer system 1700 may train a large language model.

In block 4701, in some embodiments, computer system 1700 may obtain a training corpus, that is a large collection of computer readable text.

In block 4702, in some embodiments, computer system 1700 may tokenize the corpus. A token may be a word, a contraction, or a part of a word. The set of tokens may include inflexions so that computer system 1700 may tokenize “expectation”, for example, as “expect”+“ation”. The set of tokens may include the letters of the alphabet so that computer system 1700 may tokenize a new word that is not in the set of tokens by spelling the word with one token for each letter.

In block 4703, in some embodiments, computer system 1700 may build a concordance. That is, computer system 1700 may construct a data structure by which, for any specified word, computer system 1700 can find all the instances of the specified word in the training corpus. In some embodiments, computer system 1700 may build additional related concordances such that, for example, computer system 1700 can directly find all instances of a specified word pair for any word pair in the concordance. In some embodiments, computer system 1700 may construct a concordance for all instances of a specified word that have one or more specified attributes, such as the part of speech of the instance of the word.

In block 4704, in some embodiments, computer system 1700 may select one or more subsets of the training corpus. In some embodiments, computer system 1700 may select a distinct subset of the corpus for each of a plurality of subsystems in a distributed implementation of the process illustrated in FIG. 47. In some embodiments, computer system 1700 may select subsets that are distinct but that may overlap and not be disjoint. In some embodiments, computer system 1700 may select a distinct subset of the corpus for each of a plurality of distributed subsystems.

In block 4705, in some embodiments, computer system 1700 may select a corpus for initial training or pretraining event detectors, event predictors, and/or prior context features.

In block 4706, in some embodiments, computer system 1700 may train one or more named-set discriminators that discriminate two or more subsets of the vocabulary or of the set of tokens. In some embodiments, computer system 1700 may use the process described in association with FIG. 28 to train a subnetwork or a separate network to discriminate two or more specified sets. In some embodiments, computer system 1700 may name each set with a list of selected words within the set. In some embodiments, computer system 1700 may select one or more nodes in the embedding of a sequence of one or more tokens and designate the activation value of each selected node as an input variable for a named-set discriminator. In some embodiments, computer system 1700 may select one or more other nodes in the network and designate the activation value of each selected node as an input variable for a named-set discriminator. In some embodiments, computer system 1700 may add a new node to the network with specified input connections and train the node as a named-set detector.

In block 4707, in some embodiments, computer system 1700 may train one or more event detectors. In some embodiments, computer system 1700 may specify as an “event” any property of the training sequence and/or the activation values of nodes in the network. In some embodiments, computer system 1700 may define a sequence position event as the presence or absence of the event property for a specified position in a specified text sequence. In some embodiments, computer system 1700 may define an occurrence of an interval event as the presence or absence of a specified sequence position event occurring within a specified interval of the specified text sequence. In some embodiments, computer system 1700 may select a portion of the training text as the specified text sequence. In some embodiments, computer system 1700 may select a portion of a generated sequence of text as the specified text sequence.

In block 4708, in some embodiments, computer system 1700 may train one or more “future event” predictors. In some embodiments, computer system 1700 may train as a future-event predictor a node or subsystem that receives input only from node activations and events that computer system 1700 may determine solely from the tokens up to a specified input limit position in the specified text sequence. In some embodiments, computer system 1700 may train the event predictor node to predict the presence or absence of a specified event during a specified future interval. In some embodiments, computer system 1700 may train an event predictor to model the relative likelihood of a predicted event in the specified interval compared to the a priori likelihood. In some embodiments, computer system 1700 may train an event predictor to model the logarithm of the ratio of the conditional probability of the event occurring in a specified interval divided by the a priori probability of the event occurring.

In block 4709, in some embodiments, computer system 1700 may pretrain a language model based on one or more transformer networks based on the corpus selected in block 4704.

In block 4710, in some embodiments, computer system 1700 may select a corpus for continued training. In some embodiments, computer system 1700 may select the same corpus in block 4710 as the corpus selected in block 4705. In some embodiments, computer system 1700 may select a distinct corpus in block 4710 to facilitate validation of the subsystems trained in blocks 4706-4709. In some embodiments, computer system 1700 may select a smaller corpus in block 4705 to enable more efficient pretraining and a larger corpus in block 4709 to facilitate training systems with a greater number of learned parameters.

In block 4711, in some embodiments, computer system 1700 may select one or more nodes to split. In some embodiments, computer system 1700 may select one or more nodes based on any of the criteria described in association with blocks 4202-4207 of FIG. 42.

In block 4712, in some embodiments, computer system 1700 may create additional components in the network based on node splitting and component duplication as described in association with FIGS. 41 and 42. In some embodiments, computer system 1700 may create additional attention heads of one or more of the multi-head attention blocks of the transformer pretrained in block 4709. In some embodiments, computer system 1700 may duplicate the input nodes to an attention head to supply input values for duplicates of that attention head. In some embodiments, computer system 1700 may use multiple combining networks as illustrated in FIG. 45 to match up the outputs of a first multi-head attention block to the inputs of a second multi-head attention block that may have more or fewer heads than the first multi-head attention block. In some embodiments, computer system 1700 may create one or more duplicates of a full system component such as a transformer.

In block 4713, in some embodiments, computer system 1700 may add one or more named features to one or more of the token embeddings in one or more of the multi-head attention blocks of one or more transformers.

In block 4714, in some embodiments, computer system 1700 may load one or more event-indexed models. During training, computer system 1700 may look ahead in the sequence of tokens in the training sample to determine any event that will occur in a specified future interval. In some embodiments, computer system 1700 may preload any models indexed by any event that will occur in the specified interval to avoid delay in the loading process due to retrieval latency.

In block 4715, in some embodiments, computer system 1700 may look ahead in the token sequence to preload token-index models.

In block 4716, in some embodiments, computer system 1700 may look ahead in the token sequence to preload token-indexed samples from the corpus.

In block 4717, in some embodiments, computer system 1700 may update the resident or newly loaded forward models from tallies of the newly observed values of conditioned variables in the models. In some embodiments, computer system 1700 may prevent model updating for data that has been designated as set aside for validation testing.

In block 4718, in some embodiments, computer system 1700 may update the resident or newly loaded backward models from tallies of the newly observed values of conditioned variables in the models. In some embodiments, computer system 1700 may prevent model updating for data that has been designated as set aside for validation testing.

In block 4719, in some embodiments, computer system 1700 may perform validation testing of the resident and newly loaded models.

In block 4720, in some embodiments, computer system 1700 may temporarily freeze the training of some models. In some embodiments, computer system 1700 may freeze the training of models that satisfy specified performance criteria.

In block 4721, in some embodiments, computer system 1700 may determine whether to continue or terminate the training process. In some embodiments, computer system 1700 may terminate the training process for the training corpus obtained in block 4701 and may release the system as trained for deployment. In some embodiments, computer system 1700 may resume training as lifelong learning during deployment.

FIG. 48 is a flow chart of an illustrative embodiment of a process by which computer system 1700 may generate text using a pretrained large language model.

In block 4801, in some embodiments, computer system 1700 may load a large language model pretrained such as described in FIG. 47.

In block 4802, in some embodiments, computer system 1700 may obtain a starting text, such as a prompt, question, instruction or other text from a human user. In some embodiments, computer system 1700 may obtain a starting text from another computer readable source, such a webpage or a digitized book or other document. In some embodiments, computer system 1700 may obtain a starting text from an AI text generator.

In block 4803, in some embodiments, computer system 1700 may load transformers, forward probability models and/or predictors. In some embodiments, computer system 1700 may load one or more independent generator systems. In some embodiments, computer system 1700 may predict tokens that are likely to occur in the next position. In some embodiments, computer system 1700 may predict tokens that are likely to occur in a specified future interval.

In block 4804, in some embodiments, computer system 1700 may rank the predicted future tokens in each position and select only the best to be on a short list of candidates. In some embodiments, computer system 1700 may determine the number of tokens selected as candidates for a specific position based on specified hyperparameters and criteria.

In block 4805, in some embodiments, computer system 1700 may load backward conditional probability models for candidate tokens in the short lists.

In block 4806, in some embodiments, computer system 1700 may load samples of text from the corpus for one or more of the candidate tokens for the next position.

In block 4807, in some embodiments, computer system 1700 may make a preliminary evaluation of the degree of agreement of the prior context for each candidate based on the backward models for the candidate. Optionally, computer system 1700 may also evaluate the degree of agreement or similarity of the sequence of prior tokens with the prior context in the samples from the corpus. In some embodiments, computer system 1700 may measure the similarity of two tokens being compared based on the correlation of their embeddings in one or more heads in one or more layers of a transformer.

In block 4808, in some embodiments, computer system 1700 may select the best candidates for the next position based on the evaluation in 4807.

In block 4809, in some embodiments, computer system 1700 may do a full evaluation of each of the selected best candidates for the next token. In some embodiments, computer system 1700 may estimate the a posteriori probability of each candidate by applying Bayes rule for the backward conditional probabilities.

In block 4810, in some embodiments, computer system 1700 may choose the next token. In some embodiments, computer system 1700 may select the best scoring candidate. In some embodiments, computer system 1700 may randomly select the next token from a specified subset of the best candidates with a probability proportional to the estimated a posteriori probability of each candidate. In some embodiments, computer system 1700 may restrict the set of candidates from which the next token may be chosen based on a specified criterion. In some embodiments, the specified criterion may limit the maximum number of candidates in the random selection. In some embodiments, the criterion may limit the candidates in the random selection to those with an estimated probability greater than a specified fraction of the estimated probability of the best candidate.

In block 4811, in some embodiments, computer system 1700 may make a record of any use of a sample from the training corpus. In some embodiments, computer system 1700 may use the concordance to find one or more passages in the training corpus that satisfy a specified measure of similarity to the text that computer system 1700 has generated. In some embodiments, computer system 1700 may keep a record of such instances of similarity. In some embodiments, computer system 1700 may test the generated text against one or more passages from the training corpus based on specified criteria for copyright infringement and make proper citations to prior work.

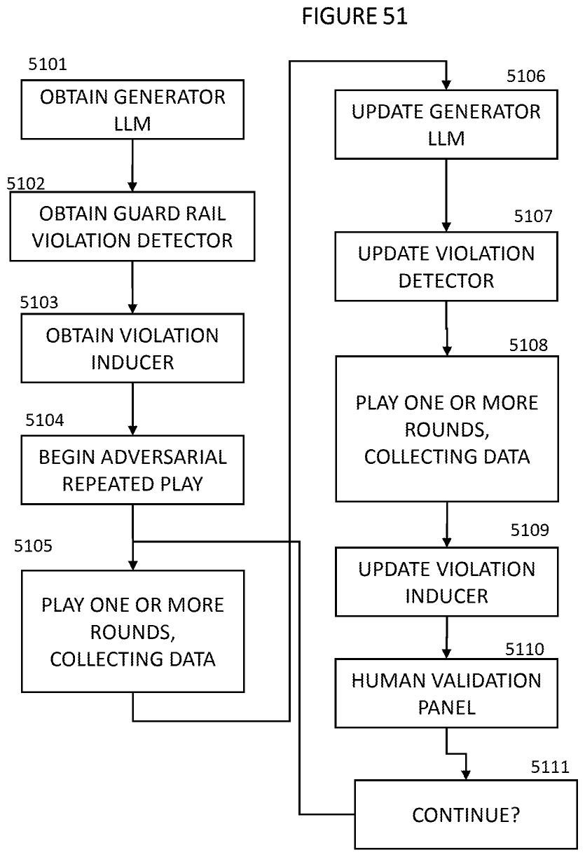

In block 4812, in some embodiments, computer system 1700 may perform one or more tests of the sequence generated so far with respect to a set of guard rail tests. In some embodiments, one or more guard rail tests may be based on the records of use of prior work made in block 4811. In some embodiments, computer system 1700 may train such guard rail tests as discussed in association with FIG. 51. If the current sequence fails a guard rail test, computer system 1700 may proceed to block 4813. If the current sequence passes all guard rail tests, computer system 1700 proceeds to block 4214.

In block 4813, in some embodiments, computer system 1700 may move backward in the current sequence by an amount determined by specified criteria and resume generating the sequence from the earlier point. In some embodiments, for the resumed generation, computer system 1700 may adjust some hyperparameters to control the generation process more tightly. Computer system 1700 then proceeds to block 4817.

In block 4814, in some embodiments, computer system 1700 may output the text up to the position of the token selected in block 4810.

In block 4815, in some embodiments, computer system 1700 may check the current token and/or other criteria to determine if the current text generation process should be terminated. In some embodiments, computer system 1700 may include in the set of tokens one or more control tokens including a control token that marks the end of a passage being generated. In some embodiments, computer system 1700 may terminate the current text generation process whenever the end-of-passage control token is chosen in block 4810. If computer system 1700 determines to terminate the current generation process, computer system 1700 returns to block 4802 to obtain a new starting text. In interactive use, computer system 1700 may wait in block 4802 until the user supplies a new starting text.

In block 4816, in some embodiments, computer system 1700 may move to the next position in the text being generated.

In block 4817, in some embodiments, computer system 1700 may adjust the dynamic ensemble of distributed generator subsystems based on specified criteria and the respective current workloads of the ensemble members.

FIG. 49 is a flow chart of an illustrative embodiment of an aspect of the invention in which computer system 1700 trains a large language model comprising a hidden Markov process model. In some embodiments, computer system 1700 may create a state space in which there are one or more states for each word in a specified vocabulary. In some embodiments, computer system 1700 may create two or more states for a word to have a distinct state for each distinct prior context that may be associated with different probabilities for future words.

In block 4901, in some embodiments, computer system 1700 may select or define one or more attributes for each word in a specified vocabulary. In some embodiments, computer system 1700 may select a part-of-speech attribute. In some embodiments, computer system 1700 may select an attribute that distinguishes two or more distinct meanings for a word. In some embodiments, computer system 1700 may select an attribute that records the value of a future-event predictor in the prior sequence of tokens. In some embodiments, computer system 1700 may include an attribute that represents the current token in a word that is represented as a sequence of tokens. In some embodiments, computer system 1700 may model each word Wᵢ as a sequence of tokens T₁, T₂, . . . , T_{K} and add a token position attribute k to word Wᵢ, where 1≤k≤K.

In block 4902, in some embodiments, computer system 1700 may define an expanded hidden state with an additional state for each combination of attribute values. In some embodiments, computer system 1700 may define multiple state spaces with one or more attributes represented as a hidden stochastic process. In some embodiments, computer system 1700 may define an expanded hidden state with additional states that are not predefined. In some embodiments, computer system 1700 may train the hidden Markov process with undefined states to learn the states using the EM algorithm, which is well known to those skilled in the art of training hidden Markov process models. In some embodiments, computer system 1700 may train the hidden Markov process model such that each additional state has a distinct role represented by its Markov process transition probabilities.

In block 4903, in some embodiments, computer system 1700 may train one or more base Markov processes with fewer attributes than will be trained in blocks 4904-4915. In some embodiments, computer system 1700 may train a base Markov process with no attributes, and optionally with an expanded state space. In some embodiments, computer system 1700 may train a base Markov process with one or more attributes, such as part-of-speech tags that computer system 1700 may be able to compute deterministically, separately from the process of training the Markov process model.

In block 4904, in some embodiments, computer system 1700 may add one or more future prediction variables as attributes to a word instance.

In block 4905, in some embodiments, computer system 1700 may train augmented state transition models that represent changes in attributes from prior context, such as future prediction variables, updated to take account of the word associated with the current state as computer system 1700 adds a new word in the word sequence. In some embodiments, computer system 1700 may represent transition probabilities of changes in the attributes in addition to transition probabilities from a specified word instance to the next word in the word sequence.

In block 4906, in some embodiments, computer system 1700 may use samples from the training corpus to estimate word transition probabilities and/or changes in attributes.

In block 4907, in some embodiments, computer system 1700 may expand the state space of the base Markov model. In some embodiments, computer system 1700 may initialize the expanded Markov process model from the base model. In some embodiments, computer system 1700 may represent a single state in the base Markov model as a plurality of states in the expanded state space. In some embodiments, computer system 1700 may initially represent each of the states in the expanded space corresponding to a single state in the base model as being equally likely except for a small random perturbation. Computer system 1700 may use the small random perturbation to avoid the training being stuck in an unstable local minimum in the maximum likely training.

In block 4908, in some embodiments, computer system 1700 may define a forward alpha probability beam by α(t,j)=Pr(Xₜ=j, Y₀=y₀, Y₁=y₁, . . . , Yₜ=yₜ), where Xₜ is a random variable representing the state of a hidden Markov process at time t, Yₜ is an observed conditional random variable at time t whose probability distribution depends only on Xₜ, and y₀, y₁, . . . y_{T} is a sequence of observations. In some embodiments, computer system 1700 may define a backward conditional probability beam by β(t,j)=Pr(Xₜ=j|Yₜ₊₁=yₜ₊₁, Yₜ₊₂=yₜ₊₂, . . . , Y_{T}=Y_{T}).

In some embodiments, computer system 1700 may compute a forward alpha probability beam by α(t+1,j)=Σᵢα(t,i)A_{i,j} B_{j,y}_{ₜ}, where A_{i,j} is the current estimate of the probability of transitioning from state i to state j, and B_{j,y}_{ₜ} is the probability that Yₜ=yₜ, given that Xₜ=j. The value α(t,i) is the joint probability of all the words up to and including time t subject to the condition that the hidden Markov process be in state i at word position t. In some embodiments, computer system 1700 may initialize α(0, i) to the same value for all i. In some embodiments, computer system 1700 may beam prune the values of α(t,i), setting α(t,i)=0 for all values of i for which α(t,i)<ε*maxⱼ α(t,j), for a specified value of ε.

In block 4909, computer system 1700 may initialize a backwards beam by setting β(T,j)=1.0 for all states j and for T being the position of the end of the sequence being modeled. The value of β(t,j) is the conditional probability of all the words for t+1 to T, conditioned on the Markov process being in state j at word position t.

In block 4910, in some embodiments, computer system 1700 may compute the backwards beam as β(t,i)=Σⱼ A_{i,j}B_{j,y}_{ₜ₊₁}β(t+1, j), where β_{j,y}_{ₜ₊₁} is the current estimate of the conditional probability that Yₜ₊₁=yₜ₊₁ given that Xₜ₊₁=j. In preferred embodiments, computer system 1700 may avoid overflow and underflow by normalizing the α(t,i) to sum to a specified constant for each word position t by multiplying the α(t,i) values by a normalizing factor. In preferred embodiments, computer system 1700 may use the same normalizing factor for β(t,⋅) as was used for α(t,⋅), rather than computing a different normalizing factor for β(t,⋅). The forward computation of alpha and the backward computation of beta are well known to those skilled in the art of estimating hidden Markov processes.

In block 4911, in some embodiments, computer system 1700 may combine the α(t,⋅) and β(t,⋅) as γ(t,i)=α(t,i)β(t,i). Then γ(t,i) is the joint probability of all observed words from t=0 to t=T and of the system being in state i at time t. Note that Σᵢ γ(t,i) is the joint probability of all the observed words from time t=0 to time t=T and that this quantity is the same for all values of t.

$$\frac{γ ( t , i )}{{\sum }_{j} γ ( t , j )}$$

is the probability that the Markov process is in state i at time t, given all the observed words from t=0 to t=T. Similarly, α(t,i)A_{i,j} B_{j,y}_{ₜ₊₁}β(j,t) is the probability that the Markov process was in state i at time t and in state j at time t+1, and that the values randoms Y₀=y₀, . . . , Y_{T}=y_{T} for all the observed words from t=0 to t=T.

In block 4912, in some embodiments, computer system 1700 may compute the quantities Â_{i,j,t}=Σₜ α(t,i) A_{i,j}B_{j,y}_{ₜ}β(j,t)/Σᵢγ(t,i). Â_{i,j,t} is the conditional probability that the process is in state i at time t and in state j at time t+1, given all the observed words from t=0 to t=T. In some embodiments, computer system 1700 may compute the forward beam, the backward beam, and γ(t,i) in batches, where a batch may be a shorter sequence of words, such as a sentence or paragraph. In block 4912, computer system 1700 may accumulate the quantity Â_{t,j,t} for all word positions in a batch and may accumulate for multiple batches. The quantity Â_{t,j,t} accumulated for all batches may be used by computer system 1700 in block 4914 to replace A_{i,j} in an iterative process that is an instance of the expectation and maximization (EM) algorithm, which converges to a maximum likelihood estimate of the true transition matrix. The use of the forward-backward computation and the EM algorithm are well known to those skilled in the art of training hidden Markov process models.

In block 4913, in some embodiments, computer system 1700 may check whether all batches have been processed. If not, computer system 1700 returns to block 4908. If all batches have been processed, computer system 1700 proceeds to block 4914.

In block 4914, in some embodiments, computer system 1700 may update the model by replacing A_{i,j} with

$${\sum }_{t = 0}^{T - 1} {A}_{i , j , t} / T .$$

This replacement is an instance of the EM algorithm, which converges to a maximum likelihood estimate of the true transition matrix for the hidden Markov process. In some embodiments, computer system 1700 may use a similar update for the B_{j,k}. This training of the matrices A and B corresponds to the EM algorithm and is well known to those skilled in the art of training hidden Markov process models.

In block 4915, in some embodiments, computer system 1700 may test whether the EM update process has converged based on specified criteria. If not, computer system 1700 returns to block 4908, starting again with the first batch. If the stopping criteria are met, the process illustrated in FIG. 49 is done.

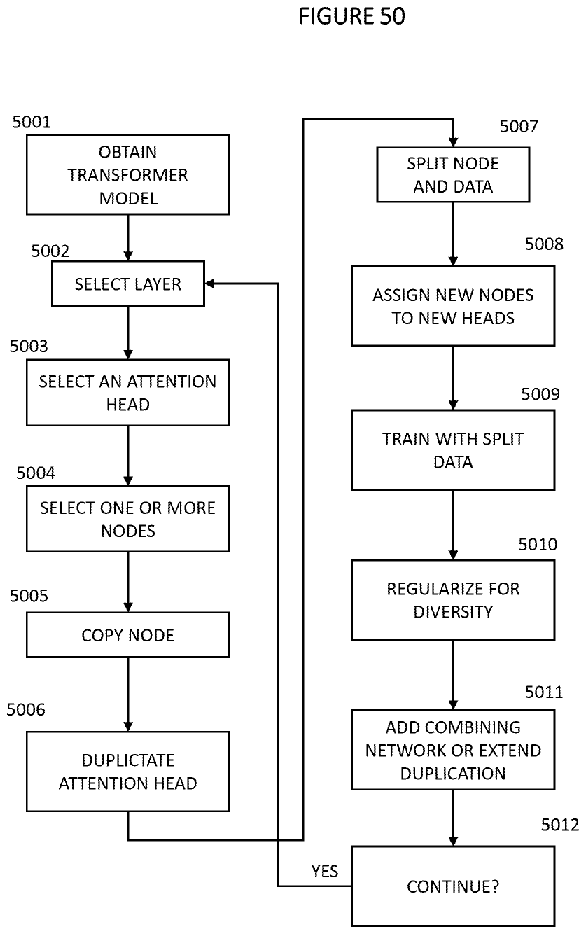

FIG. 50 is a flow chart of an illustrative embodiment of an aspect of the invention in which computer system 1700 incrementally increases the size of a transformer by increasing the number of attention heads in a specified attention layer.

In block 5001, in some embodiments, computer system 1700 may obtain a pretrained transformer model.

In block 5002, in some embodiments, computer system 1700 may select a specific attention layer.

In block 5003, in some embodiments, computer system 1700 may select a specific attention head.

In block 5004, in some embodiments, computer system 1700 may select one or more nodes in neural network layers following the selected attention head.

In block 5005, in some embodiments, computer system 1700 may make one or more copies of each selected node.

In block 5006, in some embodiments, computer system 1700 may make one or more copies of the selected attention head.

In block 5007, in some embodiments, computer system 1700 may split the node and data, such as described in association with FIGS. 41 and 42 and block 519 of FIG. 5, block 1510 of FIG. 15, block 3510 of FIG. 35, block 4204 of FIG. 42, and blocks 4711 and 4712 of FIG. 47.

In block 5008, in some embodiments, computer system 1700 may duplicate the selected attention head with copies of one or more split nodes distributed among the duplicates of the attention head.

In block 5009, in some embodiments, computer system 1700 may train the system comprising the duplicated attention heads with data split among the duplicates based on the node and data split of block 5007.

In block 5010, in some embodiments, computer system 1700 may add is-not-equal-to data dependent regularization links between selected pairs of the original and duplicated attention heads.

In block 5011, in some embodiments, computer system 1700 may extend the duplication of attention heads to higher attention block layers. In some embodiments, computer system 1700 may add a combining network to compute a number of outputs that match the number of attention heads in the next higher attention block layer. In some embodiments, computer system 1700 may add is-not-equal-to relation regularization links to selected pairs of nodes among the original and duplicate attention heads to increase diversity. In some embodiments, computer system 1700 may selectively back propagate decorrelation of errors from the combining network.

In block 5012, in some embodiments, computer system 1700 may determine whether to continue increasing the number of attention heads based on specified criteria. If so, computer system 1700 returns to block 5002. Otherwise, the process illustrated in FIG. 50 is complete.

FIG. 51 is a flow chart of an illustrative embodiment of an aspect of the invention that uses fictitious play to train guard rails for a generative AI system and to train a system to detect guardrail violations.

In block 5101, in some embodiments, computer system 1700 may obtain a pretrained or partially trained primary large language model or other text generation system. In some embodiments, computer system 1700 may use this text generation system to produce text in response to a prompt, question, instruction, or other starting text. In some embodiments, computer system 1700 may use this primary text generation system as a chatbot, that is to generate text in conversational mode in which this chatbot style text generation system takes turns alternately generating text and receiving text.

In block 5102, in some embodiments, computer system 1700 may obtain a pretrained or partially trained adversarial guard rail violation detection system for a specified set of guard rail tests.

In some embodiments, computer system 1700 may obtain a cooperative guard rail violation detection system to use as an internal component of the text generation system obtained in block 5101. In some embodiments, computer system 1700 may use this internal guard rail violation detection system so that computer system 1700 may detect and correct a potential guard rail violation before posting the text comprising the potential violation. Note that this internal cooperative guard rail violation detection system is separate from the adversarial guard rail detection system.

In block 5103, in some embodiments, computer system 1700 may obtain a pretrained or partially trained adversarial text generator trained to generate starting text or conversational text designed to induce a chatbot or other text generation system to violate one or more specified guard rail tests. In some embodiments, computer 1700 may use this adversarial text generator in combination with the adversarial guard rail violation detection system to induce the text generator obtained in block 5101 to violate one or more guard rail rules and to detect that violation.

In block 5104, in some embodiments, computer system 1700 may begin a competitive, adversarial competition or simulated game in which one player comprises the text generation system obtained in block 5101 and any internal guard rail violation detection system and a second player comprises the guard rail violation inducer obtained in block 5103 and the guard rail violation detection system obtained in block 5102. In some embodiments, computer system 1700 may implement this adversarial competition as a zero-sum two-person game in which any success or positive score by one player is balanced by a failure or negative score of equal magnitude for the opposing player. For this two-person game formulation, computer system 1700 may treat the coalition of the adversarial violation detection system and the violation inducing system as a single player.

In block 5105, in some embodiments, computer system 1700 may simulate the play of one or more rounds of the game. In some embodiments, in each round of the game, computer system 1700 may use the adversarial text generation system to produce starting text, such as a prompt or query and/or conversational turn-taking text to provide to the primary text generation system. In some embodiments, computer system 1700 may also obtain text from a benign source, such as text previously obtained in use by a non-adversarial user.

Computer system 1700 may then, in the simulated game, use the primary text generation system to produce new text from the starting text or conversation. In some embodiments, in the simulated game, computer system 1700 may use the internal guard rail violation detect system and make corrections if a potential violation is detected. In some embodiments, computer system 1700 may apply the internal guard rail violation detector during the generation of text. In some embodiments, computer system 1700 may halt the generation of text if a violation is detected and may take corrective action. In some embodiments, computer system 1700 may continue until a stopping token is generated. In some embodiments, computer system 1700 may then test whether a guard rail violation has occurred and take corrective action.

Once computer system 1700 has generated text in a simulated play of the game, computer system 1700 may apply the external violation detection system. In some embodiments, computer system 1700 may then determine a positive score for the generator if text is generated without a detected violation and a negative score for the generator if a violation is detected. In some embodiments, computer system 1700 may make the magnitude of the negative score for a violation larger than the magnitude of the positive score for a text generation without a detected violation, as specified by one or more hyperparameters.

In some embodiments, during the generation and guard rail violation detection of the simulation as repeated play of the game of attack and defense, computer system 1700 may record, for each play, whether the starting text or conversational text was from a violation inducer or from benign source and whether the violation detector successfully detected an attack or falsely report an attack for benign text.

In block 5106, in some embodiments, computer system 1700 may add attack and detection data to the training data and resume training of the generator. In some embodiments, computer system 1700 may continue supervised or self-supervised training during the generation in the simulation. In other embodiments, computer system 1700 may avoid training during the simulation. In preferred embodiments, computer system 1700 does not train the violation inducer either during the simulation or in block 5106 or block 5107.

In some embodiments, in block 5106, computer system 1700 may also train the generator using data previously obtained from play of the simulated attack and defense in block 5108. In preferred embodiments, computer system 1700 does not use this data previously obtained in block 5108 until after the simulation in block 5105 is complete. By updating the generator only after simulated play in block 5105 and only updating the violation inducer after simulated play in block 5108, computer system 1700 avoids the instability and convergence difficulties that may be caused by simultaneous updates.

In block 5107, in some embodiments, computer system 1700 may train the violation detector on the data collected during the simulation of block 5105. In preferred embodiments, computer system 1700 does not train the violation inducer in either block 5106 or block 5107.

In block 5108, in some embodiments, computer system 1700 may play one of more rounds of the game of simulated use and attack and defense of the guard rails of the generator, as in block 5105.

In block 5109, in some embodiments, computer system 1700 may resume training of the violation inducer using data obtain in block 5108. In preferred embodiments, computer system 1700 does not train either the generator or the internal violation detector either during the simulation in block 5108 or during the training in block 5109.

In block 5110, in some embodiments, computer system 1700 may present one or more detections of guard rail violations to a human violation review panel.

In block 5111, in some embodiments, computer system 1700 may determine whether to continue the simulated play of attack and defense based on specified stopping criteria. If computer system 1700 determines to continue, computer system 1700 returns to block 5105. Otherwise, the process illustrated in FIG. 51 is complete.

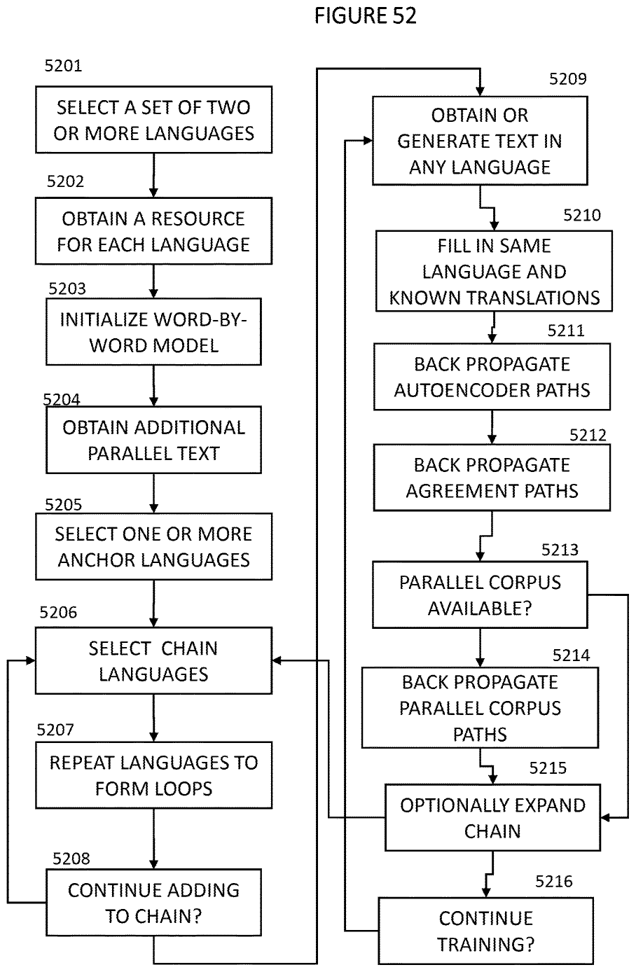

FIG. 52 is a flow chart of an illustrative embodiment of the invention in which computer system 1700 trains a translation system using a multi-path chain of one-way translations in which each link in the chain translates from a source language to a target language. In some embodiments, one or more of the languages covered by the chain of translation may be a “low resource” language for which there is not enough computer readable text to train a direct language pair translation system with adequate performance.

In block 5201, in some embodiments, computer system 1700 may select a set of one or more source languages. In some embodiments, computer system 1700 may use a source language as the starting language for a chain. In some embodiments, computer system 1700 may select a low resource language as a source language.

In block 5202, in some embodiments, computer system 1700 may obtain, preferably for each language, a commonly available resource such as a phrase book or bilingual dictionary. In some embodiments, computer system 1700 may obtain a monolingual language resource, such as a Wikipedia article, blog or other material posted on the web. In some embodiments, computer system 1700 may include many language pairs for which there is no available bilingual resource.

In block 5203, in some embodiments, computer system 1700 may initialize a word-by-word translation model for one or more language pairs from a resource such as a phrase book or a bilingual dictionary.

In block 5204, in some embodiments, computer system 1700 may obtain additional parallel text for language pairs for which such parallel text is available.

In block 5205, in some embodiments, computer system 1700 may select one or more anchor languages. In some embodiments, computer system 1700 may select an anchor language as the final language in a chain of translation steps.

In block 5206, in some embodiments, computer system 1700 may select one or more additional languages that may be linked in as intermediate languages for one or more paths through the multi-path chain being constructed.

In block 5207, in some embodiments, computer system 1700 may repeat a language already present in a path through the multi-path chain in order to create a loop of language ordered pairs that begins and ends with the same language. In some embodiments, computer system 1700 may use autoencoder training in block 5210 for any loop of languages.

In block 5208, in some embodiments, computer system 1700 may determine whether to continue adding to the multi-path chain that computer system 1700 is constructing. If so, computer system 1700 returns to block 5206. Otherwise, computer system 1700 proceeds to block 5209. Note that there is no limit imposed on the maximum size or on the number of languages in a chain. There is also no limit on the number of times a language may be repeated in the chain.

In block 5209, in some embodiments, computer system 1700 may obtain text or generate a sample of text in any of the languages in the chain. In some embodiments, computer system 1700 may start translating this sample of text through multiple translation paths in the translation chain.

In block 5210, in some embodiments, computer system 1700 may fill in the target translation for chain terminations that are the same language as the text obtained or generated in block 5209 or for which there is a known translation or parallel corpus.

In block 5211, in some embodiments, computer system 1700 may back propagate from correct answers and errors as in an autoencoder for any path that has the same language as the text obtained or generated in block 5209. In some embodiments, computer system 1700 may also back propagate from any language for which computer system 1700 filled in parallel text in block 5209.

In block 5212, in some embodiments, computer system 1700 may receive translations from multiple paths through the chain arriving at the same destination. In some embodiments, computer system 1700 may independently translate each of the received translations into the designated language of the receiving chain destination. There may be differences among the multiple translations into this designated language. If computer system 1700 knows the correct translation, it may back propagate based on the correct answer. However, in some embodiments, computer system 1700 does not need to know the correct translation. In some embodiments, computer system 1700 does not even need to know whether there was an error in one or more of the received translations before the final translation at the destination or if there was an error in the final translation at the destination. In some embodiments, in either case, computer system 1700 may impose a regularization penalty if two translations into the target language disagree and/or a regularization reward if they do agree. In some embodiments, computer system 1700 may first back propagate this regularization back through the final translation in the chain. In some embodiments, computer system 1700 may then continue the back propagation to each of its immediate predecessors in each path of translation.

In block 5213, in some embodiments, computer system 1700 may determine whether there are any parallel corpora or known translations for the text obtained or generated in block 5209. If so, computer 1700 proceeds to block 5214. Otherwise, computer system 1700 proceeds to block 5215.

In block 5214, in some embodiments, computer system 1700 may back propagate from a translation from a path in the chain based on agreements or disagreements relative to the translation in the parallel corpus.

In block 5215, in some embodiments, computer system 1700 may determine whether to expand the chain adding additional chain destination languages and/or additional paths.

In block 5216, in some embodiments, computer system 1700 may determine whether to continue training based on specified criteria. If so, computer system 1700 returns to block 5209. Otherwise, the process illustrated in FIG. 52 is done.

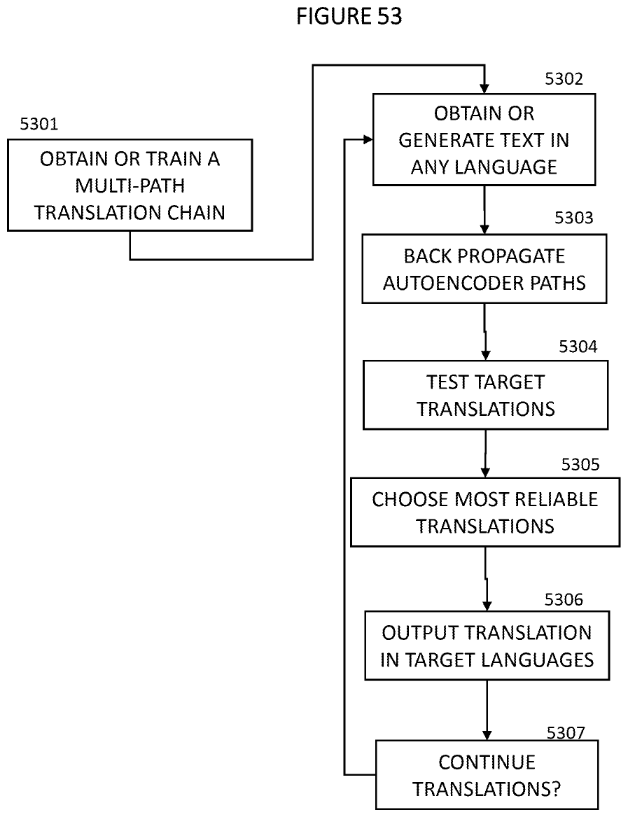

FIG. 53 is a flow chart of an illustrative embodiment of an aspect of the invention in which computer system 1700 uses a multi-path chain of paired language translations to compute a robust composite translation.

In block 5301, in some embodiments, computer system 1700 may obtain or train a multi-path chain translation system.

In block 5302, in some embodiments, computer system 1700 may obtain or generate text in any of the languages of the chain.

In block 5303, in some embodiments, computer system 1700 may propagate back along any of the autoencoder paths for any of the languages, not just the language of the text obtained in block 5302.

In block 5304, in some embodiments, computer system 1700 may test any target translation. In some embodiments, computer system 1700 may select one or more nodes in any of the local translation networks. In some embodiments, computer system 1700 may determine for each node whether the activation to a selected node has an error or close call relative to an implicit local objective based on back propagation from a selected autoencoder path. In some embodiments, computer system 1700 may rate the reliability of a translation by the proportion of implicit errors and close calls among nodes in the target network and from the predecessor networks on the paths leading to the target network.

In block 5305, in some embodiments, computer system 1700 may choose the most reliable translation for each target language. In some embodiments, computer system 1700 may choose the translation with the highest rating in the node level tests done in block 5304. In some embodiments, computer system 1700 may treat a plurality of translation paths as an entwined ensemble. In some embodiments, computer system 1700 may combine the results of the ensemble members with weights that depend on reliability ratings. In some embodiments, computer system 1700 may use a separate machine learning system that has been trained to compute the best translation from an ensemble with reliability ratings computed as in block 5304.

In block 5306, in some embodiments, computer system 1700 may output the translations chosen for one or more languages.

In block 5307, in some embodiments, computer system 1700 may determine based on specified criteria and/or user control whether to do additional translations. If so, computer system 1700 returns to block 5302. Otherwise, the process illustrated by FIG. 53 is completed.

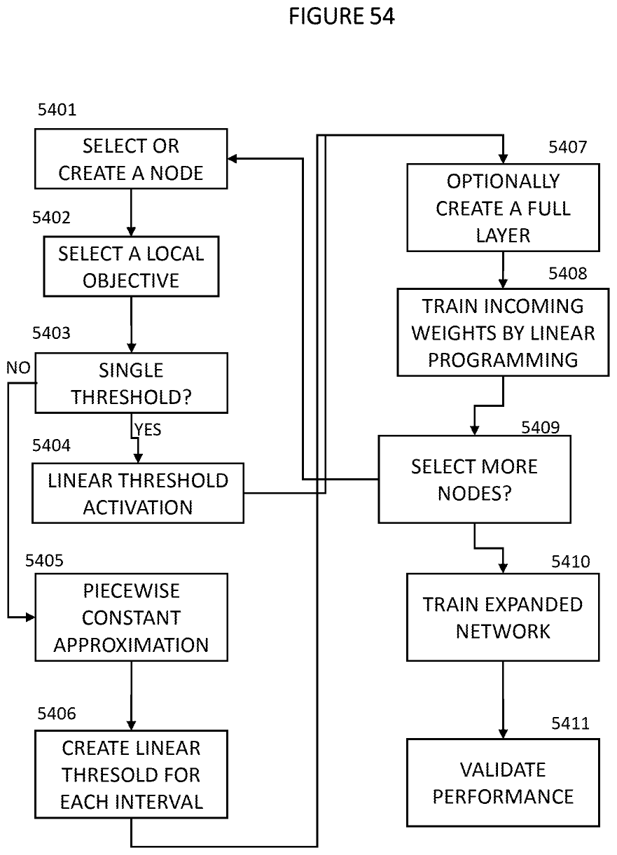

FIG. 54 is a flowchart of an illustrative embodiments of an aspect of the invention in which computer system 1700 may add nodes with linear threshold activation functions to the network and train the nodes using methods other than gradient descent.

In block 5401, in some embodiments, computer system 1700 may select a node in the network or create a new node. In some embodiments, if computer system 1700 selects an existing node in the network, preferably the node satisfies specified criteria for not needing further back propagation from the selected nodes to nodes below the selected node in the network. In some embodiments, the criteria may include an estimate that the training of the subnetwork has converged. In some embodiments, the criteria may be based on the presence of nodes in the subnetwork that are easy to interpret and that the interpretations may be disturbed by further back propagation training. In some embodiments, computer system 1700 may create a copy of an existing node in the network and select the copy for the purpose of block 5401 while allowing continued back propagation from the original node. In some embodiments, computer system 1700 may create a new node that is not related to any existing node in the network and select the new node.

In block 5402, in some embodiments, computer system 1700 may select a local objective for the selected node. In some embodiments, computer system 1700 may specify two subsets of the set of training data items and specify the objective of discriminating between the two selected sets.

In block 5403, in some embodiments, computer system 1700 may determine whether the activation function of the selected node should be a single-step threshold function or should be a piecewise constant function other than a single-step threshold function. If computer system 1700 determines that the selected node is to be a single-step threshold activation function, computer system 1700 proceeds to block 5404. Otherwise, computer system 1700 proceeds to block 5405.

In block 5404, in some embodiments, computer system 1700 may give the selected node a single-step threshold activation function. Computer system 1700 then proceeds to block 5407.

In block 5405, in some embodiments, computer system 1700 may create a piecewise constant activation function. In some embodiments, computer system 1700 may create a piecewise constant activation function that approximates the activation function of the node selected in block 5401.

In block 5406, in some embodiments, computer system 1700 may replace the node with a piecewise constant activation function with a set of linear threshold function nodes and a summation node such that, for each input value, the output of the summation node is the same as the value of the piecewise constant activation function.

In block 5407, in some embodiments, computer system 1700 may optionally create a set of linear threshold nodes that form a complete layer of the network. In some embodiments, computer system 1700 may create such a complete layer as part of a defense against adversarial attacks.

In block 5408, in some embodiments, computer system 1700 may train the weights on the incoming connections to any of the linear threshold function nodes using linear programming. In some embodiments, in a first step, computer system 1700 may determine weights that solve the linear programming problem of minimizing the maximum error for any training data item where the error is the difference between the input value at the threshold and input value to the activation function of the weighted sum of the incoming variables. If the minimum maximum error is zero, in some embodiments, computer system 1700 may then solve the linear programming problem of maximizing the difference between the incoming weight sum for the data item that minimizes the incoming sum and the threshold value. In other words, computer system 1700 may first determine if the specified sets of data items are linearly separable by solving the linear programming problem of minimizing the amount of violation of separability. If the sets are linearly separable, computer system 1700 then solves the linear programming problem of maximizing the separation.

If the sets are not linearly separable, in some embodiments, computer system 1700 may set the weights as determined by the first linear programming problem, that is, to the values that minimize the maximum error. If the sets are linearly separable, computer system 1700 may set the weights as determined by the solution to the second linear programming problem, that is, to values the maximize the minimum separation.

In block 5409, in some embodiments, computer system 1700 may determine, based on specified criteria, whether to select or create more nodes. If so, computer system 1700 returns to block 5401. Otherwise, computer system 1700 proceeds to block 5410.

In block 5410, in some embodiments, computer system 1700 may train the expanded network by gradient descent computed by back propagation. Note that for any back propagation from a linear threshold or piecewise constant activation function, the back propagated derivative is zero, resulting in no changes for weights on connections in the subnetwork due to back propagation through a node with a piecewise constant activation function. In some embodiments, the weight on such a connection may change due to back propagation through connection paths that do not go through any piecewise constant node.

In block 5411, in some embodiments, computer system 1700 may validate the performance of the network based on specified criteria, preferably evaluated on data that has not been used in training. If computer system 1700 determines that the expanded network meets the performance criteria, then computer system 1700 may accept the new network as trained.

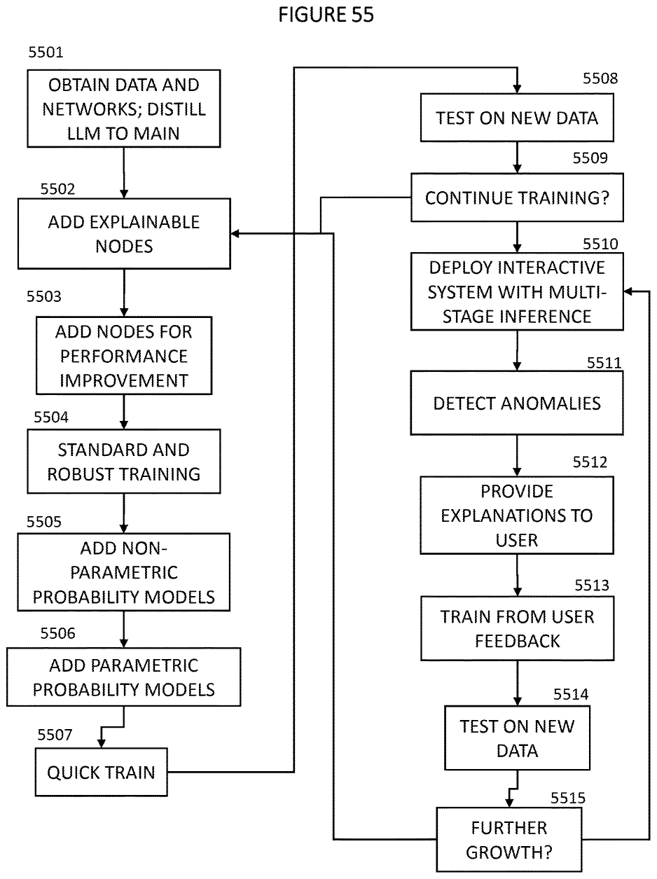

FIG. 55 is a flow chart of an illustrative embodiment of an aspect of the invention, in which, in some embodiments, computer system 1700 may develop, grow, and train an explainable large language model generative A.I. system comprising a first system for generating sequences of text (called the “main” system). In some embodiments, computer system 1700 may implement the process illustrated in FIG. 55 on each of a plurality of the computers running as semi-autonomous subsystems such as illustrated in FIG. 30, with information sharing as discussed in association with blocks 5501, 5504, 5507, 5510, 5512, and 5513. In some embodiments, computer system 1700 may implement the process illustrated in FIG. 55 on a single computer system.

In some embodiments, computer system 1700 may train a second language model system to generate explanations of selected elements of the main language model system. The second language model system may be called the “explanatory” system. In some embodiments, some of the networks for implementing the main and/or explanatory systems may be hybrid networks with units comprising general purpose cells as well as neural network nodes. In some embodiments, computer system 1700 may use cells to represent the values of hidden state variables in a transformer. For example, in some embodiments, computer system 1700 may use one or more cells in a unit of a network of the explanatory system to represent the appropriate definition of a word in a specific context. In some embodiments, computer system 1700 may use a cell in a unit of a network of the explanatory system to indicate the part of speech of a word in a specific context. In some embodiments, computer system 1700 may use cells to represent probability distribution models. In some embodiments, computer system 1700 may use data-dependent relationship regularization links between pairs of cells as well as between neural nodes. In some embodiments, computer system 1700 may create explainable cells as well as explainable neural nodes.

In some embodiments, computer system 1700 may implement the process illustrated in FIG. 55 using cloud computing resources. In some embodiments, computer system 1700 may implement the process on a distributed set of computers that communicate over a local area network (LAN) or a wide area network (WAN), with each computer representing an autonomous subsystem as discussed in association with FIG. 30. In some embodiments of explainable nodes, cells, and probabilistic models, only a minority of the learned parameters need to be resident in GPU VRAM at the same time. In various embodiments, the dedicated computers may be high-end workstations, desktop computers, or laptop computers. In some embodiments, computer system 1700 may implement some components on a smart phone with sufficient memory and processing capabilities.

In some embodiments, the main language model system may be based on one or more transformer networks. A transformer network is a deep learning architecture, known to those skilled in the art of natural language processing using large language model networks, that relies on a parallel multi-head attention mechanism. In some embodiments, the transformer architecture may comprise both an encoder network and a decoder network. In some embodiments, the transformer architecture may comprise only an encoder or only a decoder. In some embodiments, the main language model may comprise one or more networks, each of which may be either an autoencoder architecture or an autoregressive architecture.

In some embodiments, computer system 1700 may use one or more networks in the main system to train on and/or to generate sequences of “items.” In the following discussion, the term “item,” as an element of a sequence, may refer to a word, a sub word unit called a “token,” and/or a multiword unit called a “semantic unit.” In some embodiments, computer system 1700 may use one or more of the networks to compute a sequence of hidden state values associated with the sequence of items. In discussion of some embodiments of some aspects of the invention, the sequence of hidden state values may also be referred to as a sequence of “items.” In some embodiments, a network in the main language model system may be an autoregressive architecture network trained to generate text by repeatedly predicting the next item in a sequence. In some embodiments, a network in the main language model system may be trained to “fill in the blank,” predicting a word or other item that has been left out in a sequence of items, with both left and right context available.

In some embodiments, computer system 1700 may increase the number of nodes in one or more networks in the main language model system. In some embodiments, computer system 1700 may increase the number of networks in the main language model system. In some embodiments, computer system 1700 may increase the number of attention heads in an attention layer of a transformer. In some embodiments, computer system 1700 may train some of the new parameters using “one-pass training” or “fractional-pass” training, as explained in association with block 5507. In one-pass training, computer system 1700 may train multiple learned parameters in a single pass through the training data. In some embodiments, computer system 1700 may train multiple learned parameters in a single pass through a subset of the training data. In some embodiments, computer system 1700 may store some of the learned parameters on secondary storage to be retrieved into RAM only as needed, thereby reducing the amount of CPU and GPU RAM required.

In block 5501, in some embodiments, computer system 1700 may obtain one or more pretrained language model networks as an initial language model system. In some embodiments, computer system 1700 may distill the initial language model system into one or more networks in each of the subsystems of the main language model system. In some embodiments, computer system 1700 may obtain a pretrained language model network as the explanatory system. In some embodiments, computer system 1700 may pretrain the explanatory system, using examples of explainable nodes and associated explanations trained in previous system and saved in a repository.

In some embodiments, the initial language system may comprise one or more pretrained transformer networks, each comprising one or more attention blocks, in which each attention block may comprise one or more attention heads. Transformer networks are well known to those skilled in the art training large language models for text generation and other natural language processing tasks. In preferred embodiments, computer system 1700 may obtain a pretrained base network that achieves state-of-the-art performance on a specified task based on specified criteria such as accuracy of predicting the next word in a sequence subject to constraints on one or more measures of computational resources required, such as the amount of computation time, the number of and the processing capability of CPUs, the number of and the processing capability of GPUs, the amount of random access memory for CPUs and GPUs, and the amount of secondary storage.

In some embodiments, computer system 1700 may maintain a set of repositories. In some embodiments, computer system 1700 may maintain a repository of pretrained networks. In some embodiments, computer system 1700 may maintain a repository of trained explainable nodes and cells. In some embodiments, computer system 1700 may maintain a repository of non-parametric and/or parametric probability models. In block 5501, computer system 1700 may obtain one or more pretrained networks from the repository. During training, in some embodiments, computer system 1700 may store a partially or fully trained network in the repository. In some embodiments, computer system 1700 may store and/or retrieve explainable nodes and cells. In some embodiments, computer system 1700 may store or retrieve conditional probability models. In some embodiments, computer system 1700 may store distributed repositories on secondary storage of one or more of the subsystems and/or on secondary storage of one or more other computer systems.

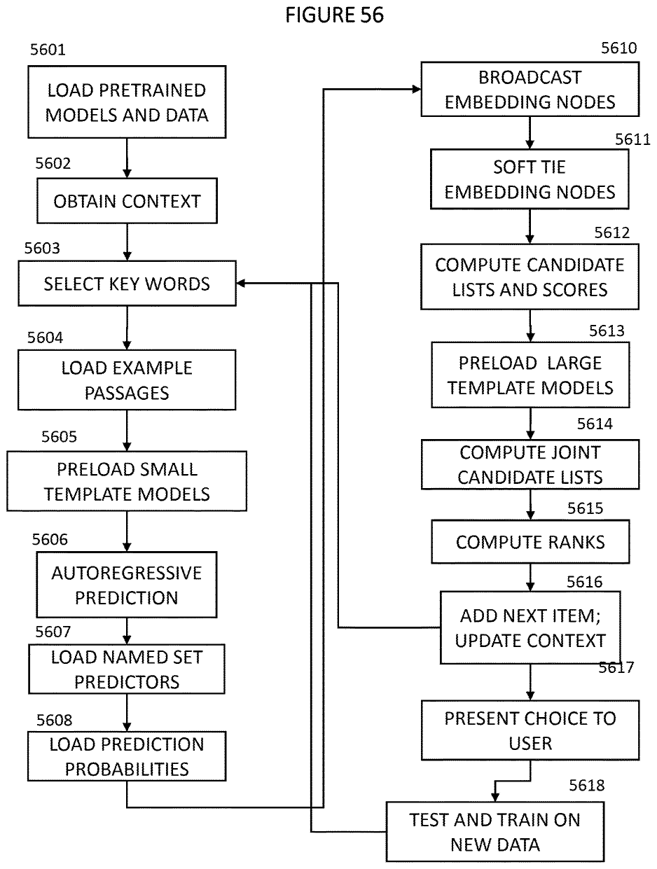

In some embodiments, in block 5501, computer system 1700 may obtain the training data for training the main language model system. In some embodiments, computer system 1700 may distribute distinct subsets of the training data to each of the semi-autonomous subsystems, to increase diversity and to reduce the memory and I/O requirements for the individual subsystems. In some embodiments, this training data for the main language model system may be different from the training data used to train the initial language model system. In some embodiments, the initial language model system may be provided by an outside vendor with the training data not supplied. In some embodiments, for each of the main language model subsystems, computer system 1700 may build a concordance for the set of training data for the main language model system. In some embodiments, computer system 1700 may use the concordance to retrieve sample passages that contain words or phrases in a sequence of items of training data or a sequence of items being generated. The use of sample passages is discussed further in association with block 5604 of FIG. 56. In some embodiments, during generation, computer system 1700 may select among two or more candidate words or phrases for the continuation of the passage being generated by comparing the current context of the generation process with the contexts that occur in the passages computer system 1700 retrieves using the concordance for each of the candidate continuations. In some embodiments, computer system 1700 may store in a repository or retrieve from a repository one or more networks that have been trained by fine tuning on a specialized task, such as summarization or paraphrasing. In some embodiments, computer system 1700 may retrieve from a repository a network that has been pretrained on the task of merging text from two or more sources, to create a coherent blend of the two or more sources while avoiding close copying of any one source. In some embodiments, computer system 1700 may retrieve a distinct subset of the set of specialized task networks for each subsystem. In some embodiments, computer system 1700 may retrieve from a repository a network that has been pretrained to generate proper citations for any passages quoted or paraphrased from a source. In some embodiments, computer system 1700 may use the pretrained networks to summarize, paraphrase, merge, and make citations to improve originality and to avoid copyright infringement.

In block 5502, in some embodiments, computer system 1700 may add one or more explainable nodes or cells. In some embodiments, computer system 1700 may add one or more additional layers and/or one or more additional attention heads to contain the explainable nodes. In some embodiments, computer system 1700 may create one or more copies of a subsystem in which each copy has a distinct subset of a set new explainable nodes. In some embodiments, computer system 1700 may implement one or more additional networks as a new autonomous subsystem.

In general, a node or cell that has been trained to discriminate between two explainable sets of training data items is an explainable element. In some embodiments, a hybrid node or cell may classify each data item as belonging to a specific set out of a collection of more than two explainable sets. Note that any classification into more than two classes may be implemented as a tree of two-way discriminations. Without loss of generality, the discussion of explainable discriminations in FIGS. 55 and 56 in terms of two-way discrimination is to be understood as also referring to n-way discrimination with n≥2. In some embodiments, computer system 1700 may restructure any n-way discrimination as a set of 2-way discriminations.

In some embodiments, computer system 1700 may select any element and create an associated explainable element by first computing, for two or more classification categories, a linear or monotonic regression of the number of instances of each category as a function of activation value of the selected element. In a language model system, in some embodiments, computer system 1700 may designate each word as a category. In some embodiments, computer system 1700 may designate each named state of a hidden model as a category. Computer system 1700 may then select a first set of one or more categories with positive regression coefficients and a second set of one or more categories with negative regression coefficients. In some embodiments, computer system 1700 may select a first set comprising a subset of the set of categories with regression coefficients greater than a first specified threshold T1 and a second set comprising a subset of the set of categories with regression coefficients less than a second specified threshold T2≤T1. In some embodiments, computer system 1700 may then train a new explainable node or cell to discriminate the selected positive categories from the selected negative categories. In training a text generation system, the set of categories is the set of items in a specified vocabulary of words, tokens, multi-word semantic units, or named hidden states.

In some embodiments, computer system 1700 may add prediction nodes to one or more of the networks in the main language system. In some embodiments, computer system 1700 may train one or more of the new nodes to predict, given a partially specified sequence, whether one or more of a specified list of items will occur within a designated interval of the sequence for which the items have not yet been observed or not yet been generated. In some embodiments, computer system 1700 may explain a specified list of items by reciting the contents of the list. The prediction of whether one or more items of the list of items will occur in a specified interval of a sequence is also explainable and is a testable hypothesis. Thus, such a prediction node is explainable, and a specific prediction node may be trained by back propagation from observing whether the prediction is true of false as a function of whether activation of the specific node is above or below a specified threshold. In some embodiments, computer system 1700 may select to train one or more specific prediction nodes by training only the weights on the direct connections into a prediction node without back propagation further back into the pretrained network. In some embodiments, computer system 1700 may use this form of training a prediction node as one of the types of quick training in block 5507.

In some network embodiments, such as an autoregressive next word predictor, computer system 1700 may specify the designated interval of unspecified items as an interval of future positions in the sequence. In such an embodiment, the autoregressive network may be said to be trained to “predict” the next word during training but may be said to “generate” the next word during inference or deployment for use by an end user. In some embodiments, computer system 1700 may process a sequence in backwards order, or both forwards and backwards, or in some other order. Without loss of generality, some of the explanations in the following discussion of aspects of the illustrative embodiment may be expressed in terms of forward generation for clarity. However, such an expression should also be interpreted to apply to text generation or prediction in whatever order the individual items may be predicted or generated.

In some embodiments, in block 5502, computer system 1700 may create a diverse set of networks that have been designed and trained to be robust against adversarial attacks. In some embodiments, computer system 1700 may create a diverse set of so-called “canary” networks which are designed and trained with no defense against adversarial attacks. In some embodiments, computer system 1700 may train a set of homologous networks to be diverse by linking selected ordered pairs of homologous nodes to be connected by data-dependent unidirectional relation regularization links imposing an asymmetric relation, such as the “is-not-equal-to” relation.

In block 5503, in some embodiments, computer system 1700 may evaluate one or more selected nodes in one or more of the networks in the main language model system to determine whether the original node should be expanded to be a plurality of nodes by creating additional nodes associated with the original node to improve the performance of the network.

In some embodiments, computer system 1700 may evaluate one or more selected nodes to be split and/or replaced by a plurality of nodes based on the criteria and node splitting methods described in association with FIG. 42 and/or by other methods of incremental growth, such as discussed in association with block 103 of FIG. 1, blocks 504 and 524 of FIG. 5, and block 604 of FIG. 6. In some embodiments, computer system 1700 may train or partially train the expanded network in block 5503. In some embodiments, computer system 1700 may postpone the training of the expanded network to be done together with the quick training in block 5507.

In both block 5502 and block 5503, in some embodiments, computer system 1700 may add new nodes to the layer containing a node being expanded. In some embodiments, computer system 1700 may create a new layer to contain the new nodes created in association with a set of one or more nodes being expanded in an existing layer. In some embodiments, computer system 1700 may create one or more additional attention heads to contain the new nodes.

In block 5504, in some embodiments, computer system 1700 may update and train the main language model system, as expanded in block 5502 and/or 5503. In some embodiments, computer system 1700 may use standard training using gradient descent back propagation. In some embodiments, computer system 1700 may also use alternate training methods such as those discussed in association with FIG. 5. In some embodiments, computer system 1700 may train nodes with piecewise constant activation functions, such as linear threshold functions, to make the main language model system more robust against adversarial attacks. In some embodiments, computer system 1700 may postpone some training of the main language model to use some of the quick training methods discussed in association with block 5507.

In some embodiments, computer system 1700 may update and incrementally train the explanatory network. In some embodiments, computer system 1700 may add additional nodes to the explanatory network by node splitting as described in association with FIG. 42 and/or by other methods of incremental growth, such as discussed in association with block 103 of FIG. 1, blocks 504 and 524 of FIG. 5, and block 604 of FIG. 6. In some embodiments, computer system 1700 may use a pretrained text generation network as a base for fine tuning as an explanatory network. For fine tuning the explanatory network, computer system 1700 may use examples such as an example with two parts: (1) an explainable node that detects a specified set or words or that discriminates between two specified sets of words, and (2) an explanation comprising text from one or more human readable sources such as a dictionary, a thesaurus, an ontology, a mereology, or a grammar.

In some embodiments, computer system 1700 may fine tune the explanatory system as an interactive tutorial system. In some embodiments, computer system 1700 may on a broader language related tutorial task than explaining a large language model system. For example, computer system 1700 may train the explanatory system as an interactive system to explain word meanings and grammar for a student learning a foreign language. As another example, computer system 1700 may train the explanatory system to teach reading comprehension, including the analysis of context. In some embodiments, computer system 1700 may teach a person with dyslexia the principle of phonics.

In some embodiments, computer system 1700 may train the explanatory system as an interactive tutor to train a user of a large language in prompt engineering. In some embodiments, during deployment of the main language model system computer system 1700 may use the explanatory system to suggest changes in a prompt before submitting the prompt to the main language model system. In some embodiments, computer system 1700 may automatically make changes in a prompt. In some embodiments, computer system 1700 may make changes in a prompt to make the system more robust against adversarial attacks.

In some embodiments, computer system 1700 may train third language model system on the task of comparing two sentences or two paragraphs to determine whether the two passages are semantically similar. This third language model system is called the “semantic analysis” system.

In block 5505, in some embodiments, computer system 1700 may add probability models associated with explainable elements (nodes or cells) and the events the elements predict. In some embodiments, computer system 1700, for one or more explainable named set prediction elements xᵢ, may train a non-parametric conditional probability such as Pr(yⱼ|act(xᵢ)>T₂) or Pr(yⱼ|act(xᵢ)<T₁) [Eq. 1], for specified thresholds T1<T2 for an event yⱼ in one of the two sets being discriminated.

In some embodiments, computer system 1700 may estimate the probability of an event yⱼ conditioned on a plurality of explainable elements based on a naive independence assumption:

$$Pr ( {y}_{j} \vert {x}_{i 1} , {x}_{i 2} , … , {x}_{ik} ) = {\prod }_{i = i 1}^{ik} Pr ( {y}_{j} \vert {x}_{i} ) . \qquad [ Eq . 1 A ]$$

In some embodiments, computer system 1700 may use logarithms of probabilities rather than probabilities. In some embodiments, computer system 1700 may train one or more non-parametric correlation correction models conditioned on activation values of two or more explainable elements, such as

CC(yⱼ,xᵢ₁,xᵢ₂)=log(Pr(yⱼ|act(xᵢ₁)>T2 AND act(xᵢ₂)>T2)/(Pr(yⱼ|act(xⱼ)>T2)*Pr(yⱼ|act(xᵢ₂)>T2))). [Eq. 2]

In some embodiments, computer system 1700 may train a parametric probability model, such as a member of the family of exponential distribution such as the Gaussian distribution, for the activation values of one or more explainable elements conditioned on the given value of an event yⱼ:

log(Pr(act(xᵢ_{₁})=zᵢ_{₁}, . . . , act(xᵢ_{ₖ})=zᵢ_{ₖ}|yⱼ)). [Eq. 3]

Such a model, expressed either as probabilities or as logarithms of probabilities is herein called a “template-type model.” In some embodiments, in blocks 5611 and 5615 of FIG. 56, computer system 1700 may apply a softmax operation over the values given by expression [Eq. 3] for a specified set C of candidates yⱼ, jϵC to estimate the respective posterior probability of each candidate. This softmax computation corresponds to an application of Bayes rule, which is well known to those skilled in the art of computing posterior probability estimates.

In block 5506, in some embodiments, computer system 1700 may add one or more additional template-type models to the main language model system. In some embodiments, computer system 1700 may use a template-type model to represent the probability of the activation values of a specified set of explainable elements conditional on a specified event in the portion of a sequence that has not yet been observed (if evaluated during training) or not yet been generated (if evaluated during inference or generation). In some embodiments, computer system 1700 may use a parametric probability model with sufficient statistics estimated by robust statistics. In some embodiments, computer system 1700 may train the robust parametric model using quick training as described in association with block 5507.

In block 5507, in some embodiments, computer system 1700 may use one or more methods of training herein called “quick training.”

According to a first quick training method, in some embodiments, computer system 1700 may train the weights of the incoming connections of an explainable node by direct training from a local objective defined by the explanation of the node. In some embodiments, especially when the explainable node has been added to a pretrained network, computer system 1700 may back propagate only to the weights on the direct incoming connections to the explainable node and not back propagate any deeper into the pretrained network. Thus, this training will be as quick as training a single node network. In some embodiments, computer system 1700 may soft tie a set of two or more explainable nodes, regularizing each of the nodes in the set to have an activation closer to the average activation of the set of nodes. In some embodiments, computer system 1700 may share a common explanation for the nodes in a set of soft-tied nodes. In some embodiments, computer system 1700 may use a node-to-node regularization links with the “is-equal-to” relationship, rather than directly soft tying to the average value. In some embodiments, computer system 1700 may counter tie some connection weights for corresponding connections leading to nodes that are soft tied, to increase diversity in how the networks compute a shared soft tied objective. In some embodiments, computer system 1700 may counter tie or may use an “is-not-equal-to” regularization links between pairs nodes that do not have associated explanations or that have distinct explanations.

According to a second quick training method, in some embodiments, computer system 1700 may train one or more non-parametric models for an event conditioned on the activation value of an explainable element, as described in association with block 5504. In some embodiments, computer system 1700 may train these models based on frequency counts in a single pass or a partial pass of the training data. In some embodiments, computer system 1700 may soft tie two or more non-parametric models.

According to a third quick training method, in some embodiments, computer system 1700 may train a non-parametric model for the correlation correction for an event condition on a specified set of two or more explainable elements, as described in association with expression 5505.2. In some embodiments, computer system 1700 may train these models based on frequency counts in a single pass or a partial pass of the training data.

According to a fourth quick training method, in some embodiments, computer system 1700 may estimate the sufficient statistics for one or more template-type models with single pass training or partial pass training. In some embodiments, computer system 1700 may represent each template model by a separate data structure that may be indexed by the specified event and may be stored in secondary storage when not actively being used. In some embodiments, computer system 1700 may use the concordance to find passages that contain examples to train a template model conditioned on a specific item rather than processing the full training corpus.

According to a fifth quick training method, in some embodiments, computer system 1700 may fine tune one or more of the networks in the autonomous subsystems to model a specialized task. Fine tune training is well known to those skilled in the art of training large language models.

According to a sixth quick training method, in some embodiments, computer system 1700 may fine tune the pretrained explanatory network. For example, an explainable element may be associated with the embedding of a hidden state position-wise embedding at a specific position in the sequence. In some embodiments, computer system 1700 may train the explanatory network to produce the proper dictionary definition for the word in the context of the specified position, given the context text as a prompt. As another example, in some embodiments, computer system 1700 may train the explanatory network to generate an explanation of a named set, given a listing of the items in the named set as the prompt. In some embodiments, computer system 1700 may train the explanatory network to generate an explanation of an explainable element in terms of descriptions of one or two named sets detected and/or discriminated by the explainable element, with the context of the element in the sequence as a prompt.

According to a seventh quick training method, in some embodiments, computer system 1700 may select any node in a language model and interpret the node as one or more 2-way discriminations. In some embodiments, for a node with a non-monotonic activation function with more the one local maximum, computer system 1700 may create an equivalent set of nodes, each with a monotonic or unimodal activation function. In some embodiments, computer system 1700 may explain a node with a monotonic activation function as a discriminator between a set of data D1 with activation values less than a specified threshold T1 and a set of data D2 with activation values greater than a specified threshold T2. In some embodiments, computer system 1700 may explain a node with a unimodal activation function as a detector of a set D.

According to an eighth quick training method, in some embodiments, computer system 1700 may annotate one or more items in the training corpus with explanations. In some embodiments, computer system 1700 may annotate every word and every identified multi-word semantic unit. In some embodiments, computer system 1700 may pretrain a system to identify the corresponding dictionary definition of each instance of a specified word. In some embodiments, computer system 1700 may separately train a classifier for each word with the classification categories comprising the set of definitions for the word in a dictionary. In some embodiments, computer system 1700 may train a classifier for each word or semantic unit with the classification categories comprising a list of example translations of the word or semantic unit to one of more other languages.

According to a ninth quick training method, in some embodiments, computer system 1700 may select one or more words or semantic units and may cluster instances of the selected word or semantic unit that occur in the training data. In some embodiments, computer system 1700 may cluster all instances of all words or semantic units that occur in a specified set of training data. In some embodiments, for each word or unit, computer system 1700 may compute full context template model for a word such as the expression of 5505.3 log(Pr(act(xᵢ_{₁})=zᵢ_{₁}, . . . , act(xᵢ_{ₖ})=zᵢ_{ₖ}|yⱼ)), in which the xᵢ_{ₘ} are taken from both the preceding context and the following context. In some embodiments, computer system 1700 may then use k-means clustering or any of many clustering algorithms that are well known to those skilled in the art of machine learning. In some embodiments, computer system 1700 may compute clusters for a specified word or semantic unit based one of the non-parametric models that is conditioned on the specified word or semantic unit.

According to a tenth quick training method, in some embodiments, computer system 1700 may continue fine tuning the explanatory language model system during deployment.

According to an eleventh quick training method, in some embodiments, computer system 1700 may generate new non-parametric probability models using samples retrieved from the training corpus using the concordance. In some embodiments, computer system 1700 may estimate a weighed non-parametric model based on semantic similarity computed by the semantic analysis language model system.

According to a twelfth quick training method, in some embodiments, computer system 1700 may train an initial large language model by incrementally adding a specified number of layers to a large language model comprising explainable nodes that have already been trained to discriminate specific named sets. In some embodiments, for one or more nodes in the new layers, computer system 1700 may apply a relationship regularization link from a lower layer with an “is-equal-to” link to a corresponding node in a new layer. In some embodiments, computer system may initially train the new layers with a specified initial strength and gradually reduce the strength controlled by a hyperparameter tuned to a value that has been previously determined to minimize generalization error. In some embodiments, computer system 1700 may train new explainable nodes in each added transformer layer. In some embodiments, computer system 1700 may continue adding layers to the initial large language model until a specified number of layers has been achieved.

In some embodiments, computer system 1700 may compute a smoothed histogram of the counts of activation values in each interval of a monotonic or unimodal activation function of a selected node for the data items in a specified set of items. In some embodiments, computer system 1700 may create a new node as a detector for each mode in the smoothed histogram. In some embodiments, computer system 1700 may then train a template model to detect data items in a specified named set that are in a specified mode of the multimodal smoothed histogram. In some embodiments, computer system 1700 may explain each such template detector as a detector for the set of data corresponding to the mode in the smoothed histogram. In some cases, computer system 1700 may determine that the data in such a detected set may correspond to a particular value for one or more syntactic or semantic features and make that association part of the explanation. In some embodiments, computer system 1700 may save a list of the data items and/or the incoming weights and thresholds associated with the detector node in a repository. In some embodiments, computer system 1700 may explain a new detector node in terms of the similarity of its response to data items to the responses of one or more explainable nodes in the repository.

Thus, in some embodiments, computer system 1700 may explain a so-called “hidden state” in higher layers of a transformer network as a discrete state space with each state corresponding to an explainable detector, making the hidden states explicit and explainable. In some embodiments, computer system 1700 may train the explanatory network to explain some hidden states in terms of these explicit state values. In some embodiments, computer system 1700 may store the value of a hidden state in a cell. In some embodiments, computer system 1700 may use such a hidden state value as a feature or attribute which may be used as an input to a node in a higher layer. In some embodiments, computer system 1700 may soft tie or link an explicit hidden state cell with other cells in the same network or other networks.

In block 5508, in some embodiments, computer system 1700 may test the main language model system or a subsystem on new data that has not been used in training the system or subsystem. In some embodiments, testing a partially trained system on new data or data that has been set aside from the training data is well known to those skilled in the art of machine learning and is sometimes called “validation testing.” In principle, the same validation data should not be used repeatedly for multiple rounds of training and validation testing. Especially, in training large neural networks, such as large transformer-based language models there is not enough data available for frequently repeated validation testing, which may result in sub optimal performance when inevitably encountering new data during deployment. In some embodiments, in block 5508, computer system 1700 may obtain a continuing supply of new data through user feedback during interactive use by a developer, beta tester or end user. In addition, in some embodiments, computer system 1700 may do validation testing on the associated detection or discrimination task of an individual explainable node. Typically, computer system 1700 constructs an individual explainable node with a relatively small number of learned parameters. In some embodiments, computer system 1700 may train an individual explainable node on a small subset of the available training data. In addition, in some embodiments, computer system 1700 may associate each explainable node with a human understandable explanation that imposes a strong implicit regularization. Thus, computer system 1700 may train and validate each explainable node in a way that will more reliably generalize to new data than does training and validation testing only of the final classification output of a large neural network.

In block 5509, in some embodiments, if the performance on the new data has degraded more than a specified criterion, computer system 1700 may apply increased regularization and resume training. In some embodiments, computer system 1700 may revert the main language model system back to an earlier version if the performance on the new data is worse by more than a specified criterion. In some embodiments, computer system 1700 may determine to move to deployment if the performance on the new data satisfies specified stopping criteria. If computer system 1700 determines to move to deployment, computer system 1700 proceeds to block 5510. In some embodiments, computer system 1700 may continue or resume growth and training of a network during deployment.

In block 5510, in some embodiments, computer system 1700 may deploy a system comprising the main large language model network, the explanatory network, and an interface for interactive use of the system by a developer, a beta tester, or an end user. In some embodiments, once computer system 1700 has generated a passage of text, computer system 1700 may present to the user a choice of two or more versions of the generated passage for the user to select the version that the user prefers. In some embodiments, computer system 1700 may use the selection of preferred generated passages for further training of the system in block 5513. The deployment of a multi-stage interactive system is described in more detail in association with FIG. 56.

In block 5511, in some embodiments, computer system 1700 may use one or more specialized networks fine-tuned to detect anomalies and/or adversarial attacks. In training data, computer system 1700 may attempt to identify anomalies in the training data. In some embodiments, computer system 1700 may delete anomalous data from the training corpus. In some embodiments, computer system 1700 may attempt to correct an anomaly in the training corpus. During training, in some embodiments, computer system 1700 may train the main language model system to resist adversarial attacks by simulating an adversarial attack while training the network to generate a passage such as the network would have produced in the absence of the adversarial attack.

In some embodiments, computer system 1700 may implement one or more specified guard rails to align the generated text with human objectives. In some embodiments, for each guard rail criterion, computer system 1700 may train one of more specialty networks to detect violations of the guard rail in the prompt or other context. In some embodiments, for each guard rail criterion, computer system 1700 may train one of more specialty networks to detect violations of the guard rail in the generated text.

In some embodiments, computer system 1700 may attempt to detect and/or defeat adversarial attacks. In some embodiments, computer system 1700 may use a diverse set of canary networks and a diverse set of networks trained to be robust against adversarial attacks. In some embodiments, computer system 1700 may train a network to be more robust by adversarial training. That is, computer system 1700 may train the network on data produced by simulated adversarial attacks but provide the network with the correct answer in the training data. In some embodiments, computer system 1700 may train a more robust network by adding one or more explainable nodes with piecewise constant activation functions, such as act(x)=−1, if x<=T1, =0, if T1<x<=T2, =1, if x>T2. In some embodiments, computer system 1700 may train a node to discriminate two named sets with such a piecewise constant activation function by using linear programming to adjust the weights on the incoming connections, optimizing a specified objective for the number of correctly discriminated data items with a term for maximizing T2−T1. In some embodiments, computer system 1700 may use an active defense, changing the network in response to the current context, as discussed in association with block 415 of FIG. 4. For example, in some embodiments, computer system 1700 may train a network with one or more explainable nodes, each associated with one of three related piecewise constant activation functions: (1) one defined as above, (2) one defined by act(x)=−1, if x<=T1, =1 if x>T1, and (3) one defined by act(x)=−1, if x<=T2, =1 if x>T2. In some embodiments, computer system 1700 may train different weights on the outgoing connections for each version of the piecewise constant activation function. In some embodiments, computer system 1700 may train the network by randomly picking which version of the piecewise constant activation function to use for each training data item. In some embodiments, when generating text during deployment computer system 1700 may use the second version if |x−T2|<E, for a specified value of ε, use the third version if |x−T1|<ε, and use the first version otherwise.

In some embodiments, computer system 1700 may detect an adversarial attack by systematic differences in the responses of the set of canary networks from the responses of the robust networks. For example, in some embodiments, computer system 1700 may detect a greater number of guard rail violations in the responses of the canary networks than in the responses of the robust networks.

In block 5512, in some embodiments, computer system 1700 may present to the user one or more explanations generated by the explanatory network. In some embodiments, computer system 1700 may present an explanation to receive confirmation that the explanation is correct. In some embodiments, the user may request computer system 1700 to present an explanation. In some embodiments, computer system 1700 may enable the user to rate the quality of the explanation. In some embodiments, computer system 1700 may use the explanatory network to generate a second explanation or an elaboration of the first explanation. In some embodiments, computer system 1700 may perform additional training of the explanatory based on the interaction with the user. In some embodiments, computer system 1700 may store the user interaction in a repository for future training of explanatory systems.

In block 5513, in some embodiments, computer system 1700 may do fine tuning for one of more specified networks using an objective function based on user preferences whenever the user expresses a preference when presented with two or more choices in block 5510 or block 5512.

In block 5514, in some embodiments, computer system 1700 may test the performance of the system on new data. In some embodiments, computer system 1700 may test the performance of one of the subsystems on data that has been used to train another subsystem but not used in training any of the networks in the subsystem being tested. In some embodiments, computer system 1700 may test the performance of the explanation associated with an explainable node. In some embodiments, computer system 1700 may individually test one or more explainable prediction elements (nodes or cells). In some embodiments, computer system 1700 may test an explainable element directly from the prediction made by the element. In some embodiments, computer system 1700 may train a prediction element for every instance in which the element makes an error in the prediction and on a random sampling of the instances in which the element does not make an error.

In block 5515, in some embodiments, computer system 1700 may determine, based on specified criteria whether to continue growing one or more networks. If computer system 1700 determines continue growth and development, computer system 1700 returns to block 5502. Otherwise, computer system 1700 returns to block 5510 to continue using the current networks in deployment.

FIG. 56 is a flow chart of an illustrative embodiment of the process of using an explainable large language model text generation system in an interactive deployment. In some embodiments, computer system 1700 may perform steps 5601-5613 separately for the collection of networks in each autonomous subsystem and then combine the joint candidate lists in block 5614.

In block 5601, in some embodiments, computer system 1700 may load pretrained language models in one or more computers, workstations, or other subsystems, as illustrated in FIG. 30. In some embodiments, computer system 1700 may link corresponding nodes in pairs of subsystems with data-dependent relationship regularization links. In some embodiments, computer system 1700 may link two or more nodes in item embeddings with the “is-equal-to” relationship or a similar relationship to reinforce training towards the linked nodes having similar explanations. In some embodiments, computer system 1700 may link one or more pairs of corresponding nodes with the “is-not-equal-to” relationship or some other asymmetric relationship to increase the diversity among the set of pretrained language models. In some embodiments, computer system 1700 may pretrain each language model on a distinct subset of the training corpus, to increase the diversity among the set of pretrained language models. In some embodiments, computer system 1700 may load a specified set of training data for each subsystem.

In block 5602, in some embodiments, computer system 1700 may obtain a prompt or context. In some embodiments, computer system 1700 may use one or more of the language models to generate additional text to be added to the obtained context.

In block 5603, in some embodiments, computer system 1700 may select a set of key words or phrases from the current context. The current context may be the context obtained in block 5602, or the current context may be a text sequence that computer system 1700 has successively extended by multiple passes through the loop from block 5603 to block 5616.

In block 5604, in some embodiments, computer system 1700 may use the keywords in the current context and a concordance or other means to load example passages in which one or more keywords and/or key phrases appear. In some embodiments, computer system 1700 may load the rest of a passage in which the context is only the first portion of the passage.

In some embodiments, computer system 1700 may use the semantic analysis language model system to test each example passage that is retrieved in block 5604 for semantic similarity with the current context. In some embodiments, computer system 1700 may estimate context-specific non-parametric probability models from the example passages weighted by semantic similarity.

In block 5605, in some embodiments, computer system 1700 may preload parametric probability models, such as those described in association with block 5505 of FIG. 55. In some embodiments, in block 5605, computer system 1700 may preload only a select subset of the set of parametric probability models, in order to reduce the amount of memory required for the parametric probability models. In some embodiments, computer system 1700 may load one or more parametric probability models that each model a specified limited number of explainable node activations (or other modeled events). In some embodiments, computer system 1700 may load distinct subsets of the set of parametric models in each subsystem to reduce the memory requirement for each subsystem relative to the total number of models loaded across the full distributed system.

In block 5606, in some embodiments, computer system 1700 may perform autoregressive prediction of the next item in one or more of the diverse, distributed subsystems. In some embodiments, computer system 1700 may perform a plurality of text generation tasks simultaneously, with only a subset of subsystems dedicated to any one task.

In block 5607, in some embodiments, computer system 1700 may load the weights for the incoming connections for any explainable nodes that have been added to the network or for which the weights have been changed.

In block 5608, in some embodiments, computer system 1700 may load prediction probabilities, such as those discussed in association with block 5504 of FIG. 55.

In block 5610, in some embodiments, computer system 1700 may broadcast the activation values of selected embedding nodes from each subsystem working on the same generation task to all other subsystems working on that generation task.

In block 5611, in some embodiments, computer system 1700 may then revise each of the selected nodes in each the subsystem working on the same task using data-dependent regularization links with the “is-equal-to” relationship. In some embodiments, computer system 1700 may replace each of the activations with the average activation of a set of linked nodes, which is equivalent to a special case of the “is-equal-to” relation in the limiting case in which the link strength approaches infinity.

In block 5612, in some embodiments, computer system 1700 may compute a list of candidate items for each of a specified number of positions in the sequence beyond the current position. In some embodiments, computer system 1700 may revise a candidate list that computer system 1700 computed from a previous position in the sequence. In some embodiments, such as when computing the candidate list for the position right after the initial prompt, computer system 1700 may compute a new candidate list from scratch. In some embodiments, computer system 1700 may chose candidates by choosing the items that have the best scores using specified rules for combining the results of (1) word counts in the examples obtained in block 5604, (2) the scores from the autoregressive transformer in block 5606, and (3) the non-parametric probability models of block 5608.

In some embodiments, computer system 1700 may estimate the probability of each potential candidate y; as the item in a specified future position. In some embodiments, computer system 1700 may estimate the probability for each transformer network by standard computation of an autoregressive transformer network, which is well known to those skilled in the art of autoregressive text generators. In some embodiments, computer system 1700 may estimate the probability of candidate yⱼ for each network using the non-parametric probability models and the naïve independence assumption of expression 5505.1A in block 5505 of FIG. 55. In some embodiments, computer system 1700 may correct for the naïve independence assumption in part by using the estimated correlation correction of expression 5505.2. In some embodiments, computer system 1700 may estimate the probability of each potential candidate in part by using a small template model preloaded in block 5605. In some embodiments, computer system 1700 may combine all the partial estimates using another independence assumption, multiplying the probability estimates or adding their logarithms. In some embodiments, computer system 1700 may train a neural network as a probability estimate combing network for which computer system 1700 trains the output to be a more accurate estimate of the probability based on all the partial estimates. In some embodiments, computer system 1700 may apply a softmax operation to the combined estimate of log(Pr(act(xᵢ_{₁})=zᵢ_{₁}, . . . , act(xᵢ_{ₖ})=zᵢ_{ₖ}|yⱼ)), to estimate log(Pr(yⱼ|act(xᵢ_{₁})=zᵢ_{₁}, . . . , act(xᵢ_{ₖ})=zᵢ_{ₖ}))), corresponding to an application of Bayes rule.

In block 5613, in some embodiments, computer system 1700, for the current position, may load any large template models that are on the short list but that are not already loaded. In some embodiments, computer system 1700 may begin to preload any large template models on the short list for later positions that are not already loaded. In some embodiments, computer system 1700 may begin preloading a large template model as soon as the event yⱼ on which the model is conditioned is among the future events ranked with a relative ranking better than a specified criterion. In some embodiments, computer system 1700 may use the relative ranking computed in block 5615 in a previous round for determining ranking order for loading large template models for future positions. In some embodiments, computer system 1700 may load each large template model into only one of the semi-autonomous systems. Computer system 1700 may subsequently share the score computed for each large template model with the other autonomous subsystems.

In block 5614, in some embodiments, computer system 1700 may compute the joint candidate scores and lists as described in association with block 5612, except in block 5614 computer system 1700 may use the large template models rather than the small template models.

In block 5615, in some embodiments, computer system 1700 may compute the scores for the short list for the current position.

In block 5616, in some embodiments, computer system 1700 may add a new token or longer item selected in block 5615 to the sequence being generated. In some embodiments, computer system 1700 may select the highest ranked candidate from the candidate list for the position currently being generated. In some embodiments, computer system 1700 may select an item from among the top-ranking candidates by a random choice with each candidate selected with a probability proportional to its estimated posterior in the current context. In some embodiments, computer system 1700 may update the context with the addition of the new item.

In some embodiments, computer system 1700 may determine whether the chosen item marks the end of the passage being generated. If so, computer system 1700 proceeds to block 5617. Otherwise, computer system 1700 returns to block 5603.

In block 5617, in some embodiments, computer system 1700 may present two or more choices of a generated passage to the user and record the user's choice, as discussed in association with block 5510 of FIG. 55. In some embodiments, computer system 1700 may provide one or more explanations to the user and receive user feedback.

In block 5618, in some embodiments, computer system 1700 may test and train on data that has not yet been used in training a network. For a specified explainable element (node, cell, or probability model), computer system 1700 may test and train on data that has not been used in training the specified element. As discussed in association with block 5507, computer system 1700 may use quick train methods for training an explainable element. Because each explainable element is tied to an explanation the explainable element, models associated with explanations may generalize to new data better than other models. The difference in generalization performance may be greater when the quantity of training data is small relative to the number of learned parameters. In some embodiments, computer system 1700 may take account of this difference in generalization performance when adjusting the degree of regularization. In some embodiments, computer system 1700 may test the generalization performance on the new data. In the use of an interactive system with user feedback, there is a continuing stream of new data. In some embodiments, computer system 1700 may test and train on new data acquired from interaction with the user and then continue to collect additional new data as the system is used.

Embodiments of the present invention can be used to improve operation, including the learning, of many and various types of machine learning systems in a variety of applications. For example, dynamic hybrid networks according to embodiments of the present invention can improve recommender systems, speech recognition systems, and classification systems, including image and diagnostic classification systems (e.g., classifying medical diagnoses) to name but a few examples, such as by making networks that are more robust against disturbances in input data according to any of the techniques described herein. As explained herein, embodiments of the present invention can be used with generative AI systems. Various embodiments of the present invention can, therefore, be used to develop and/or train generative AI systems for, for example:
Language applications, such as essay and prose generation, software code development and language translation;
Audio applications, such developing songs and snippets of audio clips with text inputs, recognizing objects in videos and creating accompanying noises for different video footage, and creating custom music;
Visual applications, such as creation of 3D images, avatars, graphs, film, animations, graphics for video games and virtual reality, and other illustrations and video, including for example, creating graphs that show new chemical compounds and molecules that aid in drug discovery, creating realistic images for virtual or augmented reality, producing 3D models for video games, design logos, enhancing or editing existing images, etc.
Generating synthetic data to train other AI models when additional training data are needed, including, for example, generating synthetic training data for training vehicles to operate autonomously, to make more accurate classifications or discriminators (for classifier and discriminators), etc.;
Generating 3D worlds and models for simulations and development of vehicles (such as cars) and other 3D objects;
Generating new protein sequences to aid in drug discovery; and/or
Generating simulations of the planet to aid weather forecasting and natural disaster prediction.

Further, a hybrid or neural network as described herein could be deployed in an operational setting, after being trained or partially trained (such as when the hybrid network continues to be trained post-deployment), for example, as a classifier, a generator, or a predictor, as but a few examples.

As a classifier (or discriminator), the network could be deployed to categorize inputs into one or more categorization categories. Example uses for a network according to an embodiment of the present invention trained as a classifier include:
Image classification—classifying whether an image or video include a particular type of object; or whether an image or real or fake, such as used in a GAN;
Fraud detection—classifying whether a particular set of captured data, such as for a financial transaction, are indicative of fraud;
Document classification—classifying whether an electronic document is a particular type of document (e.g., check, contract, article, etc.) or is about, or pertains to, a particular subject;
Spam filtering—classifying whether a email is likely to be spam or not based on content of the email and metadata about the email;
Facial recognition—identifying faces in an image or video, and/or determining an identity of a person in an image or video;
Voice recognition—determining an identify of a person based on a voice recording of the person;
Medical diagnostic test—determining whether a person is likely to have a particular medical condition based on test results or other medical-related data for the certain;
Customer behavior prediction—determining a likely behavior of a customer based on socioeconomic, demographic, and/or behavioral data about the customer; and
Malware classification—classifying whether software constitutes malware.

As a generator, the network could be deployed to generate data to train another machine learning system, such as a machine learning classifier. The generated data could be images (e.g., synthetic images) with examples (both positive and negative) of a medical condition that are used to train a medical imaging system through machine learning to detect the medical condition in the images. For example, the generator once trained may be deployed to generate MRI scan images, tomographic scan images, such as for CT (computed tomography), OCT (optical coherence tomography), or PET (positron emission tomography), X-ray images, and/or ultrasound scans, to train through machine learning a corresponding classifier for medical conditions that are detectable in the scans/images. The generator could also be used to generate images or videos of objects that can be used to train a computer vision system to detect the object in the images or videos. The computer vision system could be part of a robot or autonomous vehicle, for example. The generator could also be deployed, for example, to generate synthetic cyber-threats that could be used to train a cybersecurity system to detect cyber threats.

A generator could also be trained to generate creative works, as described herein, such as textual/written works, visual art, music or audio books.

As a predictive modeler, the hybrid network could be deployed to predict whether patterns; predict forward-looking costs for goods or services, such as insurance, financial securities, etc.; predict forward-looking sales, costs and supply quantities for a business; predict consumer characteristics for a particular consumer or a particular good/service; make medical-related predictions for a person; etc.

In one general aspect, therefore, the present invention is directed, in various embodiments, to computer-implemented methods and computer systems for training, dynamically, a machine-learning network from a base system. The machine-learning network comprises, when built, multiple layers, where the multiple layers comprise an input layer, an output layer, and one or more hidden layers between the input and output layers. Training the machine-learning network comprises iteratively training, by a programmed computer system, the machine-learning network with a set of training data. The iterative training comprises computing learned parameters for the machine-learning network, where the learned parameters comprise a weight for weighted connections in the machine-learning network. Computing the learned parameters comprises, for each training data item in the set of training data: a forward pass through the machine-learning network that involves computations using the learned parameters; and for at least a first portion of the machine-learning network, a back-propagation pass through the machine-learning network. The back-propagation pass comprises, for the first portion of the machine-learning network, computation of derivatives, with respect to a loss function, for the learned parameters. The method further comprises the step of making, by the programmed computer system, a sensibility level assessment of the machine-learning network, where the sensibility level assessment comprises a determination of whether the machine-learning network produces an insensible result according to a criteria of sensibility. The method further comprises the step of making, by the programmed computer system, one or more sensibility-improving modifications to the machine-learning network, where each of the one or more sensibility-improving modifications is in response to a determination, in the sensibility level assessment of the machine-learning network, that the machine-learning network produces an insensible result, such that the one or one or more sensibility-improving modifications make the machine-learning network less vulnerable to producing insensible results.

In one general aspect, a computer system according to embodiments of the present invention comprises one or more processor cores; and computer memory in communication with the one or more processor cores. The computer memory stores computer instructions that when executed by the one or more processor cores, cause the one or more processor cores to train, dynamically, a machine-learning network from a base system. The machine-learning network comprises, when built, multiple layers, where the multiple layers comprise an input layer, an output layer, and one or more hidden layers between the input and output layers. The computer instructions, when executed by the one or more processors, cause the one or more processors to train the machine-learning network by: iteratively training the machine-learning network with a set of training data, where the iterative training comprises computing learned parameters for the machine-learning network, where the learned parameters comprise a weight for weighted connections in the machine-learning network. Computing the learned parameters comprises, for each training data item in the set of training data: a forward pass through the machine-learning network that involves computations using the learned parameters; and for at least a first portion of the machine-learning network, a back-propagation pass through the machine-learning network, where the back-propagation pass comprises, for the first portion of the machine-learning network, computation of derivatives, with respect to a loss function, for the learned parameters. The computer instructions, when executed by the one or more processors, cause the one or more processors to train the machine-learning network by: making a sensibility level assessment of the machine-learning network, where the sensibility level assessment comprises a determination of whether the machine-learning network produces an insensible result according to a criteria of sensibility; and making one or more sensibility-improving modifications to the machine-learning network, where each of the one or more sensibility-improving modifications is in response to a determination, in the sensibility level assessment of the machine-learning network, that the machine-learning network produces an insensible result, such that the one or one or more sensibility-improving modifications make the machine-learning network less vulnerable to producing insensible results.

In various implementations, at least one of the one or more sensibility-improving modifications comprises a structural modification to the machine-learning network.

In various implementations, the structural modification comprises replacing, by the programmed computer system, a node of the machine-learning network with a plurality of replacement nodes. The node can have a non-monotonic activation function with N monotonic intervals, where N>1; and the plurality of replacement nodes can comprise N replacement nodes, where each of the N replacement nodes is for a respective one of the N monotonic intervals. In various implementations, the method can further comprise initializing, by the programmed computer system, the plurality of replacement nodes to have identical connections and connection weights; and after initializing, subsequently training, by the programmed computer system, the plurality of replacement nodes such that the connection weights for the plurality of replacement nodes are non-identical. In various implementations, each of the plurality of replacement nodes has a different activation function. In various implementations, the structural modification further comprises addition of a switch to the machine-learning network to select which of the plurality of replacement nodes is to use a specific data item.

In various implementations, the structural modification comprises adding a node to the machine-learning network. The node can comprise an error prediction node or an error correction node. The node can also comprises a detector-imitating node that is trained to imitate a detector and where making the one or more sensibility-improving modification comprises determining, by the programmed computer system, a location in the machine-learning network for the detector-imitating node.

In various implementations, making the one or more sensibility-improving modifications comprises: a first training stage for the machine-learning network that trains selectively a sub-portion of the machine-learning network; and after the first training stage, a second training stage that trains an entirety of the machine-learning network.

In various implementations, making the one or more sensibility-improving modifications comprises a first training stage for the machine-learning network that trains a selected element of the machine-learning network with a selected sub-portion of training data. The selected element can comprise a detector element of the machine-learning network, and where the selected sub-portion of training data comprises training data within a threshold distance of a decision boundary for the detector element.

In various implementations, the structural modification comprises replacing, by the programmed computer system, a selected node in the machine-learning network with a set of replacement nodes that comprises first, second and third replacement nodes, where: the first replacement nodes copies incoming connections to the selected node that have positive weights; the second replacement nodes copies incoming connections to the selected node that have negative weights; the third replacement node copies outgoing connections from the selected node; and the third replacement node has a first incoming connection from the first replacement node and a second incoming connection from the second replacement node.

In various implementations: the machine-learning network comprises, prior to the one or more sensibility-improving modifications, a regression-type output; and at least one of the one or more sensibility-improving modifications comprises converting, by the programmed computer system, the regression-type output to a classification-type output for the machine-learning network.

In various implementations, the one or more sensibility-improving modifications to the machine-learning network comprises creating and using, by the programmed computer system, a substitute derivative function for a node of the machine-learning network.

In various implementations, the one or more sensibility-improving modifications to the machine-learning network comprises, by the programmed computer system, excluding one or more training data items from a selected node of the machine-learning network.

In various implementations, the one or more sensibility-improving modifications to the machine-learning network comprises, by the programmed computer system, delegating one or more training data items from a set of training data items for the machine-learning network.

In various implementations, at least one of the one or more sensibility-improving modifications comprises a modified activation function for a node of the machine-learning network. The modified activation function can comprises, for a node of the machine-learning network that, prior to the one or more sensibility-improving modifications, comprises an unbounded activation function, replacing the unbounded activation function with a bounded activation function for the node. The modified activation function can comprises, for a node of the machine-learning network that, prior to the one or more sensibility-improving modifications, comprises non-monotonic activation function, replacing the non-monotonic activation function with a monotonic activation function for the node. The modified activation function can comprise a modified activation function with less change in output values than an activation function for the node prior to the at least one of the one or more sensibility-improving modifications. The modified activation function can comprise a piecewise constant activation function. The modified activation function can comprise a plurality of selectively-used replacement activation functions, where the plurality of selectively-used replacement activations functions are selected based on an input to the machine-learning network.

In various implementations, the one or more sensibility-improving modification comprises training a node in the machine-learning network to: produce a first output value for an input that is within a known set; and produce a second output value, different from the first input value, when the input is not within the known set.

In various implementations, the modified activation function comprises a randomized activation function such that an activation value from the node for a specific data item is randomly different.

In various implementations, the modified activation function comprises an activation function f(x) where a constant background score is output for values of x less than a threshold value T1. In various implementations, the modified activation function comprises an activation function f(x) where a constant background score is output for values of x greater than a threshold value T2.

In various implementations, the sensibility level assessment of the machine-learning network comprises a determination of whether a small change in an input to the machine-learning network causes the machine-learning network to make a mistake on the input that the machine-learning network did not make before the small change in the input. The small change can comprise a change where L∞norm for the input is less than a threshold value. The one or more sensibility-improving modifications can comprise a structural modification to the machine-learning network upon the determination that the small change in the input to the machine-learning network causes the machine-learning network to make the mistake on the input that the machine-learning network did not make before the small change in the input. The one or more sensibility-improving modifications can comprise a change to an activation function of a node in the machine-learning network upon the determination that the small change in the input to the machine-learning network causes the machine-learning network to make the mistake on the input that the machine-learning network did not make before the small change in the input.

In various implementations, the sensibility level assessment of the machine-learning network is based on a dimensionality of a number of variables for the machine-learning network and derivatives of an output function of the machine-learning network with respect to an input.

In various implementations: the sensibility level assessment of the machine-learning network comprises a test of a decision boundary for a decision by the machine-learning network; and making the one or more making the one or more sensibility-improving modifications comprises moving, by the programmed computer system, a position of the decision boundary.

In various implementations, making the one or more sensibility-improving modifications comprises creating, by the programmed computer system, a local normed space with an autoencoder, such that the local normed space limits an effective dimensionality of input to a detector element or discriminator element of the machine-learning network.

In various implementations, making the sensibility level assessment of the machine-learning network comprises making, at least, by the programmed computer system, both a first sensibility level assessment and making a second sensibility level assessment, where the first sensibility level assessment has a different criteria for sensibility than the second sensibility level assessment.

In various implementations, the first sensibility level assessment comprises a determination of whether a small change in an input to the machine-learning network causes the machine-learning network to make a mistake on the input that the machine-learning network did not make before the small change in the input.

In various implementations, the second sensibility level assessment comprises guidance from a hybrid network learning management system (HNLMS), where the HNLMS comprises a cooperative association of a team of one or more human experts and one or more AI systems. The guidance can comprise a hyperparameter of a sensibility criteria for the machine-learning network.

In various implementations, the method further comprises, as part of the training of the machine-learning network and after making the sensibility level assessment of the machine-learning network: making, by the programmed computer system, a classification of an input data item to be classified with the machine-learning network; and making, by the programmed computer system, an additional modification to the machine-learning network based on the classification of the input data item to be classified.

In various implementations, making the classification comprises computing, by the programmed computer system, an activation value for each node in the machine-learning network.

In various implementations, after making the one or more sensibility-improving modifications, the machine-learning network comprises one or more units and zero or more nodes, such that a sum of the units and the nodes is greater than two, where: each of the one or more units produces multiple outputs, each from a separate activation function, where each of the separate activation functions are applied to an output of a common affine transformation for the unit; and each of the zero or more nodes produces a single output, with a single activation function, applied to an output of a single affine transformation for the node. In various implementations, at least one of the units comprises a robust template model. In various implementations, the robust template model comprises at least two input variable norm cells and a template summation cell connected to the two input variable norm cells. In various implementations, each of the at least two input variable norm cells computes a single-variable norm. In various implementations, each of the single-variable norms is computed using a hyperparameter specified by a system comprising a cooperation of a team of one or more humans with one or more AI systems.

In various implementations: the back-propagation pass for the first portion of the machine-learning network comprises training the first portion of the machine-learning network via gradient descent; and computing the learned parameters further comprises, by the programmed computer system, training a second portion of the machine-learning network via training technique different from gradient descent.

In various implementations, the training technique different from gradient descent comprises a histogram analysis, where the histogram analysis comprises: computing a histogram of one or more variables from the training of the machine-learning network; and making the one or more sensibility-improving modifications to the machine-learning network comprises making the one or more sensibility-improving modifications to the machine-learning network based on the histogram.

In various implementations, the training technique different from gradient descent comprises setting an implicit local training target for a node of the machine-learning network. In various implementations, the training technique different from gradient descent comprises back-propagating labeled data examples for a second portion of the machine-learning network. In various implementations, the labeled data examples have implicit errors corrected.

In various implementations, the training technique different from gradient descent comprises using an empirically estimated learned parameter for a node in a second portion of the machine-learning network.

In various implementations, the training technique different from gradient descent comprises using an empirically estimated hyperparameter for a second portion of the machine-learning network.

In various implementations, the training technique different from gradient descent comprises error minimization and back propagation of data examples for the second portion of the machine-learning network. The error minimization and back propagation of data examples for the second portion of the machine-learning network can be in addition to back-propagation of derivatives through the second portion of the network.

In various implementations, training the machine-learning network comprises training the machine-learning network to make a classification, once trained, on a presented data item.

In various implementations, the method further comprises: training, by the programmed computer system, a diverse set of canary networks and a diverse set of robust networks; and diagnosing, by the programmed computer system, a potential violation of sensibility from a data item for classification by the machine-learning network with the diverse set of canary networks and a diverse set of robust networks.

In various implementations the method further comprises: computing, by the programmed computer system, an alignment for the presented data item; and using, by the programmed computer system, the alignment to inform the classification by the machine-learning network. The alignment can be to a type of human knowledge. The type of human knowledge can comprise a mereology.

In various implementations, the machine-learning network is trained as a creative work generator. The creative work generator can be trained as a written creative work or as a visual creative work. In various implementations, the creative work generator is trained as a musical work generator.

In various implementations, the creative work generator comprises a hyperparameter for controlling an amount of human participation in creating a creative work generated by the creative work generator.

In various implementations the machine-learning network is trained to have an explicit representation of human knowledge.

In various implementations, the creative work generator comprises a style hyperparameter used in generating a creative work.

In various implementations, the creative work generator further comprises a style adjustment subsystem for generating the style hyperparameter. In various implementations, the style adjustment subsystem comprises a parametric autoencoder.

Any patent, publication, or other document incorporated by reference into this specification is incorporated in its entirety unless otherwise indicated but only to the extent that the incorporated material does not conflict with the descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference.

Whereas particular examples and embodiments of the inventions described herein have been described above for purposes of illustration, it will be evident to those skilled in the art that numerous variations of the details of the present inventions may be made without departing from the inventions as defined in the appended claims. While the present disclosure provides descriptions of various specific aspects for the purpose of illustrating various aspects of the present disclosure and/or its potential applications, it is understood that variations and modifications will occur to those skilled in the art. Further, it is to be understood that the figures and descriptions of the present invention have been simplified to illustrate elements that are relevant for a clear understanding of the present invention, while eliminating, for purposes of clarity, other elements. Accordingly, the invention or inventions described herein should be understood to be at least as broad as they are claimed and not as more narrowly defined by particular illustrative aspects provided herein. No particular aspect or aspects of the examples are necessarily intended to limit the scope of the present invention.

1. A computer-implemented method comprising:
training, dynamically, by a programmed computer system, a machine-learning network from a base system, wherein the machine-learning network comprises, when built, multiple layers, wherein the multiple layers comprise an input layer, an output layer, and one or more hidden layers between the input and output layers, wherein each layer comprises one or more nodes such that the machine-learning network comprises a plurality of nodes, and wherein training the machine-learning network comprises:
iteratively training, by the programmed computer system, the machine-learning network with a set of training data, wherein the iterative training comprises computing learned parameters for the machine-learning network, wherein the learned parameters comprise a weight for weighted connections in the machine-learning network, wherein computing the learned parameters comprise, for each training data item in the set of training data:
a forward pass through the machine-learning network that involves computations using the learned parameters; and
for at least a first portion of the machine-learning network, a back-propagation pass through the machine-learning network, wherein the back-propagation pass comprises, for the first portion of the machine-learning network, computation of derivatives, with respect to a loss function, for the learned parameters;
making, by the programmed computer system, a sensibility level assessment of the machine-learning network, wherein the sensibility level assessment comprises a determination of whether a result produced by the machine-learning network is insensible according to a criteria of sensibility, wherein the result for which the sensibility level assessment is made comprises one or more activation values computed by one or more nodes of the machine-learning network in response to input data; and
making, by the programmed computer system, one or more sensibility-improving modifications to the machine-learning network, wherein each of the one or more sensibility-improving modifications is in response to a determination, in the sensibility level assessment of the machine-learning network, that the machine-learning network produces an insensible result, such that the one or one or more sensibility-improving modifications make the machine-learning network less vulnerable to producing insensible results.

2. The computer-implemented method of claim 1, wherein at least one of the one or more sensibility-improving modifications comprises a structural modification to the machine-learning network.

3. The computer-implemented method of claim 2, wherein the structural modification comprises replacing, by the programmed computer system, a node of the machine-learning network with a plurality of replacement nodes.

4. The computer-implemented method of claim 3, wherein:
the node has a non-monotonic activation function with N monotonic intervals, where N>1; and
the plurality of replacement nodes comprises N replacement nodes, wherein each of the N replacement nodes is for a respective one of the N monotonic intervals.

5. The computer-implemented method of claim 3, further comprising:
initializing, by the programmed computer system, the plurality of replacement nodes to have identical connections and connection weights; and
after initializing, subsequently training, by the programmed computer system, the plurality of replacement nodes such that the connection weights for the plurality of replacement nodes are non-identical.

6. The computer-implemented method of claim 3, wherein each of the plurality of replacement nodes has a different activation function.

7. The computer-implemented method of claim 6, wherein the structural modification further comprises addition of a switch to the machine-learning network to select which of the plurality of replacement nodes is to use a specific data item.

8. The computer-implemented method of claim 2, wherein the structural modification comprises adding a node to the machine-learning network.

9. The computer-implemented method of claim 8, wherein the node comprises an error prediction node.

10. The computer-implemented method of claim 8, wherein the node comprises an error correction node.

11. The computer-implemented method of claim 8, wherein the node comprises a detector-imitating node that is trained to imitate a detector and wherein making the one or more sensibility-improving modification comprises determining, by the programmed computer system, a location in the machine-learning network for the detector-imitating node.

12. The computer-implemented method of claim 1, wherein making the one or more sensibility-improving modifications comprises:
a first training stage for the machine-learning network that trains selectively a sub-portion of the machine-learning network; and
after the first training stage, a second training stage that trains an entirety of the machine-learning network.

13. The computer-implemented method of claim 1, wherein making the one or more sensibility-improving modifications comprises a first training stage for the machine-learning network that trains a selected element of the machine-learning network with a selected sub-portion of training data.

14. The computer-implemented method of claim 13, wherein the selected element comprises a detector element of the machine-learning network, and wherein the selected sub-portion of training data comprises training data within a threshold distance of a decision boundary for the detector element.

15. The computer-implemented method of claim 2, wherein the structural modification comprises replacing, by the programmed computer system, a selected node in the machine-learning network with a set of replacement nodes that comprises first, second and third replacement nodes, wherein:
the first replacement nodes copies incoming connections to the selected node that have positive weights;
the second replacement nodes copies incoming connections to the selected node that have negative weights;
the third replacement node copies outgoing connections from the selected node; and
the third replacement node has a first incoming connection from the first replacement node and a second incoming connection from the second replacement node.

16. The computer-implemented method of claim 1, wherein:
the machine-learning network comprises, prior to the one or more sensibility-improving modifications, a regression-type output; and
at least one of the one or more sensibility-improving modifications comprises converting, by the programmed computer system, the regression-type output to a classification-type output for the machine-learning network.

17. The computer-implemented method of claim 1, wherein the one or more sensibility-improving modifications to the machine-learning network comprises creating and using, by the programmed computer system, a substitute derivative function for a node of the machine-learning network.

18. The computer-implemented method of claim 1, wherein the one or more sensibility-improving modifications to the machine-learning network comprises, by the programmed computer system, excluding one or more training data items from a selected node of the machine-learning network.

19. The computer-implemented method of claim 1, wherein the one or more sensibility-improving modifications to the machine-learning network comprises, by the programmed computer system, delegating one or more training data items from a set of training data items for the machine-learning network.

20. The computer-implemented method of claim 1, wherein at least one of the one or more sensibility-improving modifications comprises a modified activation function for a node of the machine-learning network.

21. The computer-implemented method of claim 20, wherein the modified activation function comprises, for a node of the machine-learning network that, prior to the one or more sensibility-improving modifications, comprises an unbounded activation function, replacing the unbounded activation function with a bounded activation function for the node.

22. The computer-implemented method of claim 20, wherein the modified activation function comprises, for a node of the machine-learning network that, prior to the one or more sensibility-improving modifications, comprises non-monotonic activation function, replacing the non-monotonic activation function with a monotonic activation function for the node.

23. The computer-implemented method of claim 20, wherein the modified activation function comprises a modified activation function with less change in output values than an activation function for the node prior to the at least one of the one or more sensibility-improving modifications.

24. The computer-implemented method of claim 20, wherein the modified activation function comprises a piecewise constant activation function.

25. The computer-implemented method of claim 20, wherein the modified activation function comprises a plurality of selectively-used replacement activation functions, wherein the plurality of selectively-used replacement activations functions are selected based on an input to the machine-learning network.

26. The computer-implemented method of claim 1, wherein the one or more sensibility-improving modification comprises training a node in the machine-learning network to:
produce a first output value for an input that is within a known set; and
produce a second output value, different from the first input value, when the input is not within the known set.

27. The computer-implemented method of claim 20, wherein the modified activation function comprises a randomized activation function such that an activation value from the node for a specific data item is randomly different.

28. The computer-implemented method of claim 20, wherein the modified activation function comprises an activation function f(x) where a constant background score is output for values of x less than a threshold value T1.

29. The computer-implemented method of claim 20, wherein the modified activation function comprises an activation function f(x) where a constant background score is output for values of x greater than a threshold value T2.

30. The computer-implemented method of claim 1, wherein the sensibility level assessment of the machine-learning network comprises a determination of whether a small change in an input to the machine-learning network causes the machine-learning network to make a mistake on the input that the machine-learning network did not make before the small change in the input.

31. The computer-implemented method of claim 30, wherein the small change comprises a change where L∞norm for the input is less than a threshold value.

32. The computer-implemented method of claim 31, wherein one or more sensibility-improving modifications comprise a structural modification to the machine-learning network upon the determination that the small change in the input to the machine-learning network causes the machine-learning network to make the mistake on the input that the machine-learning network did not make before the small change in the input.

33. The computer-implemented method of claim 31, wherein one or more sensibility-improving modifications comprise a change to an activation function of a node in the machine-learning network upon the determination that the small change in the input to the machine-learning network causes the machine-learning network to make the mistake on the input that the machine-learning network did not make before the small change in the input.

34. The computer-implemented method of claim 1, wherein the sensibility level assessment of the machine-learning network is based on a dimensionality of a number of variables for the machine-learning network and derivatives of an output function of the machine-learning network with respect to an input.

35. The computer-implemented method of claim 1, wherein:
the sensibility level assessment of the machine-learning network comprises a test of a decision boundary for a decision by the machine-learning network; and
making the one or more making the one or more sensibility-improving modifications comprises moving, by the programmed computer system, a position of the decision boundary.

36. The computer-implemented method of claim 1, wherein making the one or more sensibility-improving modifications comprises creating, by the programmed computer system, a local normed space with an autoencoder, such that the local normed space limits an effective dimensionality of input to a detector element or discriminator element of the machine-learning network.

37. The computer-implemented method of claim 1, wherein making the sensibility level assessment of the machine-learning network comprises making, at least, by the programmed computer system, both a first sensibility level assessment and making a second sensibility level assessment, wherein the first sensibility level assessment has a different criteria for sensibility than the second sensibility level assessment.

38. The computer-implemented method of claim 37, wherein the first sensibility level assessment comprises a determination of whether a small change in an input to the machine-learning network causes the machine-learning network to make a mistake on the input that the machine-learning network did not make before the small change in the input.

39. The computer-implemented method of claim 38, wherein the second sensibility level assessment comprises guidance from a hybrid network learning management system (HNLMS), wherein the HNLMS comprises a cooperative association of a team of one or more human experts and one or more AI systems.

40. The computer-implemented method of claim 39, wherein the guidance comprises a hyperparameter of a sensibility criteria for the machine-learning network.

41. The computer-implemented method of claim 1, further comprising, as part of the training of the machine-learning network and after making the sensibility level assessment of the machine-learning network:
making, by the programmed computer system, a classification of an input data item to be classified with the machine-learning network; and
making, by the programmed computer system, an additional modification to the machine-learning network based on the classification of the input data item to be classified.

42. The computer-implemented method of claim 41, wherein making the classification comprises computing, by the programmed computer system, an activation value for each node in the machine-learning network.

43. The computer-implemented method of claim 1, wherein, after making the one or more sensibility-improving modifications, the machine-learning network comprises one or more units and zero or more nodes, such that a sum of the units and the nodes is greater than two, wherein:
each of the one or more units produces multiple outputs, each from a separate activation function, where each of the separate activation functions are applied to an output of a common affine transformation for the unit; and
each of the zero or more nodes produces a single output, with a single activation function, applied to an output of a single affine transformation for the node.

44. The computer-implemented method of claim 43, wherein at least one of the units comprises a robust template model.

45. The computer-implemented method of claim 44, wherein the robust template model comprises at least two input variable norm cells and a template summation cell connected to the two input variable norm cells.

46. The computer-implemented method of claim 45, wherein each of the at least two input variable norm cells computes a single-variable norm.

47. The computer-implemented method of claim 46, where each of the single-variable norms is computed using a hyperparameter specified by a system comprising a cooperation of a team of one or more humans with one or more AI systems.

48. The computer-implemented method of claim 1, wherein:
the back-propagation pass for the first portion of the machine-learning network comprises training the first portion of the machine-learning network via gradient descent; and
computing the learned parameters further comprises, by the programmed computer system, training a second portion of the machine-learning network via training technique different from gradient descent.

49. The computer-implemented method of claim 48, wherein the training technique different from gradient descent comprises a histogram analysis, wherein the histogram analysis comprises:
computing a histogram of one or more variables from the training of the machine-learning network; and
making the one or more sensibility-improving modifications to the machine-learning network comprises making the one or more sensibility-improving modifications to the machine-learning network based on the histogram.

50. The computer-implemented method of claim 48, wherein the training technique different from gradient descent comprises setting an implicit local training target for a node of the machine-learning network.

51. The computer-implemented method of claim 48, wherein the training technique different from gradient descent comprises back-propagating labeled data examples for a second portion of the machine-learning network.

52. The computer-implemented method of claim 51, wherein the labeled data examples have implicit errors corrected.

53. The computer-implemented method of claim 48, wherein the training technique different from gradient descent comprises using an empirically estimated learned parameter for a node in a second portion of the machine-learning network.

54. The computer-implemented method of claim 48, wherein the training technique different from gradient descent comprises using an empirically estimated hyperparameter for a second portion of the machine-learning network.

55. The computer-implemented method of claim 48, wherein the training technique different from gradient descent comprises error minimization and back propagation of data examples for the second portion of the machine-learning network.

56. The computer-implemented method of claim 55, wherein the error minimization and back propagation of data examples for the second portion of the machine-learning network is in addition to back-propagation of derivatives through the second portion of the network.

57. The computer-implemented method of claim 1, wherein training the machine-learning network comprises training the machine-learning network to make a classification, once trained, on a presented data item.

58. The computer-implemented method of claim 57, further comprising:
training, by the programmed computer system, a diverse set of canary networks and a diverse set of robust networks; and
diagnosing, by the programmed computer system, a potential violation of sensibility from a data item for classification by the machine-learning network with the diverse set of canary networks and a diverse set of robust networks.

59. The computer-implemented method of claim 57, further comprising:
computing, by the programmed computer system, an alignment for the presented data item; and
using, by the programmed computer system, the alignment to inform the classification by the machine-learning network.

60. The computer-implemented method of claim 59, wherein the alignment is to a type of human knowledge.

61. The computer-implemented method of claim 60, wherein the type of human knowledge comprises a mereology.

62. The computer-implemented method of claim 1, wherein the machine-learning network is trained as a creative work generator.

63. The computer-implemented method of claim 62, wherein the creative work generator is trained as a written creative work.

64. The computer-implemented method of claim 62, wherein the creative work generator is trained as a visual creative work.

65. The computer-implemented method of claim 62, wherein the creative work generator is trained as a musical work generator.

66. The computer-implemented method of claim 62, wherein the creative work generator comprises a hyperparameter for controlling an amount of human participation in creating a creative work generated by the creative work generator.

67. The computer-implemented method of claim 62, wherein the machine-learning network is trained to have an explicit representation of human knowledge.

68. The computer-implemented method of claim 62, wherein the creative work generator comprises a style hyperparameter used in generating a creative work.

69. The computer-implemented method of claim 68, wherein the creative work generator further comprises a style adjustment subsystem for generating the style hyperparameter.

70. The computer-implemented method of claim 69, wherein the style adjustment subsystem comprises a parametric autoencoder.

71. A computer system comprising:
one or more processor cores; and
computer memory in communication with the one or more processor cores, wherein the computer memory stores computer instructions that when executed by the one or more processor cores, cause the one or more processor cores to train, dynamically, a machine-learning network from a base system, wherein the machine-learning network comprises, when built, multiple layers, wherein the multiple layers comprise an input layer, an output layer, and one or more hidden layers between the input and output layers, wherein each layer comprises one or more nodes such that the machine-learning network comprises a plurality of nodes, and wherein the computer instructions, when executed by the one or more processors, cause the one or more processors to train the machine-learning network by:
iteratively training the machine-learning network with a set of training data, wherein the iterative training comprises computing learned parameters for the machine-learning network, wherein the learned parameters comprise a weight for weighted connections in the machine-learning network, wherein computing the learned parameters comprise, for each training data item in the set of training data:
a forward pass through the machine-learning network that involves computations using the learned parameters; and
for at least a first portion of the machine-learning network, a back-propagation pass through the machine-learning network, wherein the back-propagation pass comprises, for the first portion of the machine-learning network, computation of derivatives, with respect to a loss function, for the learned parameters;
making a sensibility level assessment of the machine-learning network, wherein the sensibility level assessment comprises a determination of whether a result produced by the machine-learning network is insensible according to a criteria of sensibility, wherein the result for which the sensibility level assessment is made comprises one or more activation values computed by one or more nodes of the machine-learning network in response to input data; and
making one or more sensibility-improving modifications to the machine-learning network, wherein each of the one or more sensibility-improving modifications is in response to a determination, in the sensibility level assessment of the machine-learning network, that the machine-learning network produces an insensible result, such that the one or one or more sensibility-improving modifications make the machine-learning network less vulnerable to producing insensible results.

72. (canceled)

73. The computer system of claim 71, wherein;
at least one of the one or more sensibility-improving modifications comprises a structural modification to the machine-learning network; and
the structural modification comprises replacing a node of the machine-learning network with a plurality of replacement nodes.

74-81. (canceled)

82. The computer system of claim 71, wherein the computer instructions, when executed by the one or more processors, cause the one or more processors to make the one or more sensibility-improving modifications via:
a first training stage for the machine-learning network that trains selectively a sub-portion of the machine-learning network; and
after the first training stage, a second training stage that trains an entirety of the machine-learning network.

83-85. (canceled)

86. The computer system of claim 71, wherein:
the machine-learning network comprises, prior to the one or more sensibility-improving modifications, a regression-type output; and
at least one of the one or more sensibility-improving modifications comprises converting the regression-type output to a classification-type output for the machine-learning network.

87. The computer system of claim 71, wherein the one or more sensibility-improving modifications to the machine-learning network comprises creating and using a substitute derivative function for a node of the machine-learning network.

88-95. (canceled)

96. The computer system of claim 71, wherein the one or more sensibility-improving modification comprises training a node in the machine-learning network to:
produce a first output value for an input that is within a known set; and
produce a second output value, different from the first input value, when the input is not within the known set.

97-99. (canceled)

100. The computer system of claim 71, wherein the sensibility level assessment of the machine-learning network comprises a determination of whether a small change in an input to the machine-learning network causes the machine-learning network to make a mistake on the input that the machine-learning network did not make before the small change in the input.

101-103. (canceled)

104. The computer system of claim 71, wherein the sensibility level assessment of the machine-learning network is based on a dimensionality of a number of variables for the machine-learning network and derivatives of an output function of the machine-learning network with respect to an input.

105. The computer system of claim 71, wherein:
the sensibility level assessment of the machine-learning network comprises a test of a decision boundary for a decision by the machine-learning network; and
the computer instructions, when executed by the one or more processors, cause the one or more processors to make the one or more making the one or more sensibility-improving modifications by moving a position of the decision boundary.

106. The computer system of claim 71, wherein the computer instructions, when executed by the one or more processors, cause the one or more processors to make the one or more sensibility-improving modifications by creating a local normed space with an autoencoder, such that the local normed space limits an effective dimensionality of input to a detector element or discriminator element of the machine-learning network.

107. The computer system of claim 71, wherein the computer instructions, when executed by the one or more processors, cause the one or more processors to make the sensibility level assessment of the machine-learning network by making both a first sensibility level assessment and making a second sensibility level assessment, wherein the first sensibility level assessment has a different criteria for sensibility than the second sensibility level assessment.

108-110. (canceled)

111. The computer system of claim 71, wherein the computer instructions, when executed by the one or more processors, further cause the one or more processors to, as part of the training of the machine-learning network and after making the sensibility level assessment of the machine-learning network:
make a classification of an input data item to be classified with the machine-learning network; and
make an additional modification to the machine-learning network based on the classification of the input data item to be classified.

112. (canceled)

113. The computer system of claim 71, wherein, after making the one or more sensibility-improving modifications, the machine-learning network comprises one or more units and zero or more nodes, such that a sum of the units and the nodes is greater than two, wherein:
each of the one or more units produces multiple outputs, each from a separate activation function, where each of the separate activation functions are applied to an output of a common affine transformation for the unit; and
each of the zero or more nodes produces a single output, with a single activation function, applied to an output of a single affine transformation for the node.

114-126. (canceled)

127. The computer system of claim 71, wherein the computer instructions, when executed by the one or more processors, cause the one or more processors to train the machine-learning network by training the machine-learning network to make a classification, once trained, on a presented data item.

128. The computer system of claim 127, wherein the computer instructions, when executed by the one or more processors, further cause the one or more processors to:
train a diverse set of canary networks and a diverse set of robust networks; and
diagnose a potential violation of sensibility from a data item for classification by the machine-learning network with the diverse set of canary networks and a diverse set of robust networks.

129. The computer system of claim 127, wherein the computer instructions, when executed by the one or more processors, further cause the one or more processors to:
compute an alignment for the presented data item; and
use the alignment to inform the classification by the machine-learning network.

130-140. (canceled)
